(19) United States
(12) Patent Application Publication
(10) Pub. No.: US 2003/0161355 A1
(43) Pub. Date: Aug. 28, 2003

(54) Multi-mode framer and pointer processor for optically transmitted data

(76) Inventors: Rocco Falcomato, San Jose, CA (US); Chau-Hom Guo, Cupertino, CA (US)

Correspondence Address: Scott B. Stahl, Jackson Walker LLP, Ste. 600, 2435 N. Central Expwy., Richardson, TX, 75080, US

(21) Appl. No.: 10/329,287

(22) Filed: Dec. 23, 2002

Related U.S. Application Data
(60) Provisional application No. 60/343,555, filed on Dec. 21, 2001.

(51) Int. Cl. H04L 12/28; H04L 12/56; H04J 3/02

(52) U.S. Cl. 370/539; 370/907

(57) ABSTRACT

A multi-mode framer/pointer processor apparatus can selectively accommodate one or more OC-192 data streams and can also selectively accommodate an OC-768 data stream.

This application claims the priority under 35 U.S.C. 119(e)(1) of U.S. Provisional Application No. 60/343,555 filed on Dec. 21, 2001 and incorporated herein by reference.

### FIELD OF THE INVENTION

This invention relates to data processing and, more particularly, to the processing of data transmitted in optical networks.

### BACKGROUND OF THE INVENTION

FIG. 117 diagrammatically illustrates an example of a SONET/SDH framer/pointer processor apparatus according to the prior art. The apparatus of FIG. 117 interfaces between a digital cross-connect apparatus and OC-192 signals transmitted on a fiber optic transmission medium. As shown in FIG. 117, the prior art apparatus requires 4 OC-192C framers, each of which is independent of other framer/pointer processors. The 4 separate framer devices of FIG. 117 are typically provided as part of a chip set on a line card between the optical transmission medium and the digital cross-connect apparatus.

It is desirable in view of the foregoing to provide framer functionality such as illustrated in FIG. 117 in a more highly integrated form.

Exemplary embodiments of the present invention provide a multi-mode framer/pointer processor apparatus which can selectively accommodate one or more OC-192 data streams and which can also selectively accommodate an OC-768 data stream. In exemplary embodiments, the multi-mode framer/pointer processor apparatus is provided on a single chip integrated circuit device.

### BRIEF DESCRIPTION OF THE DRAWINGS

FIG. 1 diagrammatically illustrates exemplary embodiments of a framer and pointer processor apparatus according to the invention.

FIG. 1A diagrammatically illustrates the framer and pointer processor of s FIG. 1 operating in an OC-768 environment.

FIG. 1B diagrammatically illustrates the framer and pointer processor of FIG. 1 operating in an OC-192 environment.

FIG. 1C is a top level view of the framer and pointer processor of FIG. 1.

FIG. 2 illustrates a data format convention according to the prior art.

FIGS. 3-5 illustrate a data format convention utilized by exemplary embodiments of the invention.

FIGS. 6-9 diagrammatically illustrate exemplary embodiments of the microprocessor interface of FIG. 1.

FIGS. 10-11B diagrammatically illustrate exemplary embodiments of the bit aligner of FIG. 1.

FIGS. 12-15 diagrammatically illustrate exemplary embodiments of a demultiplexer of FIG. 1.

FIGS. 16-19 diagrammatically illustrate exemplary embodiments of a further demultiplexer of FIG. 1.

FIGS. 20-20B diagrammatically illustrate exemplary embodiments of a further demultiplexer of FIG. 1.

FIGS. 21-23 diagrammatically illustrate exemplary embodiments of a multiplexer of FIG. 1.

FIGS. 24 and 24A diagrammatically illustrate exemplary embodiments of a further multiplexer of FIG. 1.

FIGS. 25-26A diagrammatically illustrate exemplary embodiments of a further multiplexer of FIG. 1.

FIGS. 27-32 diagrammatically illustrate exemplary embodiments of a deskew apparatus of FIG. 1.

FIGS. 33-37 diagrammatically illustrate exemplary embodiments of a further deskew apparatus of FIG. 1.

FIGS. 38-54C diagrammatically illustrate exemplary embodiments of the framer apparatus of FIG. 1.

FIGS. 55-72 diagrammatically illustrate exemplary embodiments of the SPE multiplexer/demultiplexer apparatus of FIG. 1.

FIGS. 73-94 diagrammatically illustrate exemplary embodiments of the pointer processor apparatus of FIG. 1.

FIGS. 95-115B diagrammatically illustrate exemplary embodiments of the time division multiplexing apparatus of FIG. 1.

FIG. 116 illustrates exemplary data inputs to the SPE multiplexer of FIG. 1.

FIG. 116A illustrates exemplary data outputs produced by the SPE multiplexer of FIG. 1 in response to the data inputs of FIG. 116.

FIG. 117 diagrammatically illustrates an example of a framer/pointer processor apparatus according to the prior art.

FIG. 118 illustrates in tabular format the programmability of fixed stuff columns in STS payloads according to exemplary embodiments of the invention.

FIG. 119 illustrates the POH of an STS-192c stream according to exemplary embodiments of the invention.

FIG. 120 diagrammatically illustrates exemplary embodiments of a memory apparatus which permits flexible concatenation of STS channels according to the invention.

### DETAILED DESCRIPTION

### I

The Titan is a single chip SONET/SDH Framer and Pointer Processor device that includes exemplary embodiments of the invention. The Titan device can be configured to operate in one of the following modes:

Single SONET OC-768/SDH STM-256 Framer and Pointer Processor

Single/Dual/Triple or Quad Port SONET OC-192/SDH STM-64 Framer and Pointer Processor.

This device can be configured to support any mix of STS-1/AU-3 or STS-Nc/AU-4-Xc payloads from a single OC-192c/AU-4-64c to 192 STS-1/AU-3 channels per port in OC-192 mode.

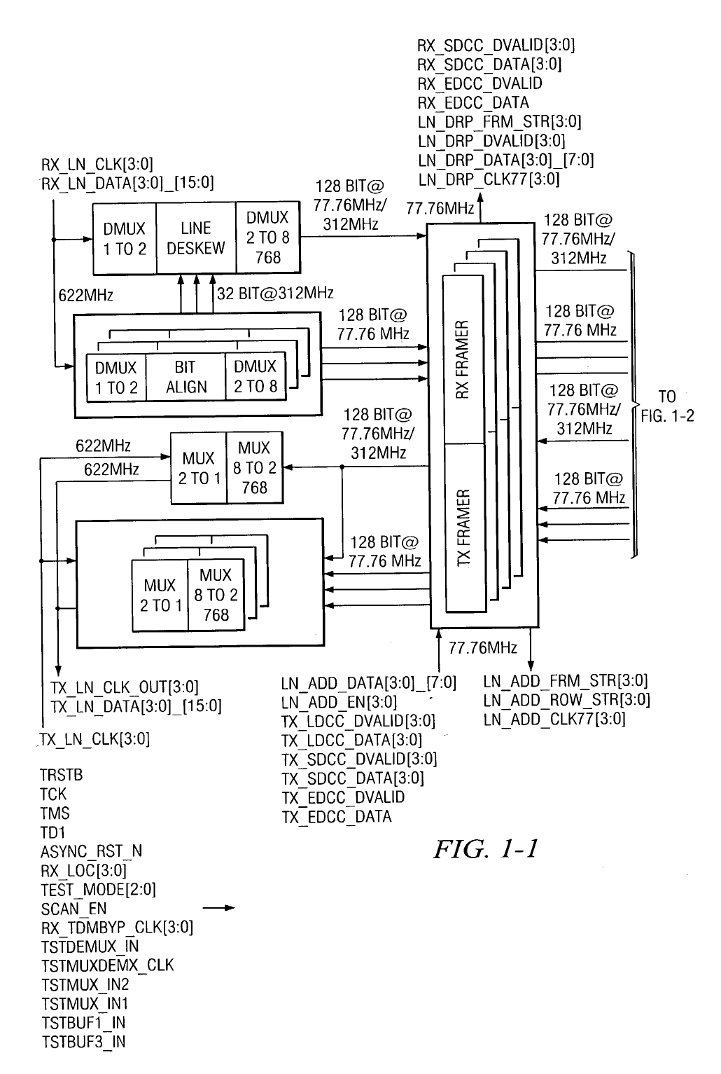

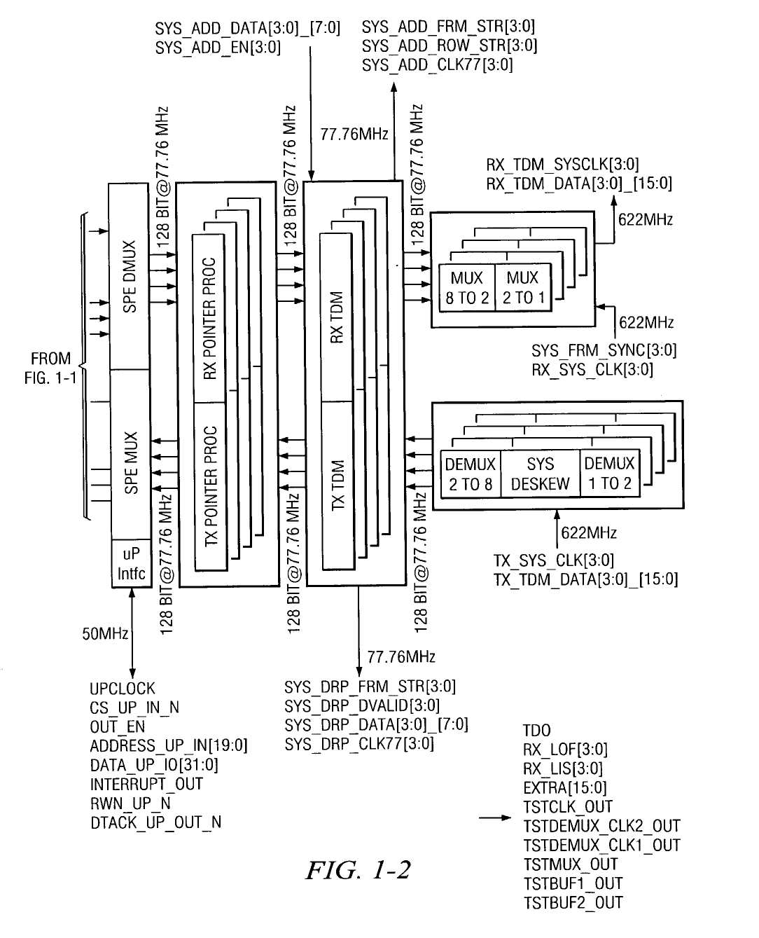

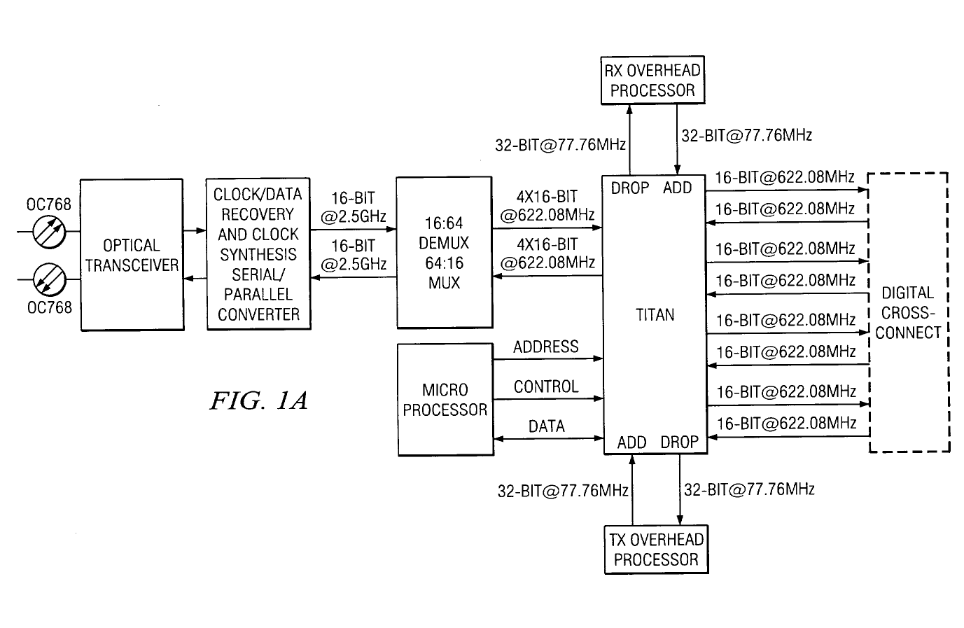

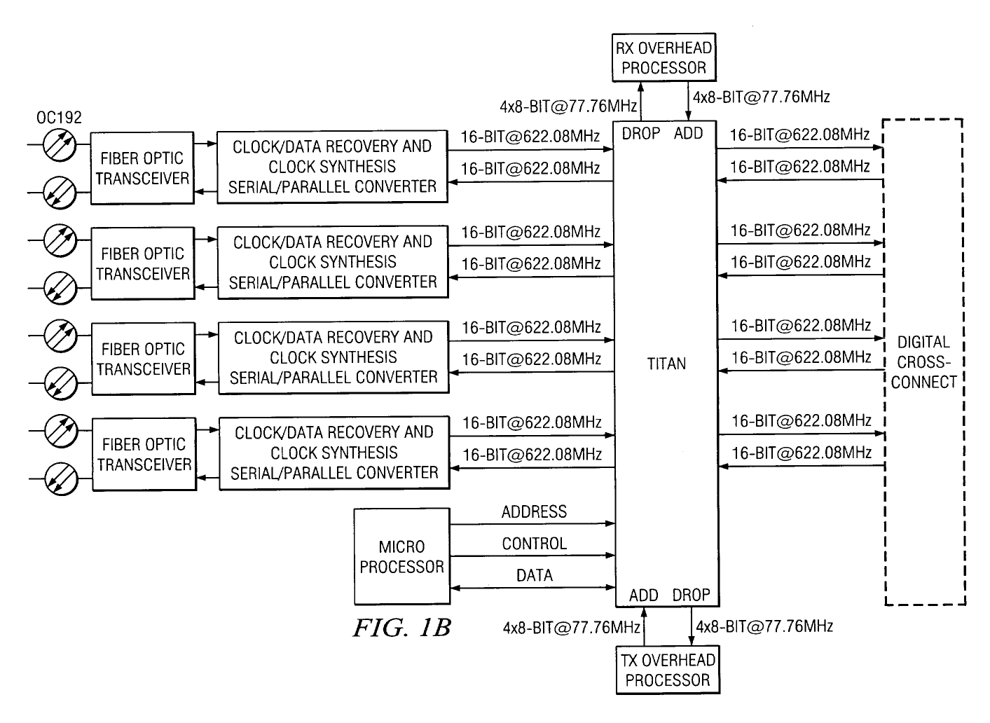

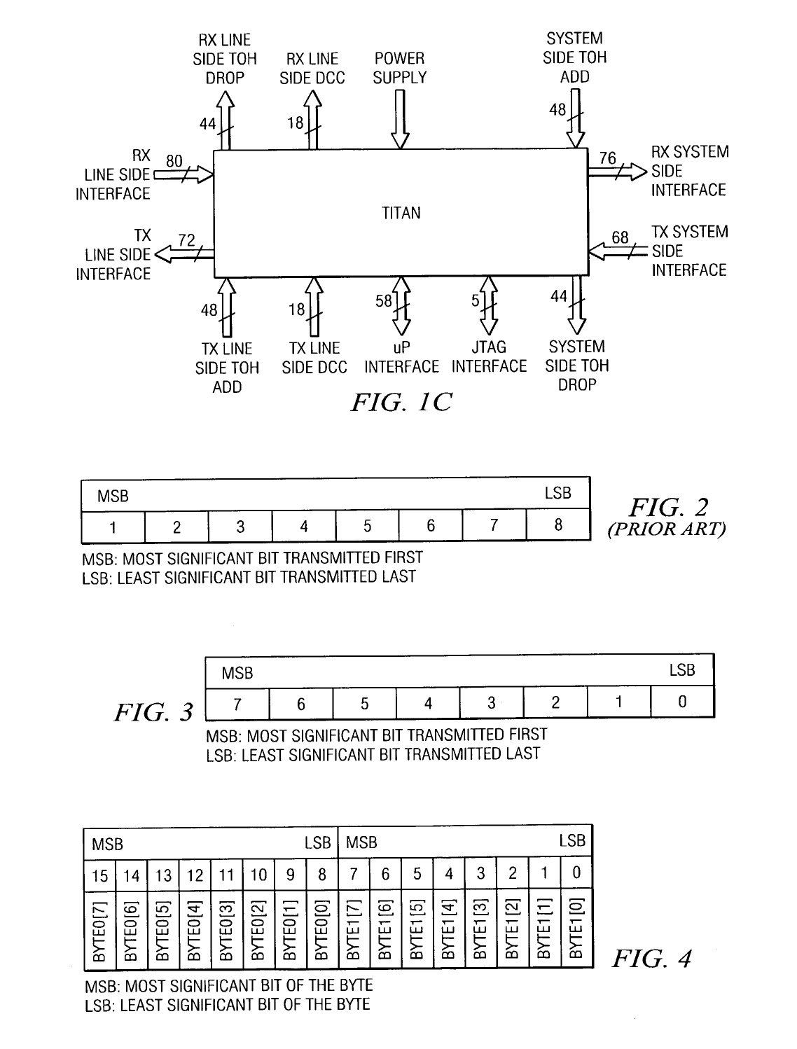

FIG. 1 shows exemplary embodiments of the Titan device with reference to the major hierarchical floor-planning blocks. FIG. 1C shows the device from a top level perspective.

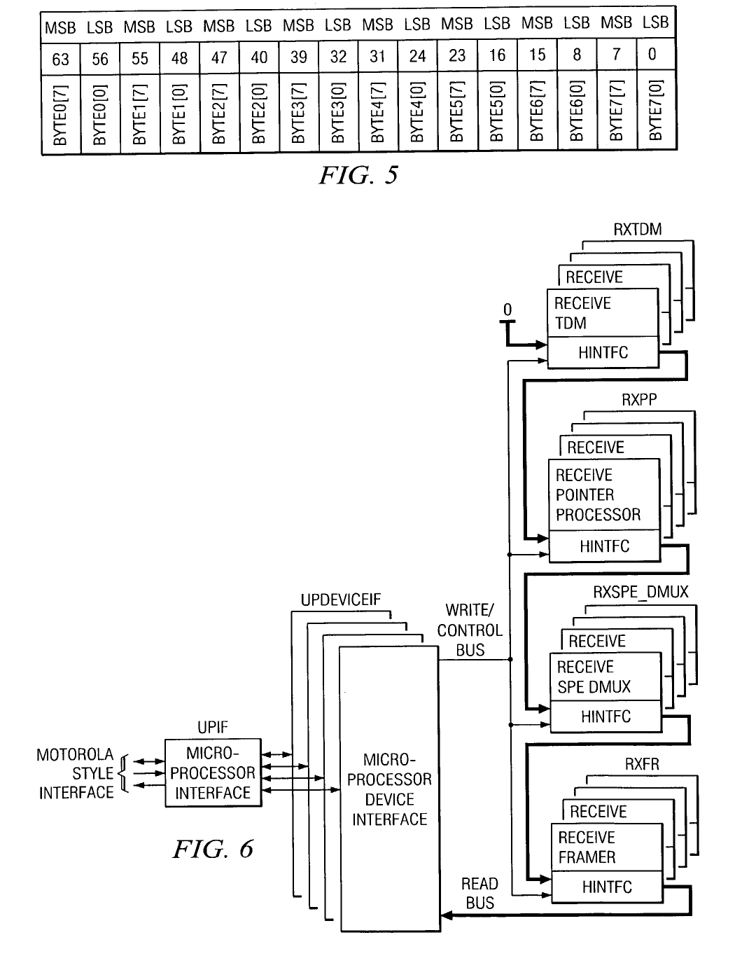

It is important to note the convention differences between the bit position numbering generally used in SONET, such as GR-253-CORE (FIG. 2) and the bit position numbering used in this specification (FIG. 3). Note also the byte positions for OC-192 (FIG. 4) and OC-768 (FIG. 5) used in this specification.

When Titan is configured as an OC-192 device (see FIG. 1B), there is a 10 Gbps SFI-4 interface for each port on the system and line side that is organized (see FIG. 1B) as a 622 MHz interface at 16 bits. For every 622 MHz clock, there are two bytes of information transmitted, and FIG. 4 describes how the most significant byte is transmitted in the least significant byte position and vice versa.

When Titan is configured as an OC-768 device (see FIG. 1A), there are four 10 Gbps SFI-4 interfaces that are aggregated together inside Titan to create a single 40 Gbps link on the line side of the device, thus for every 622 MHz clock there are eight bytes transmitted. FIG. 5 describes the byte ordering positions of the eight bytes.

Exemplary Features

Supports SONET line timing mode on the Rx line side and SONET external timing mode on the Rx and Tx system side, and on the Tx line side.

SONET/SDH synchronous multiplex/demultiplex single channel OC-768/STM-256 to 4 channels OC-192/STM-64 when device is configured in OC-768 mode.

Terminates on the Rx line side both section and line overhead bytes A1/A2, J0, B1, B2, K1/K2, S1, M0/M1.

Terminates on the Tx system side section overhead bytes A1/A2, B1.

Generates on the Tx line side both section and line overhead bytes A1/A2, J0, B1, B2, K1/K2, S1, M0/M1.

Generates on the Rx system side both section overhead bytes A1/A2, B 1.

Supports four external interfaces for extraction and insertion of all Transport Overhead (TOH) bytes on both the line side and system side interfaces operating at 77 MHz.

Supports two external interfaces for extraction and insertion of all Data Communications Channel (SDCC, LDCC, and EDCC) bytes operating at 77 MHz.

Supports single independent port for OC-768 mode.

1. Provides a 64-bit bus on the line side operating at 622 MHz.

2. Provides quad OIF SFI-4 interfaces on the system side operating at 622 MHz.

3. Supports de-multiplexing operation on the line of OC-768 stream at 64 bytes at a time.

Supports up to four independent ports for OC-192 mode.

1. Provides quad OIF SFI-4 interfaces on the line side operating at 622 MHz.

2. Provides quad OIF SFI-4 interfaces on the system side operating at 622 MHz.

Supports STS-1 granularity pointer processing.

Supports STS-1 granularity Path Overhead (POH) monitoring for B3, G1, C2.

Supports single programmable channel for monitoring J1 path trace message.

Supports standard and non-standard concatenation levels, i.e., STS-3c, STS-5c, STS-21c, STS-48c, etc.

Line side and system side scrambler/de-scrambler have an option to be enabled/disabled and uses (1+x⁶+x⁷ polynomial.

Supports Rx line side and Tx system side Loss of Signal (LOS), Loss of Frame (LOF), Severely Errored Frame (SEF).

Supports Rx line side Loss of Pointer (LOP) and Alarm Indication Signal (AIS).

Supports Rx and Tx line side Loss of Clock (LOC) alarms.

Rx line and Tx system data input de-skewer provides +/−8 UI 622 MHz clock cycles between four ports.

Rx system interface aligns receive payload to system frame pulse.

Provides plesiosynchronous fifo synchronizer to synchronize Rx line data to Rx system clock.

Provides power down feature for rams of each block.

Provides a 20-bit address and 32-bit data interface to MPC860 Motorola microprocessor.

Allows dynamic provisioning of new service without disrupting service on existing channels.

Provides bit-aligner on the Rx Line and Tx System side to lock the A1/A2 pattern to the octet boundary in OC-192 and OC-768 mode.

Provides bit-aligner on the Tx System side to lock the A1/A2 pattern to the octet boundary in OC-192 mode.

Testing features

1. JTAG interface for I/O boundary scan.

2. Full internal scan of all flip flops.

3. Internal memory BIST for all memories.

4. Internal test bus for multiplexing of internal state machines to external pins.

5. LVDS I/O buffer testing.

6. MUX2TO1 and DEMUX1TO2 testing.

7. Single port OC-768, and per port OC-192 Rx to Tx and Tx to Rx line side loopback.

8. Per port Rx to Tx and Tx to Rx system side loopback.

9. Programmability to capture any byte in SONET stream on Rx line side and Tx system side.

10. Programmable insertion of LOS, LOF on Rx system side and Tx line side.

b 11. Programmable insertion of B1 and B2 errors on Rx system side and Tx line side.

12. Programmable long frame or short frame mode.

13. Programmable AIS-L and AIS-P on the Tx system side.

Miscellaneous pins

1. Provides separate interrupt pins per port (RX[n]_LIS), for programmably selecting any one of the following line side alarms: LOF, LOS, SEF and LOC alarms.

2. External input pins per port for receive line LOC reporting by CDR or transponder device (RX[n]_LOC).

3. External output pins per port for LOF reporting (RX[n]_LOF).

Clocking

There are four external ports in Titan, each comprising an SFI-4 compliant 10 Gb/s link and operating at 622.08 MHz at 16 bits. When the device is operating as a 40 Gb/s device, the receive and transmit line side interfaces are ganged together to operate at 622.08 MHz at 64 bits. Whether the device is used as four 10 Gb/s links (OC-192 mode) or a single 40 Gb/s link (OC-768 mode), the receive and transmit system interfaces always function as four 10 Gb/s links.

The primary operating frequency of the receive and transmit SFI-4 interfaces is exactly 622.08 MHz. These blocks include the MUX2TO1 and DEMUX1TO2 blocks. The DEMUX2TO8, MUX8TO2, FR, and SPE blocks operate at ½ the primary operating frequency, or exactly 311.04 MHz. Finally, the TOH interfaces and the core blocks (PP, TDM) of the device operate at ⅛^{th} the primary frequency or exactly 77.76 MHz.

The microprocessor interface operates from 25 to 50 MHz, and is not related to the primary operating frequency.

The microprocessor interface is partitioned as described in the FIG. 6. There is a central block that terminates the external microprocessor protocol, and translates those signal to an internal proprietary format. The Host Interface block (HINTFC) is the block that performs termination of the internal protocol, and is a generic block that is instantiated in all other blocks.

The block is instantiated on the far end of the internal processor bus, and is used to terminate read/write accesses generated by the near end. The block is designated to provide a daisy chain for the read data bus to minimize bus routing for both transmit and receive datapaths, and normal point to point connections for all write bus and control signals.

FIG. 6 shows how the HINTFC module fits into the overall processor interface architecture showing the receive write/control and read bus connections only, for a single port. However there is a read daisy chain bus each for receive and transmit paths, for each port, thus there are a total of eight read bus daisy chains. The write/control bus is per port only thus there are a total of four write/control buses. There are a total of thirty-two instantiations of the HINTFC module.

The purpose of the Host Interface block is to implement the following functions:

Terminate internal bus read/write access.

Synchronize interrupts from local clock domain to the host clock domain.

Synchronize module soft resets from the host clock domain to the local clock domain.

Daisy chain read data bus signals.

Synchronize host data write bus signals from host clock domain to local clock domain.

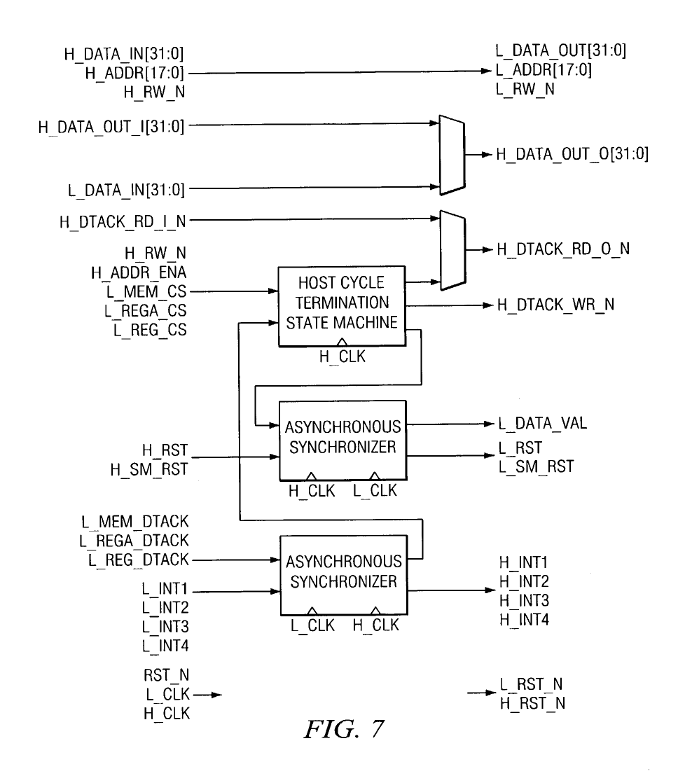

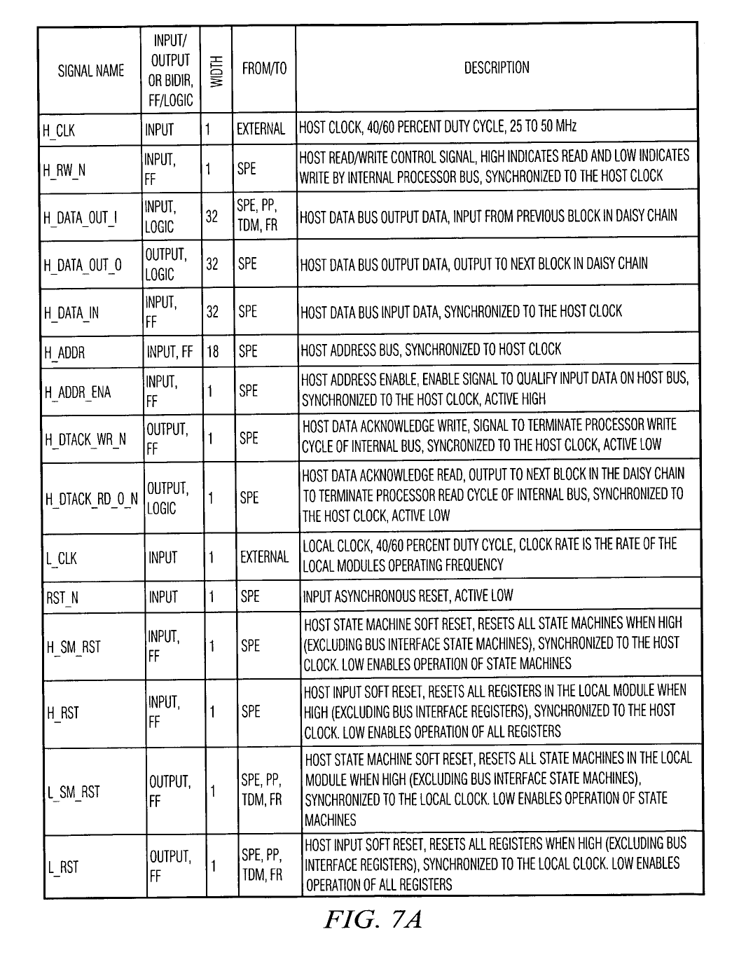

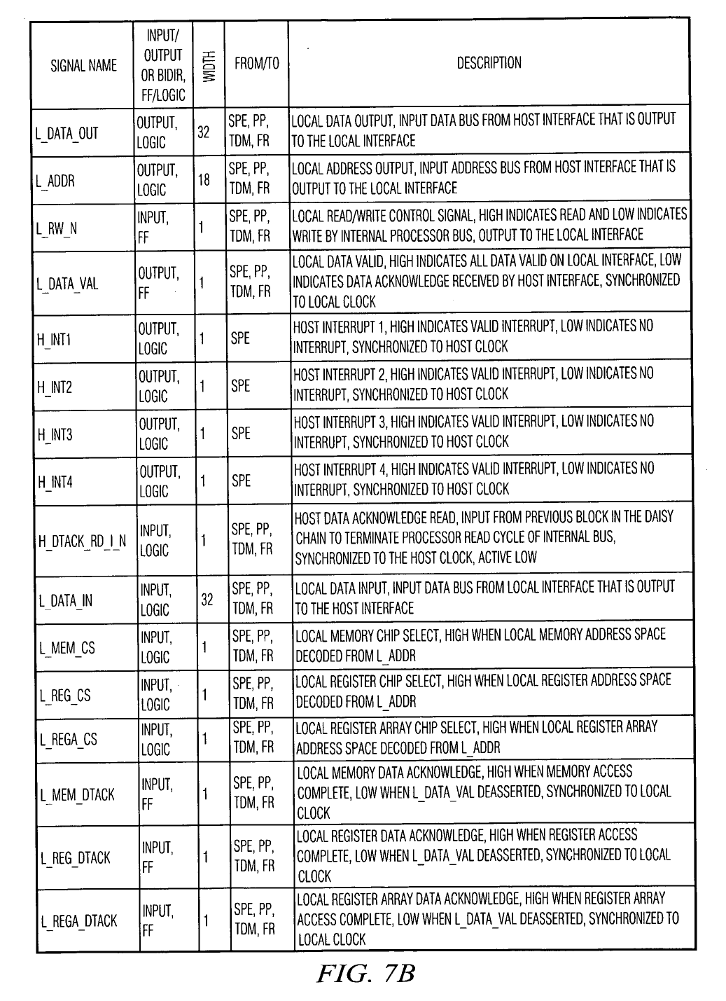

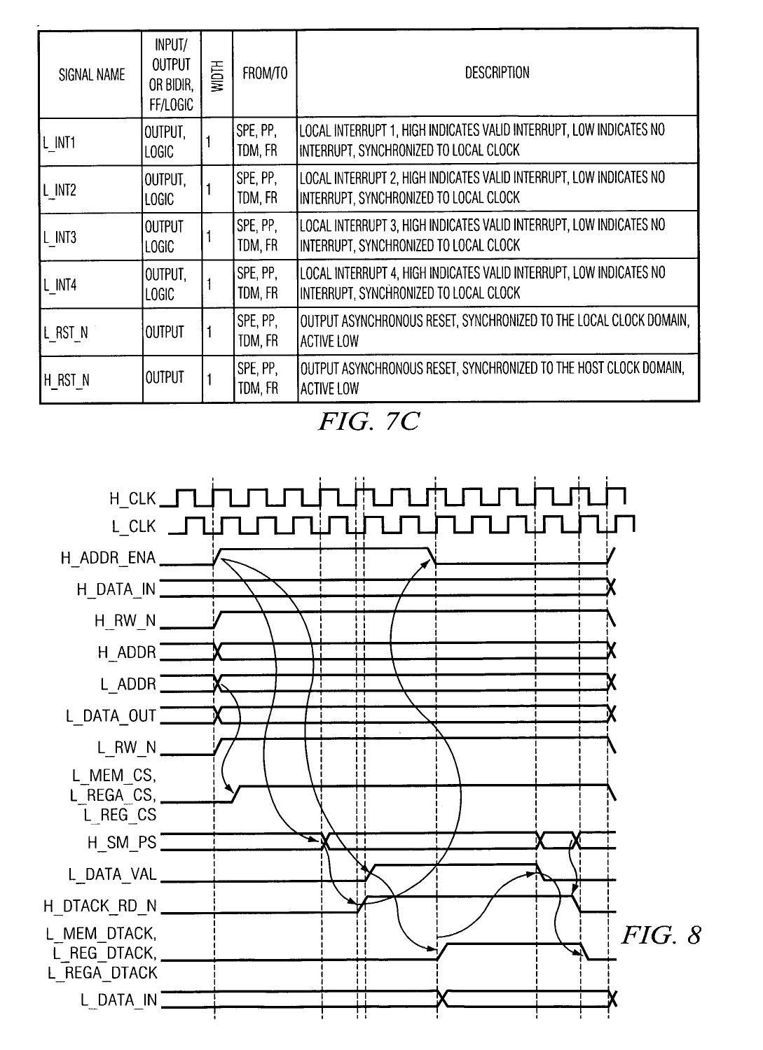

FIG. 7 is a block diagram of the top level of the HINTFC block, showing all input and output signals ( see also FIGS. 7A-7C) and basic data flow.

The Host Interface module terminates read/write accesses from the near end host interface module. An access begins when address enable goes high, which qualifies all signals on the host address bus. Since all outputs for the near end interface are generated on the same clock, and since there will be significant clock and data skew due to the long routing, the address enable signal is double clocked to provide significant setup time. When the positive going edge is detected on the double clocked address enable, the chip selects from the local module are then sampled and the cycle termination state machine switches state.

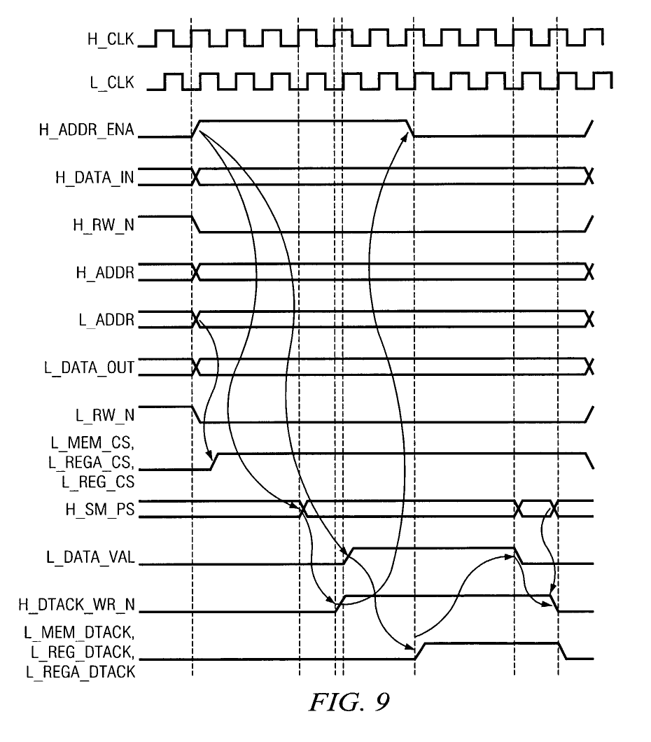

There are three states that wait for the data acknowledge from the local module for the three types of accesses: the register array access, the memory access or the register access. The data acknowledges from the local module are first synchronized to the host clock domain, before they are used by the cycle termination state machine. Once the synchronized data acknowledge is sampled high the state machine goes into its final data acknowledge state, which generates the data acknowledge back to the near end host interface and deasserts the local data valid. When the local module samples data valid low it then deasserts its local date acknowledge. FIGS. 8 and 9 respectively show read and write cycles.

The front-end high-speed multiplex/demultiplex, deskew and bit align modules include DEMXU1TO2, DEMUX2TO8, MUX2TO1, MUX8TO2, DEMUX2TO8_{—}768, MUX8TO2_{—}768, DESKEW_ALIGN, DS_SYS_ALIGN and BYAL_{—}32 modules. These modules provide the data synchronization between 622 MHz and 311 MHz and between 311 MHz and 77 MHz. The frequency of the normal data input/output of Titan is operating at 622 MHz. These modules are required since the core operating frequency of Titan is 77 MHz.

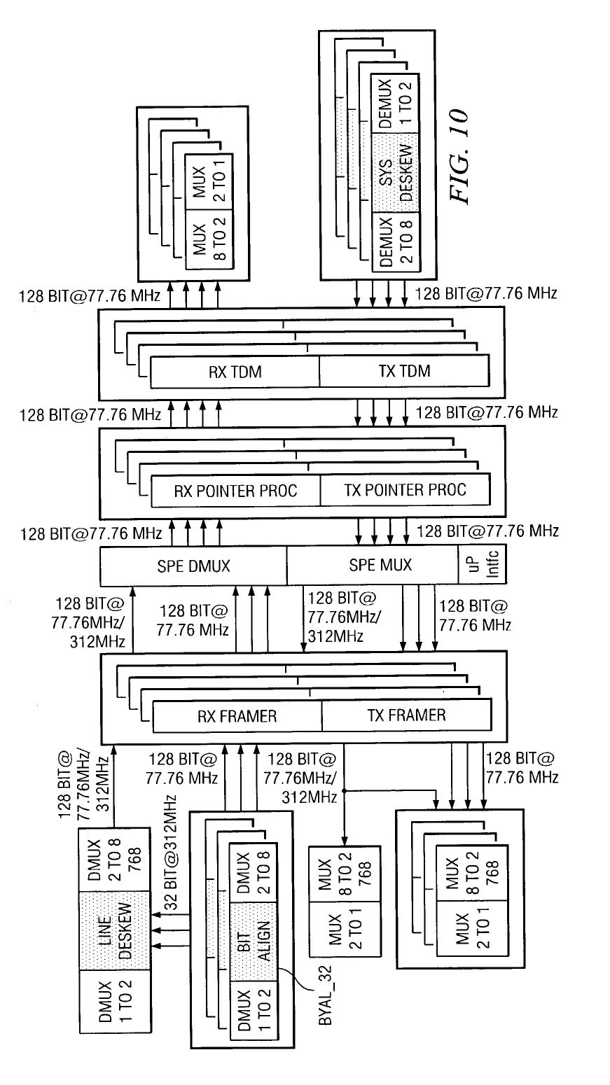

FIG. 10 highlights the BYAL_{—}32 block in the overall chip design.

The bit aligner BYAL_{—}32 resides between the DEMUX1TO2 and the DEMUX2TO8 blocks in pipes 1 through 3. In addition, it is incorporated in the DESKEW_ALIGN block in pipe 0 and all the DS_SYS_ALIGN blocks. The bit aligner has the function of aligning the input receive line side data to the octet boundary. Every 312 MHz clock the bit aligner searches for the A1/A2 pattern in the input 32 bit data, and when it finds it, it locks the octet boundary to the pattern position. The bit aligner is only functional when the framer is out of frame,,this ensures that the bit aligner doesn't lock onto the wrong octet boundary when the channel is experiencing bit errors that aren't high enough to cause the framer to go out of frame. In addition, the bit aligner is only operational in OC-192 mode, in OC-768 mode Titan is expected to interface with a multiplex/demultiplex device (see FIG. 1A) that performs the bit alignment function.

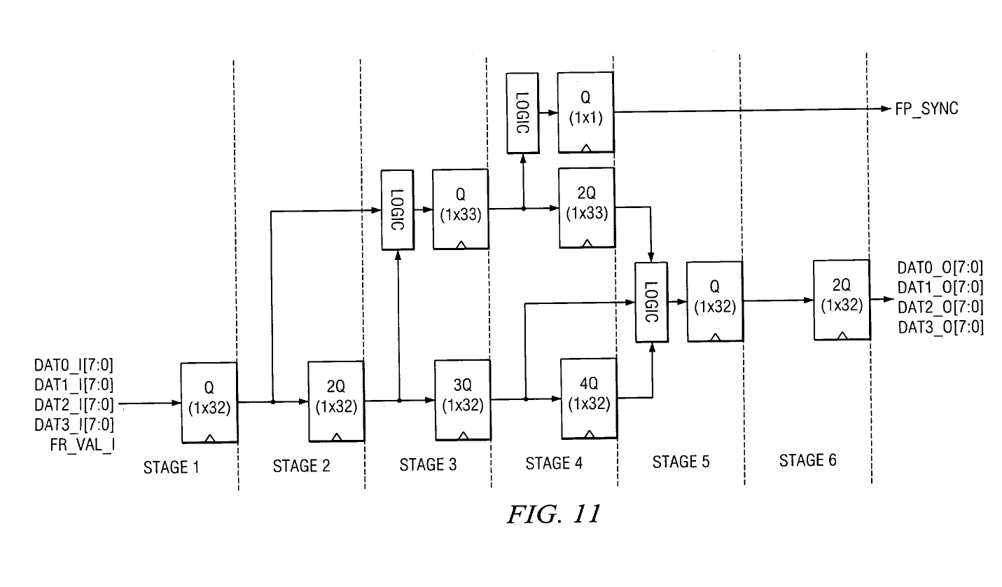

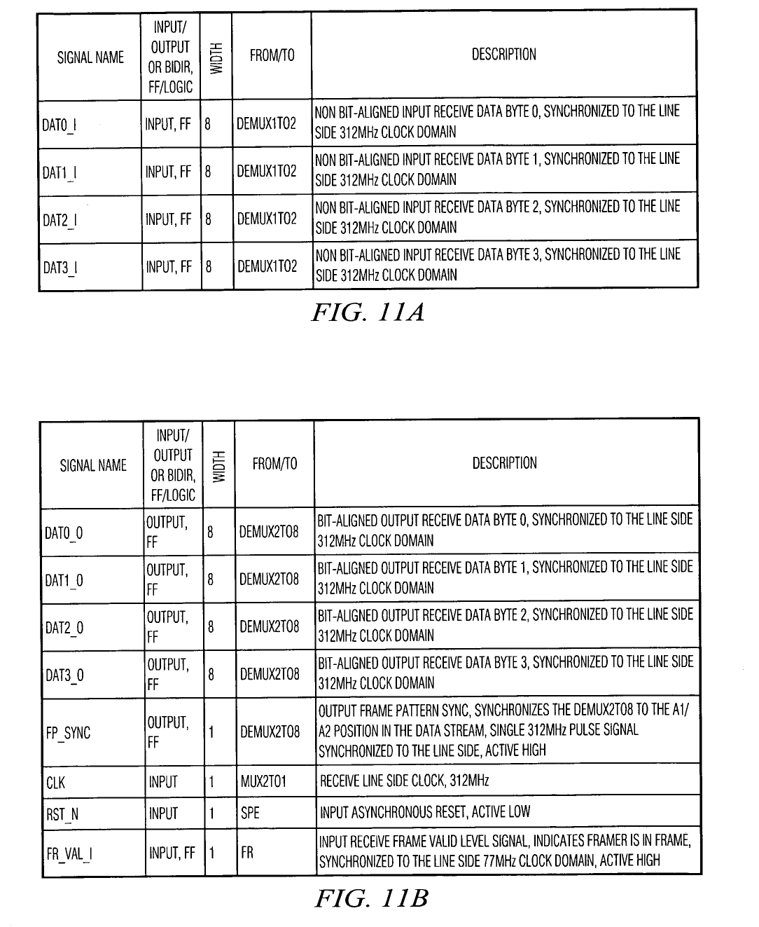

FIGS. 11-11B illustrate the bit aligner. There are six pipeline stages in the design—the first three stages are used to pipeline the input data and search for the A1/A2 pattern. Once the pattern is detected using thirty-three 32-bit comparators, the one-hot encoded comparator bus is registered. The comparator bus is unary OR'd together with the FR_VAL signal to generate the FP_SYNC signal. The FP_SYNC signal is used by the DEMUX2TO8 block to synchronize its counter to the data stream. The FP_SYNC signal must be two clocks earlier than the byte aligned data, to account for the datapath in the DEMUX2TO8. The registered one-hot encoded comparator bus then used by a multiplex, which selects data from pipeline stages three and four, to select the A1/A2 data position to the internal octet boundary.

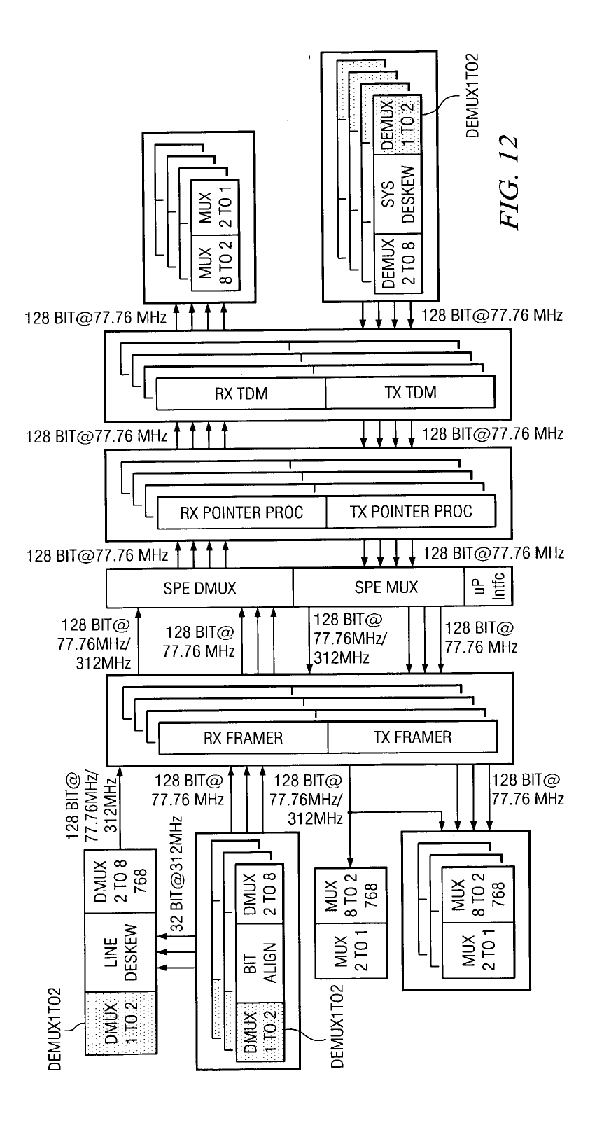

FIG. 12 highlights where the DEMUX1TO2 block resides with respect to the entire design.

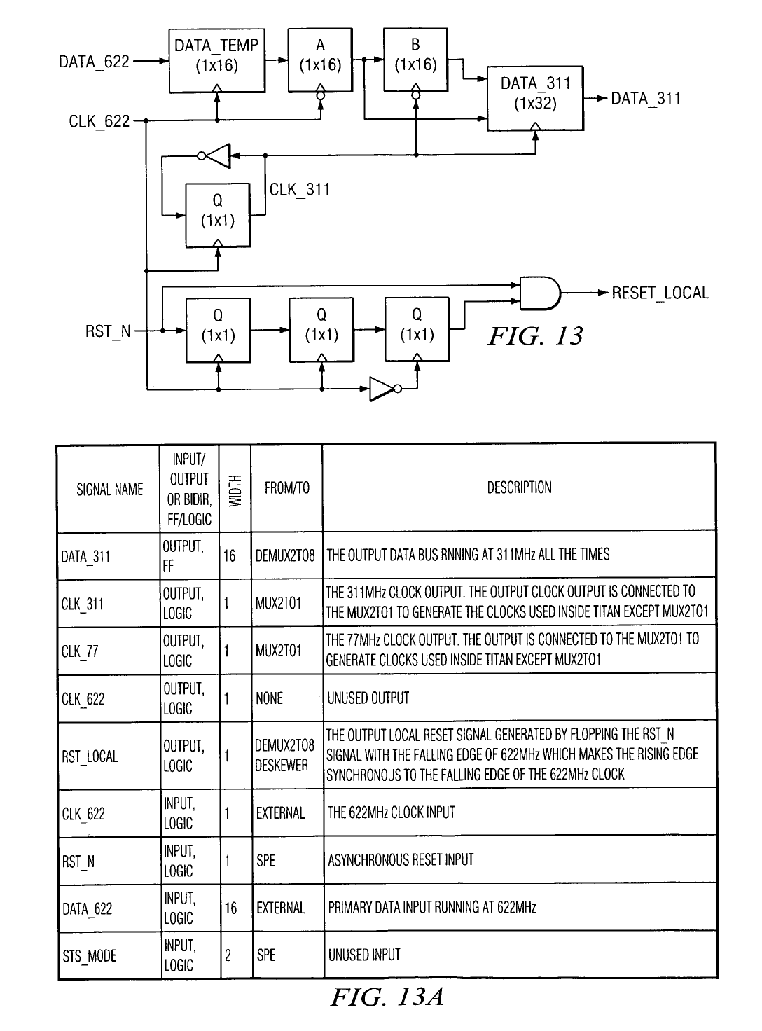

The DEMUX1TO2 module is instantiated in two places: Rx line side and Tx system side. The module generates a 311 MHz clock (CLK₁₃311) internally and uses this clock for the demultiplexing function. The module first latches the data by using the input 622 MHz clock (CLK-622). An inverted 622 MHz clock is used to shift the data to the second stage flop since the data needs to transfer to 311 MHz right away. The negative edge of 311 MHz clock is then used to shift the data out from the 622 MHz domain. Finally, the data is flopped to a 32-bit register from the shift register and output. The data from the negative edge of the 311 MHz clock serves as the lower byte of the outgoing data. FIGS. 13 and 13A describe the DEMUX1TO2 block.

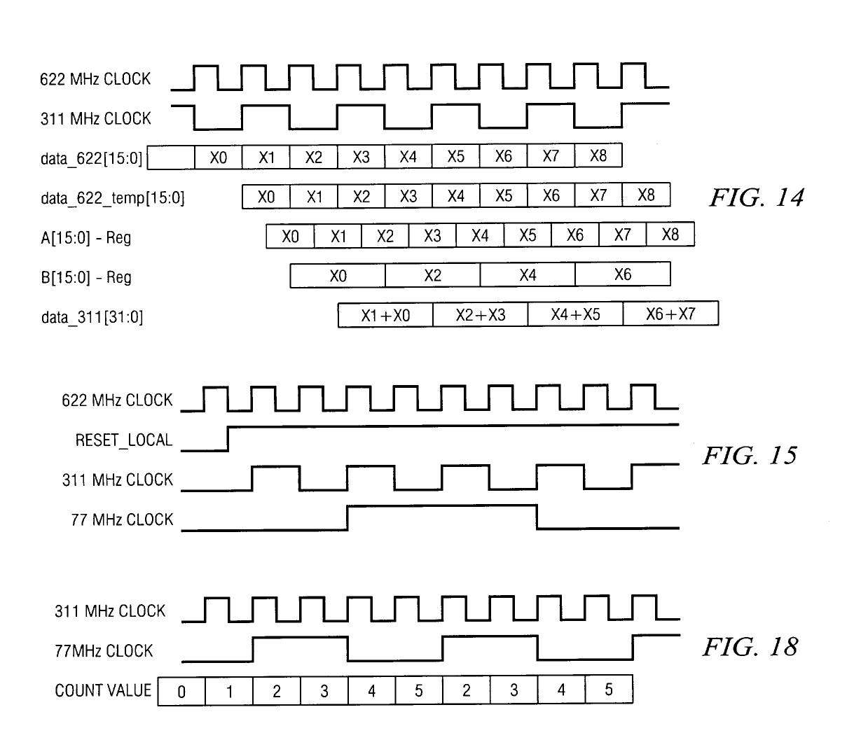

The two clocks of 622 MHz make up one 311 MHz clock. The first byte coming in goes through positive and negative 622 MHz clock stages to be latched at the negative edge of 311 MHz, which is behind the second rising edge of 622 MHz. The second byte coming in is latched only by the positive and negative edges of the 622 MHz clock. At the rising edge of 311 MHz clock, both bytes are ready and have plenty of setup time. The sequence of the data demultiplexing is shown in FIG. 14.

The RESET_LOCAL signal is generated by shifting the input reset signal RST_N three times with the negative-edge clock at the last stage. The rising edge of the RESET_LOCAL signal is synchronous to the falling edge of the 622 MHz clock. The RESET_LOCAL signal is only connected to the DEMUX2TO8 and the deskewer/bit-aligner of the same port at the same side. The three modules (DEMUX1TO2, deskew/bit-aligner and DEMUX2TO8) come out of the reset at the same 622 MHz clock.

DEMUS1TO2 also generates a 77 MHz clock (CLK_{—}77) by shifting one with an 8-bit ring counter. When the one is in bit 3, 4, 5 and 6, one is output on the 77 MHz otherwise zero is sent out. The relationship among the three clocks (622 MHz clock, 311 MHz clock and 77 MHz clock) is shown in FIG. 15.

As can be seen this module only performs the demultiplex function without looking into the content of the data. In OC-192 mode, a bit-aligner after the DEMUX1TO2 performs the alignment function by searching A1/A2 boundary inside the data stream. In OC-768 mode, the incoming data is byte aligned and the deskewer will line up the A1/A2 boundary on 32-bit boundary.

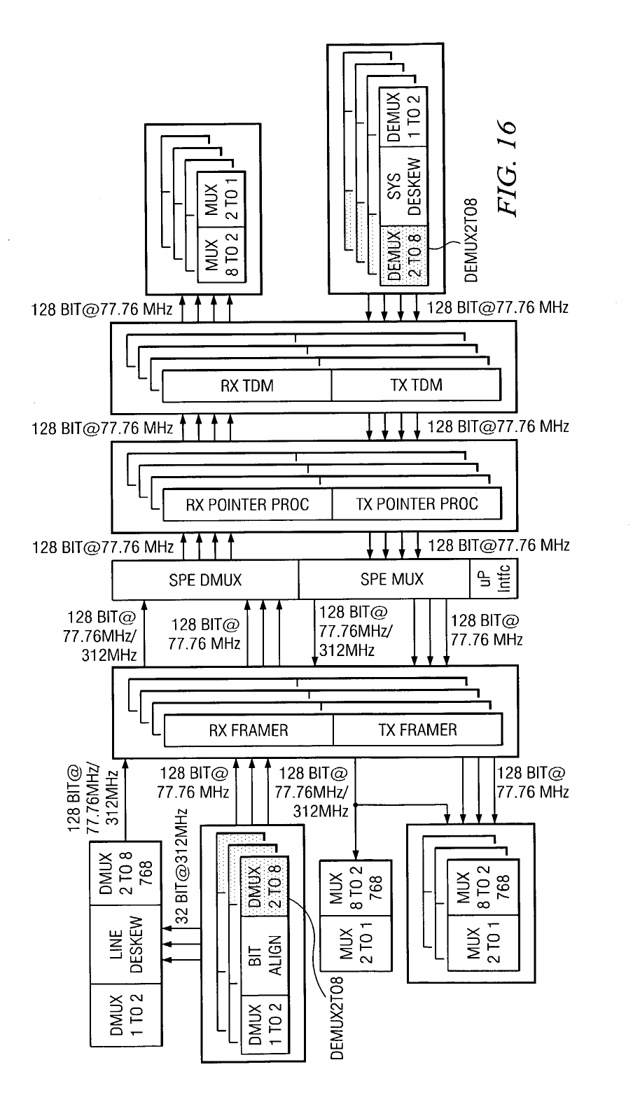

FIG. 16 highlights where the DEMUX2TO8 block resides with respect to the entire design.

The function performed by DEMUX2TO8 is purely a demultiplexing function without aligning the data with A1/A2 boundary. The bit-aligner in front of the DEMUX2TO8 lines up the data with the A1/A2 transition at the 32-bit boundary. Hence, this module translates the input data of high frequency to the output data of lower frequency.

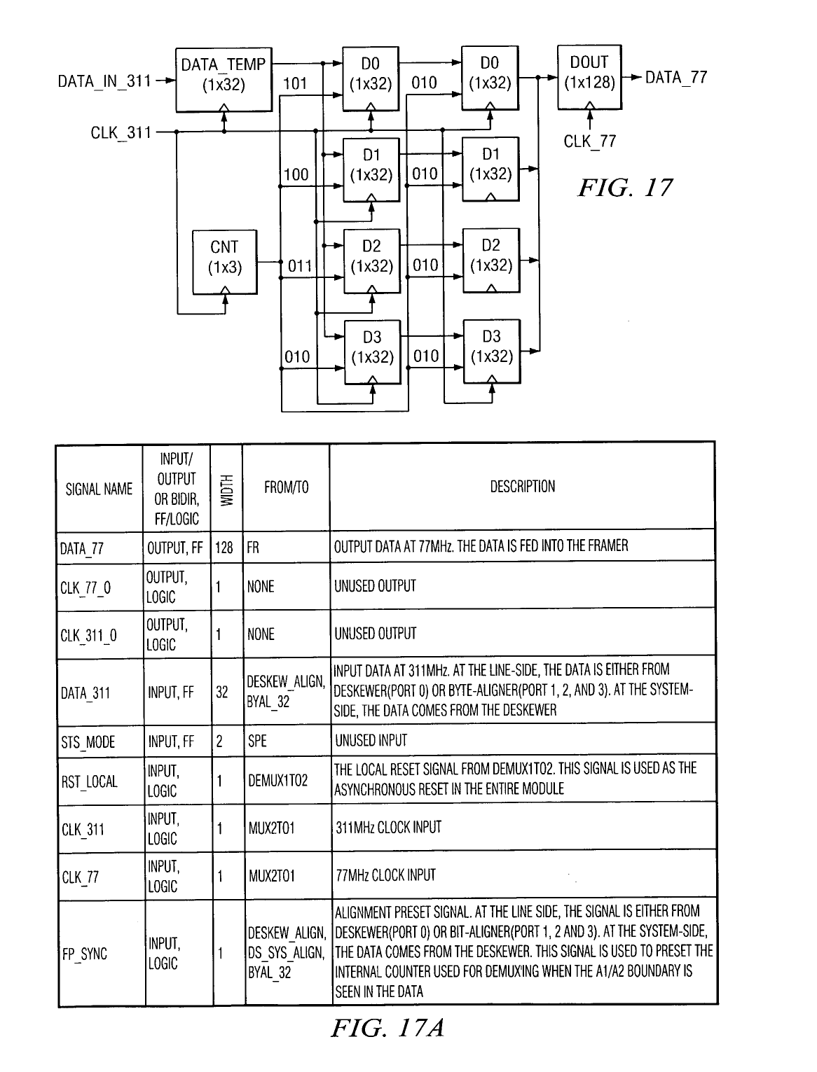

FIGS. 17 and 17A describe the function of the DEMUX2TO8 block.

Referring also to the waveforms of FIG. 18, the counter used for demultiplexing starts to count at zero. Since the 77 MHz clock leads the 311 MHz clock by one 311 MHz cycle, the counter counts to one to compensate the reset effect. Then the counting sequence is 2, 3, 4 and 5 and then going back to 2. The counter values 2, 3, 4 and 5 are used as pointers for writing to the registers. The incoming 311 MHz data is written first to the register pointed by the counter. As the count rolls back to 2, the latched data is shifted to another register that provides the data to be latched at the next rising edge of 77 MHz clock.

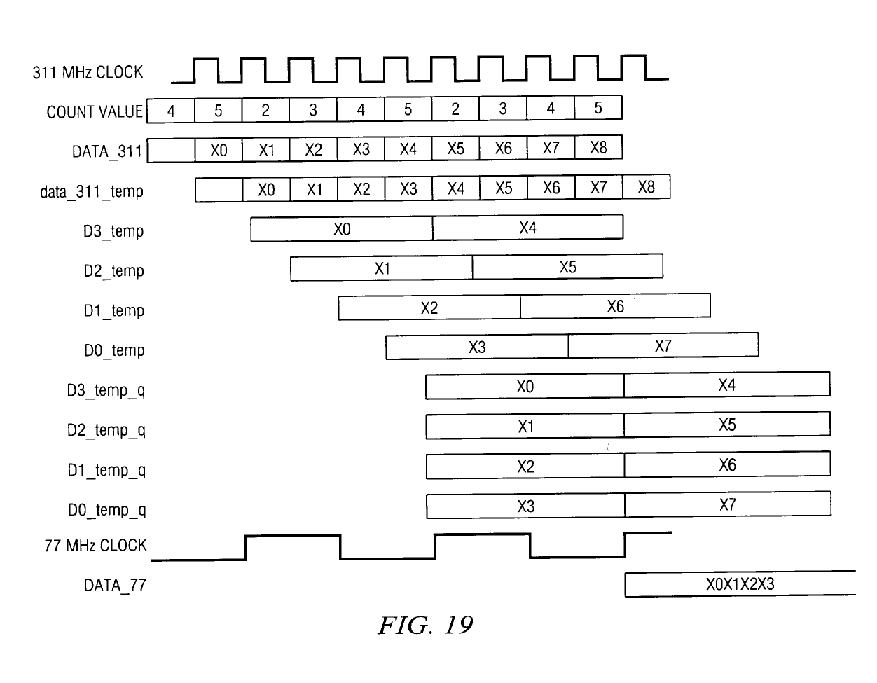

The demultiplex module does not look into the data for A1/A2 boundary. It relies solely on the bit-aligner in front of the DEMUX2TO8 to provide the aligned data. However, the counter must be preset in order to take the aligned data afresh. The FP_SYNC signal from the bit-aligner is used to preset the counter to two. When the counter is set to two, the first bytes of A2 are ready to be written to the register pointed by the counter. The sequence of the data demultiplexing is shown in FIG. 19.

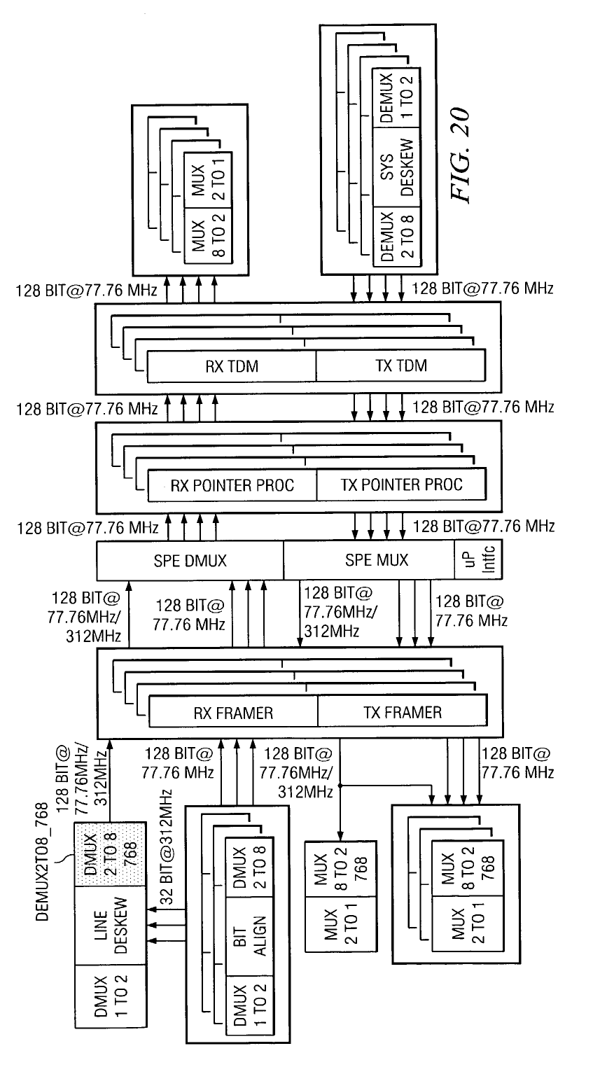

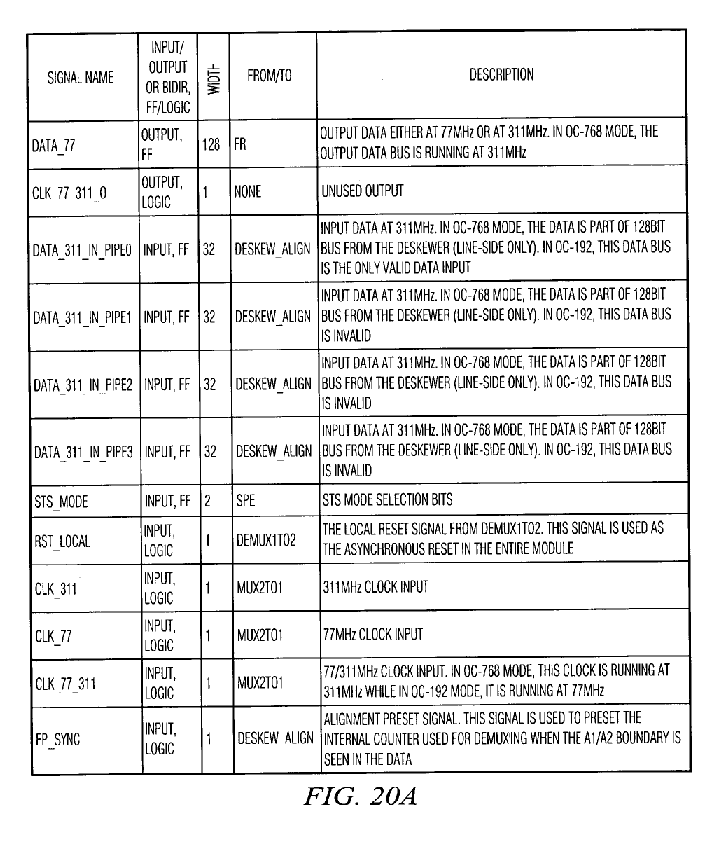

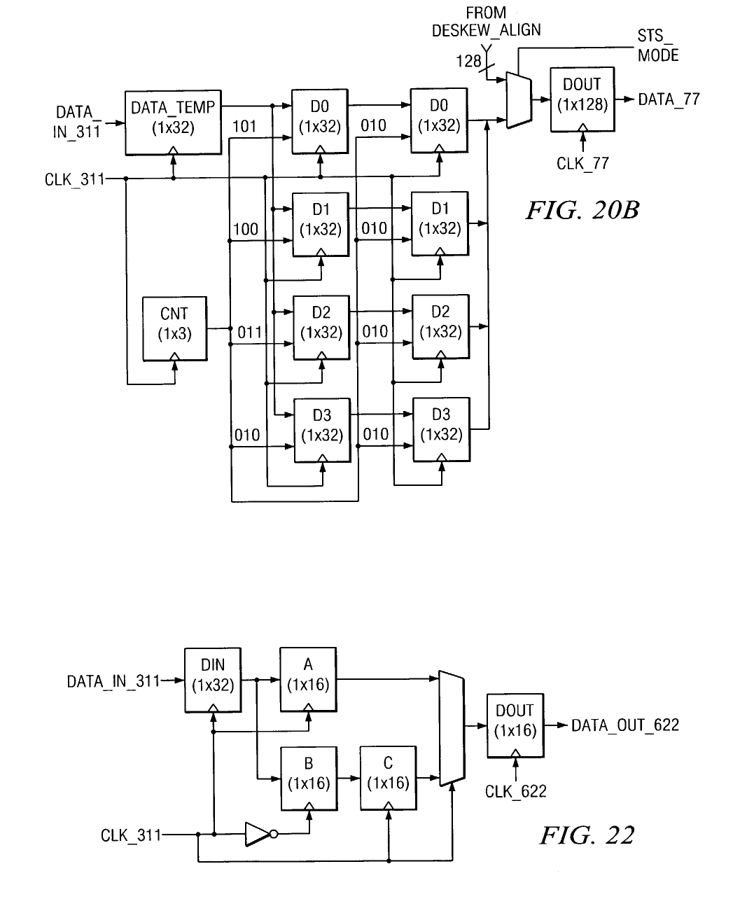

FIG. 20 highlights where the DEMUX2TO8_{—}768 block resides with respect to the entire design.

The DEMUX2TO8_{—}768 has to support both OC-192 mode and OC-768 mode. The DEMUX2TO8_{—}768 instantiates the DEMUX2TO8 module for OC-192 mode. In OC-768 mode, the deskewer resides between the DEMUX1TO2 and the DEMUX2TO8_{—}768 of port 0 on the line side. The deskewer takes the data from four DEMUX1TO2 blocks and performs deskewing relative to port 0's input clock (the master clock). After the deskewing is done, the 128-bit data is sent to DEMUX2TO8_{—}768 (see also FIGS. 20A and 20B). Therefore, in OC-768 mode, DEMUX2TO8_{—}768 serves as a simple pipeline stage for the data without performing the demultiplexing function.

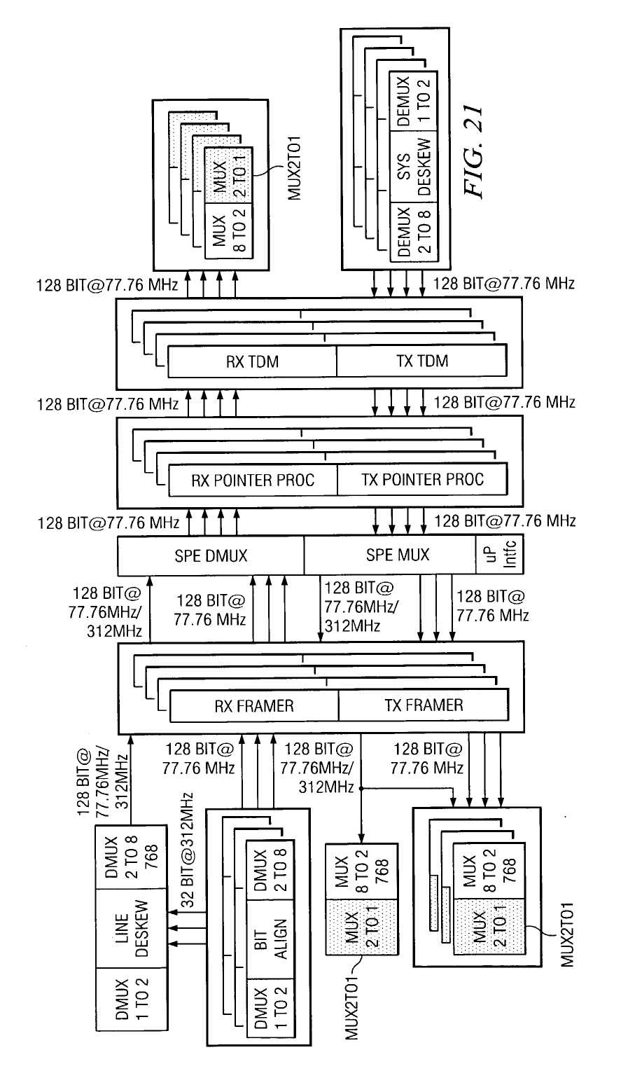

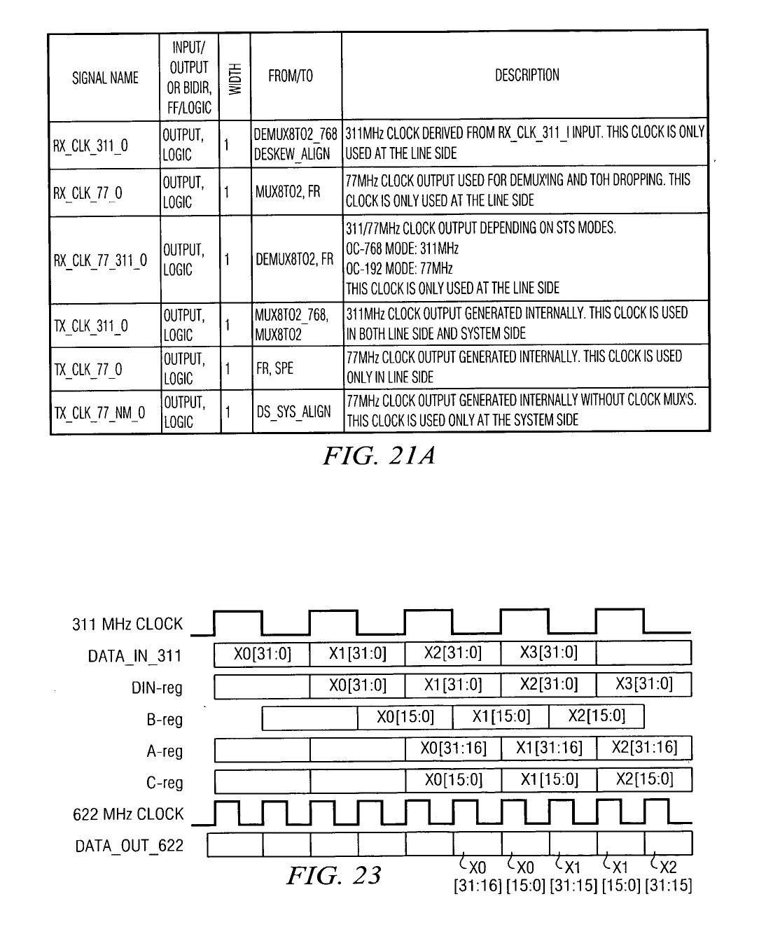

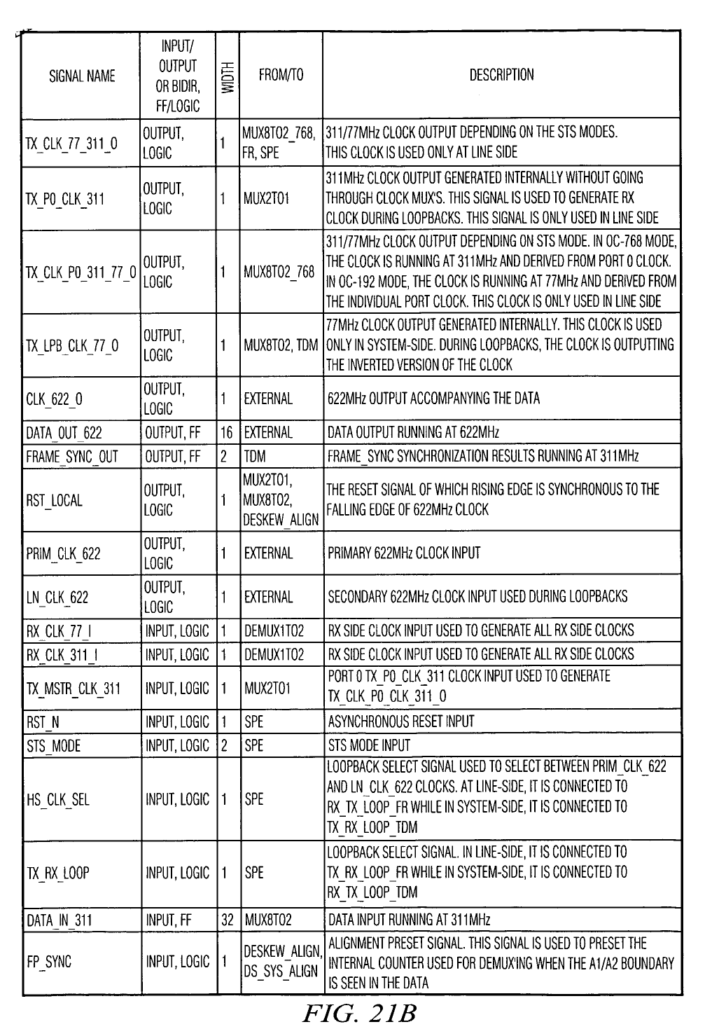

FIG. 21 highlights where the MUX2TO1 block resides with respect to the entire design.

The MUX2TO1 is instantiated on both line side and system side. It not only provides the multiplexing function, but also serves as the clock source by including most of the clock multiplexers. It is desirable to have all the clock sources and multiplexers in the same module so that the clock skews and delays can be manageable in the layout. This module is chosen to serve that purpose. (See also the Appendix and FIGS. 21A and 21B).

The multiplexing scheme is based on the relationship between the 622 MHz clock and the 311 MHz clock. The 311 MHz clock is derived from the 622 MHz clock, therefore, the logic level of the 311 MHz clock can be used as the multiplex select as shown in FIG. 22.

FIG. 23 shows how the multiplex works.

The incoming 311 MHz data first is latched in the DIN register. On the next falling edge of the 311 MHz clock, the lower 2 bytes are flopped into the B register and on the next rising edge of the same clock, the upper two bytes are flopped into the A register and at the same time, the contents of B register is shifted to C register. Two clocks after the data comes in, the 311 MHz clock is used as a multiplex selection between the A and C registers. When the clock is high, the content of the A register is multiplexed into the DATA_OUT₁₃ 622 register because the upper two bytes are transmitted first.

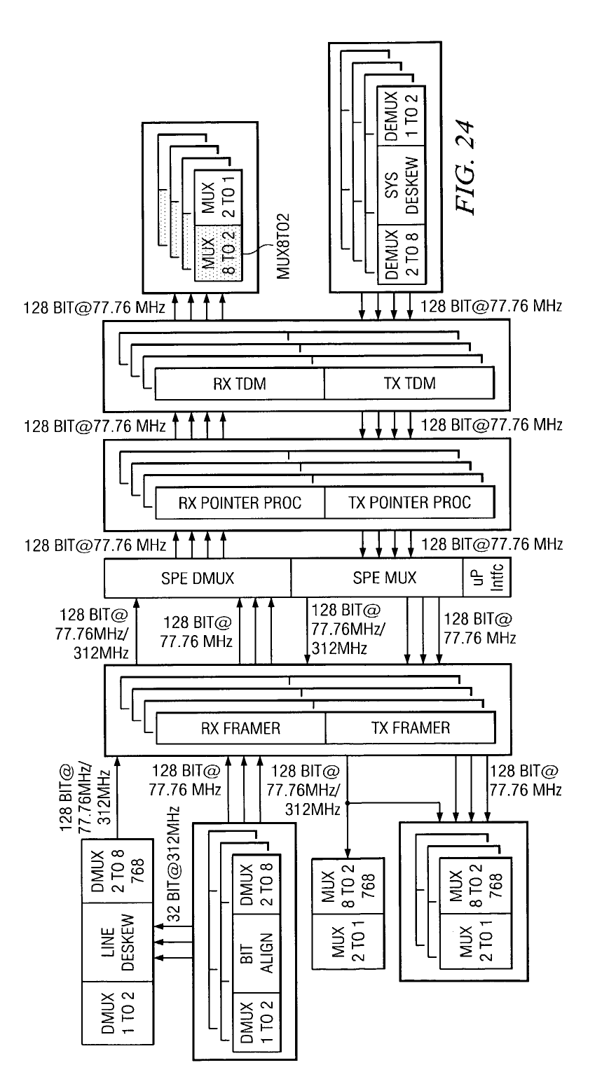

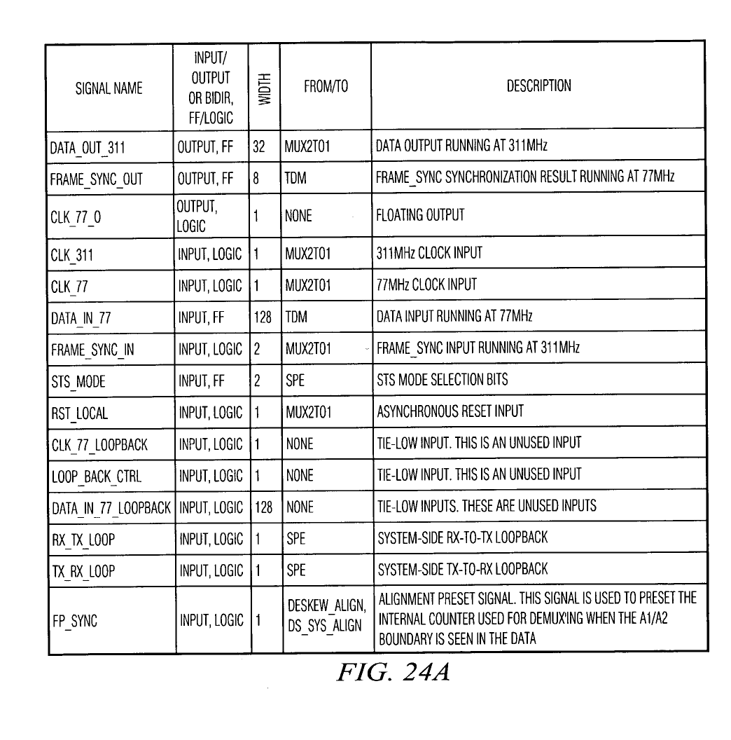

FIG. 24 highlights where the MUX8TO2 block resides with respect to the entire design.

The MUX8TO2 performs the opposite function of DEMUX2TO8. A counter running at 311 MHz is used to provide the multiplex selection. The counter can operate exactly the same way as that in the DEMUX2TO8 block. The incoming data is first latched by 77 MHz, then based on the counter value, each 32-bit of chunk data of the latched 128-bit data is multiplexed into the output register.

The counter used to multiplex the data is preset to two during some loopback modes. In the Tx to Rx and Rx to Tx loopback modes in OC-768 mode, the counter is preset to two. This is because in these modes, the RX side 77 MHz is inverted; therefore, presetting to two will line up the counter with both the 77 MHz clock and 311 MHz clock as it does for the non-inverted 77 MHz clock.

The MUX8TO2 is instantiated four times at the system side. In addition to the multiplexing function, the MUX8TO2 has to demultiplex the FRAME_SYNC signal. The input FRAME_SYNC signal is a 2-bit bus at 311 MHz, after demultiplexing the output FRAME_SYNC signal is an 8-bit bus running at 77 MHz (see also FIG. 24A). The demultiplexing scheme for the FRAME_SYNC signal can be the same as that of the DEMUX2TO8. The internal counter used for multiplexing can be shared by the FRAME_SYNC demultiplex.

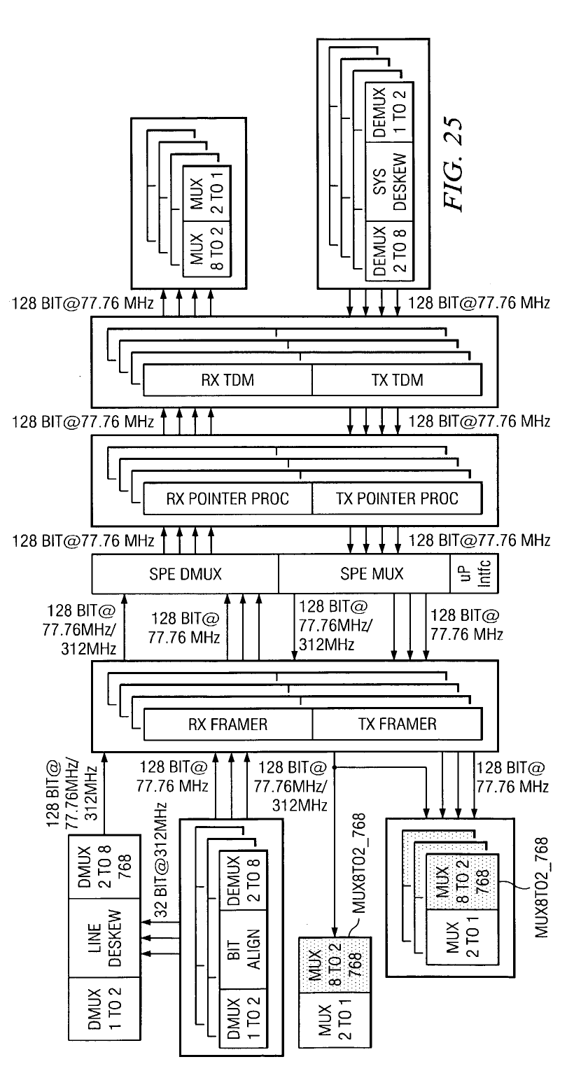

FIG. 25 highlights where the MUX8TO2_{—}768 block resides with respect to the entire design.

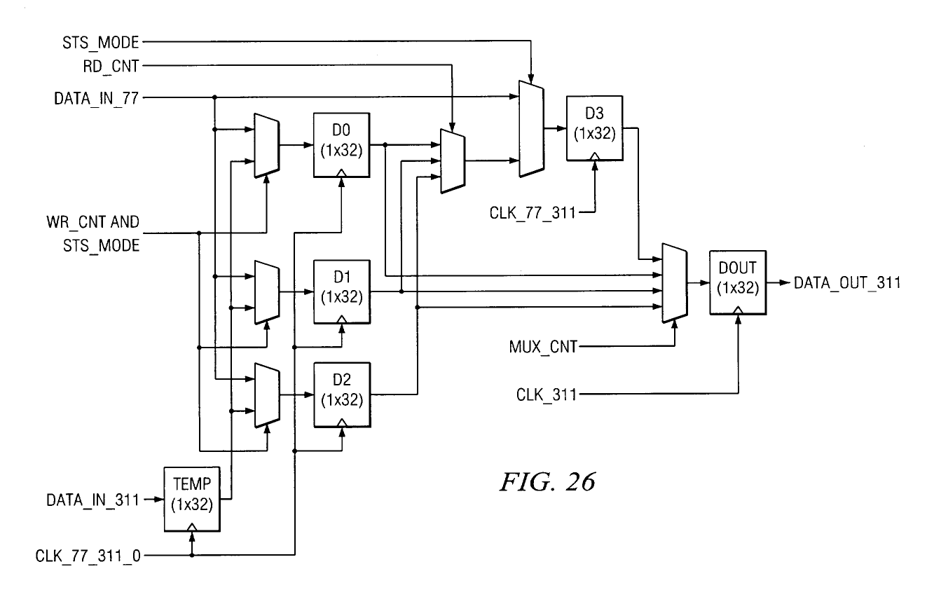

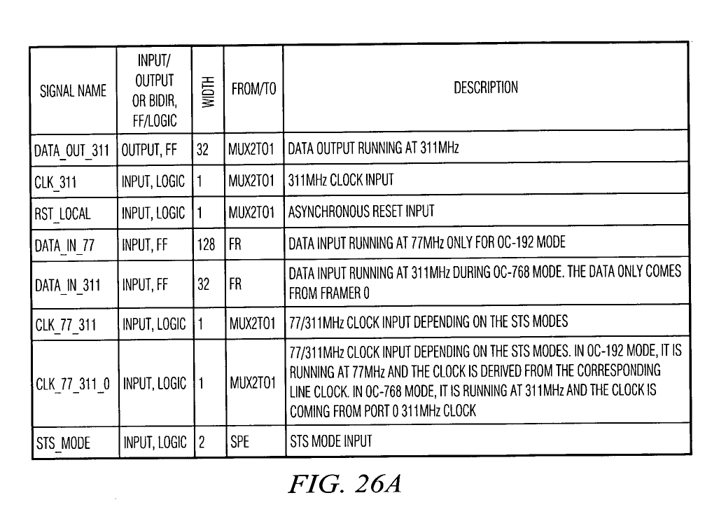

The MUX8TO2_{—}768 is instantiated on the line side, which supports both OC-192 mode and OC-768 mode. In OC-192 mode, the module behaves the same way as MUX8TO2. In OC-768 mode, this module does not perform the multiplexing function; instead, the registers are rearranged to behave as a retiming FIFO. FIGS. 26 and 26A illustrate how the rearrangement is done.

In OC-192 mode, the D0, D1, D2 and D3 registers behave as a latch for incoming 77 MHz data. The MUX_CNT is a counter used as the multiplex select. The MUX8TO2_{—}768 in OC-192 mode performs the same function as the MUX8TO2 module.

In OC-768 mode, only port zero's framer is operating, and outputs 128-bit data at 311 MHz. The four MUX8TO2_{—}768 simply take the data and send them in their local clock domain to the MUX2TO 1. The four input transmit line clocks are used to transmit the data, but only the port 0 transmit clock is used inside the port 0 framer. Therefore, when the data from port zero's framer comes into the four MUX8TO2_{—}768 modules, there is a clock domain crossing problem. The write clock accompanies the incoming data derived from the port 0 transmit clock but the read clock for output the data to MUX2TO 1 is derived from the individual port transmit clock. Since both the read and write clocks are derived from different 622 MHz clocks, a reset skew (since the clock is generated by a flop) and the clock skew cause the two clocks to have a phase shift problem up to half of 311 MHz period. We solve this problem by reorganizing the register to create a 3-level deep FIFO. Obviously, the write clock of the FIFO is the same clock used in port 0 framer and the read clock is the derived from the individual port's transmit clock. Register D0, D1 and D2 are the body of the FIFO. The write to the FIFO is controlled by WR_CNT, the write pointer. Register D3 is the latch for the output of the FIFO. The output of the FIFO is selected by the RD_CNT, the read pointer. The WR_CNT is synchronous to the write clock while the RD_CNT is synchronous to the read clock. During reset, the write pointer is reset to zero and the read pointer is preset to two. By doing so, two stages of the FIFO provides the gap in order to absorb the clock skew. Register DOUT is just another pipeline stage in this module without using MUX_CNT to select the input.

There are two clocks inputs that can run at different frequencies; one is CLK_{—}77_{—}311_{—}0 and the other one is CLK_{—}77_{—}311. Both clocks are running in either 77 MHz or 311 MHz depending on the modes. In OC-192 mode, both of them are running at 77 MHz and coming from the same source (the multiplexing happens inside MUX2TO1 module). In OC-768 mode, both are running at 311 MHz but they are derived from different sources. The CLK_{—}77_{—}311 is derived from the 622 MHz clock of the corresponding port. The CLK_{—}77_{—}311_{—}0 is coming from the port 0. As a result, the CLK_{—}77_{—}311_{—}0 is connected to the FIFO and the write pointer while the CLK_{—}77_{—}311 is used for the read pointer as well as the FIFO output latch.

The third clock input is the CLK_{—}311, which is always running at 311 MHz regardless of the STS mode.

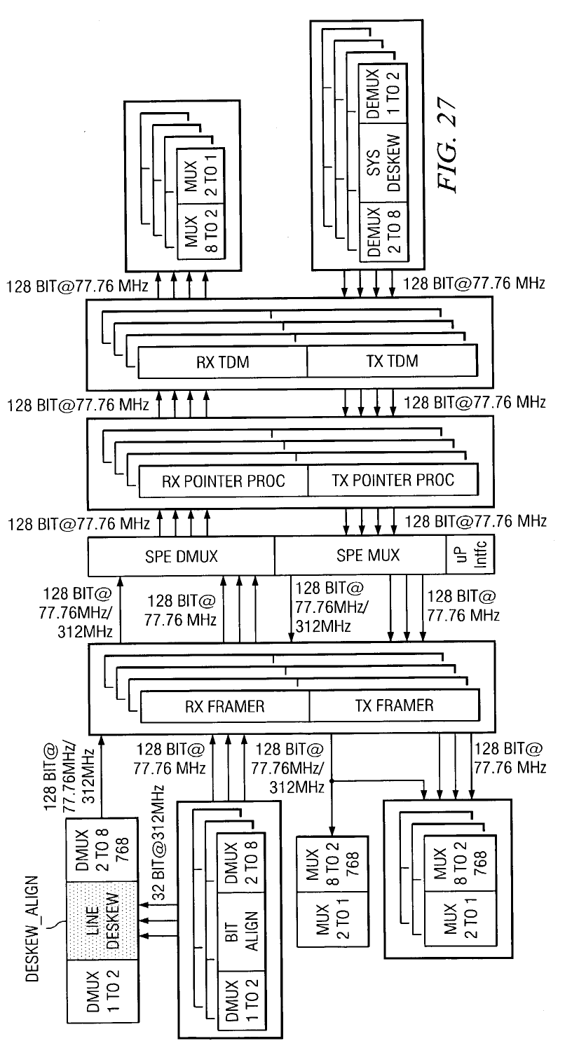

FIG. 27 highlights where the DESKEW_ALIGN block resides with respect to the entire design.

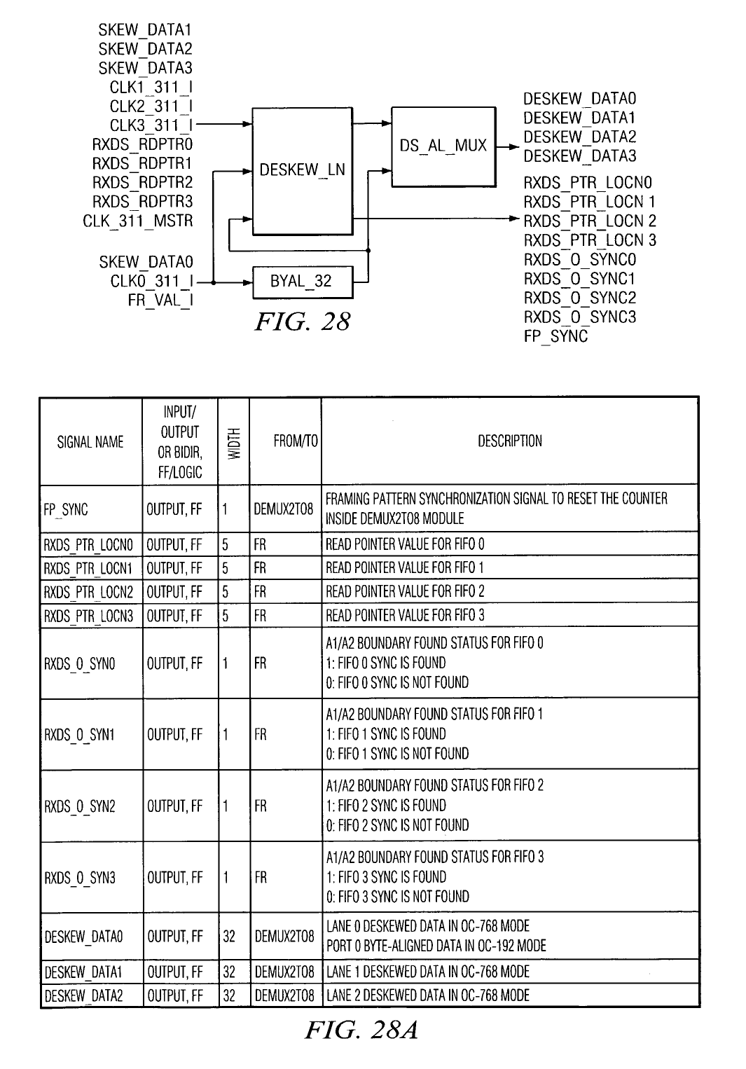

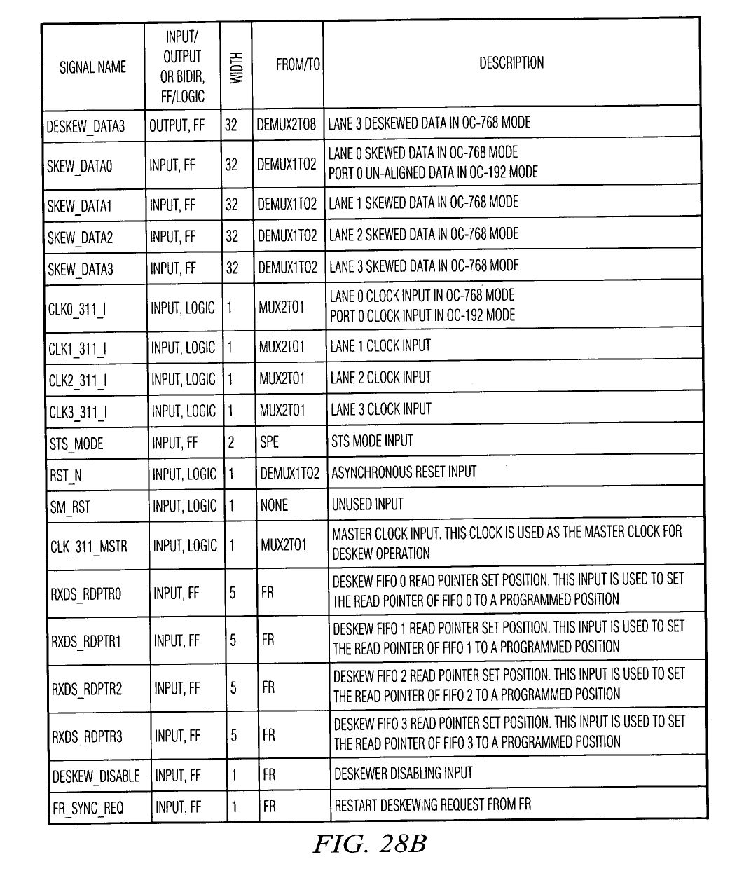

FIG. 28 is a top-level diagram of the modules contained within DESKEW_ALIGN block. The interface signals are shown in FIGS. 28A and 28B.

The following list describes exemplary features supported in DESKEW_ALIGN block.

Supporting OC-192 mode and OC-768 mode.

1. Performing bit-align function in OC-192 and OC-768 mode.

2. Performing deskewing function in OC-768 mode between four ports.

Deskewing four lanes of incoming data based on A1/A2 pattern boundary.

1. Providing 24×32 bytes FIFO for each lane.

2. FIFO writing on the individual lane clock.

3. FIFO read on the master clock domain which is lane 0 clock.

State machine controlling the read pointers.

1. Detecting the current lanes A1/A2 boundary with respect to the master lane (port 0).

2. State machine running in master clock domain.

3. Receives re-deskewing request from framer state machine.

FIFO read pointer location accessed through register read inside framer.

Programmable FIFO read pointer location through register writes to framer.

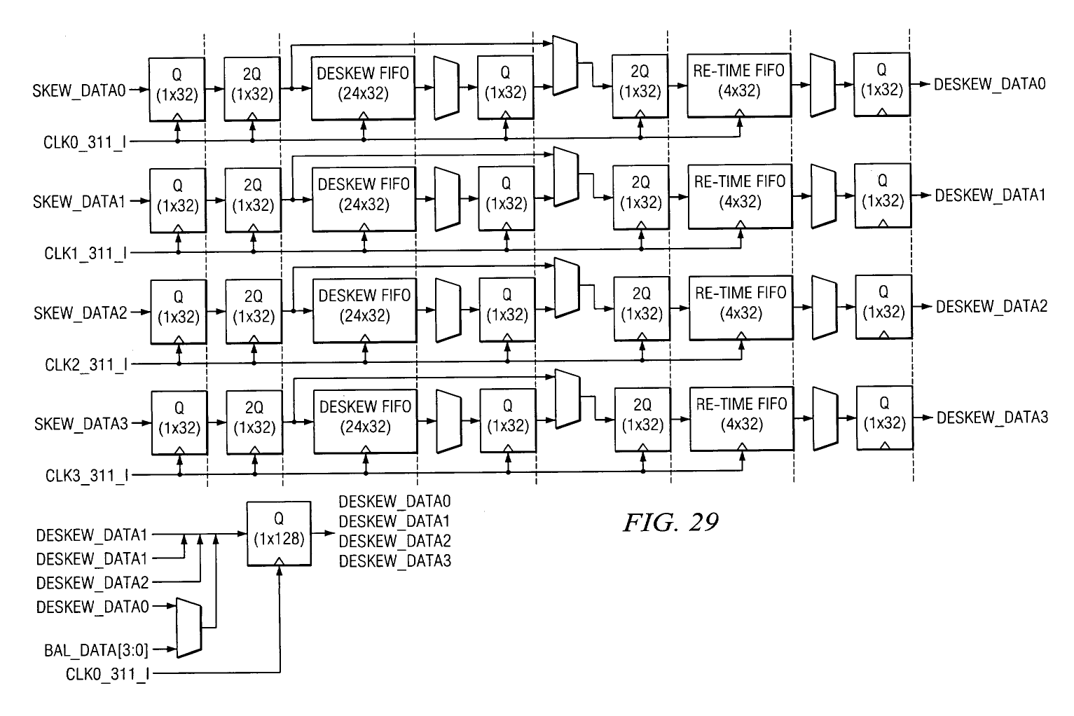

FIG. 29 shows the pipeline stages inside DESKEW_ALIGN design.

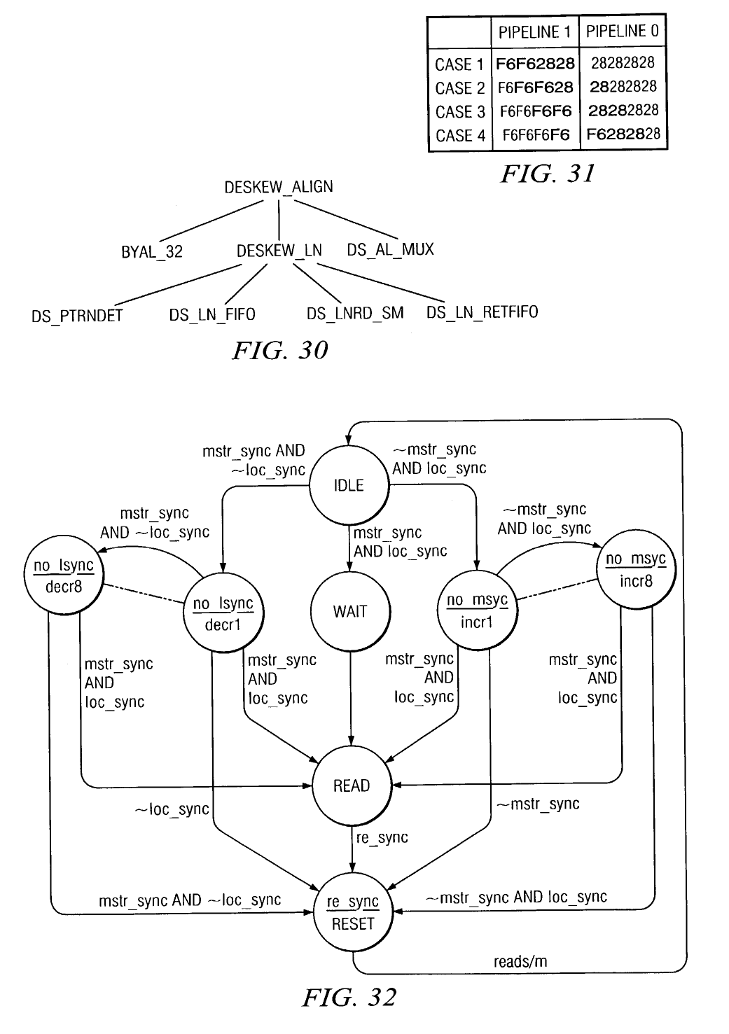

FIG. 30 is a tree diagram that shows the modular structure of the DESKEW_ALIGN design.

Data Output MUX (DS_AL_MUX)

In OC-192 mode, the DESKEW_ALIGN must send out the bit-aligned data. Therefore, the lane 0 data output is multiplexed with the BYAL_{—}32 module output during OC-192 mode. In OC-768 mode, DESKEW_ALIGN is a pipeline stage for all four lanes of data.

Deskewer (DESKEW_LN)

This is the main body of the deskewing function. Each of its sub-modules is instantiated four times, one for each lane. FIG. 29 shows the data flow details.

DESKEW_LN outputs the frame pattern detection signal, which is used in the state machine module to determine the position of the read pointer. The signal is set whenever this A1/A2 framing pattern is seen and reset to zero when the re-synchronization request from the state machine is active.

Pattern Detection Logic (DS_PTRNDET)

This module pipelines the incoming data twice and searches for F6F6-2828 patterns within the 64 bytes of data. There are four cases in which the pattern can reside (see FIG. 31).

After detecting the pattern, the status is sent to the state machine and used as the reference for deskewing.

Deskew FIFO (DS_LN_FIFO)

The FIFO is used to provide enough buffer for the deskew operation. The FIFO is constructed by twenty-four 32-bit registers and configured as a shift register. The write is based on the individual local clock and always on the position 0 of the shift-register. The write is always on without any delay or relocation. Deskewing solely depends on the read operation to line up A1/A2 boundary among four lanes. The manipulation of the read pointer is described at the next section. On read, the read pointer determines which location to be read. After reading, the data is then multiplexed with the input data for that case when the deskewing function is disabled.

In addition to the increment/decrement commands from the state machine, a programming register is provided for software to directly manage the pointer. The register resides inside the framer module. The register value is first synchronized to the local clock domain and the value update detection logic detects the change on the value. Once the new value arrives, the content of the register is examined. If the bit 0 is one, then a decrement on the read pointer is issued. If the bit 1 is one, then an increment on the read pointer is issued. If both bits are one, no action is taken.

If the deskewer is disabled through a programmable register, the read pointer value is held at OE'h position. The read pointer is also set to this location if the state machine decides to re-synchronize the data.

The read pointer operation is in the master lane clock domain while the read data is flopped at the local clock domain. The timing problem is solved by assuming once that once the deskewing is done, the read pointer stays at a fixed position until restarting the deskewing; therefore, the read pointer to the data output flops can be assumed as a false path that does not introduce any timing problem.

Deskewing State Machine (DS_LNRD_SM)

FIG. 32 shows is the state transition diagram inside the module.

The state machine is operating in the master clock domain; therefore, the local statuses have to be synchronized to the master clock domain before being used. In order to match the same delay for the synchronization of the local signal, the signals from the master channel are also passed through the same number of pipeline stages.

The state machine is triggered on the A1/A2 pattern detection signals both from the local lane and from the master lane. Once the pattern is detected either in the local lane or in master lane, the state machine starts to deskew. If the pattern is detected in both lanes, then the read pointers of the local lane does not need any change and the data is lined up at the same position as the master lane. If the pattern is found only in the local lane, then the local read pointer starts to increment every clock until either the pattern is found on the master lane or eight consecutive increments are done. By incrementing the read pointer, the local FIFO introduces more skew to match the master lane. After eight consecutive increments, if the pattern is not found at the master lane, then the state machine goes to RE_SYNC state and starts the process all over again. If the pattern is detected in the master lane not in the local lane, then the local read pointer starts to decrement to reduce the skew on the local lane. Before eight decrements are done, if the pattern is found then the state machine goes to READ state, otherwise, the state machine goes to RE_SYNC state.

Once the state machine enters the READ state, the state machine stays there until either the data is out of sync or the re_sync request from the framer is high. While the state machine stays in READ state, the read pointers on four lanes are kept unchanged until the state transitions. The input data is supposed to maintain the same skews as long as possible. If the skew changes between lanes, the data is not lined up. The framer will go out of frame and requires the restart of the process. The local out of sync detection logic is not working since the pattern detection signal is not reset until RE_SYNC state.

If the state machine is in one of INCR[1:8] states, the read pointer increment command is given to the local lane FIFO. On the other hand, if the state machine is in one of DECR[1:8] states, the read pointer decrement command is given.

When the state machine is in RE_SYNC state, the read pointer of the local lane FIFO is reset to 0E'h position and the local frame detection signal is set back to zero. In this state, all the variables go back to the initial state so that the deskewing process can restart.

Deskew Retime FIFO (DS_LN_RETFIFO)

The data read from the FIFO is output at the local clock domain. The data has to be re-timed to the master clock domain. The task has to be achieved without further introducing skews. A four level deep FIFO is allocated to perform this task. The idea is that the read on the four FIFOs is on the same location in each clock, which does not cause any skew even though the write has the clock skew.

The write operation and the write pointer are working under the local clock domain while the read operation and read pointer are working in the master clock domain. The asynchronous reset is synchronized to both clock domains and resets the read/write pointers independently. Since the read on the four FIFOs is in the clock domain (master clock), all the read pointers should come off reset at the same time and advance at the same pace.

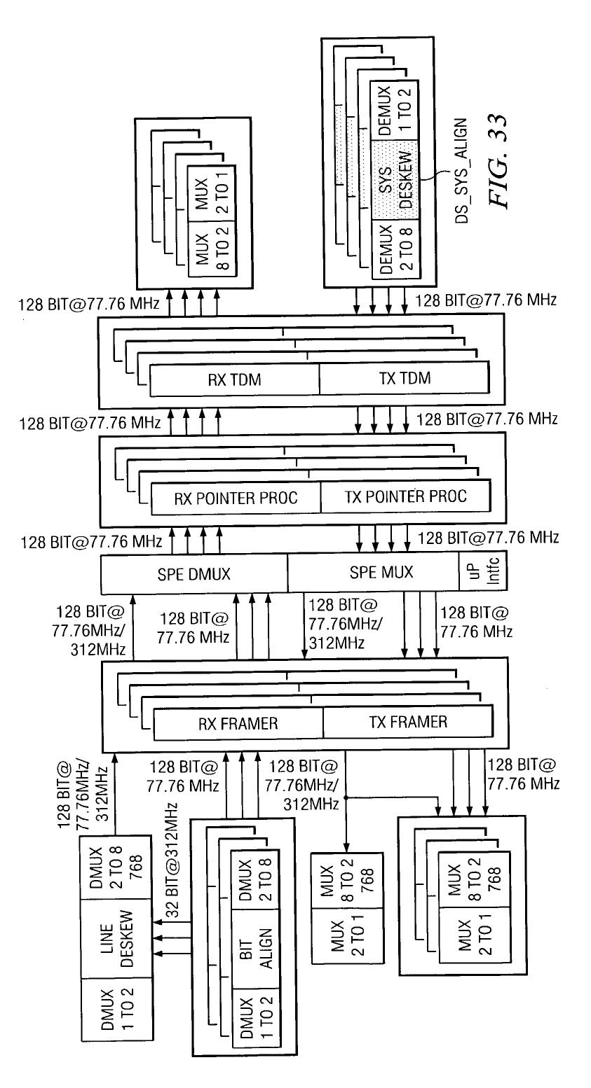

FIG. 33 highlights where the DS_SYS_ALIGN block resides with respect to the entire design.

DS_SYS_ALIGN is instantiated on the system side. It not only provides the deskewing function, but also serves as one of the clock source modules on the system side.

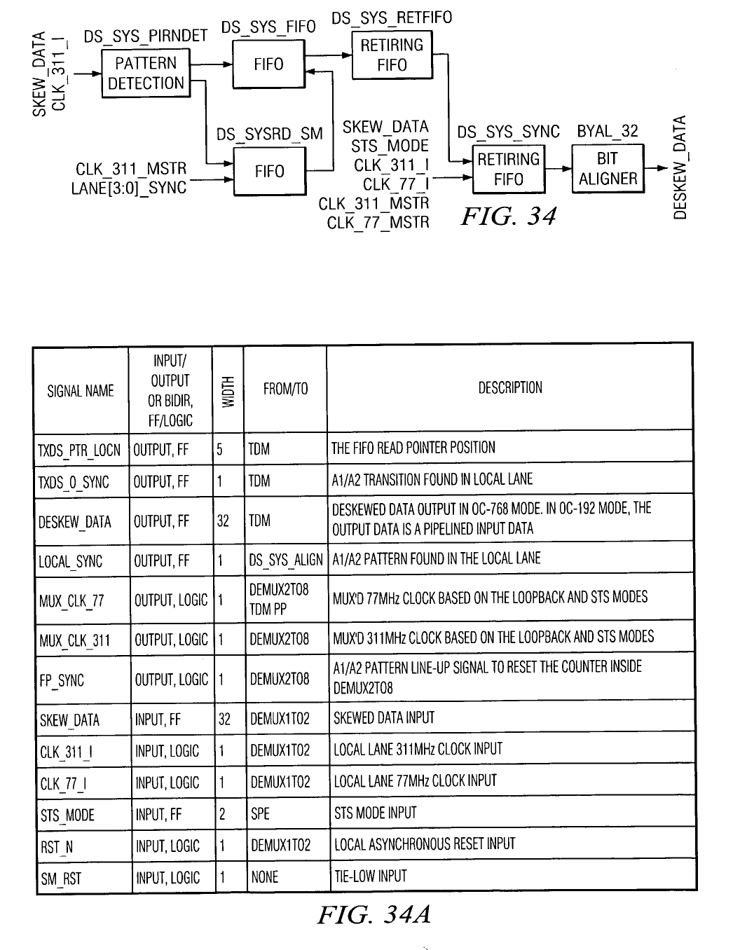

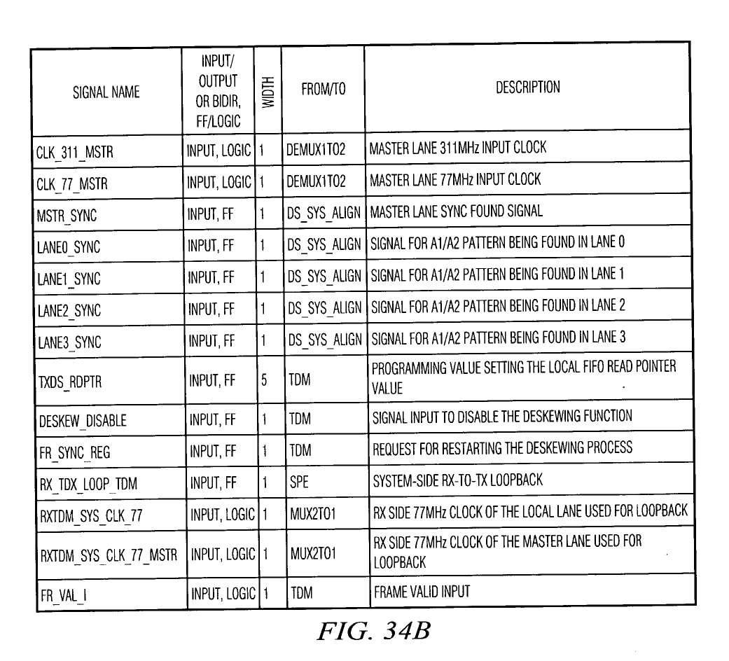

FIG. 34 is a top-level diagram of the modules contained within DS_SYS_ALIGN block. The interface signals are shown in FIGS. 34A and 34B.

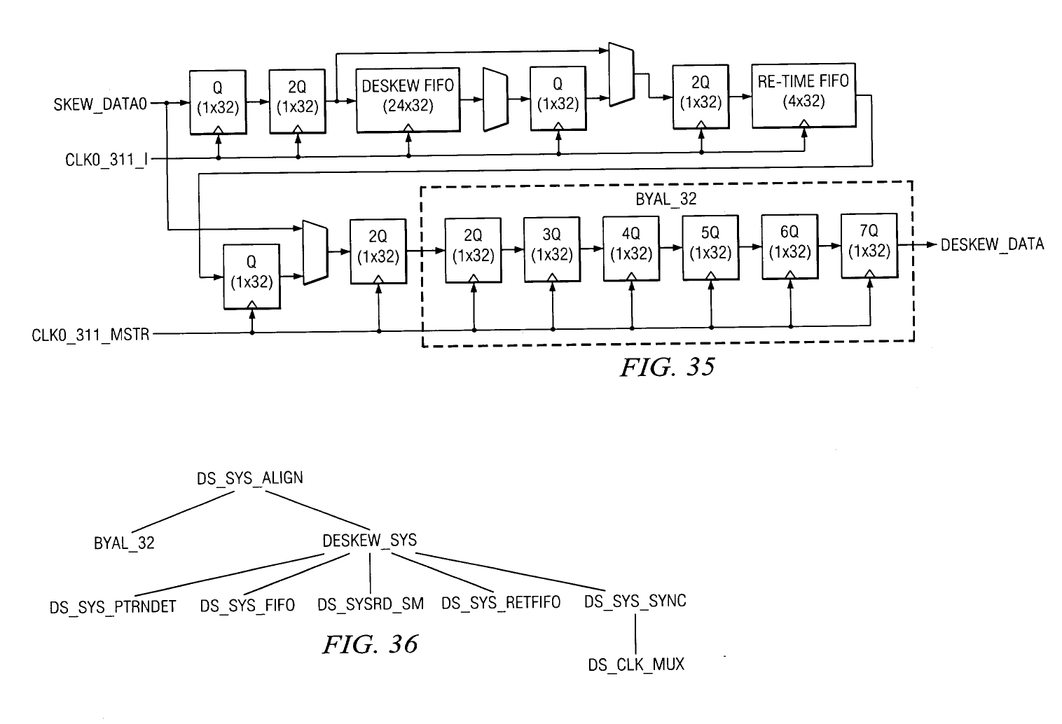

FIG. 35 illustrates the pipeline stages of the DS_SYS_ALIGN module.

FIG. 36 is a tree diagram that shows the modular structure of the DS_SYS_ALIGN design.

DESKEW_SYS

This is the main body of the deskewer. Most of the sub-modules can be identical to their counterparts in the line side deskewer.

Pattern Detection Logic (DS_SYS_PTRNDET)

This module can be identical to the DS_PTRNDET module.

Deskew FIFO (DS_SYS_FIFO)

This module can be identical to the DS_LN_FIFO module.

Deskew State Machine (DS_SYSRD_SM)

This module can be the same as DS_LNRD_SM module.

On the top-level connection, since DS_SYS_ALIGN is instantiated four times, the communication among the peer state machines becomes a top-level connection issue. In the DESKEW_ALIGN module, the state machine is instantiated four times within the module, therefore, the communication among the peer state machines are internal signals for DESKEW_ALIGN module. On the system side, the communication becomes happens at the top-level and the signals have to be routed on the top-level.

Deskew Retime FIFO (DS_SYS_RETFIFO)

This module can be identical to the DS_LN_REFIFO module.

Deskew Synchironization Module (DS_SYS_SYNC)

There are two parts of logic inside this module. One part is for multiplexing data and the other part is clock multiplexing.

In OC-192 mode, the input data of the DESKEW_SYS module is multiplexed out since in this mode, the data does not need to be deskewed. The data then goes to the bit-aligner to be aligned. In OC-768 mode, the deskewed data is sent.

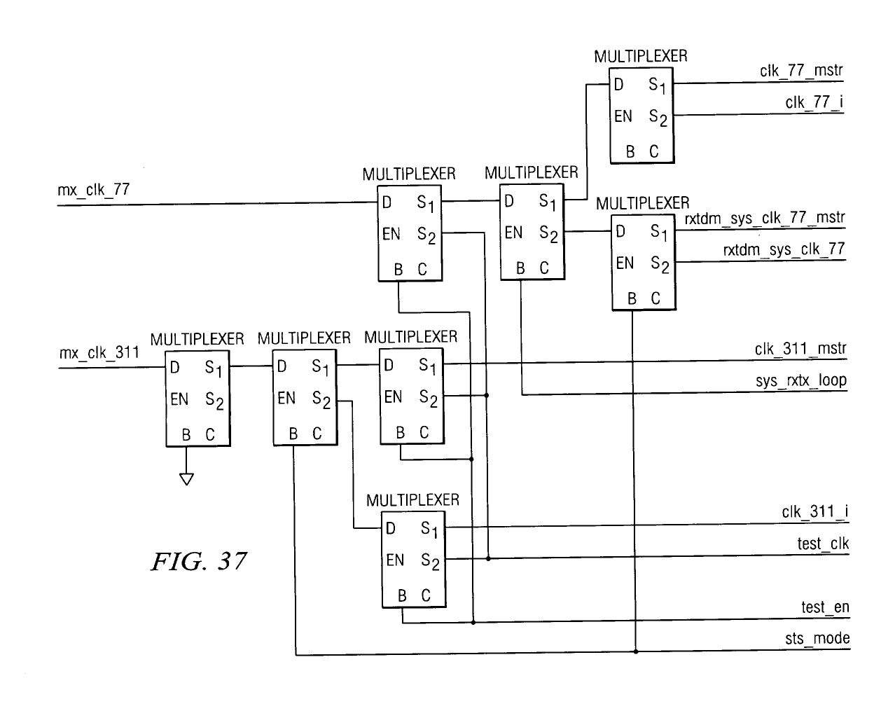

FIG. 37 shows all the clock multiplexes inside DS_SYS_SYNC.

The MX_CLK_{—}77 and MX_CLK_{—}311 are fed into DEMUX2TO8, TXTDM and TXPP. At different STS modes and loopback modes, the sources of these two clocks change.

Under normal operation, in OC-192 mode, the MX_CLK_{—}77 takes CLK_{—}77_I (local lane clock) as the source but in OC-768 mode, CLK_{—}77_MSTR (master lane clock) becomes the source. This is because during OC-768 mode, all four TDM modules are operating in the same clock domain in order to deskew the data and line up the frames.

During the system side Rx to Tx loopback, the clock source changes from the normal operation mode. In OC-192 mode, the MX_CLK_{—}77 clock takes the local lane inverted 77 MHz clock, RXTDM_SYS_CLK_{—}77, as the source while in OC-768 mode, the master lane inverted 77 MHz clock, RXTDM_SYS_CLK_{—}77_MSTR, becomes the source.

The 311 MHz clock does not have the loopback issue as 77 MHz does because during Rx to Tx loopback, the input Rx data on system side is dropped. Therefore, only STS modes determine the source of the 311 MHz clock output. In OC-192 mode, the local lane's 311 MHz clock (CLK_{—}311_I), is the source and in OC-768 mode, the master lane's clock (CLK_{—}311_MSTR) is the source.

Framer (FR)

The following diagram highlights where the FR block resides with respect to the entire design.

The framer determines frame alignment, and initiates SONET/SDH frame related alarms, such as SEF and LOF.

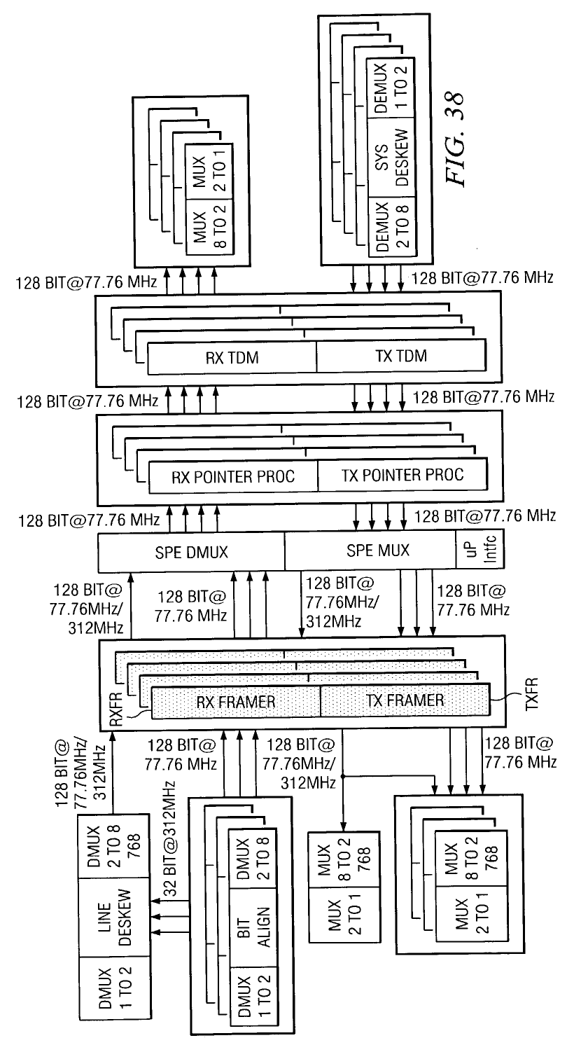

The framer module (see FIG. 38) contains two sub-modules: the Receive Framer (RXFR) and the Transmit Framer (TXFR).

Receive Framer (RXFR)

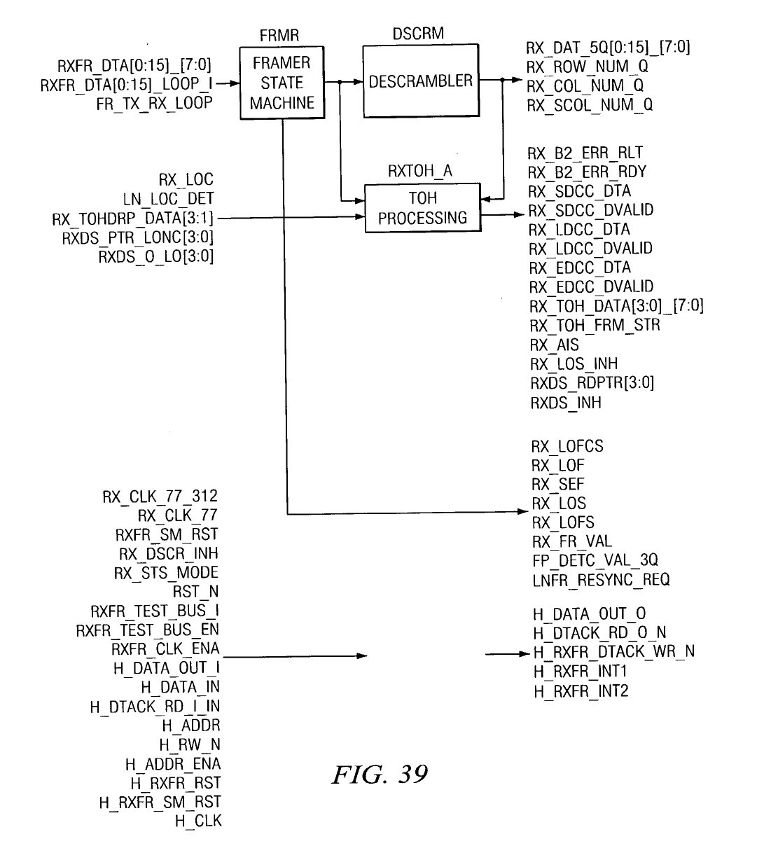

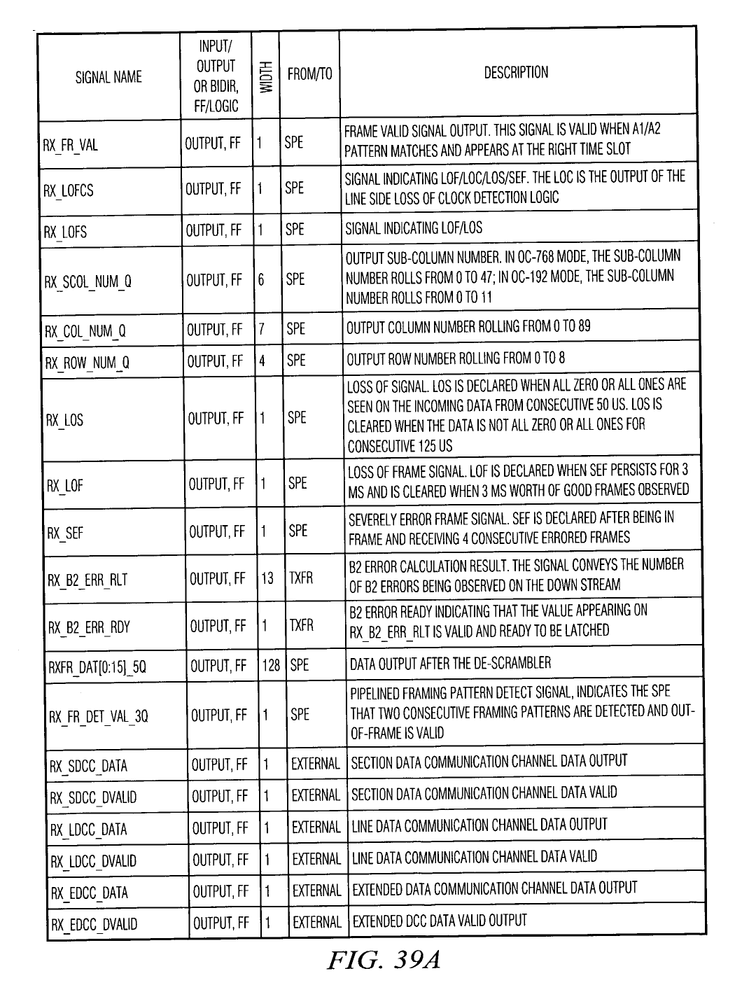

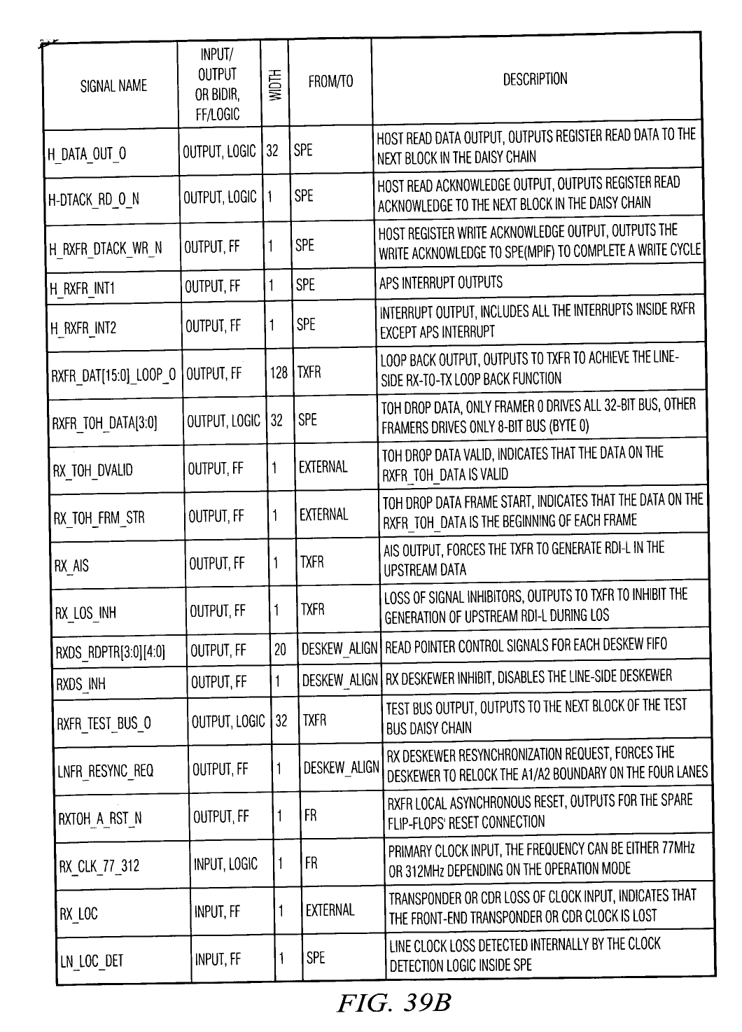

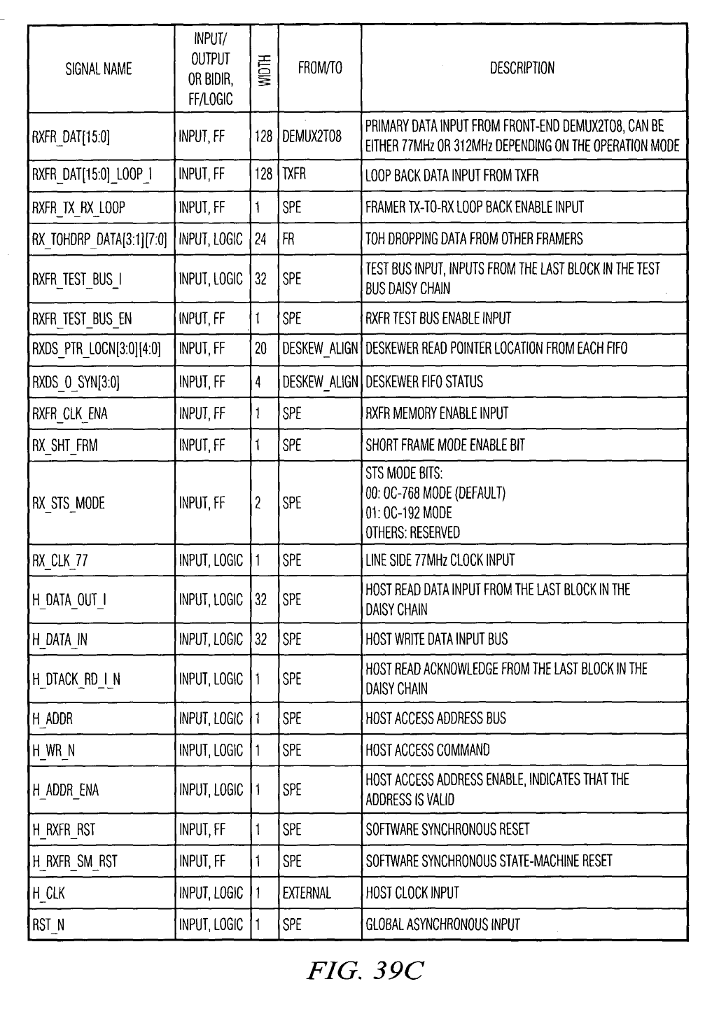

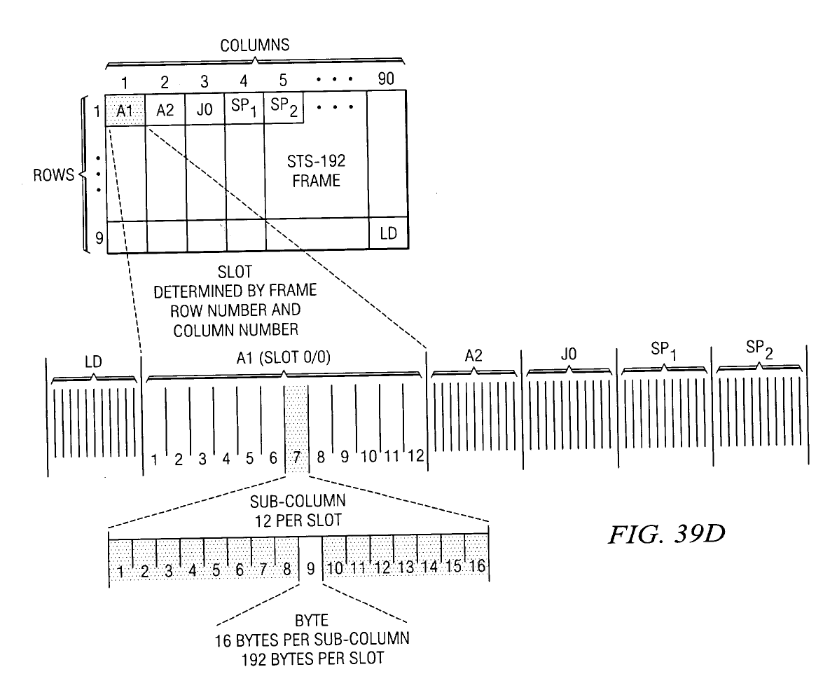

FIG. 39 is a top-level diagram of the modules contained within RXFR. The interface signals are shown in FIGS. 39A-39C.

RXFR Features

The following list describes exemplary features supported in RXFR block.

Framing Pattern match

1. Programmable window for A1/A2 pattern match while trying to go in frame.

2. Four byte window for A1/A2 pattern match when trying to go back to in-frame from SEF.

3. Generating row, column and sub-column number based on the framing pattern matching while trying to go in-frame. FIG. 39D illustrates the concepts of sub-column numbers and slots for an STS-192 stream.

Framing State Machine determines if the framer is in-frame, SEF or out of frame.

LOF (Loss of Frame) declaration and termination.

1. A counter to count consecutive bad frames for 3 ms in order to declare LOF.

2. A separate counter to count consecutive good frames for 3 ms in order to terminate LOF.

3. A good frame is defined as the framing pattern matches and appears at the right timeslot.

4. The framing pattern matching window is programmable from 4 bytes up to 12 bytes.

LOS (Loss of Signal) declaration and termination.

1. A counter to count consecutive all zeros or all ones in the data for 50 us to declare LOS.

2. A separate counter to count for 125 us window, within this window if any non-zero or non-one pattern is seen then LOS is terminated.

LOC (Loss of Clock) reporting.

De-scrambling the incoming data in both OC-768 and OC-192 modes.

J0 section message capturing.

1. In SONET mode, the J0 message is captured with 64 bytes of J0 string ending with <0×0D, 0×0A> and the same string appears three consecutive times.

2. In addition, in SONET mode, the J0 message is captured with zero in MSB (most significant bit) of the last 63 bytes and 1 in MSB of the 0^{th} byte and the same string appears three consecutive times.

3. In SDH mode, the J0 message is captured with zero in MSB of the last 15 bytes and 1 in MSB of the 0^{th} byte and the same string appears three consecutive times.

4. If the accepted message is different from the previously accepted value, an interrupt is generated to notify the system software.

B1 calculation and comparison

1. B1 is calculated throughout the entire frame on the scrambled data.

2. B1 calculation result is compared with the B1 byte of the next frame on the un-scrambled data.

3. BER algorithm is provided to calculate SF (Signal Fail) and SD (Signal Degrade).

4. A 32-bit row error counter is provided to count the error in either block mode or BER mode.

B2 calculation and comparison

1. B2 is calculated throughout the LOH (Line Overhead) and the entire SPE on the un-scrambled data.

2. B2 is calculated on the STS-1 granularity and compared with each STS-1 B2 from the next frame.

3. BER algorithm is provided to calculated SF and SD.

4. A 32-bit row error counter is provided to count the error in either block mode or BER mode.

K1/K2 processing

1. De-bouncing and detecting APS alarm.

2. De-bouncing and detecting AIS-L alarm.

3. De-bouncing and detecting RDI-L alarm.

4. De-bouncing the K1 byte.

S1 de-bouncing

1. In SONET mode, the S1 value is considered to be the accepted S1 value after eight identical and consecutive values of the S1 are received.

2. In SDH mode, the S1 value is considered to be the accepted S1 value after four identical and consecutive values of the S1 are received.

M0/M1 accumulation

1. M0/M1 incoming is accumulated in the 32-bit rollover counter and an overflow interrupt is provided.

2. In OC-768 mode, the maximum M0/M1 value is 6,144, any larger value is treated as zero.

3. In OC-192 mode, the logic can support either two bytes of M0/M1 or one byte M1; the maximum value for 2-byte mode is 1,536 and the maximum value of 1-byte mode is 256.

DCC dropping

1. Support Section DCC and Line DCC dropping in both OC-192 mode and OC-768 mode.

2. Support Extended DCC dropping in OC-768 mode only.

3. Serial data output for each DCC dropping with designated data valid output.

TOH dropping

1. Each TOH row is stored in the memory and dropped during SPE timeslots.

2. A data valid signal is generated.

3. In OC-768 mode, a 32-bit bus interface is provided with single data value signal.

4. A frame start signal is provided to flag the first TOH row.

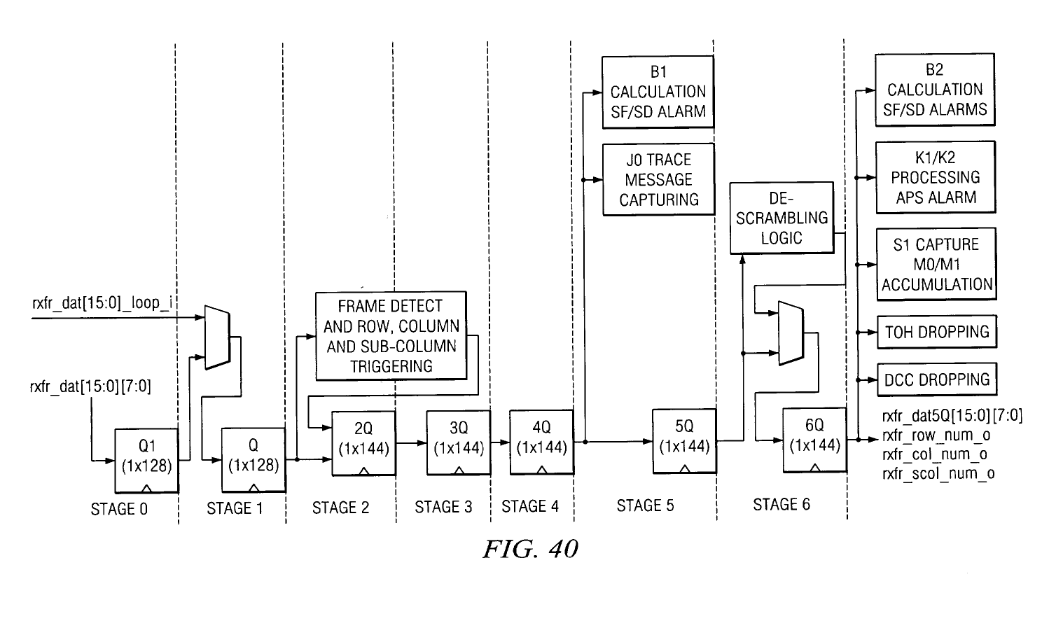

FIG. 40 shows the pipeline stages inside RXFR design.

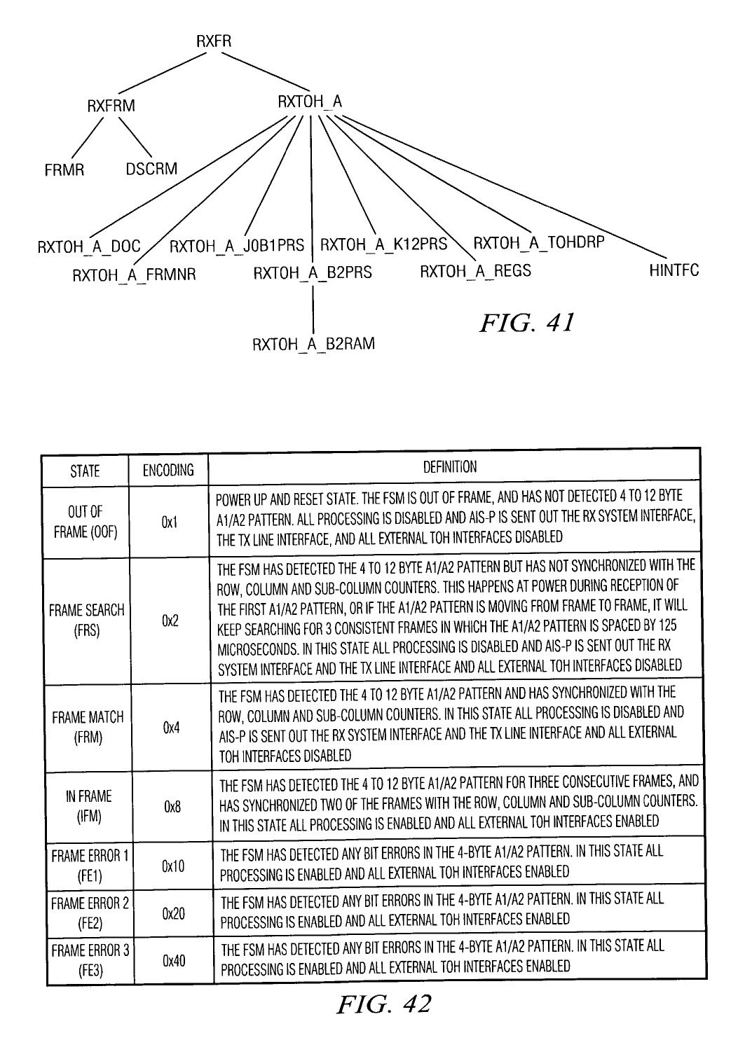

FIG. 41 is a tree diagram that shows the modular structure of the RXFR design.

RXFR Framer (RXFRM)

The RXFRM module performs the following function:

Determining in-frame/out-of-frame

Framing pattern detection

Row, column, sub-column number generation

SEF detection

LOF detection

LOS detection

LOC reporting

Data multiplexing for loop-back

Framer State Machine (FSM)

The FSM has seven states, OOF, FRS, FRM, IFM and FE1 through FE3 states. The states are summarized in FIG. 42.

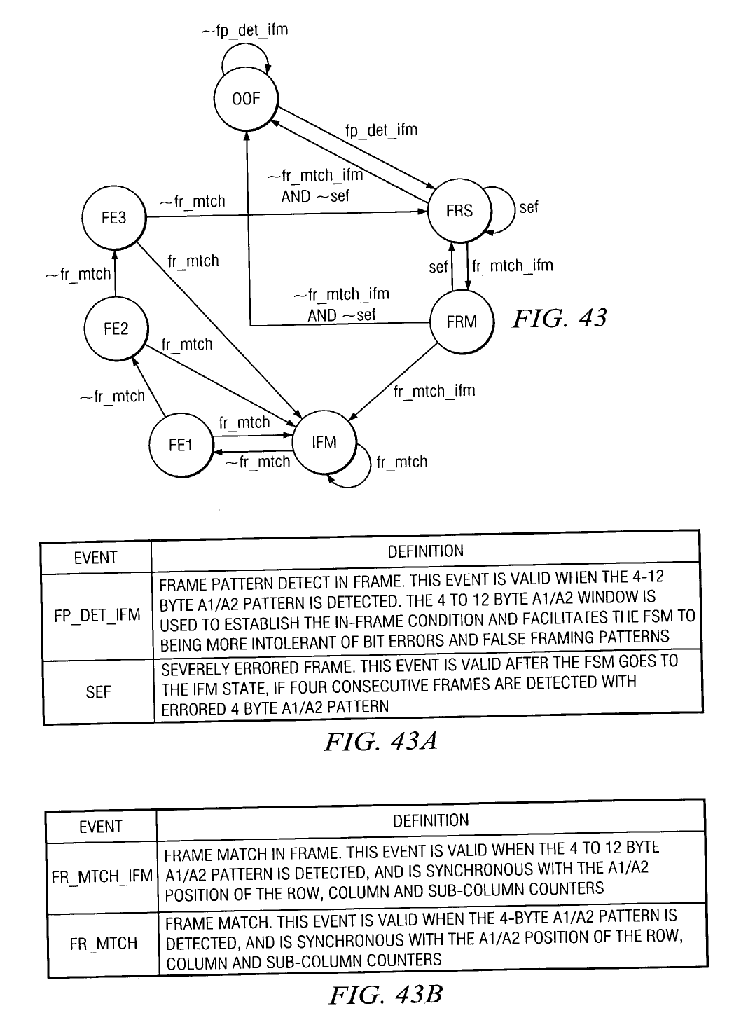

The state diagram of FIG. 43 describes the various state transitions that can happen. FIGS. 43A and 43B describe the meaning of the various events that result in state transitions.

When the framer state machine is in OOF or after reset, it takes at least four bytes of A1/A2 (2 A1 bytes and 2 A2 bytes) to match the framing pattern. The number of bytes used to determine the framing pattern is programmable, it can be either 4, 6, 8, 10 or 12 bytes of A1/A2 bytes.

Yet when the SEF alarm is asserted and the framer is in the FRS state, it only takes four bytes of A1/A2 to determine if the framing pattern matches or not.

The row, column and sub-column number counters are reset to row zero, column and sub-column zero when frame is not valid and the A1/A2 transition is seen. The counters stay reset whenever the conditions stated above are met until the framing state machine goes in-frame state. While the SEF alarm is asserted, the counters do not reset since during the SEF, the probability of going back to IFM state is high.

The SEF alarm is declared when the framing state machine is in IFM state and has seen four consecutive errored framing patterns. However, the SEF alarm is cleared when two consecutive valid framing patterns are detected. The errored framing pattern is defined as the four bytes of data at the boundary of A1/A2 timeslots not matching the A1/A2 pattern. The valid framing pattern is defined as the four bytes at the boundary of A1/A2 timeslots matching A1/A2 pattern.

There are two counters provided to declare and terminate the LOF alarm; the in-frame counter and SEF counter. The operation of these counters is described as below:

The in-framer counter starts to count when the SEF is absent and resets to zero when the SEF is present.

The SEF counter starts to count when the SEF is present, stops when SEF is absent and reset to zero when the in-framer counter reaches 3 millisecond.

The LOF is declared when the SEF counter reach three milliseconds and is terminated when the in-frame counter reach three milliseconds. The operation of these two counters is to avoid the declaration and the termination of LOF on the intermittent SEF.

There are two counters for detecting and terminating the LOS alarm. The set counter counts to 50 microseconds if consecutive all-zeros or all-ones are seen on the scrambled data, then the LOS is declared. The LOS clearing counter counts whenever the LOS alarm is active and a non all-zeros or all-ones pattern is observed on the scrambled data until 125 microseconds, then the LOS is cleared. Therefore, the LOS is cleared if within 125 microseconds, a non all-zeros or all-ones is observed on the scrambled data.

There are two ways to detect the LOC; one is using microprocessor clock to detect the toggling of the line clock and the other way is that the transponder or CDR reports the LOC through an input pin. In RXFR, the logic is designed to report the LOC by observing the input pin from the transponder or CDR and report the LOC as an interrupt.

The loopback data from TXFR is multiplexed inside FRMR and the multiplexed data is flopped and used to detect in-frame and LOS.

Scrambler/De-Scrambler (DSCRM)

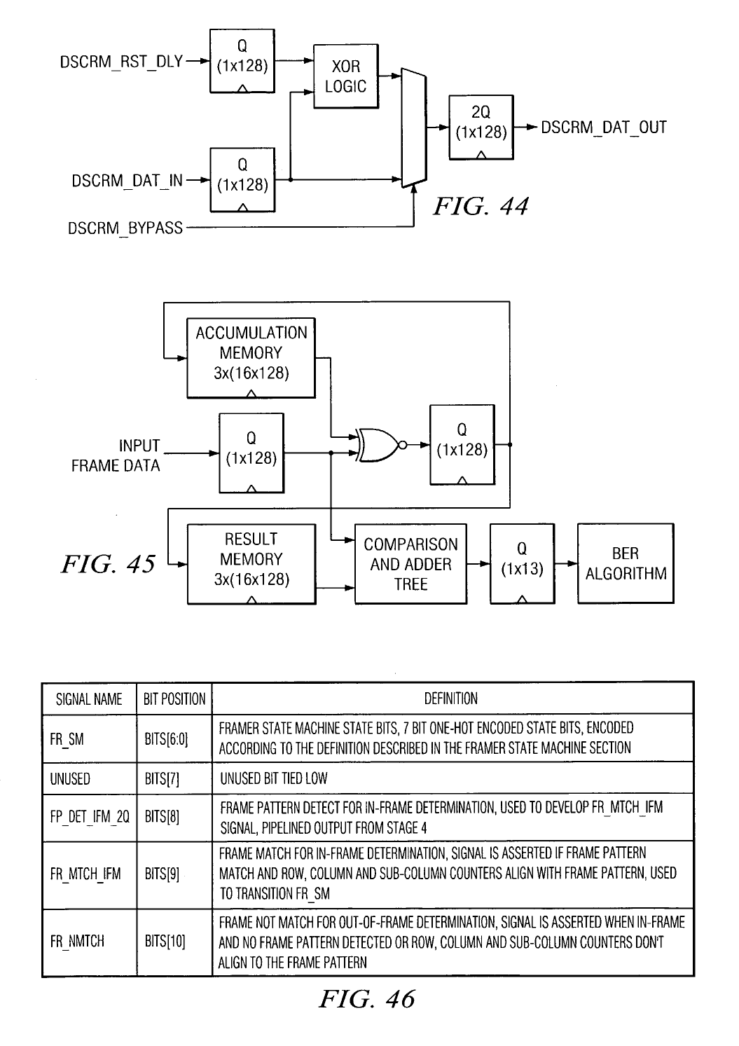

The scrambler (see FIG. 44) is used to scramble the out-going data and de-scramble incoming data. Hence, the design is used in four modules; RX line-side framer, RX system-side framer, TX line-side framer and TX system-side framer.

The scrambler is operable in two modes: OC-768 mode and OC-192 mode. In OC-768 mode, the scrambling function is reset at the first SPE byte of row 0. The first 704 bytes of A1 and the last 704 bytes of A2 can be programmed to be either scrambled or non-scrambled. The J0/Z0 bytes can also be programmed to either be scrambled or not. For OC-192 mode, the scrambling function is reset during the entire TOH bytes of row 0. All the A1, A2 and J0/Z0 bytes are non-scrambled. Furthermore, the scrambler provides the bypass mode in which the incoming data is not passed through the descrambler logic.

The “exclusive OR” (XOR) sequence is a 128-bit sequence generated by the equation: 1+x⁶+x^{7.} Each time the 128-bit scrambling sequence is XOR'd with the 128-bit data, the rotate left shifting is performed.

### RXFR_TOH (RXTOH_A)

There are three different DCC supported in this module; they are Section DCC (SDCC), Line DCC (LDCC), and Extended DCC (EDCC). The EDCC is functional only in OC-768 mode. The output interface for DCC are the same: one-bit data bus and a data valid signal.

There are only three bytes of SDCC per frame. They are located at the first byte of the row 2 and column 0, 1 and 2. The incoming SDCC data are first stored in the registers and after all three bytes are received, then the data are output bit by bit to the primary pins. The first bit coming into chip through the line data is the first bit sent out.

There are nine bytes of LDCC per frame. They are located at the first byte of the column 0, 1 and 2 of row 5, 6 and 7. For each row of row 5, 6 and 7, there are three bytes of LDCC data, and these three bytes of data are stored and output as the same way as the SDCC data are. During the AIS-L condition, the data valid signal for LDCC is kept low to invalidate the output data.

The EDCC has 144 bytes per frame. They are located from the 8^{th} byte to 56^{th} bytes of column 0 of row 5, 6 and 7. The 48 bytes of each row are stored in a memory and when the column number rolls to three, then the data are pulled out from the memory and sent out in a serial fashion.

Frame Monitoring for S1 and M0/M1 Bytes (RXTOH_A_FRAMNR)

The S1 monitoring involves data debouncing and comparison. The data debouncing is to check the stability of the S1 for a number of times. The number is eight in SONET mode and four in SDH mode. A programmable bit is used to select in which mode the logic is operating. After the data de-bouncing, the accepted data is compared against the previously accepted data, if different, then the new data is stored and an interrupt (RX_S_D) is generated.

For the incoming M0/M1 bytes, a 32-bit accumulator is provided to sum up the capped value. The capping on the M0/M1 bytes is based on STS mode. For OC-768 mode, the maximum value is 6,144 and any value larger than 6,144 is treated as 0. For OC-192 mode, if both M0/M1 are supported, the maximum value is 1,536; if only M1 is supported, the value is 256. Any incoming value above the maximum accepted value is viewed as an invalid value and treated as zero. An interrupt (RX_M01_OFLOW) is generated when the 32-bit accumulator reaches rolls over to zero.

During LOF, LOS and invalid frame, both S1 and M0/M1 functions are suspended and resumed after the alarm is off.

The latch event is provided for the software to synchronize with hardware event. After the rising edge of the latch event signal, if no S1 is accepted, then an interrupt (RX_S_FAIL_SECE) is set. If the incoming M0/M1 bytes present non-zero error after the last rising edge of latch event signal, then an interrupt (RX_M01_ERR_SECE) is set.

J0 and B1 Processing (RXTOH_A_JOB1PRS)

The J0 data can be extracted either from scrambled data or from unscrambled data depending on the scrambling mode. In OC-192 mode, J0 data are un-scrambled, while in OC-768, the J0 data can be either scrambled or un-scrambled. Please refer to the scrambler section for more details.

A mode bit (RX_J0_SDH) is provided to program the logic to operate in SDH mode while set to one. During SDH mode, the logic tries to capture a 16-byte data message, of which the MSB of the first byte is one and MSB of other bytes are zero. Then the logic debounces on the 16-byte data for three consecutive times for the same data. After debouncing, the accepted data is compared against the previously accepted data, if different the interrupt (RX_J0_D) is set to one.

In SONET mode (RX_SDH_J0=0), if mode bit (RX_J0_CLRF) is set to one, the logic looks for a 64-byte data message ending with <0×0D, 0×0A>. If mode bit (RX_J0_CLRF) is set to zero, the logic looks for a 64-byte data message of which the MSB of the first byte is one and the MSB of other bytes are zero. If captured, the data area de-bounced for three times. After de-bouncing, the accepted data is then compared against the previously accepted data, if different, the interrupt (RX_J0_D) is set.

The accepted J0 bytes can be accessed through register read command.

The B1 calculation is based on the exclusive-OR operation throughout the entire frame on the scrambled data. However, the incoming B1 byte is extracted from the un-scrambled data at the first byte of row 1 and column 0. The internally calculated B1 then compares against the incoming B1 byte to get the BIP-8 result. The comparison result (BIP-8) is applied to the BER calculation to generate the SF/SD alarms.

The algorithm for SF/SD generation is the same. The difference is the threshold registers used. The following description on the SF alarm is applicable to SD alarm only with different threshold registers.

Two sets of registers are used to set and clear the SF alarm. For setting SF alarm, the register (B1_SF_FRM_CNT_SET) is to provide the number of frames to establish a window within which the number of errors is monitored. There are two ways to monitor the errors: BER and blocked error. If BER is chosen, then the number of raw error is taken into account and error threshold register B1_SF_ERR_CNT_SET is used. If blocked error is chosen, any error in a frame represents one blocked error and the error threshold register B1_SF_EBLK_CNT_SET is used. Inside the window set up by B1_SF_FRM_CNT_SET, if the sum of raw error exceeds B1_SF_ERR_CNT_SET or the number of blocked error exceeds B1_SF_EBLK_CNT_SET, the SF alarm is set. If the error threshold is not crossed, then all the counters including frame counter and error counter are reset to zero and start another window.

In order to clear the SF alarm, the register B1_SF_FRM_CNT_CLR is to establish a frame in term of number of frames. Then as the SF alarm setting, there are two threshold registers used to monitor number of errors, they are B1_SF_ERR_CNT_CLR for BER and B1_SF_EBLK_CNT_CLR for blocked error. At the end of the window dictated by B1_SF_FRM_CNT_CLR, if the number of raw error is less than B1_SF_ERR_CNT_CLR or the number of blocked error is less than B1_SF_EBLK_CNT_CLR then, the SF alarm is cleared. If the number of errors exceeds the threshold, the framer counter and the error counter are both reset to zero to restart the monitoring window.

The frame counter and error counter are shared in setting and clearing of the alarm and these counters are read-only from the software.

If there is a transition either from high to low or from low to high in SF alarm, an interrupt (RX_B1_SF_D) is set to one. For SD alarm, the interrupt (RX_B1_SD_D) provides the same function.

A 32-bit raw error counter is provided to constantly accumulate the B1 error in either BER mode or blocked error mode. When the raw counter rolls over, an interrupt (RX_B1_ERR_OFLOW) is set to one.

Another interrupt is provided (RX_B1_ERR_SECE) when an error is observed after the last rising edge of latch event signal.

B2 Processing (RXTOH_A_B2PRS)

The B2 is provided on a per STS-1 basis. Therefore, in OC-768, there are 768 B2 bytes while in OC-192, there are 192 bytes. The computation of B2 only includes the LOH and the entire SPE. The computation results are then compared against the incoming B2 bytes, and the difference represents errors. These errors are summed up and applied to the same BER algorithm to generate SF/SD as described in the B1 calculation section above. The threshold registers for setting and clearing both alarms are separated.

A 32-bit raw error counter is provided to constantly accumulate the B2 errors in either BER mode or blocked error mode. When the raw counter rolls over, an interrupt (RX_B2_ERR_OFLOW) is set to one.

If there is a transition either from high to low or from low to high in SF alarm, an interrupt (RX_B2_SF_D) is set to one. For the SD alarm, the interrupt (RX_B2_SD_D) provides the same function.

Another interrupt is provided (RX_B2_ERR_SECE when an error is observed after the last rising edge of the latch event signal.

The result of B2 calculation has to be sent to TX side for M0/M1 bytes. The result is represented on a bus and a ready signal is active for one clock. The TX side just synchronizes the ready signal and then takes the result.

FIG. 45 illustrates the B2 calculation. Both Accumulation memory and the Result memory are of the same side—three instances of 16×128 bits. The Accumulation memory holds the intermittent values during the calculation. The Result memory holds the values after the calculation is done through the entire frame. Until the B2 timeslots come, the contents of the Result memory is ready out and compared against the incoming B2 bytes. The comparison results then go through an adder tree for summing up all the errors. After summing up all the errors, the BER algorithm is applied.

During higher priority alarms (LOF/LOS/AIS-L) or non-valid frame, the B2 calculation is stopped. All the counters are stopped (not reset). Therefore, no error is accumulated. After the alarms go away, the counters resume.

K1/K2 Byte Processing (RXTON_A_K12PRS)

The K1/K2 bytes are used for APS. This module generates several interrupts to facilitate the APS on the system level. The way to generate these interrupts is through a de-bouncing logic and comparison logic. The number of times it takes to de-bounce is programmable and used throughout all the interrupt generation. The de-bouncing circuits checks to see if the incoming data keeps the same contents for the programmed number of frames.

The K1[7:0] and K2[7:3] bits are de-bounced in order to generate RX_K1_D interrupt. After de-bouncing, the accepted value is compared against the previously accepted value. The interrupt RX_K1_D is set to one when the values are different. The content of K1[7:0] and K2[7:3] can be read from RX_K12_ACPT_VAL[7:0] and RX_K12_ACPT_VAL[15:11].

The K2[2:0] bits are used to generate three different interrupts: RX_K2_D, RX_AISL_D, and RX_RDIL_D. After K2[2:0] de-bouncing, if the accepted value is different from the previously accepted value and the value is neither 111 nor 110, then the RX_K2_D interrupt is set to one. The content of the accepted K2[3:0] can be read from RX_K12_ACPT_VAL[10:8] register bits.

The RX_AISL_D and RX_RDIL_D interrupt generation is different from RX_K2_D. If the incoming data of K2[2:0] is 111 and AIS-L status is low, after de-bouncing, then AIS-L status is set to one and the interrupt RX_AISL_D is set to one as well. After AIS-L is active, the logic starts to look for the non 111 value of K2[2:0]. If AIS-L is active and the incoming data of K2[2:0] is not equal to 111, after de-bouncing, the AIS-L status is set to zero and the RX_AISL_D interrupt is set to one. In conclusion, the RX_AISL_D interrupt is set to one. In conclusion, the RX_AISL_D interrupt is set to one when there is a transition from low to high or from high to low on RX_AISL status. The K2[2:0] is checked against 111 value after de-bouncing to see if AIS-L is active or not.

The same algorithm used to detect AIS-L is applied to RDI-L. The only difference is that the RDI-L is to check if the K2[2:0] is equal to 110 or not.

The K1 byte is also used for stability check. Every 12 frames from a window. Inside each window, if three consecutive same K1 bytes are not seen, then RX_K1_UNSTB status is set to one. When RX_K1_UNSTB status is one, and within a window, three consecutive same K1 bytes is observed, then RX_K1_UNSTB is set back to zero. Whenever there is a transition on RX_K1_UNSTB status, the RX_K1_UNSTB_D interrupt is set to one.

During higher priority alarms (LOS/LOF) or non-valid frame, all the de-bouncing counters are reset back to zero. Until these conditions go away, then the de-bouncing restarts.

TOH Dropping (RXTOD_A_TOHDRP)

The purpose of dropping the entire TOH data is to let the system process/monitor the bytes that are not processed by the RXFR, for example, E1, E2 and F1 bytes. Furthermore, by dropping entire TOH data, we can support TOH transparency which allows the same TOH data to be inserted at the system-side framer through TOH add interface.

The TOH data is first stored in memory, then output on the TOH drop pins. Two instances of 144×64 bits memory are employed to store the entire TOH data of each row. The amount of data can be either 576 (192×3) bytes or 2,304 (768×3) bytes. After the column number rolls to 3, then the logic starts to pull out the data from the memory and output them through an 8-bit bus interface. The first byte coming into the chip through line data is the first byte dropped.

Two more signals are provided to inform the location of each byte. A data valid signal is provided to notify the data on the bus is valid. When the signal goes active, it stays active until all the bytes belonging to one TOH row are dropped. The other signal provided is the frame start signal. The frame start signal is active for only one clock when the first byte of A1 is dropped. Therefore, every nine data valid signals, frame start signal is active. This signal helps to identify the location of the frame when the data starts to output.

When the frame is not valid, the data valid signal is forced to be inactive internally to let the system stop latching data from the bus.

In OC-768 mode, since the number of bytes to be dropped is four times that in OC-192 mode, the 8-bit bus simply does not offer enough bandwidth. Instead of an 8-bit bus, a 32-bit bus is provided to output the TOH data in OC-768 mode. However, only RXFR_{—}0 (the port 0 RX framer) is operating during OC-768 mode, the output data bus can be shared. The RXFR_{—}1 TOH drop bus shares with RXFR_{—}0 drop bus bit 8˜15 and RXFR_{—}2 TOH drop bus shares with RXFR_{—}1 drop bus bit 16˜23 and so on. The data valid signal and frame start signal is not shared since in OC-768 mode, only one pair of these signals is required. The data multilplexer is implemented in each framer but only RXFR_{—}0 is connected with other drop data buses from other framers.

RXFR Bus Interface and Registers (RXTOH_A_REGS)

This module includes all interrupt registers, interrupt mask registers and all the general registers used in RXFR except some read-only registers. This module is responsible for interfacing with HINTFC module to start and terminate all the register read/write transactions. For a read transaction, a data multiplex is provided to output the data.

The internal test bus in multiplexed with incoming test bus inside this module to output the internal test bus to primary pins.

A 26-bit counter inside this module counts roughly a second for latch event signal generation. Whenever this counter rolls over, the latch event is active for one clock. The latch event signal can be also triggered by a software write to a register (LATCH_EVENT). A mode register (LATCH_EVENT_MODE) is used to select which mode the event is triggered.

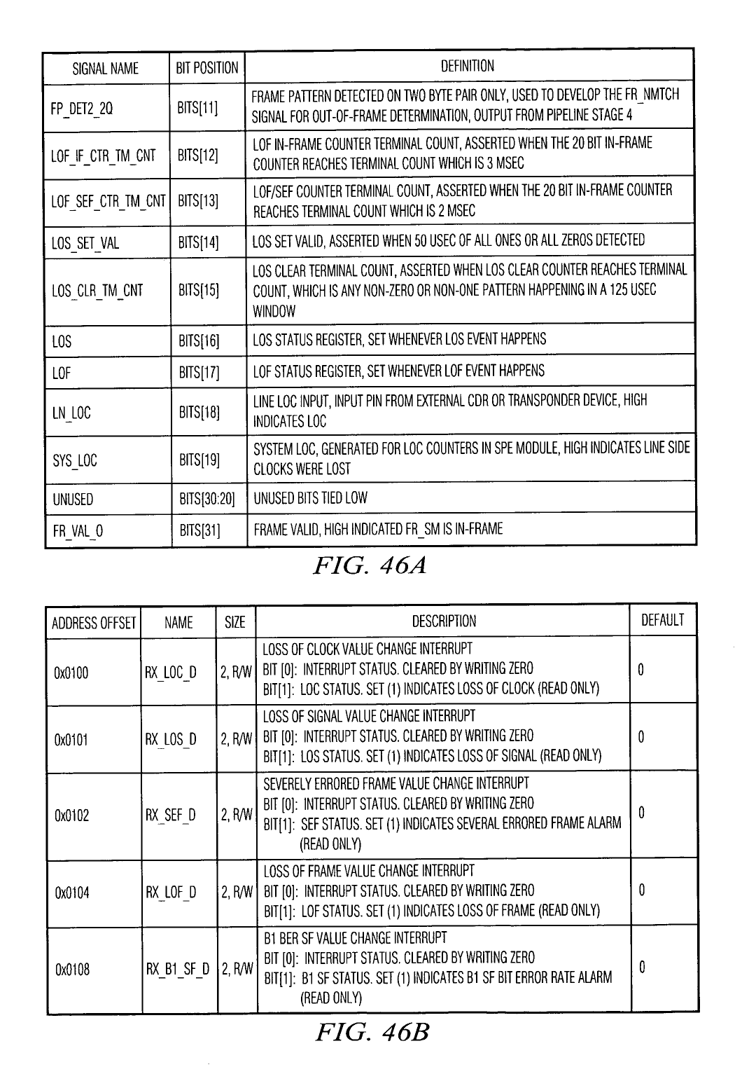

FIGS. 46 and 46A describe the signals that are multiplexed on the 32-bit daisy chained test bus for the RXFR module.

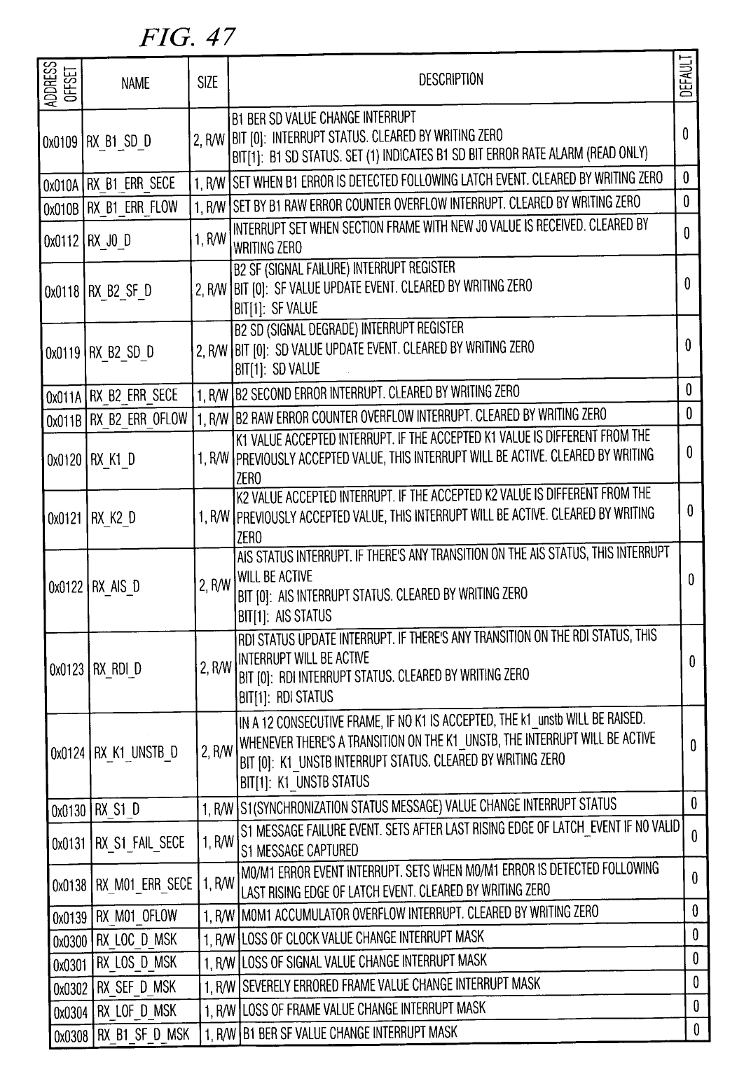

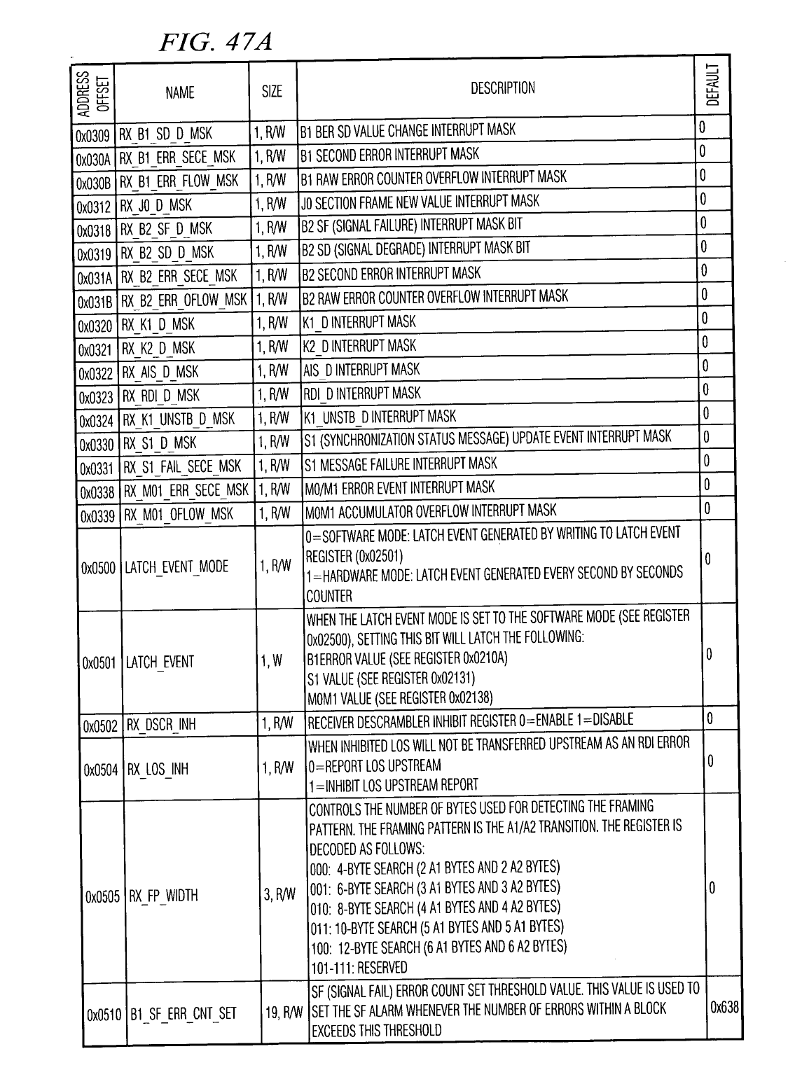

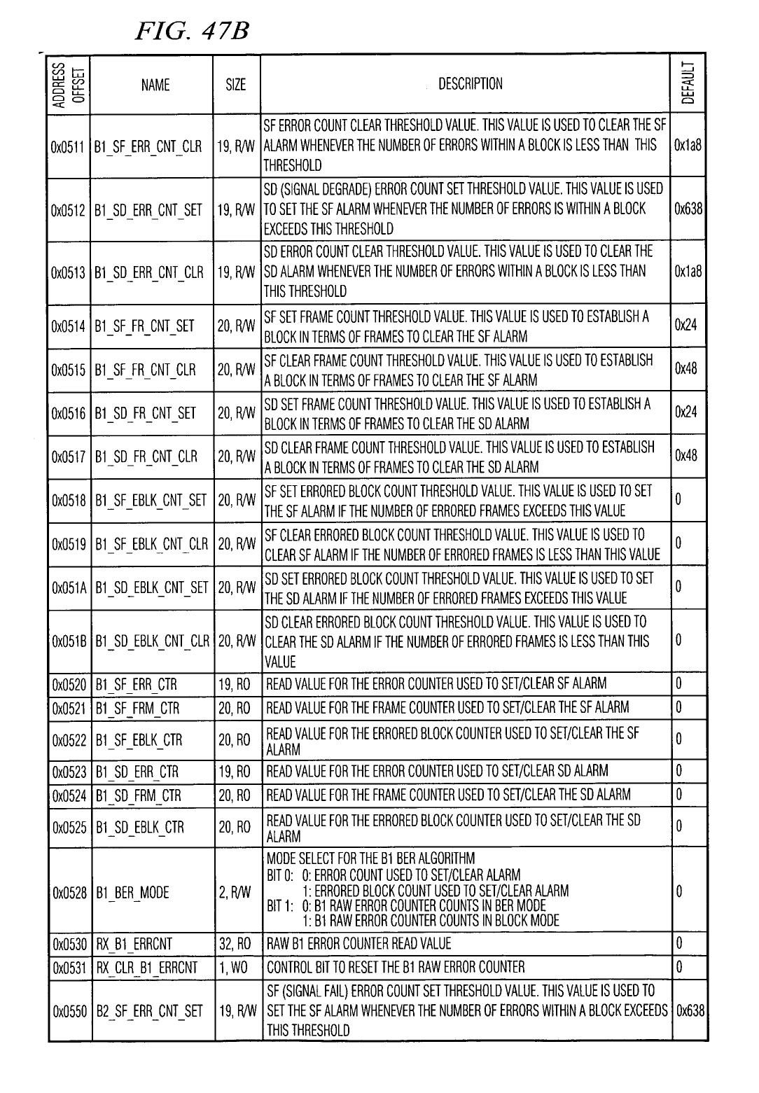

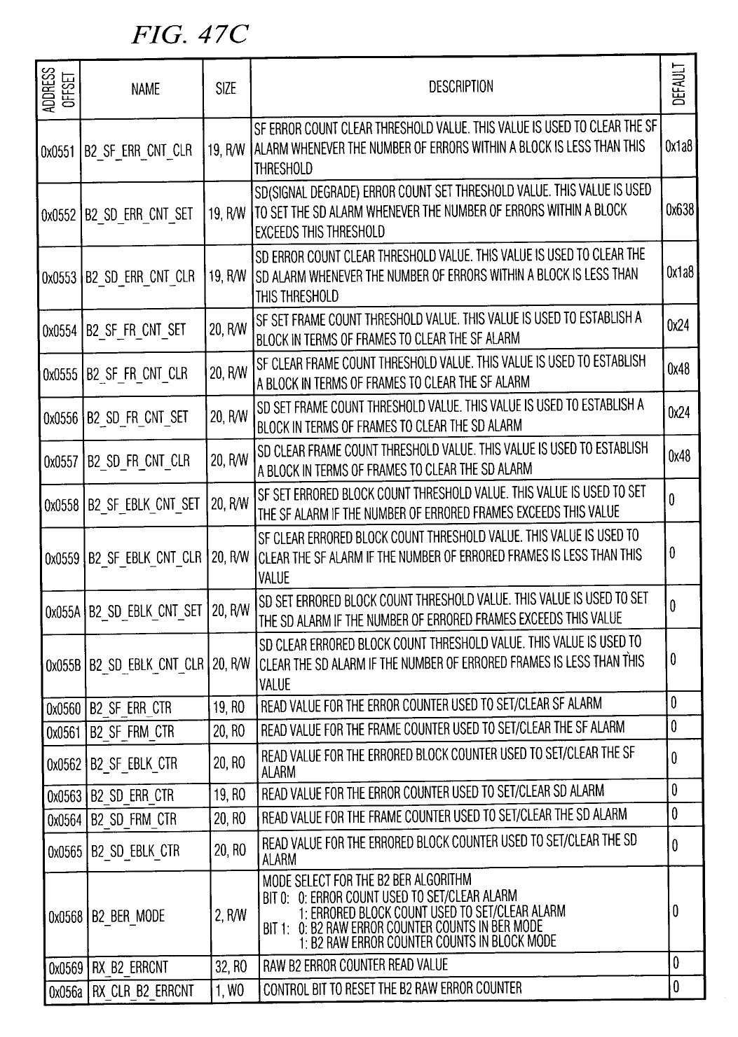

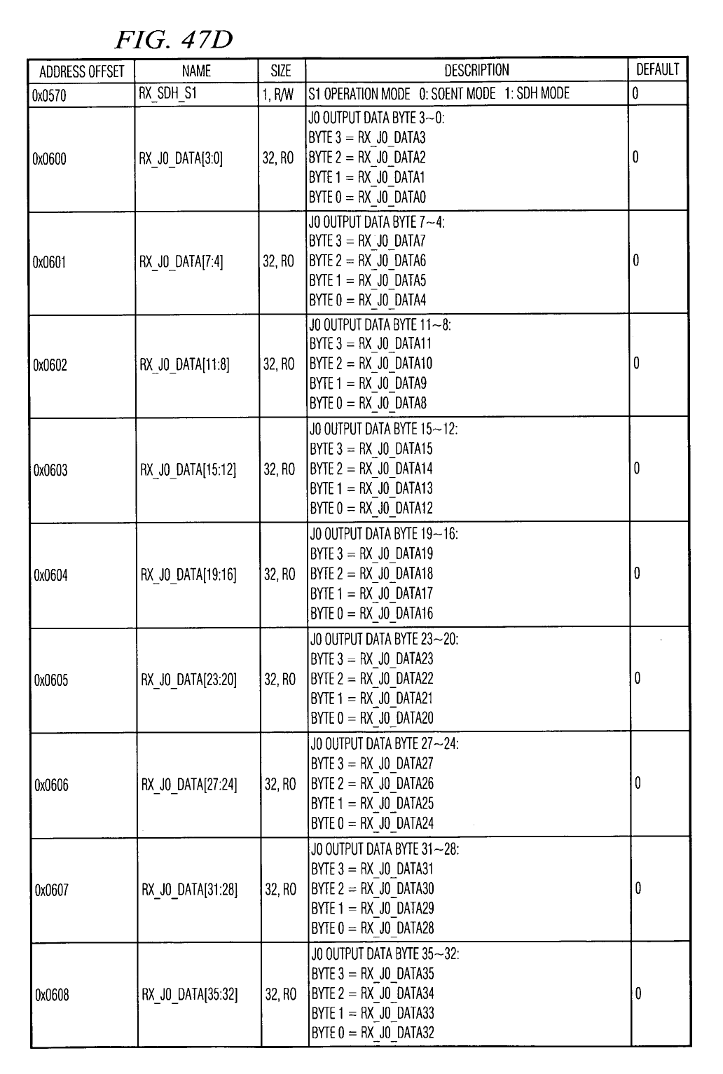

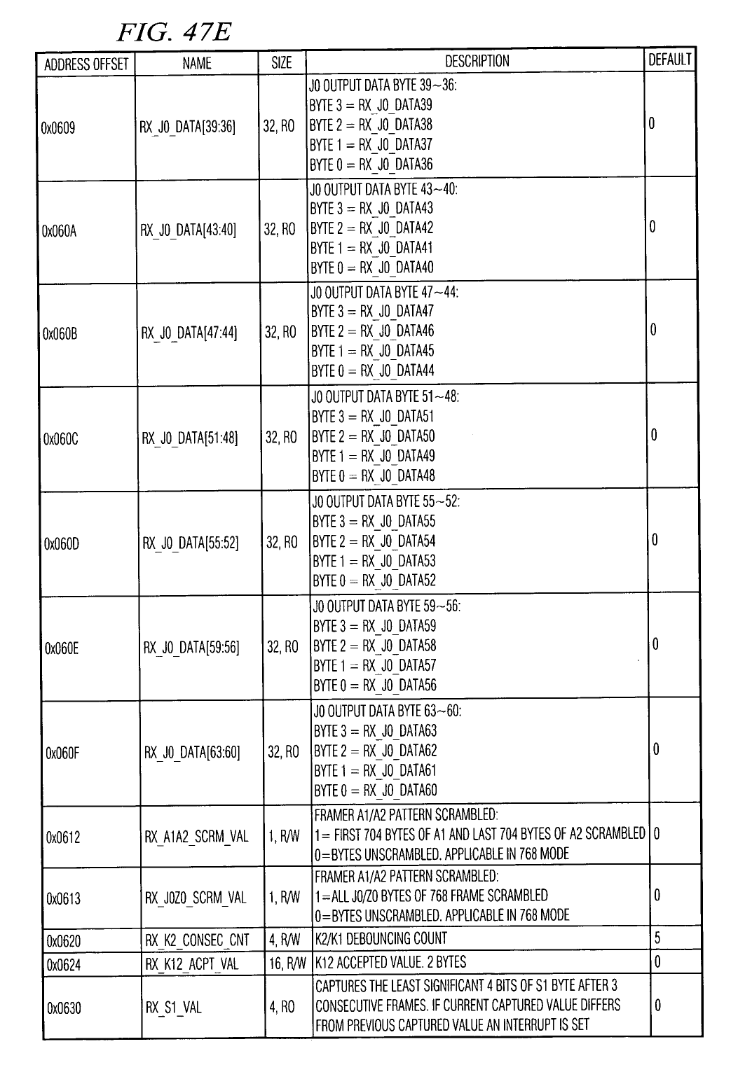

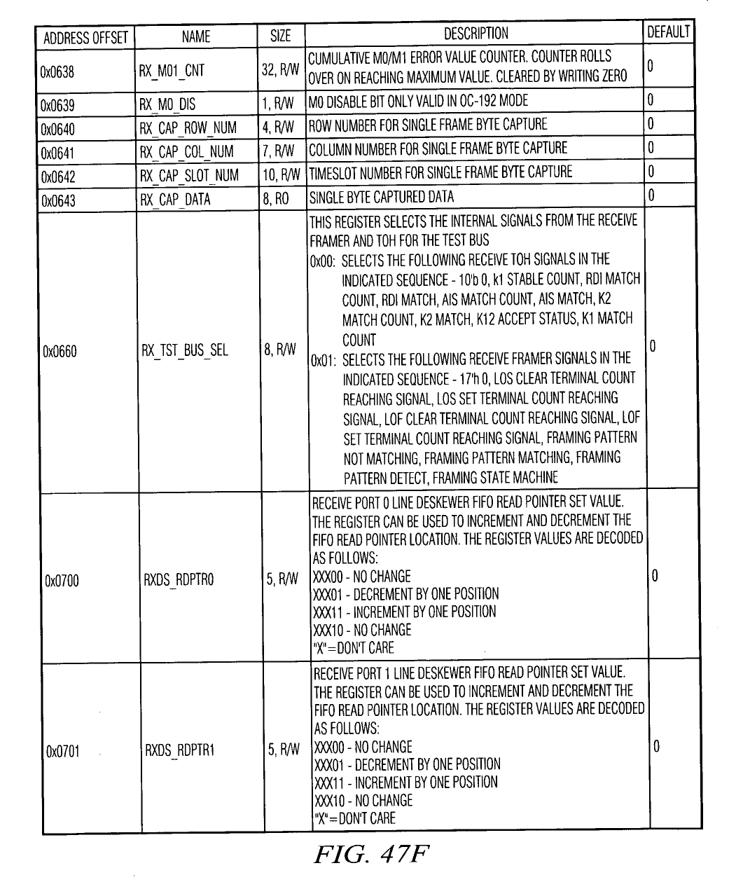

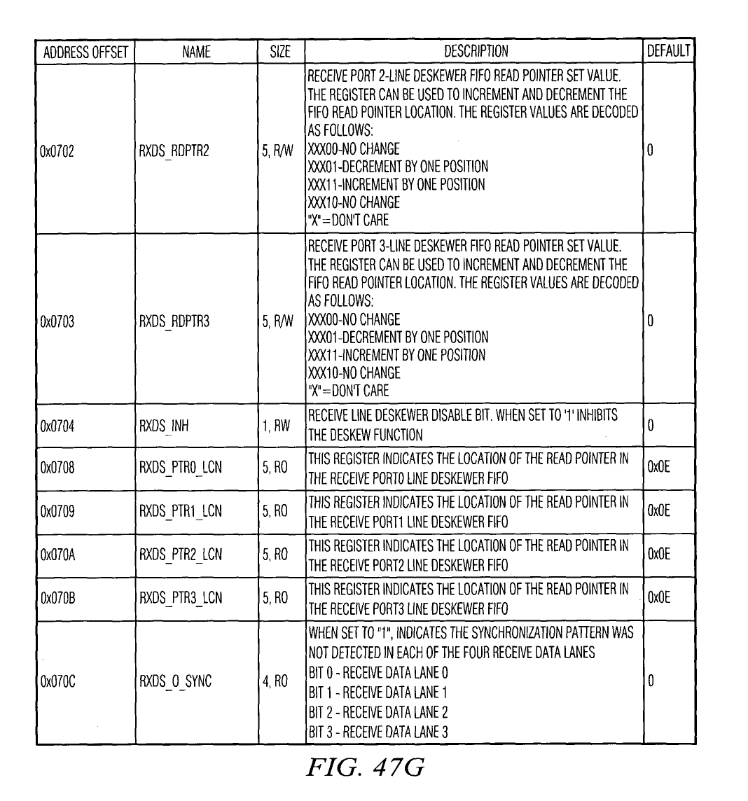

FIGS. 47-47G show a memory map for all the registers and memories in the RXFR design. The address range reflects the generic address range based on an 18-bit address.

Transmit Framer (TXFR)

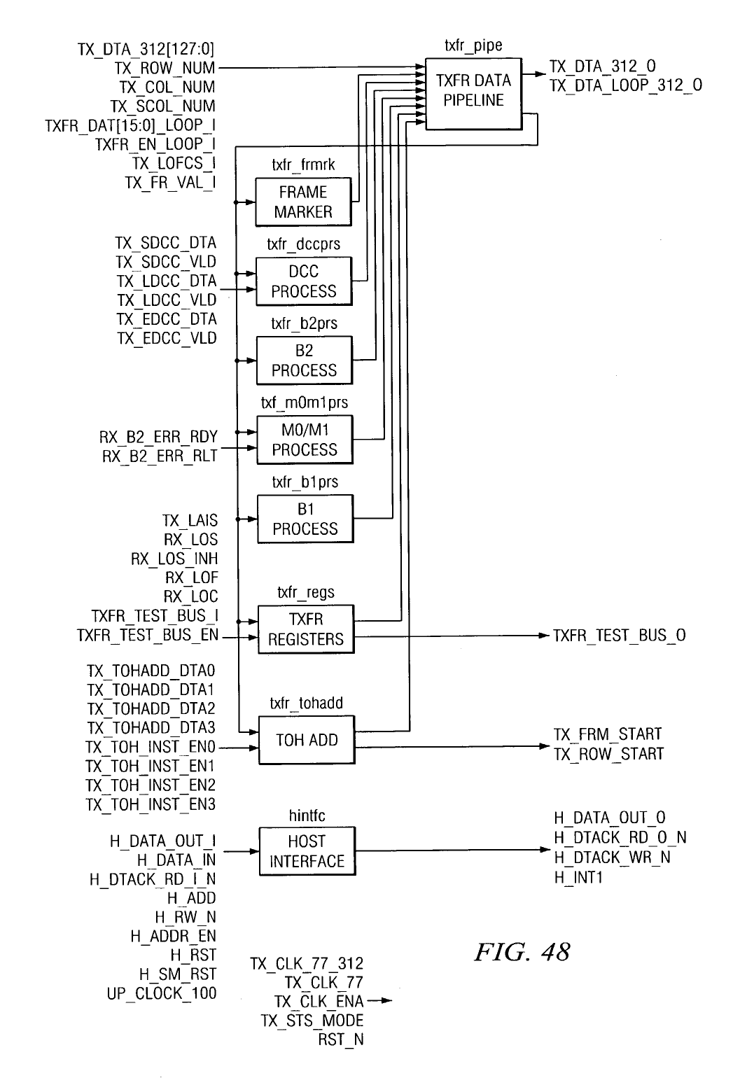

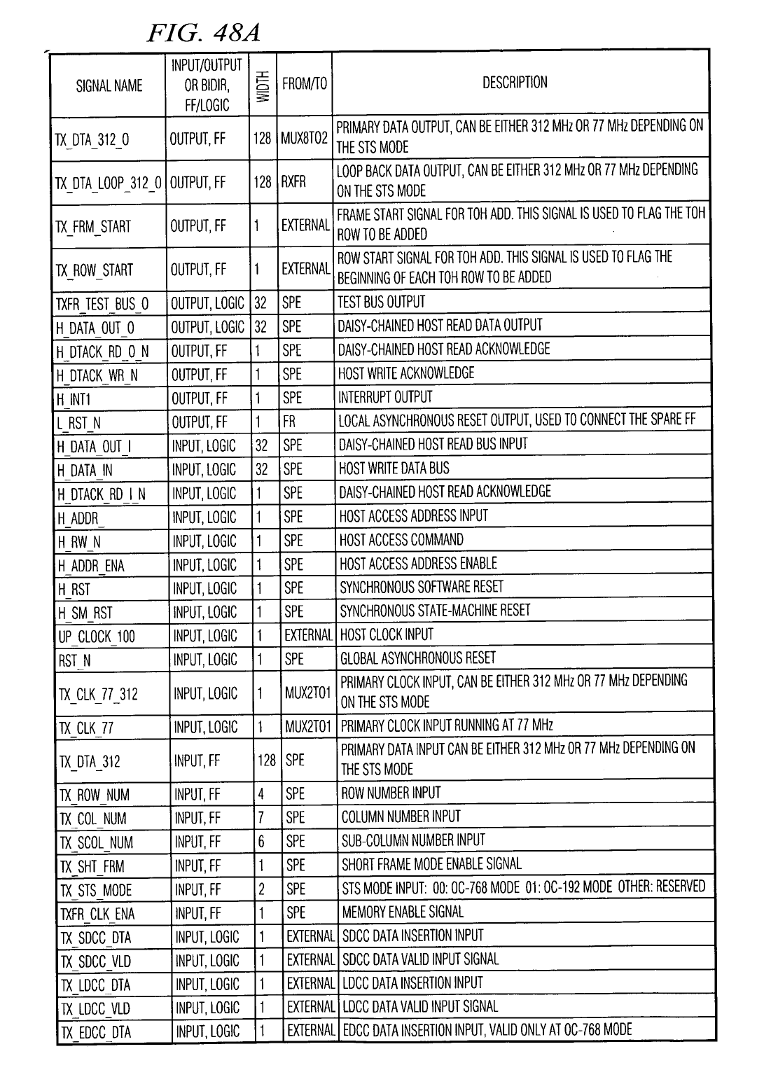

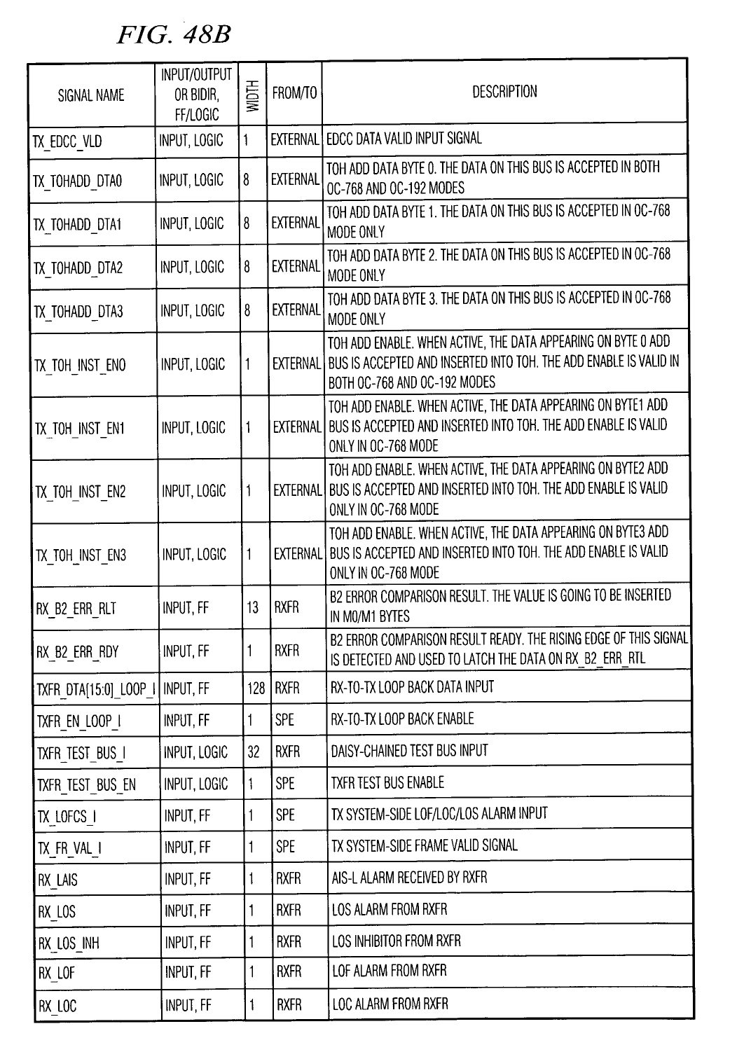

FIG. 48 is a top-level diagram of the modules contained within TXFR. The interface signals are shown in FIGS. 48A and 48B.

TXFR Features

Inserting A1/A2 framing patterns.

1. In OC-768 mode, the first 704 bytes of A1 and the last 704 bytes of A2 are programmable and can be either scrambled or un-scrambled.

Generating B1 result and insert it into B1 timeslot.

1. A programmable bit is provided to invert the B1 calculation result.

Inserting J0 message.

Generating Z0 as a fixed pattern or an incremental pattern.

Generating B2 results and inserting them into B2 timeslots.

1. A programmable bit is provided to invert the B2 calculation results.

Inserting SDCC, LDCC with the data input from the external serial interface.

Inserting EDCC with the data input from the external serial interface in OC-768 mode only.

Inserting K1/K2 bytes with the programming values.

Generating AIS-L on the LOH and SPE based on the following conditions:

1. TX system-side frame is not valid.

2. TX system-side has LOF/LOC/LOS alarms.

3. Programming register bit.

Generating RDI-L on K2 bytes based on the following conditions.

1. RX line-side LOS/LOF/LOC alarms.

2. RX line-side AIS-L alarm.

Two separate counters are provided to count the hold time in terms of number of frames for AIS-L and RID-L generation.

Inserting S1 value from programming register.

Inserting M0/M1 values based n the RX line-side B2 errors.

Inserting TOH data from external interface.

Inserting single byte into any location of the frame based on the programmed timeslot.

Scrambling the data in both OC-768 and OC-192 modes.

Generating LOF by inverting the framer marker for diagnosis purposes.

Generating LOS be sending all zeros or all ones in the entire frame for diagnosis purposes.

Providing the line side loop backs.

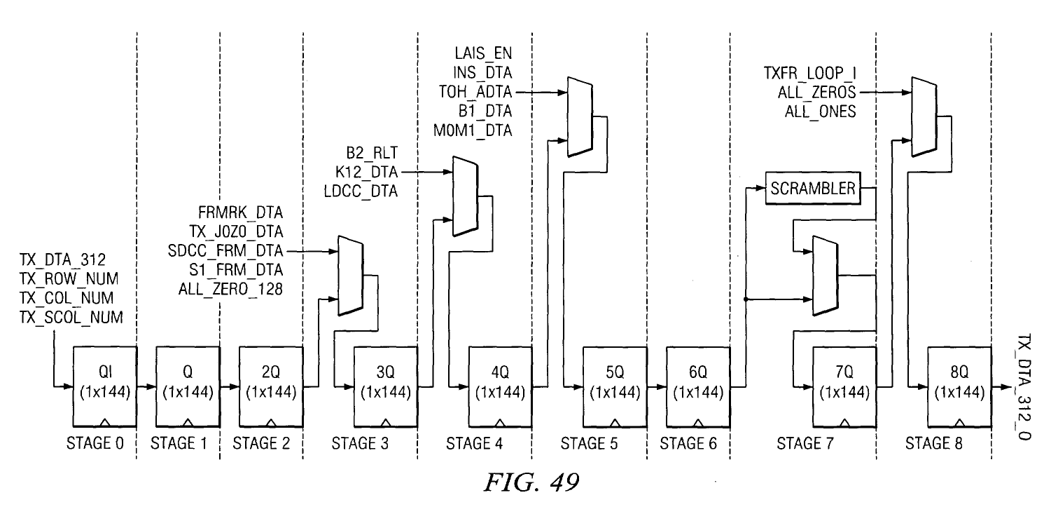

FIG. 49 shows the pipeline stages inside TXFR design.

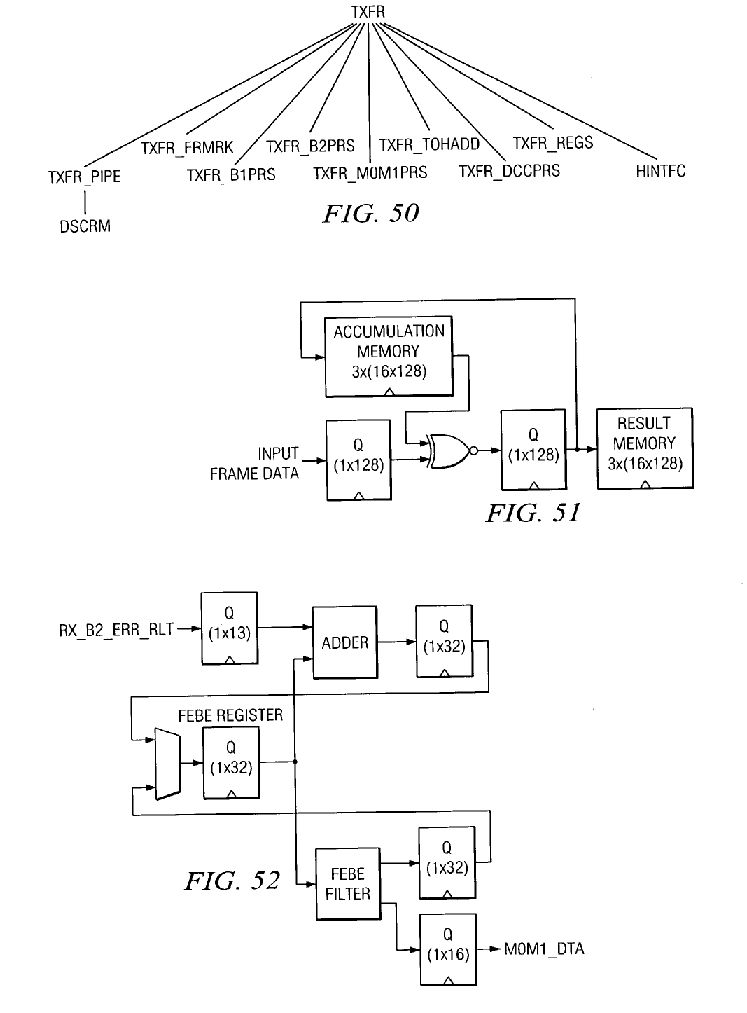

FIG. 50 is a tree diagram that shows the modular structure of the TXFR design.

TXFR Pipeline (TXFR_PIPE)

This module owns the only pipeline in the TXFR which mainly multiplexes all the TOH bytes. Please refer to TXFR Datapath Diagram for more details.

This module multiplexes in the frame marker, J0/Z0 bytes, B1 byte, DCC bytes, B2 bytes, K1/K2 bytes, S1 byte and M0/M1 bytes. All other TOH bytes are set to be zero. Furthermore, it also multiplexes the TOH add data and inserts the single frame byte.

This module includes the scrambler sub-module for scrambling the data in OC-192 mode or OC-768 mode. For more detail, please refer to the DSCRM section in RXFR.

For LOS error insertion, all zeros or all ones can be chosen to insert into the entire frame. The selection bit is TXFR_LOS_VAL_SEL.

The loopback data multiplexer also resides within this module. The input loopback data is multiplexed at the last stage of the pipeline.

Frame Marker Generation (TXFR_FRMRK)

For OC-192 mode, the frame marker is always F6/28. However, for OC-768 mode, the first 704 bytes of A1 and the last 704 bytes of A2 can be programmable. In order to transmit these programmed A1/A2 bytes, the scrambling enable bit for these bytes must be turned on at the same time.

B1 Generation (TXFR_B1 PRS) The B1 calculation XOR's the entire frames scrambled data, then the single byte result is inserted into the frame before scrambling.

A programming bit (TXFR_B1_MODE) is provided to introduce errors into B1 result. When set to one, the B1 result is inverted before being inserted into the frame.

B2 Generation (TSFR_B2PRS)

The B2 calculation is on the LOH and the entire SPE. Each B2 byte represents one STS-1; therefore, there are 192 bytes of B2 in OC-192 mode and 768 bytes in OC-768 mode. A block diagram is shown in FIG. 51.

The accumulation memory and the result memory are of the same size; each has instantiated 3 instances of 16x128 bit two-port memory. The accumulation memory is accessed throughout the entire frame except the SOH; however, the result memory is written at the last bytes of the frame for storing the result and read at the B2 timeslots of the following frame.

A mode bit (TXFR_B2_MODE) is provided to introduce B2 errors. When this bit is set to one, the result of the B2 calculation is inverted before being inserted into the following frame.

M0/M1 Generation (TXFR_M0M1PRS)

The TX side M0/M1 (FIG. 52) is used to send out the number of B2 errors that RX side has detected. The result of the B2 calculation sent from the RX side is synchronized according to the ready signal. A 32-bit accumulator is provided to sum up all the errors from the RX-side and subtract when M0/M1 bytes are inserted into the frame. However, the maximum value that M0/M1 can transfer is limited. In OC-768 mode, the maximum value is 6,144. In OC-192 mode, if both M0/M1 are enabled, the maximum value is 1,536 and the maximum value is 256. This function is performed in the FEBE filter which examines the incoming value against the maximum values.

The FEBE register holds the current RX B2 errors. If any error comes from the RX side, the FEBE register takes the sum of its contents and the incoming RX B2 errors. If an overflow is seen, the interrupt TXFR_FEBE_OFLOW is set. If a frame is transmitted in Tx side, if the value of the FEBE register is less than the maximum value that M0/MI bytes can transfer, then the FEBE register is set to zero and the content of the FEBE register is sent out. On the other hand, if the value of the FEBE register is larger than the maximum value, then the maximum value is sent out and the difference between the FEBE register and the maximum value is stored back to the FEBE register.

DCC Insertion (TXFR_DCCPRS)

There are three different DCC (Data Communication Channel) channels supported in TXFR; they are SDCC, LDCC and EDCC. The EDCC is only active during OC-768 mode. The three DCC interface protocols are the same; one bit data signal and one bit valid signal. Both signals are driven by the external logic and synchronous to the TOH ADD CLOCK WHICH IS RUNNING AT 77 MHz. When the data valid signal is active, the bit on the data signal is latched. It is the system responsibility to keep the track of how many bits has been inserted. The system can use frame start signal from TOH add bus to synchronize with the outgoing frame.

An internal counter is available for each DCC to serve as a pointer to which location the incoming bit is stored. For example, for SDCC, since it has 24 bits per frame, a 5-bit counter counts from 0 to 23 and is used as the pointer. The counter rolls back to zero when it reaches 23, without waiting for the frame boundary. Therefore, if more than 24 bits are input in one frame, the 25^{th} bit overwrites the 1^{st} bit and so on.

TOH Add (TXFR_TOHADD)

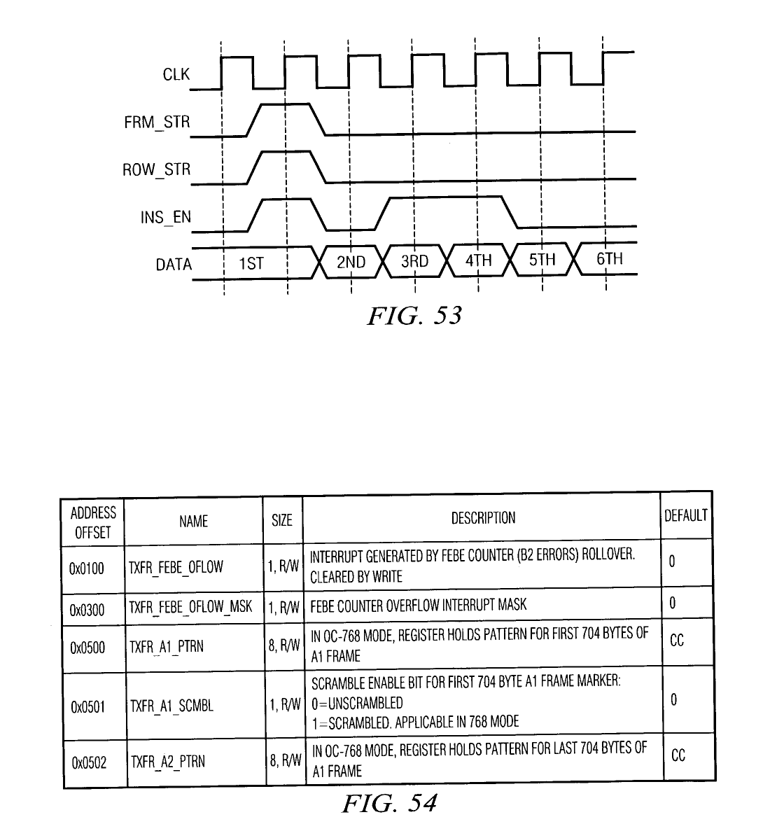

The TOH add bus can be running in two modes: OC-768 and OC-192 mode. For OC-192 mode, and 8-bit bus is used for data accompanying with an enable bit. For OC-768 mode, a 32-bit bus is used for data with four enable bits, each for one byte of the data. The TXFR_TOHADD module outputs frame start and row start signals (see FIG. 53) to help the system to keep track of the frame location. The frame start is active one clock for every frame accompanying the row start signal. Therefore, when both the row start and frame start signals are active, the bytes are inserted will be transmitted in the next frame.

The module expects the system to put the first byte of the inserted data onto the data bus and waits for the row start signal. Since the space between two consecutive row start signals is larger than the time it takes to insert the TOH bytes, the system can easily decide to put the first byte of the next row on the bus after the current row has been fully inserted. The Titan also outputs the clock for the synchronous interface protocol.

TXFR Registers (TXFR_REGS)

This module provides the registers as well as the interface with the host interface module. The detailed register definition can be found in TXFR Memory/Register Map section.

In addition, the TXFR_REGS also provides the logic for generating Z0, AIS-L and RDI-L. Z0 bytes are located from the second byte to the 768^{th} byte of row 0 and column 2 position. The default value of these bytes is 0×CC. They can be programmed to transmit an incrementing pattern. A starting value should be provided and an enabling bit should be programmed in order to generate the pattern. After being programmed for the pattern generation, the logic will start to increment from the starting value and rolls over to zero after reaching 255.

AIS-L is generated when the system side framer (TXSFR) does not see a valid frame or LOF/LOS/LOC is observed on the system side framer (TXSFR). AIS-L can be inserted by programming (TXFR_LAIS) register. Whenever one of the conditions occurs, an AIS-L hold time counter is enabled to count the number of frames, this is to guarantee the AIS-L holds enough time for the far-end equipment to detect the alarm. When the hold time counter reaches its threshold (TXFR_AIS_HFRM), if the condition triggering AIS-L is gone, then AIS-L is inactive. Otherwise, the AIS-L stays until the condition goes away. During the AIS-L, a signal is sent to TXFR_PIPE module to insert 0×FF into the entire SPE and LOH.

RDI-L is generated when one of the following conditions occurs: RX line-side LOF/LOC, RX line-side LOS, or RX line-side AIS-L. The LOS is qualified with a register from RX line-side (RX_LOS_INH). If one of the conditions happens and there is no AIS-L transmitting, the last three bits of K2 byte is inserted with 110. A RDI-L hold time counter is also provided to ensure the hold time.

The TXFR block does not multiplex any internal signals onto the 32-bit daisy chained test bus, and if selected then TXFR outputs all-zeros.

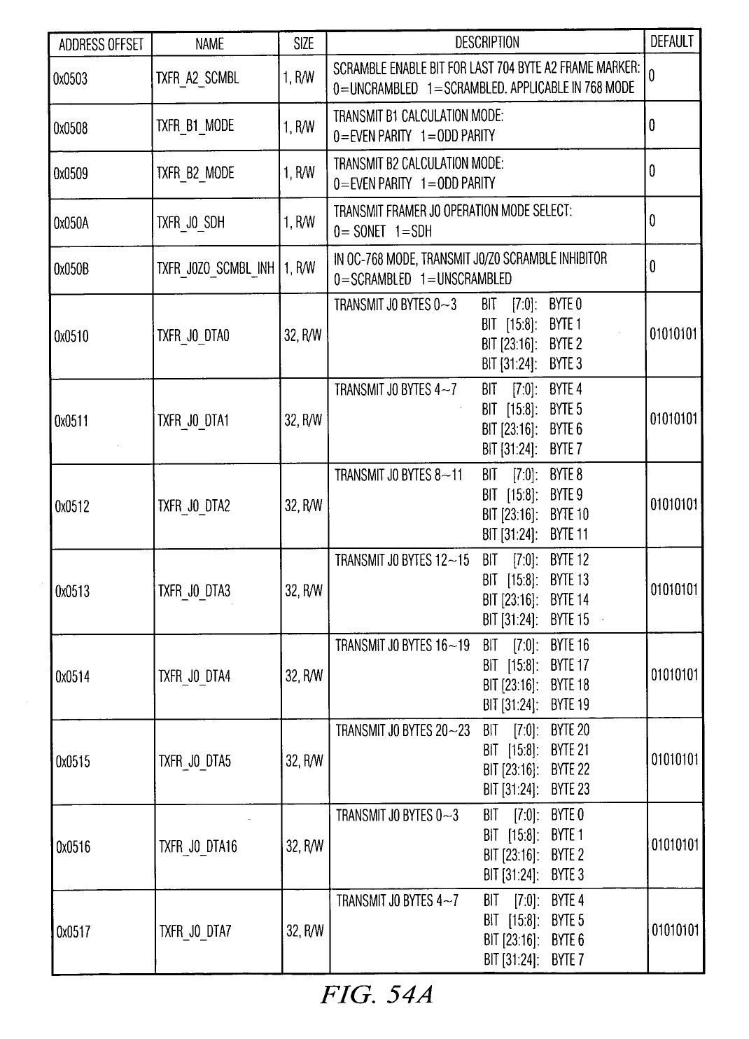

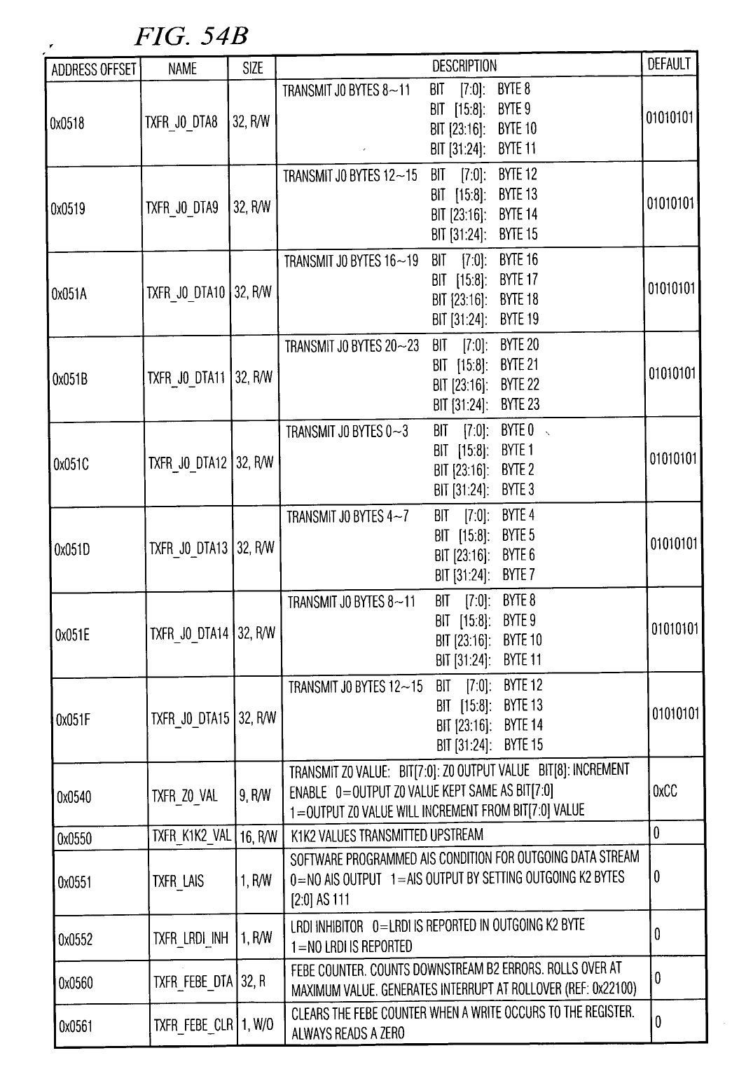

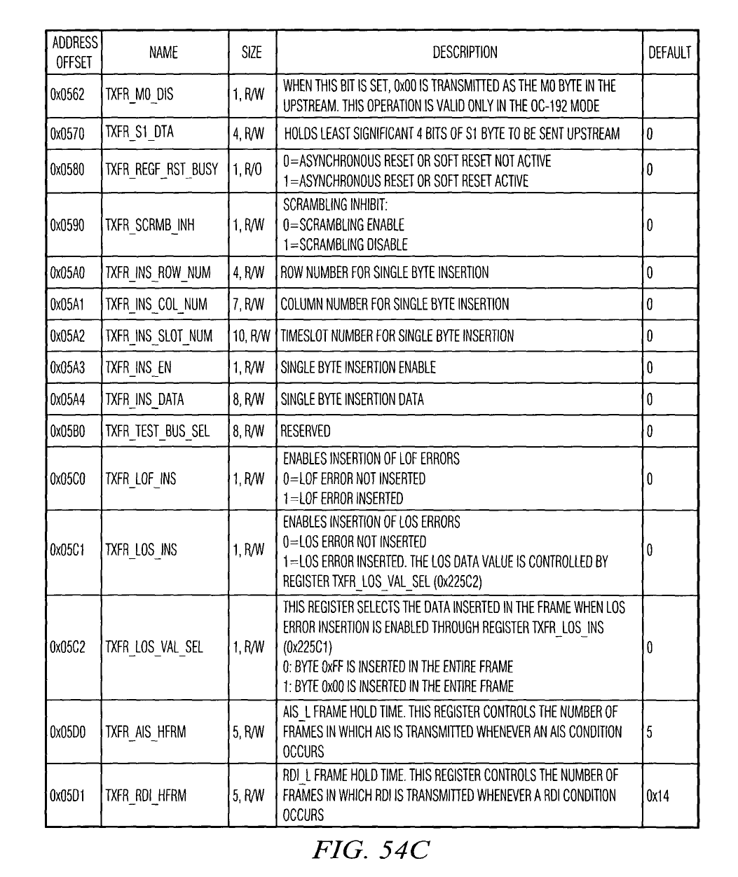

FIGS. 54-54C contain a memory map for all the registers and memories in the TXFR design. The address range reflects the generic address range based on an 18-bit address.

SPE Multiplexer/Demultiplexer and Microprocessor Interface (SPE)

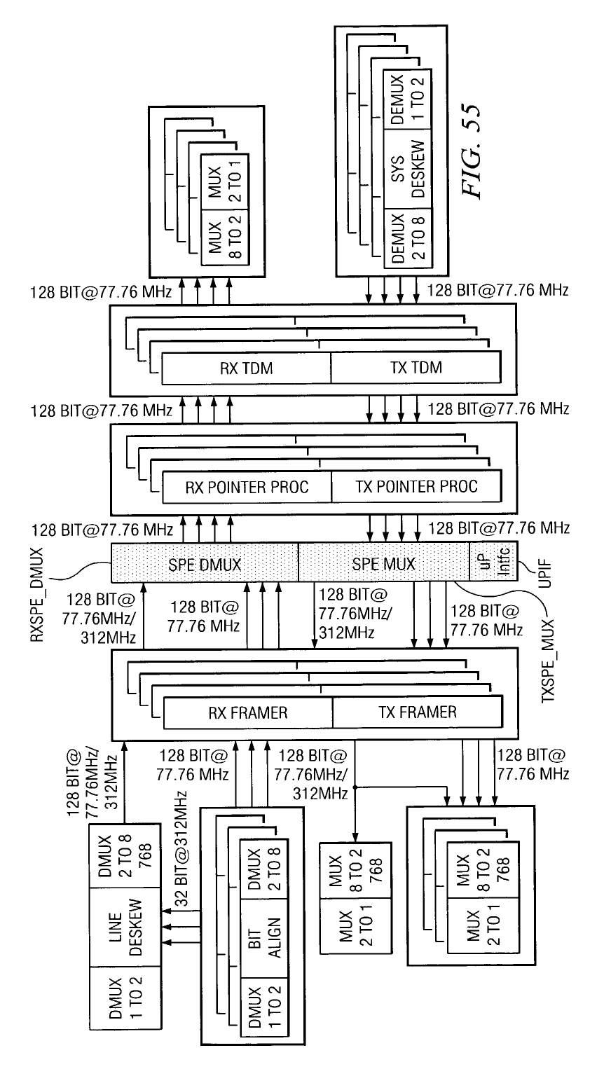

FIG. 55 highlights where the SPE block resides with respect to the entire design.

The SPE block contains six sub-blocks, the Receive SPE Demultiplexer (RXSPE_DMUX), the Transmit SPE Multiplexer (TXSPE_MUX), one instance of the Microprocessor Interface block (UPIF), four instances of the Microprocessor Device Interface block (UPDEVICEIF), four instances of the Reset block (RST_BLK) and eight instances of the line and system Loss of Clock Detect block (UPLOSSCLKDET). In addition, this block contains the spare gates modules for metal and FIB fixes.

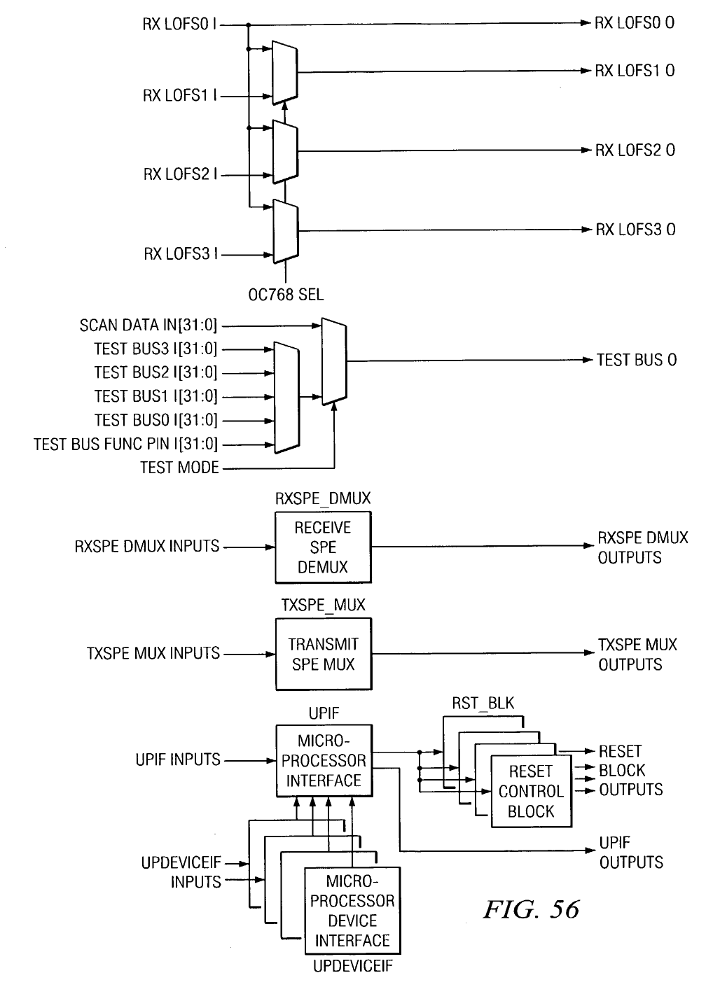

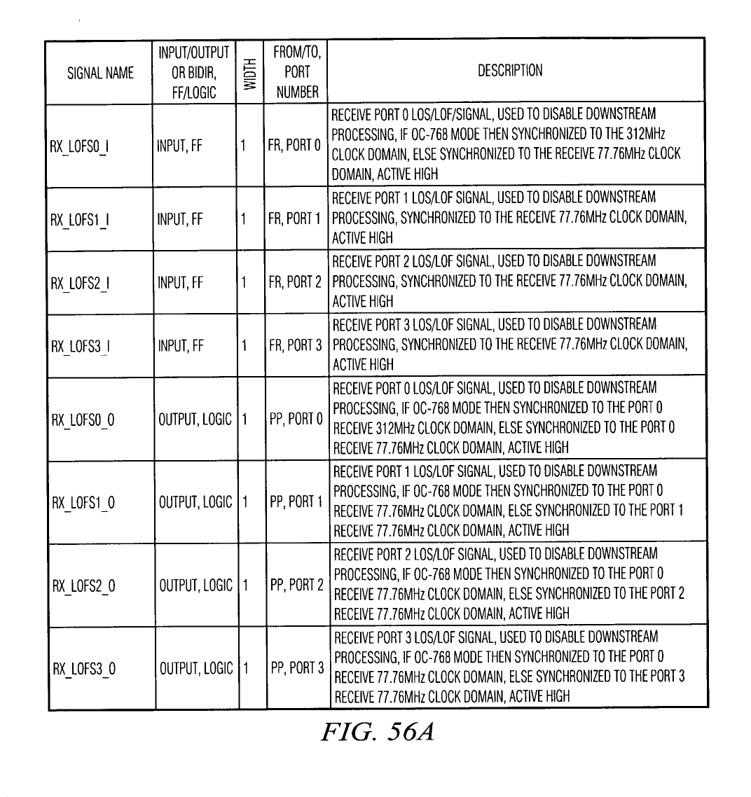

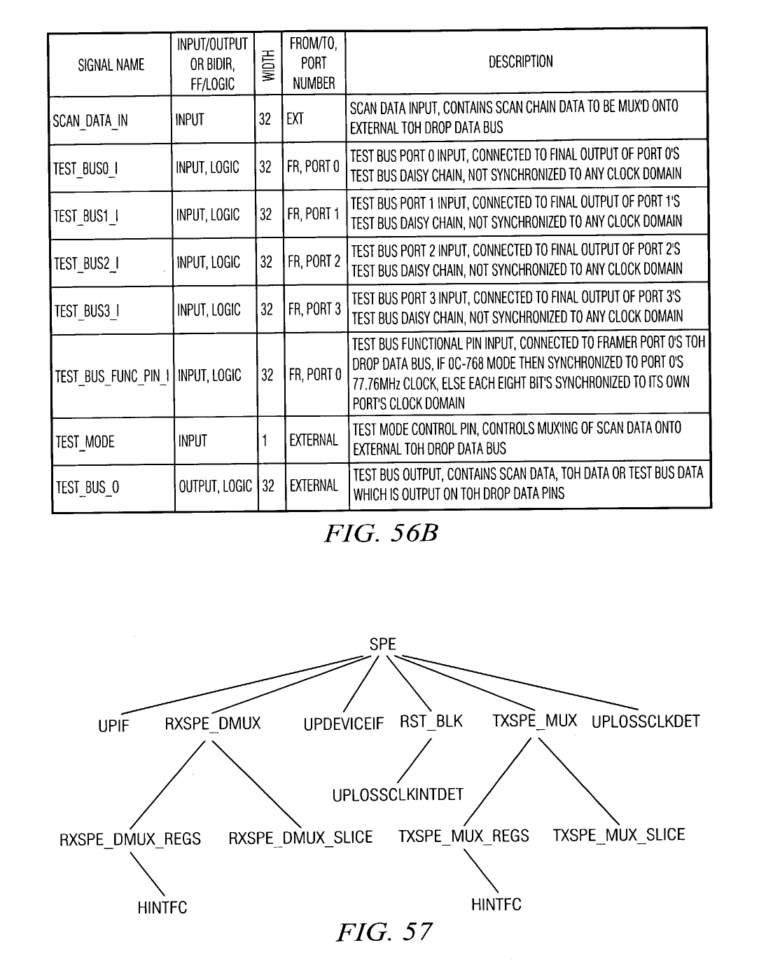

FIG. 56 is a top-level diagram of the miscellaneous logic contained at the top-level of SPE.

There are two groups of logic. The first deals with the outgoing LOF, LOS signals. In OC-192 mode, if port[n] input receive line side LOF, LOS is valid then port[n] output receive system side LOF, LOS is valid. In OC-768 mode however, since there is only one framer on port zero, then if port zeros input receive line side LOF, LOS, is valid, then port 0, 1, 2, and 3 output receive system side LOF, LOS is valid.

The second logic group deals with multiplexing the test bus and scan bus on the external receive TOH drop data pins. If TEST_MODE is enabled, then the input SCAN_DATA_IN is multiplexed onto the external receive TOH drop data pins. If TEST_MODE is not enabled, but the internal test bus is, then the internal test bus is multiplexed onto the external receive TOH drop data pins. There is a register that selects which test bus port to multiplex, as well as register to enable the multiplexing of the test bus.

FIGS. 56A and 56B describe inputs and outputs from/to logic that is instantiated in the SPE hierarchy level

FIG. 57 is a tree diagram that shows the parent and children of all the RTL files in the SPE design. All RTL design files have the (.v) extension.

Receive SPE DEMUX (RXSPE_DMUX)

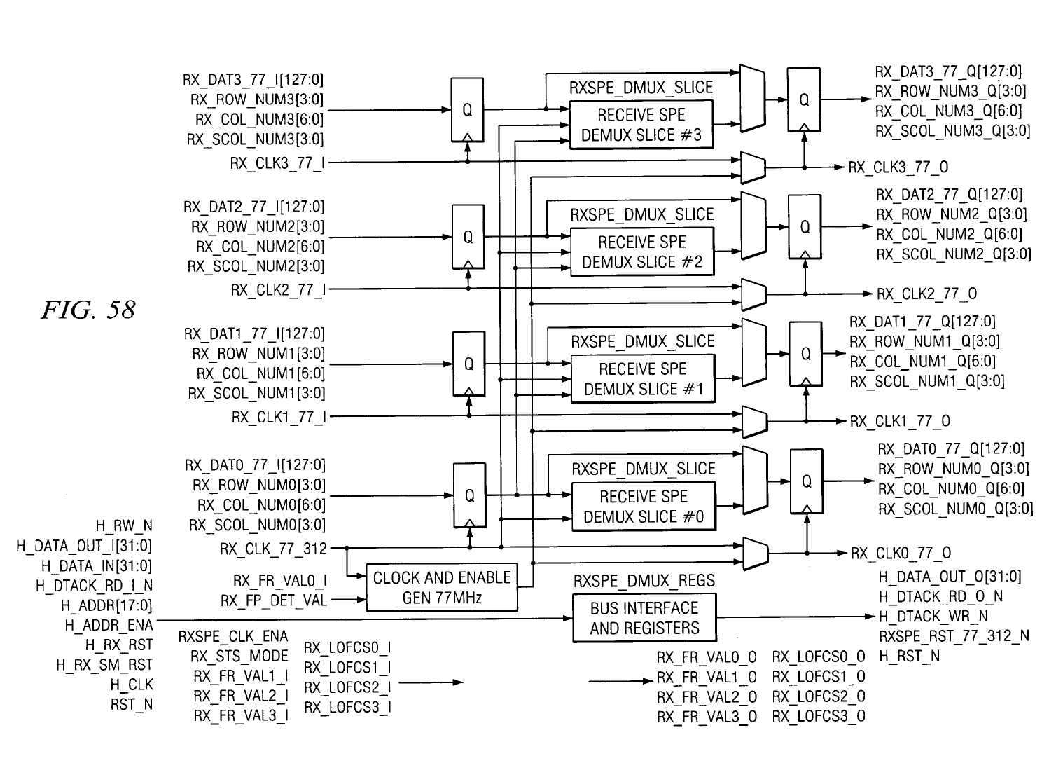

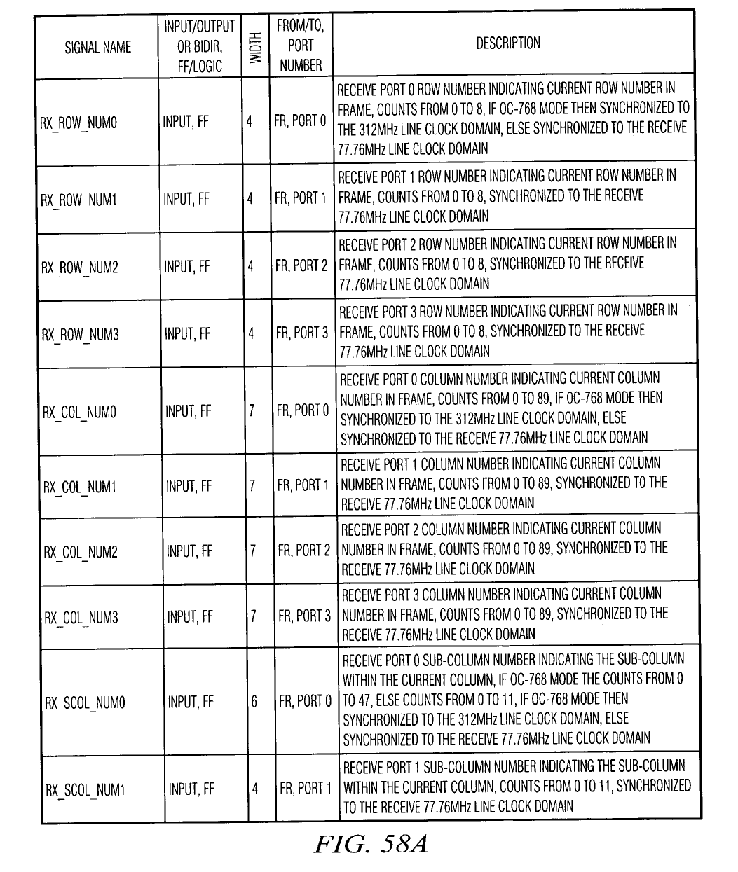

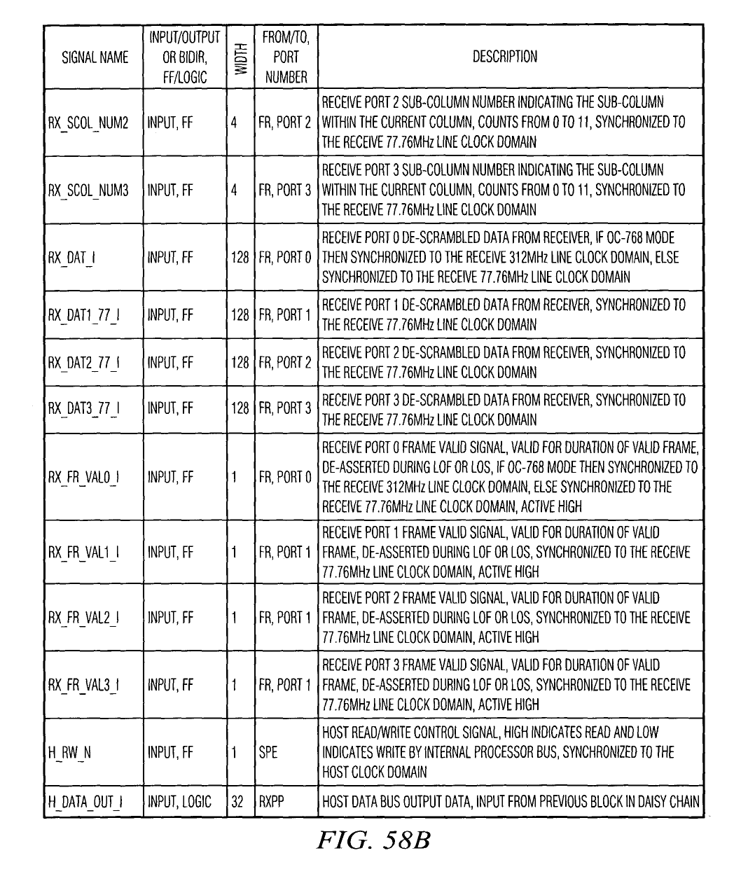

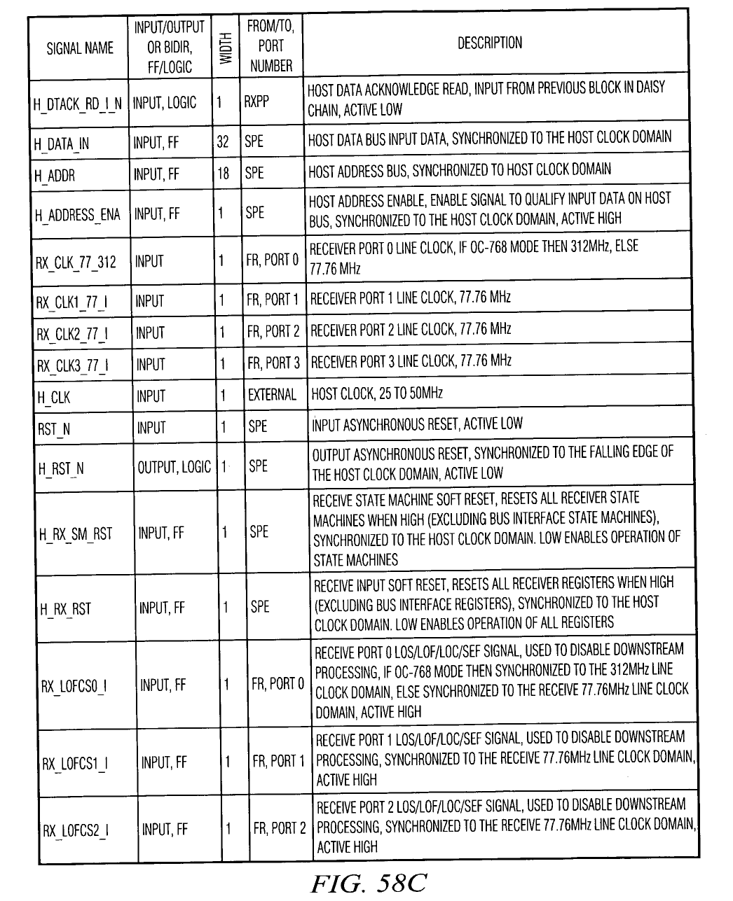

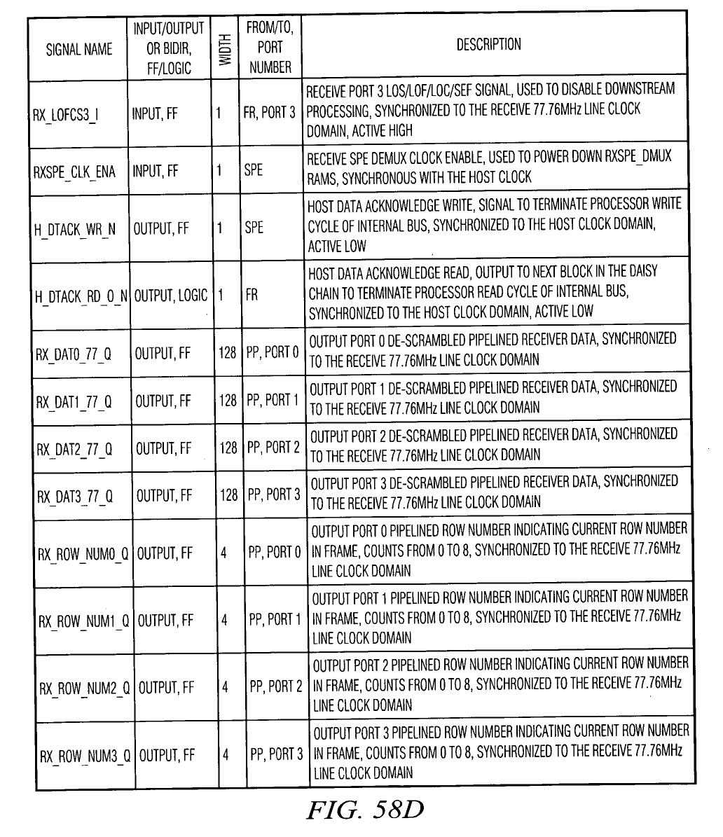

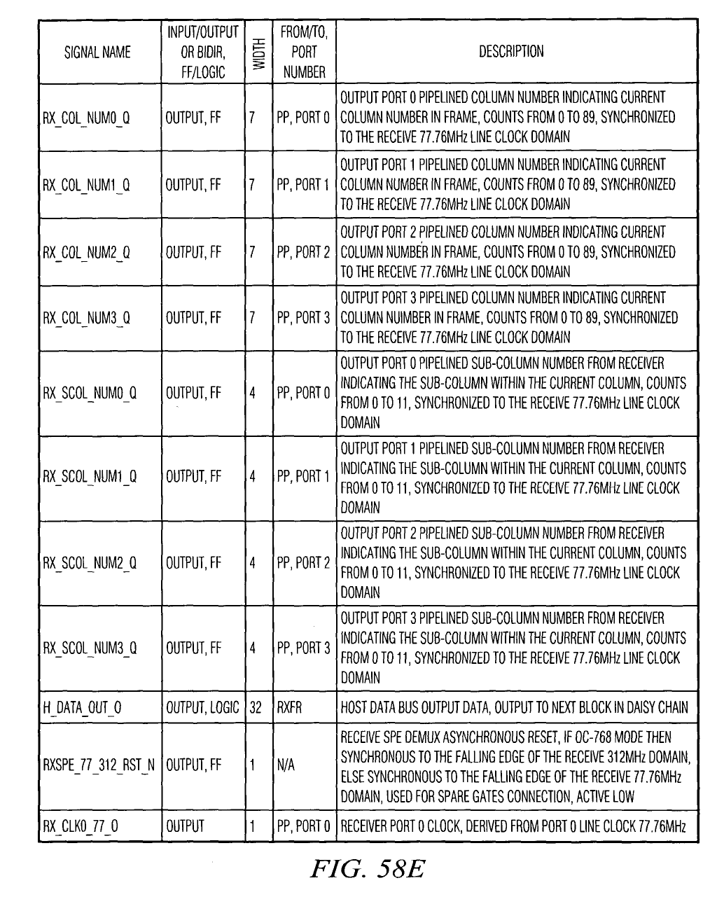

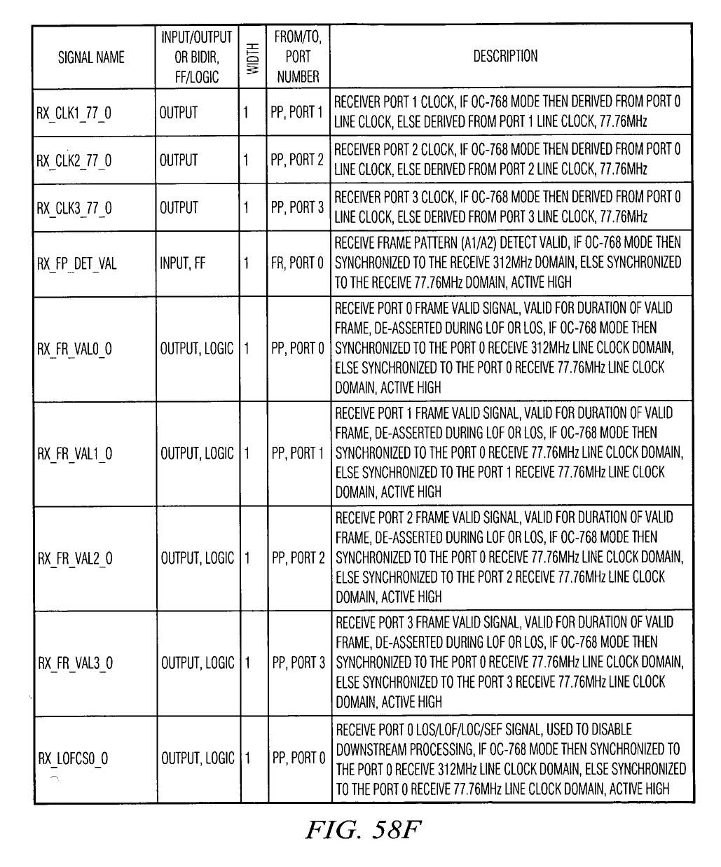

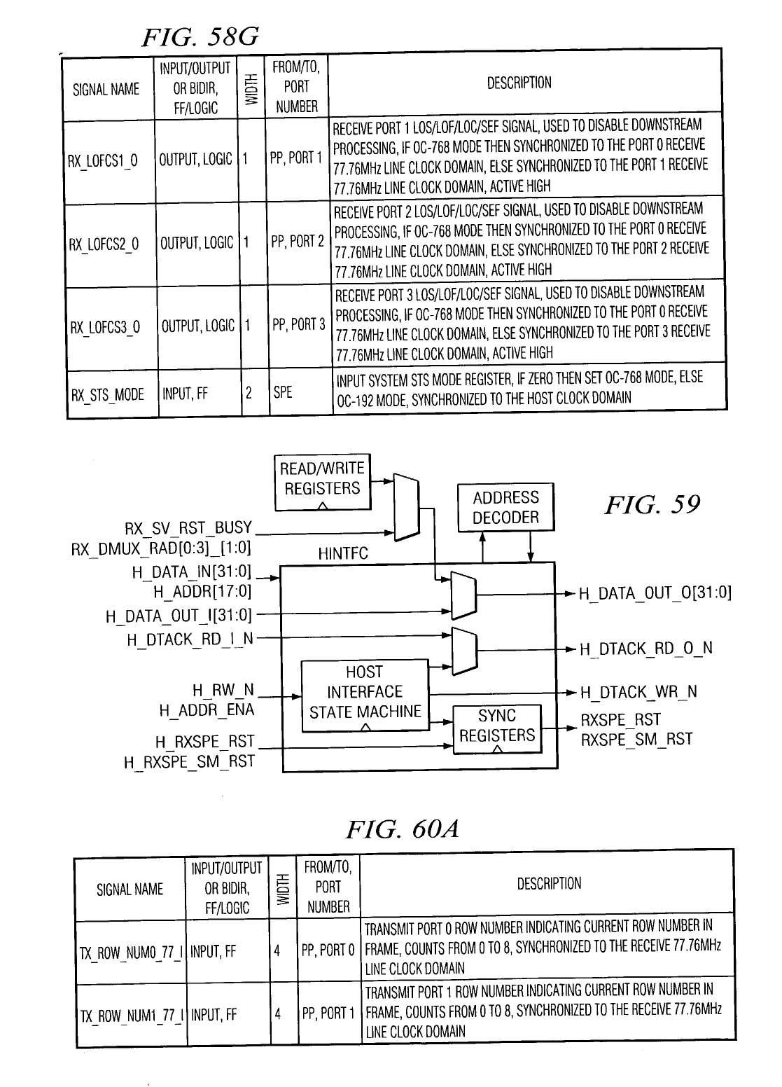

FIG. 58 is a top-level diagram of the modules and logic contained within RXSPE_DMUX. The interface signals are shown.

The following list describes exemplary features of the RXSPE_DMUX block.

Ring counter circuit

1. Clocked by port 0's 312 MHz line clock domain, generates one-hot enables for demultiplexing circuit and 77.76 MHz clock generator circuit.

2. Synchronized to port 0's A1/A2 frame pattern.

Demultiplexer

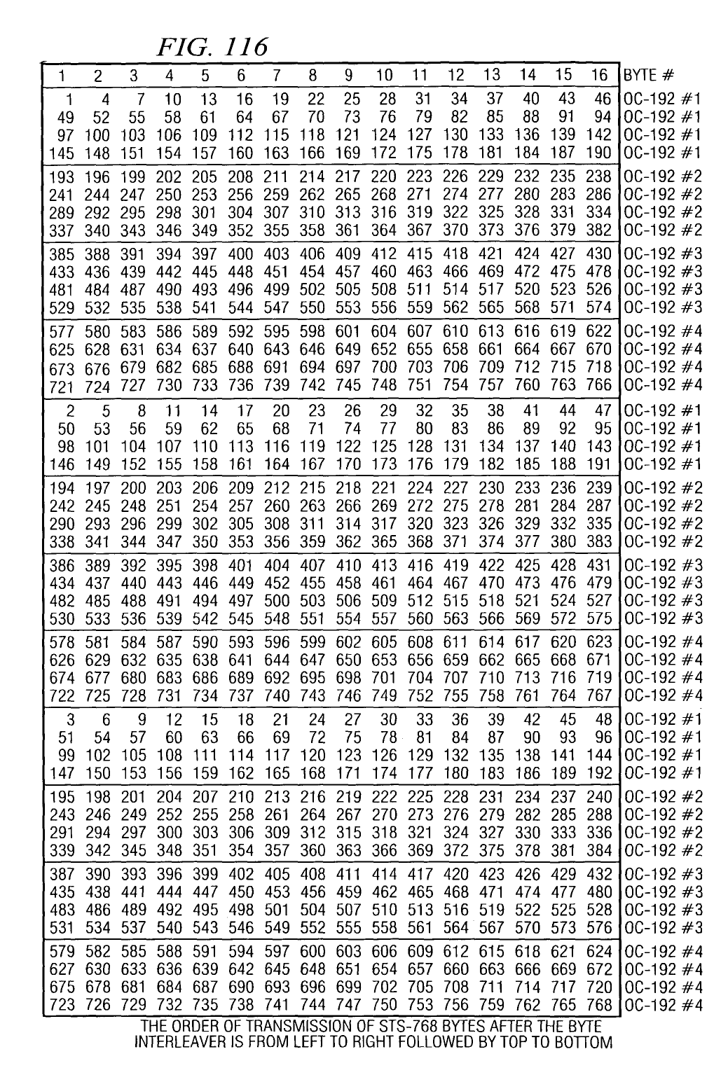

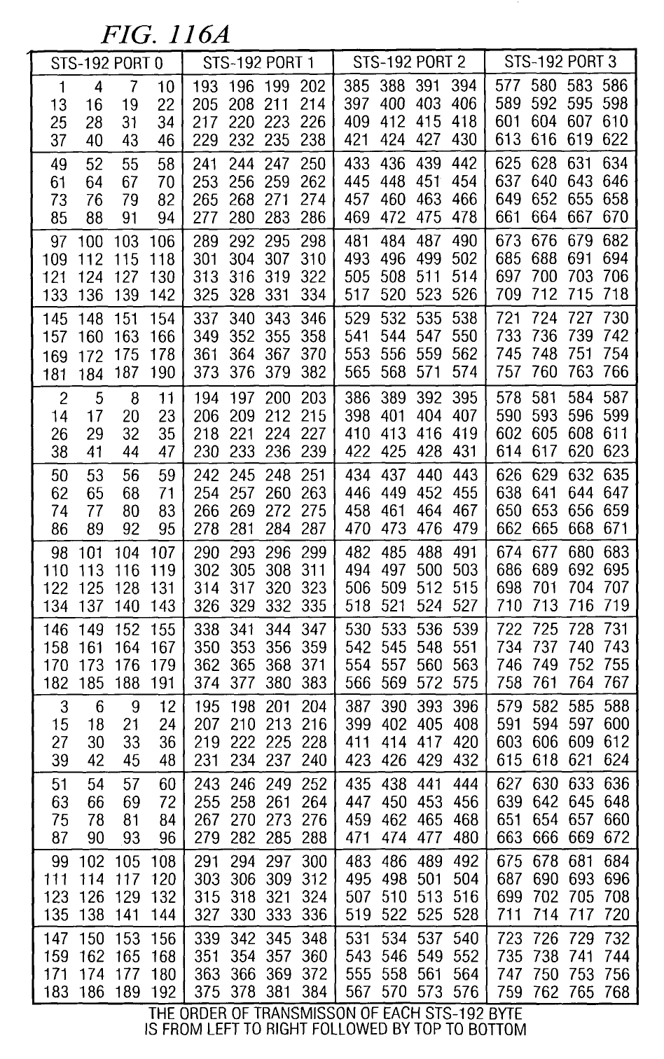

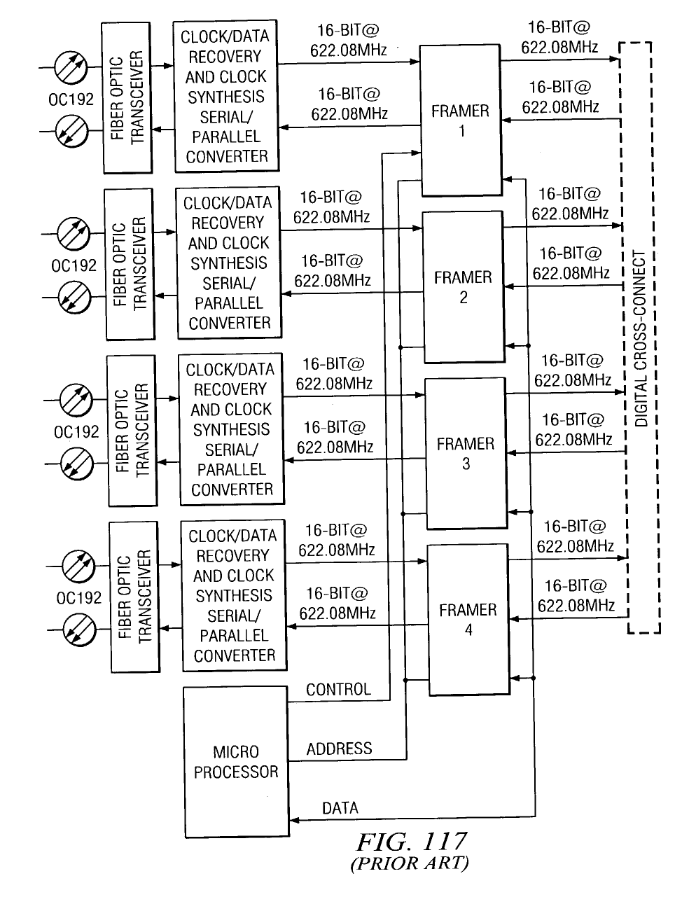

1. Converts single lane of 312 MHz 128 bit data (sse, e.g., FIG. 116), to four lanes of 77.76 MHz data.

2. Demultiplexer's OC-768 frame data 64 bytes per channel.

3. Dual port memory based approach, used four memories each of which has a 64 byte read page and a 64 byte write page.

4. Entire demultiplexer circuit clock by the 312 MHz clock.

5. Write circuit has no programmability and clocked every 312 MHz clock, synchronized to port 0's A1/A2 frame pattern.

6. Read circuit has no programmability and clocked every 4^{th} 312 MHz clock, synchronized to port 0's A1/A2 frame pattern.

7. Bypassed in OC-192 mode.

Clock generator circuit, OC-768 mode only.

1. Generates 77.76 MHz clock from port 0's 312 MHz clock.

2. Synchronized to port 0's A1/A2 frame pattern.

3. Clock period stretching feature allows re-synchronizing to new A1/A2 frame pattern position by stretching instead of shrinking clock period.

Clock multiplexing (hand instantiated from vendor library)

1. Port 0 clock multiplexers, in OC-768 mode multiplexers internally generated (from port 0), 77.76 MHz clock, else selects port 0 input 77.76 MHz clock.

2. Port 1, 2 and 3 clock multiplexers, in OC-768 mode multiplexers internally generated (from port 0), 77.76 MHz clock, else selects port 1, 2 and 3 input 77.76 MHz clock.

Clock synchronization from 312 MHz domain to 77.76 MHz domain allows for two 312 MHz cycles of setup time and two 312 MHz cycles of hold time.

Frame valid and LOF/LOS/LOC/SEF demultiplexer.

1. Port 0 frame valid and LOF/LOS/LOC/SEF always output on port 0.

2. In OC-768 mode port 0 frame valid and LOF/LOS/LOC/SEF output on port 1, 2 and 3.

3. In OC-192 mode port 1, 2 and 3 frame valid and LOF/LOS/LOC/SEF output on port 1, 2 and 3.

Internal host bus interface termination.

1. Contains all programmable registers.

2. Termination of internal bus protocol.

3. Asynchronous hard reset and soft global and state machine resets.

4. Host read data bus multiplexer

5. Host to local bus synchronization

RXSPE_DMUX Slice (RXSPE_DMUX_SLICE)

The RXSPE_DMUX_SLICE module is instantiated four times and implements the following functions:

Demultiplexer memory, synchronous two port memory physically organized as 12×128, logically organized as a write page and a read page each being 4×128.

Write circuit has no programmability and clocked every 312 MHz clock, synchronized to port 0's A1/A2 frame pattern.

Read circuit has no programmability and clocked every 4^{th} 312 MHz clock, synchronized to port 0's A1/A2 frame pattern.

Pipeline stage 2 registers.

State machines to reset demultiplexer memory.

Mesiosynchronous synchronizer to retime 312 MHz data to 77 MHz clock domain providing two 312 MHz clocks of setup and hold.

RXSPE_DMUX Bus Interface and Registers (RXSPE_DMUX_REGS)

The RXSPE_DMUX_REGS is instantiated one time and implements the following functions.

Contains all programmable registers.

Termination of internal bus protocol.

Asynchronous hard reset and soft global and state machine resets.

Address decoding for registers and memory.

Host read data bus multiplexer.

Host to local bus synchronization.

Instantiation of the HINTFC block.

FIG. 59 describes the RXSPE_DMUX_REGS block.

Transmit SPE Multiplexer (TXSPE_MUX)

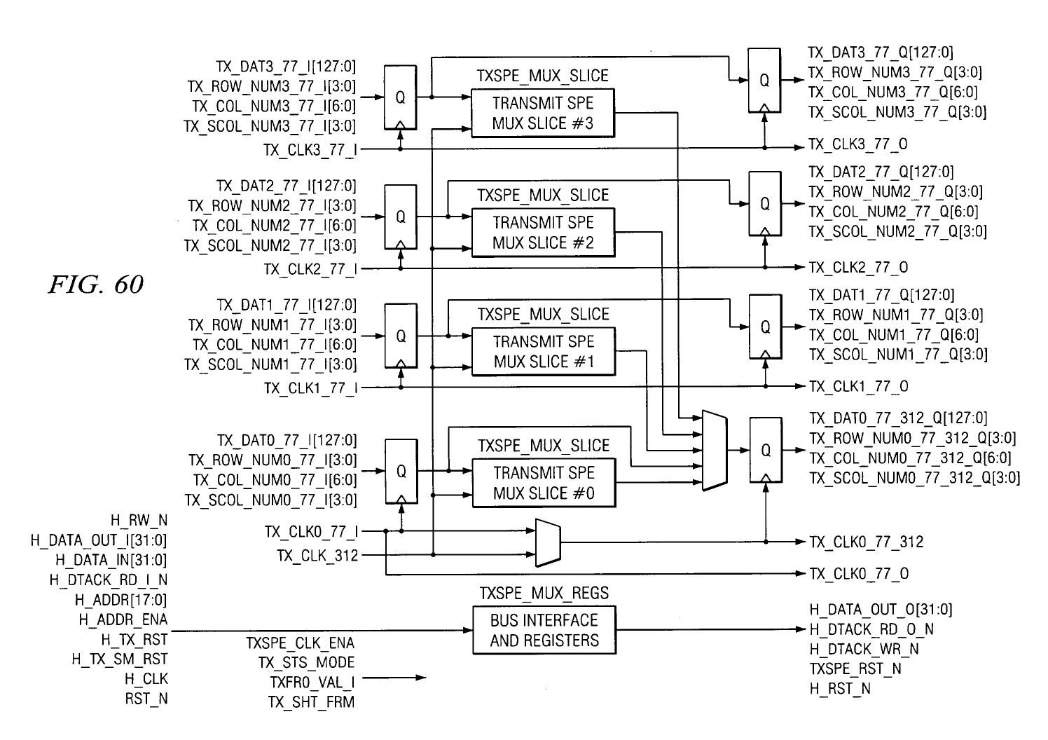

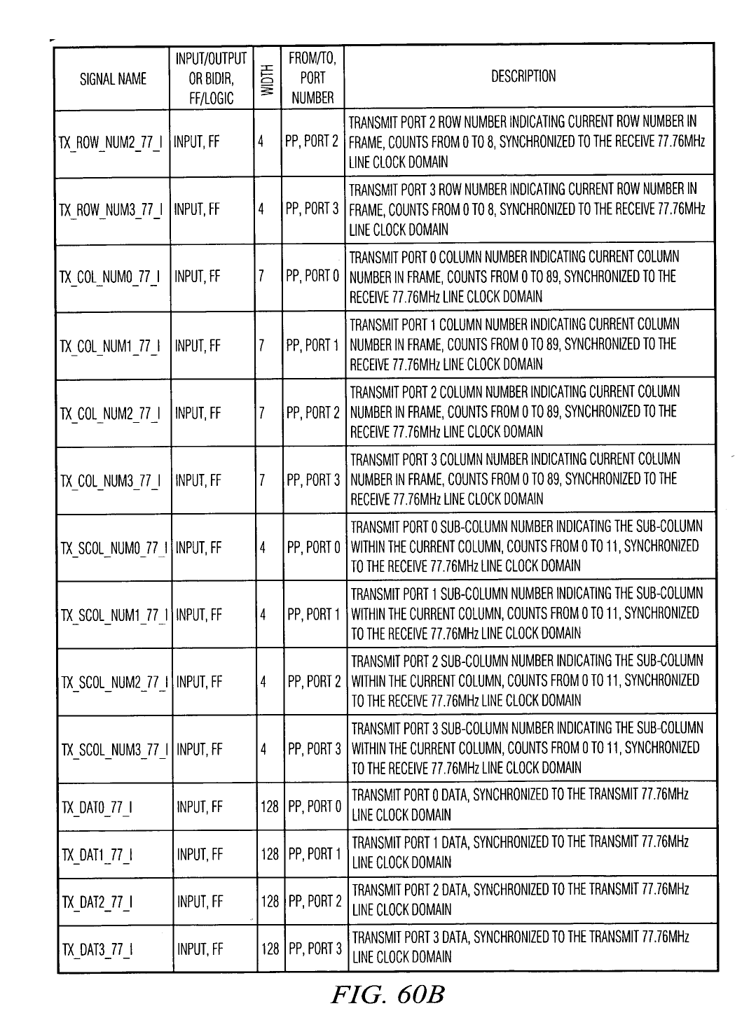

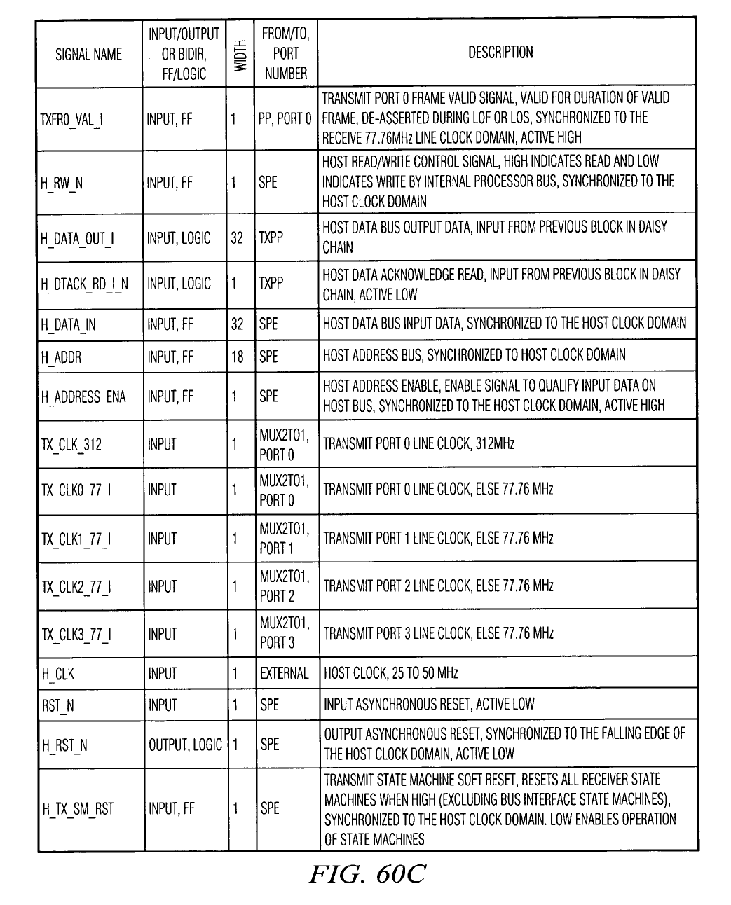

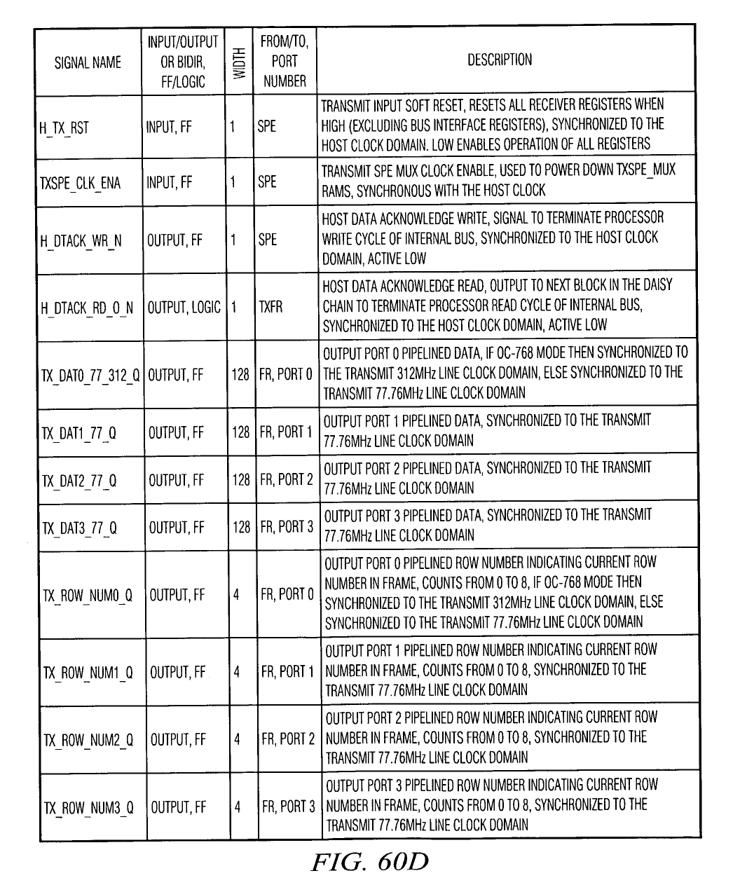

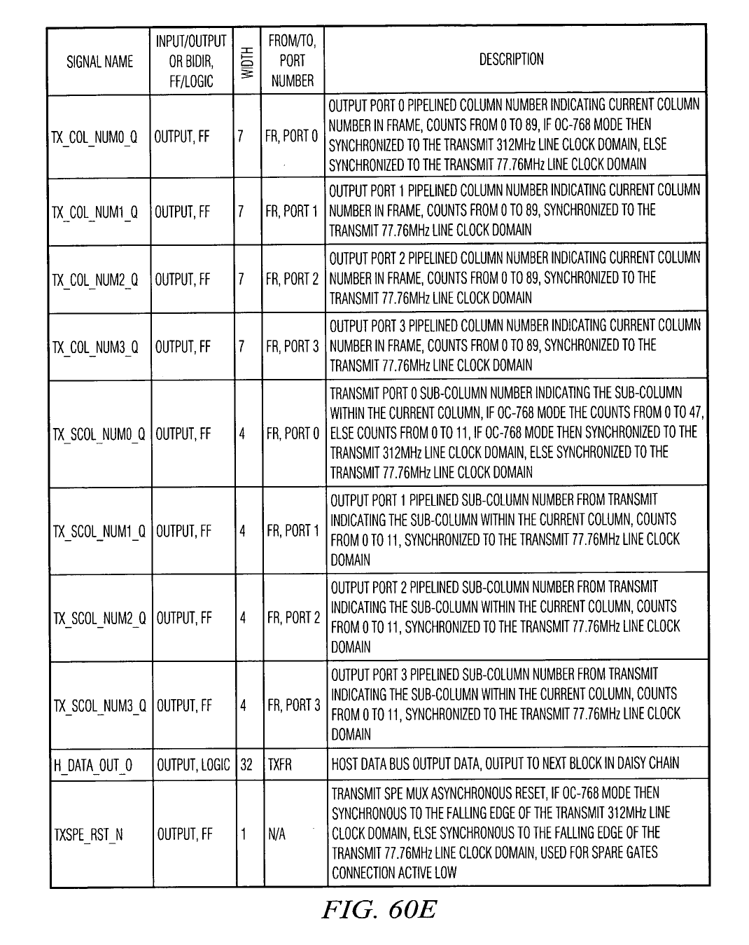

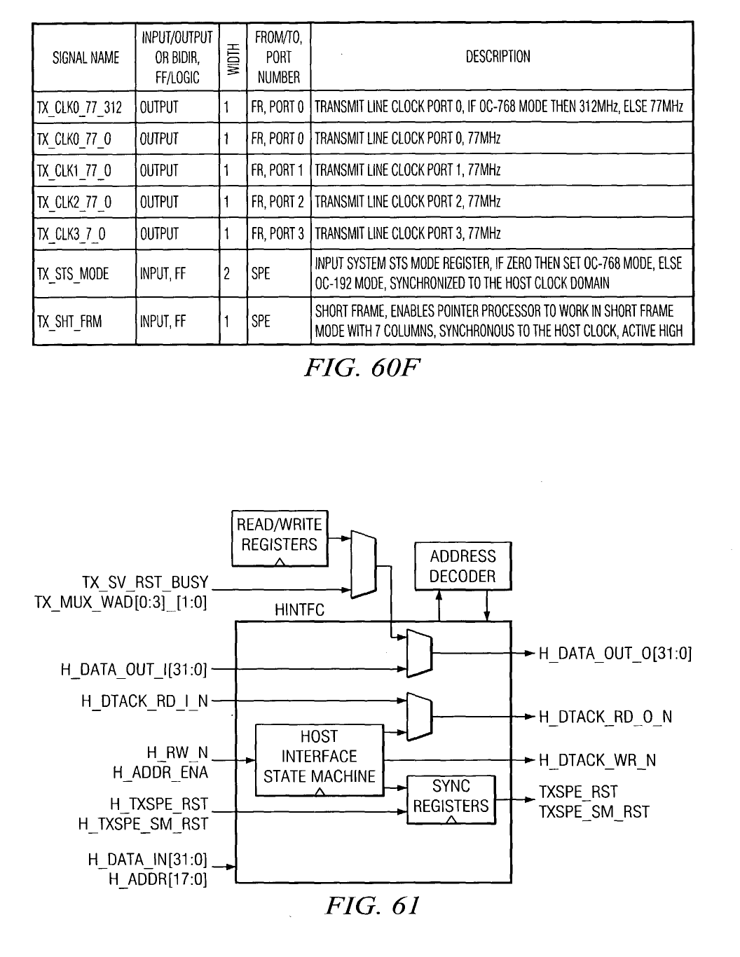

FIG. 60 is a top-level diagram of the modules and logic contained within TXSPE_MUX. The interface signals shown in FIGS. 60A-60F.

The following list describes exemplary features of the TXSPE_MUX block:

Ring counter circuit

1. Clocked by port 0's 312 MHz line clock domain, generates one-hot enables for multiplex circuit and 77.76 MHz clock generator circuit.

2. Synchronized to port 0's A1/A2 frame pattern.

Multiplexer

1. Converts four lanes of 77.76 MHz data, to a single lane of 312 MHz 128 bit data.

2. Multiplexer's OC-768 frame data 64 bytes per channel.

3. Dual port memory based approach, uses four memories each of which has a 64 byte read page and a 64 byte write page.

4. Entire multiplexer circuit clock by the 312 MHz clock.

5. Read circuit has no programmability and clocked every 312 MHz clock, synchronized to port 0's A1/A2 frame pattern.

6. Write circuit has no programmability and clocked every 4^{th} 312 MHz clock, synchronized to port 0's A/A2 frame pattern.

7. Bypassed in OC-192 mode.

Clock multiplexing (hand instantiated from vendor library)

1. Port 0 clock multiplexers, in OC-768 mode multiplexers port 0 312 MHz clock, else selects port 0 input 77.76 MHz clock.

Clock synchronization from 312 MHz domain to 77.76 MHz domain allows for two 312 MHz cycles of setup time and two 312 MHz cycles of hold time.

Internal host bus interface termination

1. Contains all programmable registers.

2. Termination of internal bus protocol.

3. Asynchronous hard reset and soft global and state machine resets.

4. Host read data bus multiplexer

5. Host to local bus synchronization.

TXSPE_MUX Slice (TXSPE_MUX_SLICE)

The TXSPE_MUX_SLICE module is instantiated four times and implements the following functions:

Multiplex memory, synchronous two port memory physically organized as 12×128, logically organized as a write page and a read page each being 4×128.

Read circuit has no programmability and clocked every 312 MHz clock, synchronized to port 0's A1/A2 frame pattern.

Write circuit has no programmability and clocked every 4^{th} 312 MHz clock, synchronized to port 0's A1/A2 frame pattern.

Pipeline stage 2 registers.

State machines to reset demultiplexer memory.

TXSPE_MUX Bus Interface and Registers (TXSPE_MUX_REGS)

The TXSPE_MUX_REGS is instantiated one time and implements the following functions:

Contains all programmable registers.

Termination of internal bus protocol.

Asynchronous hard reset and soft global and state machine resets.

Address decoding for registers and memory.

Host read data bus multiplexer.

Host to local bus synchronization./

Instantiation of the HINTFC block.

FIG. 61 describes the TXSPE_MUX_REGS block.

External Microprocessor Interface (UPIF)

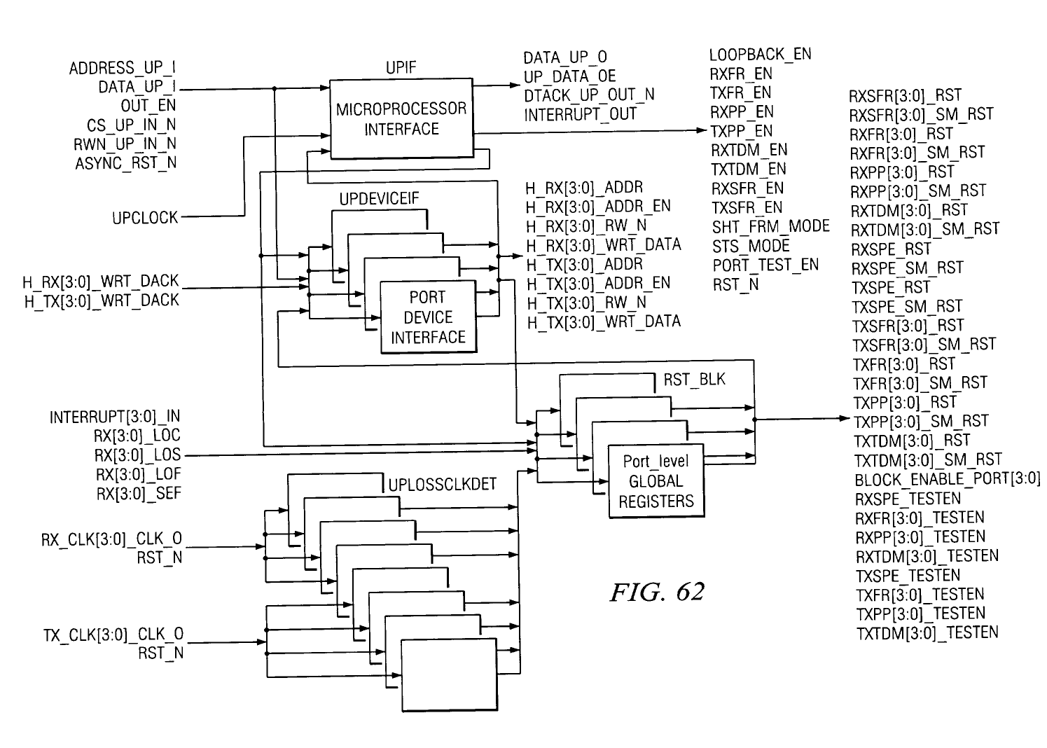

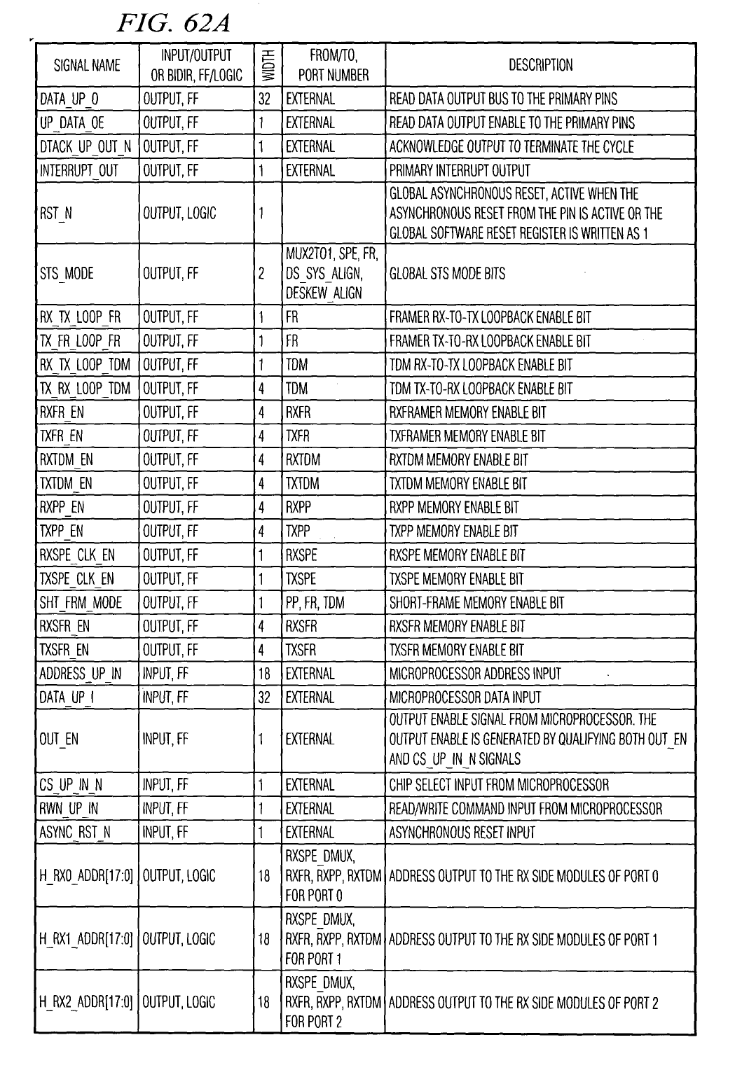

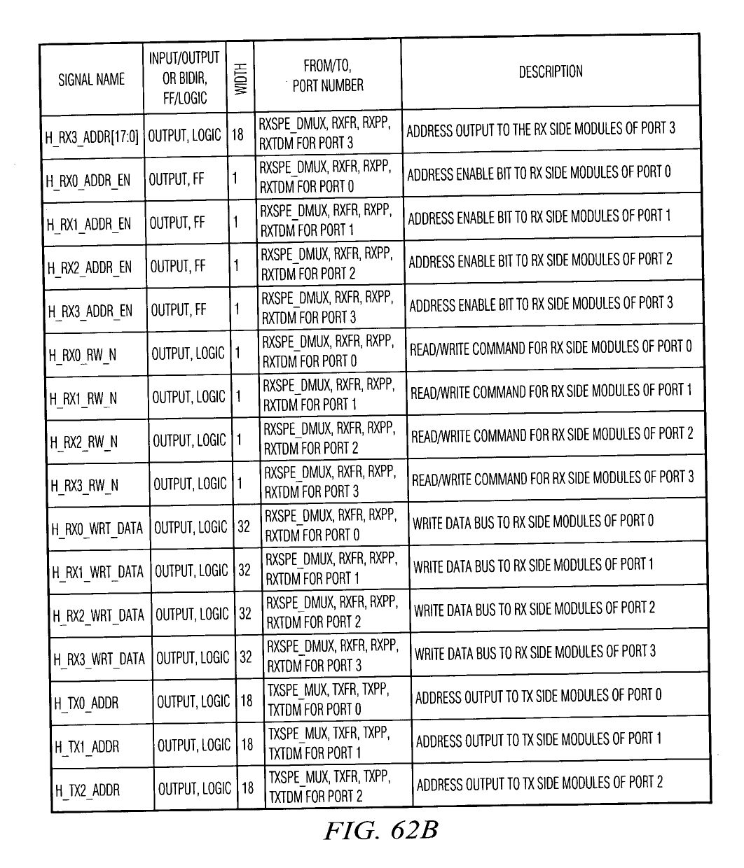

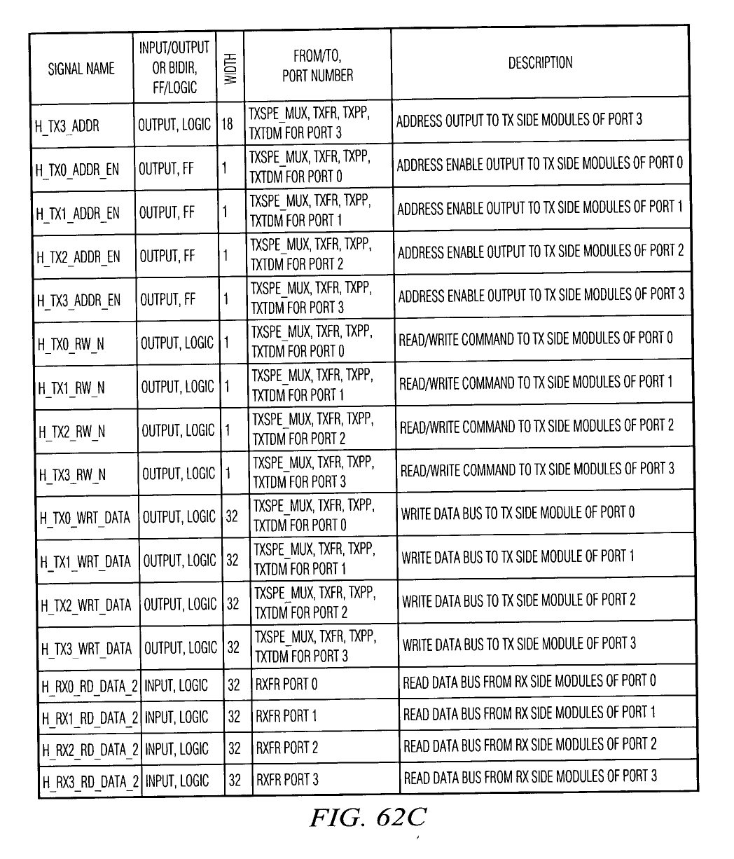

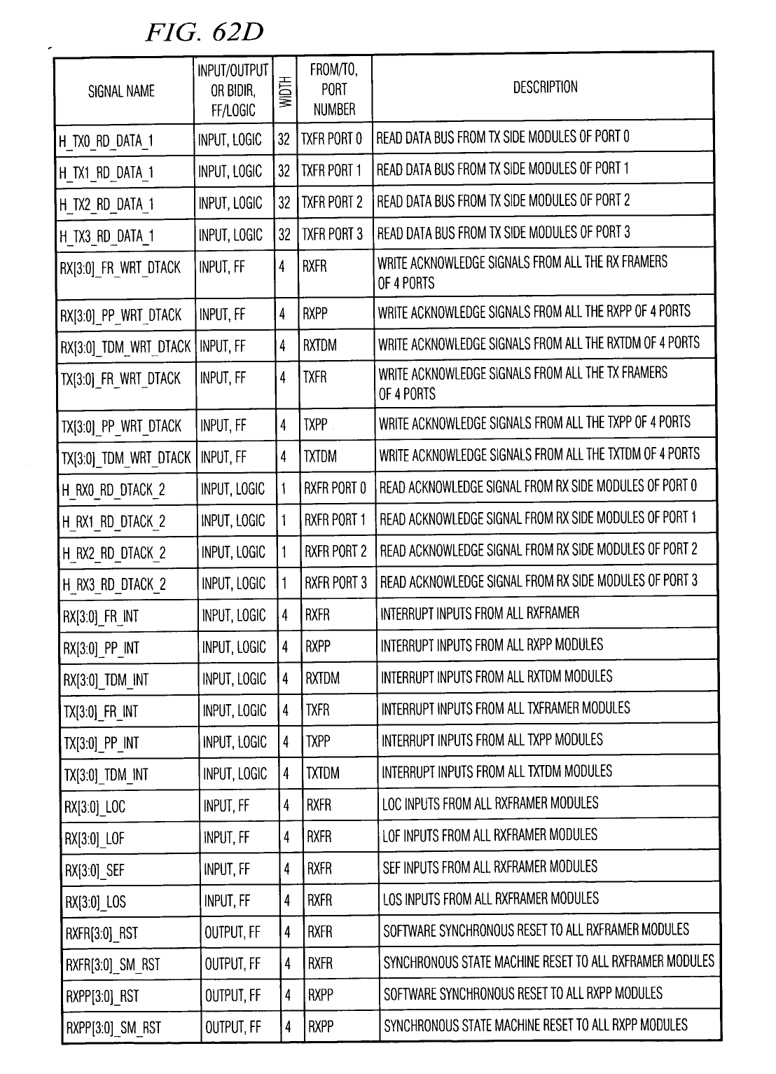

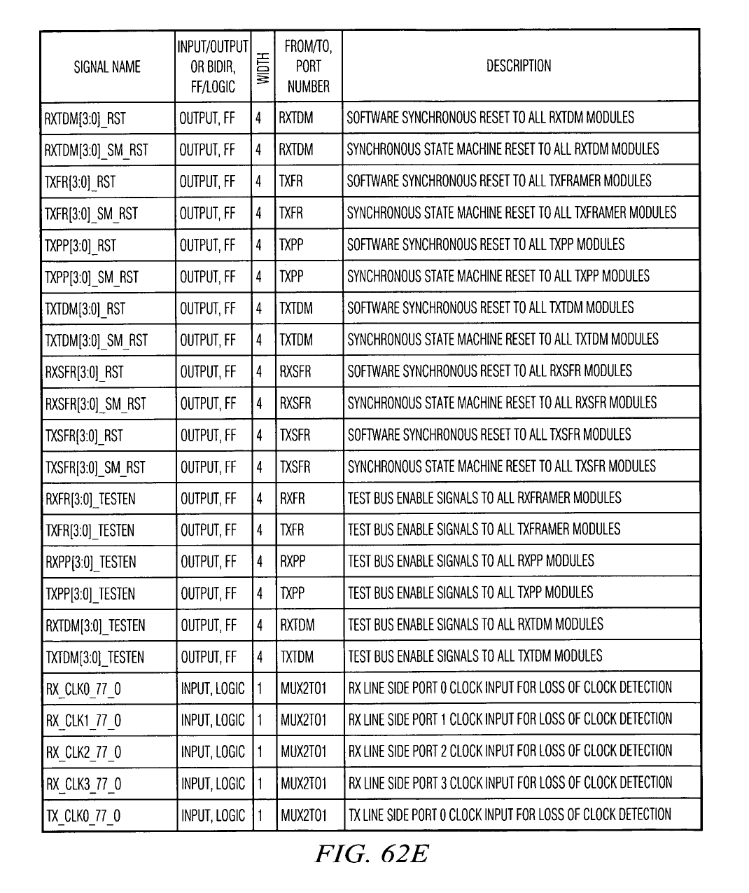

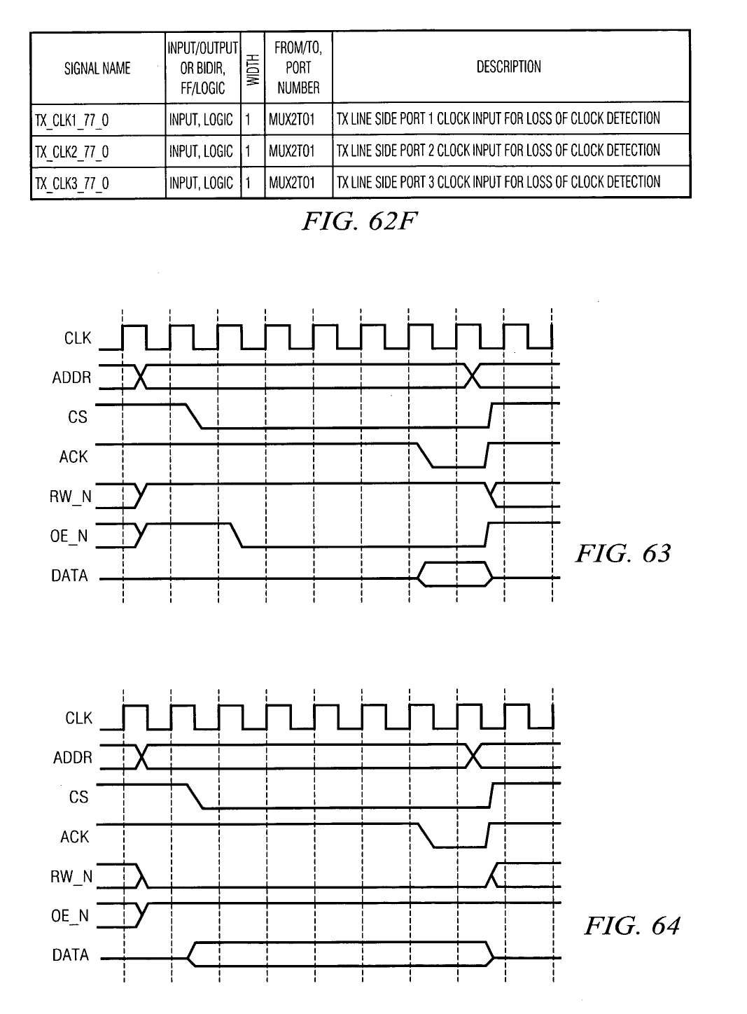

The UPIF is the module that interfaces between external microprocessor and the internal registers. In addition, the UPIF provides the LOC detection logic to detect the loss of line clocks based on microprocessor clock. The UPIF (FIGS. 62-62F) is sitting inside SPE and has 17 sub-modules.

The UPIF is the module which provides the interface between the microprocessor and the internal modules. UPIF receives the chip-select (CS) signal to initiate a transaction and generates acknowledge signal to terminate the transaction. The generation of the acknowledge signal is based on the following conditions; the timeout, the internal acknowledge signal and the port-level acknowledge signal.

FIGS. 63 and 64 respectively show the UPIF read cycles and the write cycle from the external interface point of view.

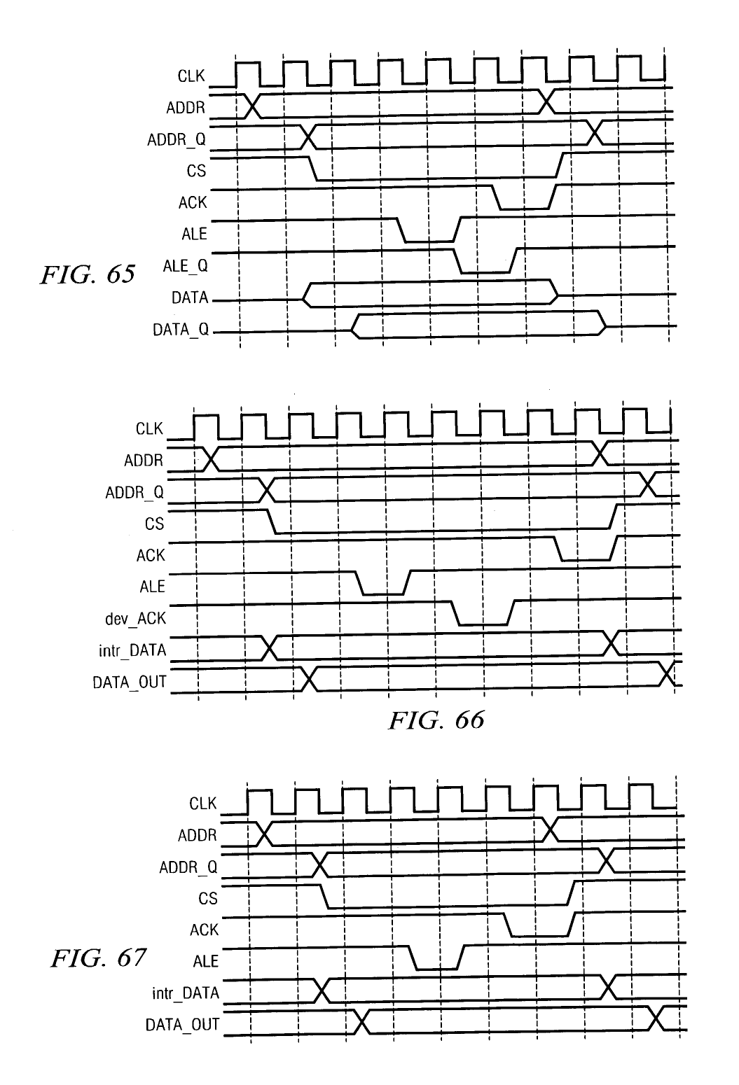

The read/write transaction can be divided into two categories; the local transactions and the port transaction. For the port transaction, the ACK signal can be either coming from the one of the port interface or triggered by timeout condition. If the timeout condition happens, the UPIF generates the ACK signal to terminate the transaction and at the same time, generating an interrupt. FIGS. 65 (write) and 66 (read) show the access to the UPIF internal registers.

FIG. 67 shows the waveforms for accessing a register outside UPIF.

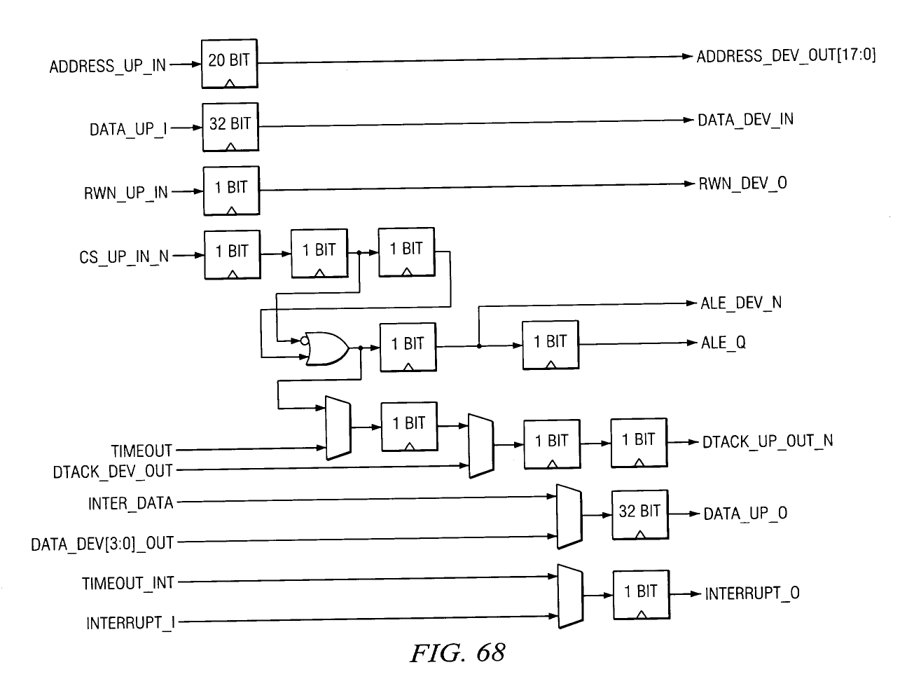

The input data, address and read/write command from microprocessor are all flopped (see FIG. 68) before being sent to port-level module or internal use. The chip-select signal is flopped three times in order to detect the falling edge. The output data is constantly flopped in order to guarantee the hold time. The interrupt is also constantly flopped since the interrupt is a level-sensitive signal.

Microprocessor Device Interface (UPDEVICEIF)

The UPDEVICEIF deals with port-level modules. It bypasses data, address and commands to both RX and TX side modules. It generates address enable by looking at the address bit for RX and TX side modules separately. It monitors the acknowledge signals from all the modules in order to terminate transactions. During the read transaction, it selects the data from RX and Tx side read data based on the read address.

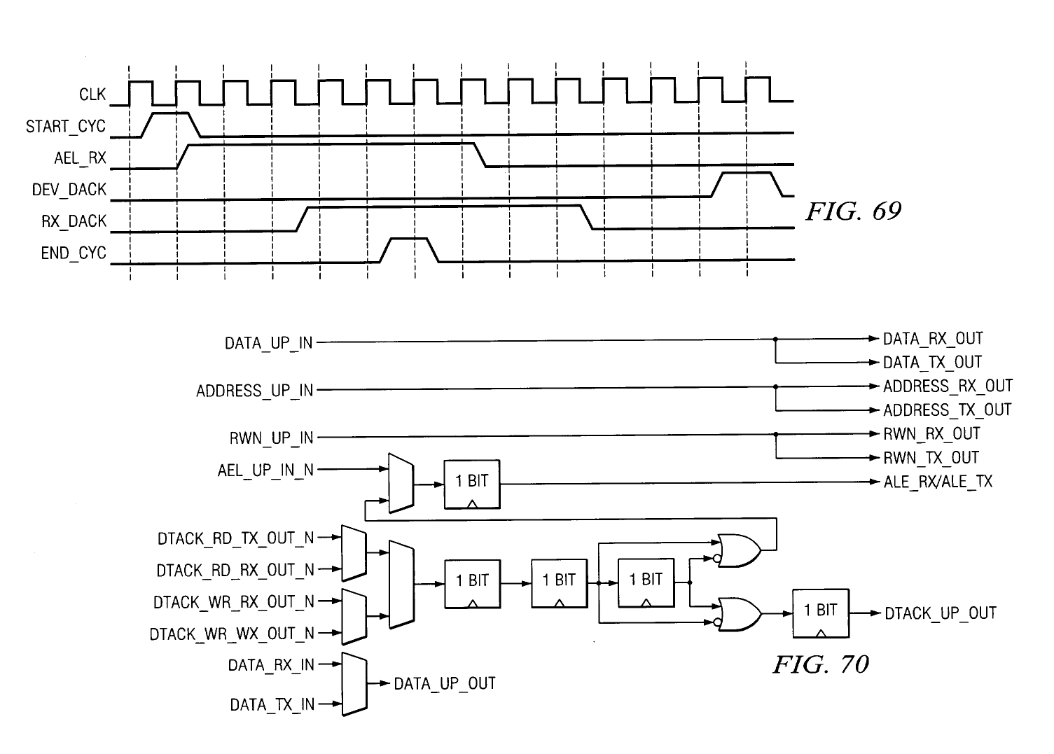

The signal used to trigger any transaction is from the UPIF by detecting the falling edge of chip-select signal. The UPDEVICEIF communicates to all the modules by using address enable signals. When the transaction is done, the module would send back the acknowledge signal. FIG. 69 shows that the rising edge of the acknowledge signal is used to de-assert the address signal; then, the falling edge of the acknowledge signal is used to terminate the transaction by sending device acknowledge signal to UPIF.

FIG. 70 shows the pipeline stage of UPDEVICEIF module. The rising edge of the acknowledge signal is used to de-assert the ALE (address enable) signal. The falling edge of the acknowledge is used to terminate the cycle from the UPIF point of view.

When a time out condition occurs, a timeout signal is sent from UPIF to deassert the ALE (address enable signal). However, the falling edge of the acknowledge signal will be ignored in UPIF.

Reset Block (RST_BLK)

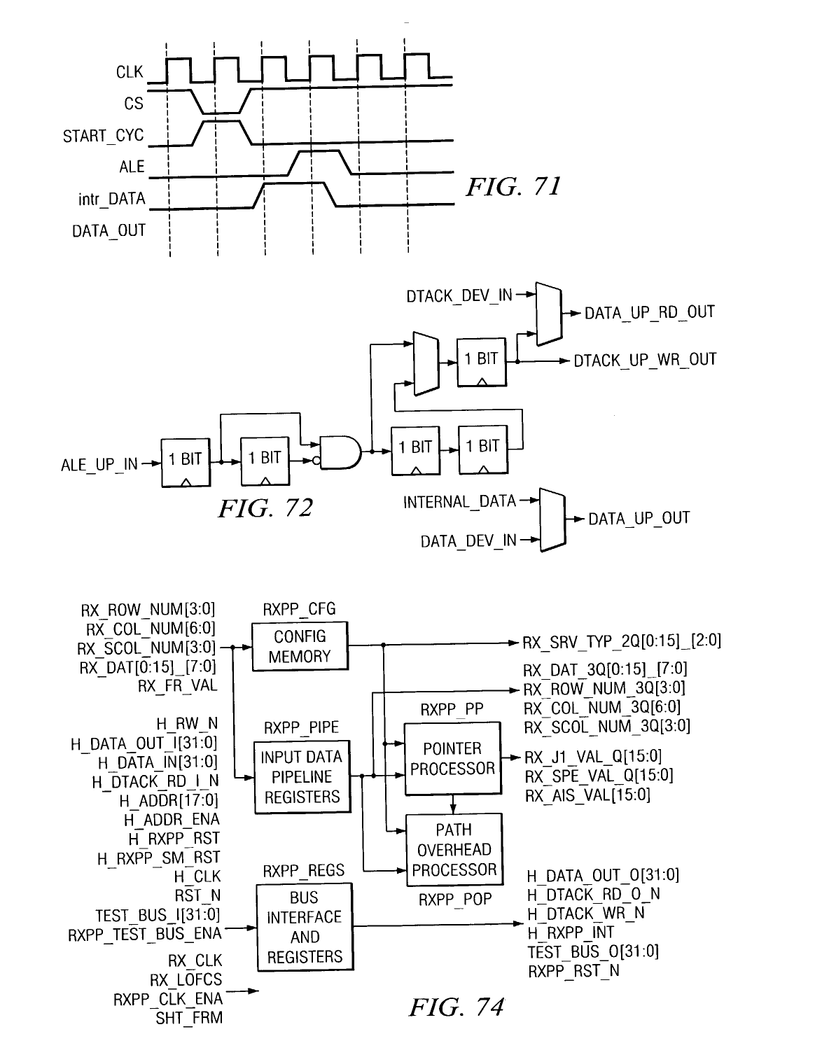

The RST_BLK module (see FIGS. 71 and 72) generates all the synchronous resets and state-machine resets for all the modules in the same port. It provides the interrupt mask register to mask the port-level interrupt. It also provides the loss of clock detection logic to detect the RX line-side clock and TX system-side clock.

The synchronous software resets are generated if one of the following bits is set: a port-level software reset bit, the RX/TX side software reset bit or the individual module software reset bit.

The synchronous state-machine resets are generated if one of the following bits is set: a port-level software reset bit, the RX/TX side state machine reset bit, the RX/TX side software reset bit, the individual module software reset bit, or the individual module state machine reset bit.

The RST_BLK module has the register to generate the test bus enable signals and the memory enable signals for each module of the corresponding port. It outputs the signals by connecting to the register outputs directly.

On reporting interrupts, the loss of clock logic inside RST_BLK will generate the LOC interrupts for the line-side and the system-side clock. The interrupt status register is also provided. A high priority port-level interrupt is provided to generate an interrupt based on the selection bits. The following four interrupts can be chosen to be presented on the high priority interrupt: LOF, LOS, SEF, and LOC (LOC reported from the transponder or CDR).

The RST_BLK is treated as one of the RX-side agents. It has its own write acknowledge signal and a daisy chained read acknowledge signal and a daisy chained read bus.

The high priority port-level interrupt is not flopped, and an internal register selects which alarm to report. After the priority decoding, the signal is sent out to DEVICEIF.

The write to the internal registers is triggered by the start cycle signal that detects the falling edge of ALE_UP_IN signal. The read to the internal registers is triggered by an address change, and once the address is decoded the, the output data multiplex is set.

Line and System Loss of Clock Detect (UPLOSSCLKDET)

The UPLOSSCLKDET module uses the clock to be detected to generate a pulse with 16 times the period called sample clock. The sample clock is synchronized to host clock domain in UPCLOSSINTEDET module. The rising and the falling edge of the synchronized sample clock is used to reset the loss of clock counter. If the counter reaches the predetermined count, then the loss of clock interrupt will be generated.

Pointer Processor (PP)

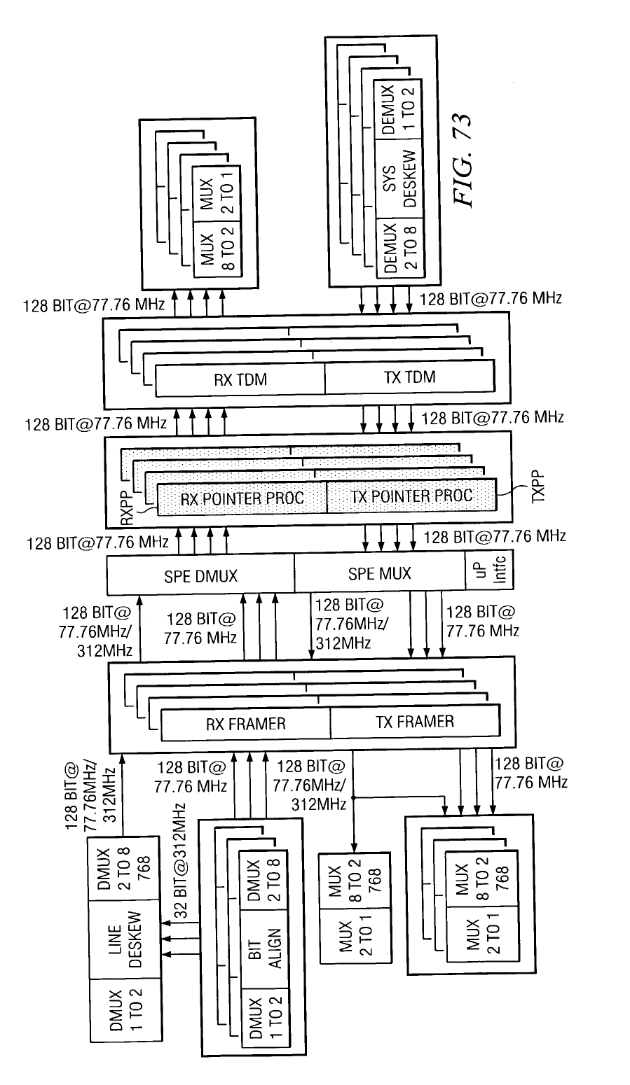

FIG. 73 highlights where the PP block resides with respect to the entire design.

The PP block contains two sub-blocks, one instance of the Receive Pointer Processor (RXPP) block and one instance of the Transmit Pointer Processor (TXPP) block. In addition, this block contains the spare gates modules for metal and FIB fixes.

Receive Pointer Processor (RXPP)

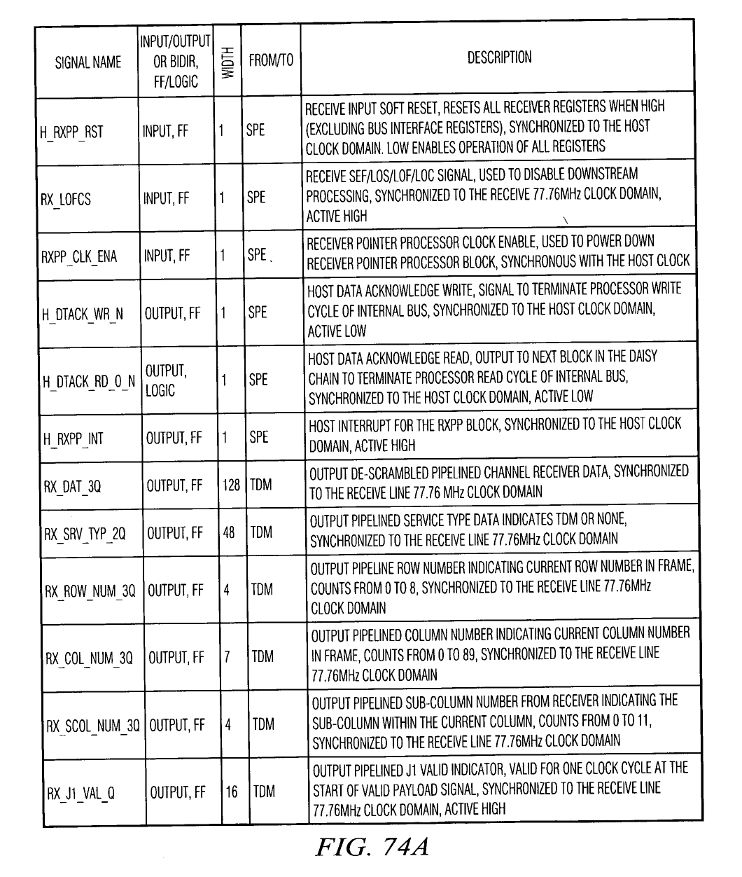

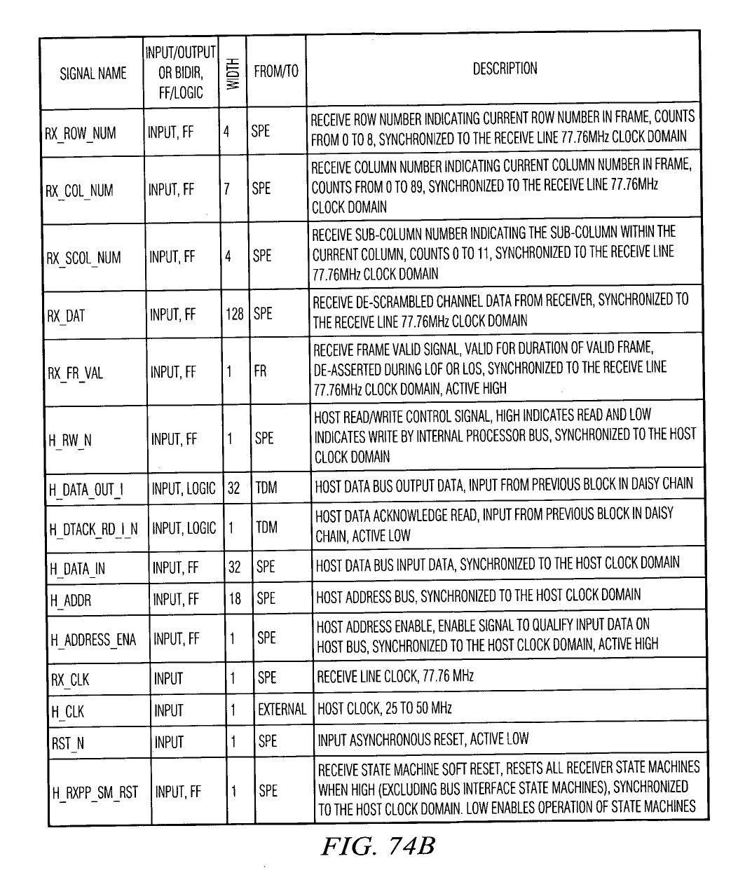

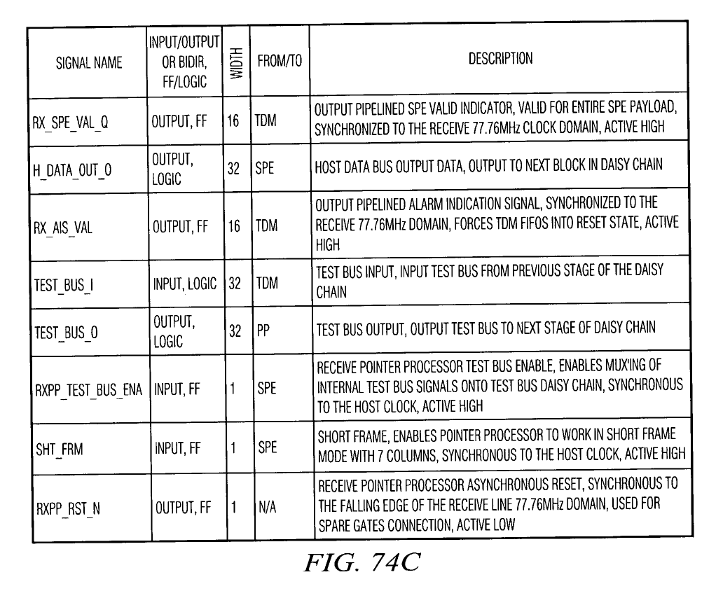

FIG. 74 is a top-level diagram of the modules contained within RXPP. The interface signals are shown in FIGS. 74A-74C.

The following list describes exemplary features of the RXPP block:

Path Overhead (POH) Termination and Monitoring

1. SONET/Path Trace (J1) single programmable channel processing 64 byte message with framing pattern detection Carriage Return/Line Feed (CR/LR).

2. SONET Path Trace (J1) single programmable channel processing 64 byte message with framing pattern detection byte zero MSB set to one and all other MSB set to zero.

3. SDH Path Trace (J1) single programmable channel processing 16 byte message with framing pattern detection byte zero MSB set to one and all other MSB set to zero.

4. SONET Path BIP (B3) even parity error checking per channel includes fixed stuff bytes with error counters per channel that count both bit and block errors.

5. SDH Path BIP (B3) even parity error checking per channel excludes fixed stuff bytes with error counters per channel that count both bit and block errors.

6. Path Signal Label (C2) five frame data debounce and hold.

7. Path Signal Label (C2) Path Label Mismatch (PLM) detection.

b 8. Path Signal Label (C2) Path Label Unused (PLU) detection.

9. Remote Error Indicator (G1) Remote Defect Indicator (RDI) and Enhanced-RDI (ERDI) processing with ten frame data debounce and hold.

10. Remote Error Indicator (G1) error counters per channel that count both bit and block errors.

Loss of Pointer (LOP-P) State Machine

1. LOP-P state machines supports NRM, LOP and AIS states and INV_POINT, EQ_NEW_POINT, NDF_ENA, AIS_VAL, INC_VAL and DEC_VAL events.

2. Consecutive invalid pointer counter per channel.

3. Consecutive NDF enable counter per channel.

4. Consecutive AIS-P valid counter per channel.

5. Consecutive new equal pointer counter per channel.

6. H1 New Data Flag (NDF) majority decoder (2 of 4).

7. H1/H2 pointer field majority decoder (8 of 10).

8. SDH programmable SS bits detection.

9. SPE counter per channel for POH byte marking.

10. Pointer register per channel holds current active pointer.

11. SPE valid marker output to TDM interface.

12. J1 valid marker output to TDM interface.

13. Increment and decrement counters per channel.

14. Programmable fixed stuff column prediction.

Alarm Indication Signal (AIS-P) Generation

1. AIS-P generated when LOP state machine in LOP oar AIS states.

2. AIS-P blocked during higher level alarms like LOS, LOF, SEF and LOC.

3. AIS-P valid output to TDM interface.

SONET/SDH Payload Envelope (SPE) Extraction

1. Payload data pipelined and output to TDM interface.

2. Payload data qualified by SPE valid output.

3 SPE is valid during POH bytes.

4. SPE is valid during payload fixed stuff bytes.

5. SPE is not valid during first timeslot after H3 timeslot if increment.

6. SPE is valid in H3 timeslot if decrement.

7. SPE is not valid during TOH timeslots unless decrement.

System Configuration Memory

1. Programmable SONET/SDH enable per channel.

2. Programmable POH fixed stuff bytes per channel.

3. Programmable concatenation channel enable per channel.

4. Programmable pointer enable per channel.

5. Programmable channel reset per channel.

6. Programmable service type per channel.

7. Programmable pointer processor channel number per channel.

Framer input data Datapath

1. Receive data Datapath.

2. Receive frame valid Datapath.

3. Receive row, column and sub-column counter Datapath.

Supports the following interrupt setting, clearing and masking.

1. J1 compare valid interrupt programmable single channel.

2. B3 error counter overflow interrupt per channel.

b 3. G1 hold interrupt per channel.

4. G1 error counter overflow interrupt per channel.

5. C2 hold interrupt per channel.

6. C2 PLM interrupt per channel.

7. C2 PLU interrupt per channel.

8. LOP interrupt per channel.

9. AIS interrupt per channel.

10. Increment counter overflow interrupt per channel.

11. Decrement counter overflow interrupt per channel.

Test bus support for multiplexing internal signals onto an external bus

1. LOP state variables.

2. SPE state variables.

3. Fixed stuff column, increment/decrement 32 port memory state variables.

4. Concatenation error 32 port memory state variables.

5. B3 page bit 32 port memory state variables.

6. J1, C2, B3 and G1 state variables.

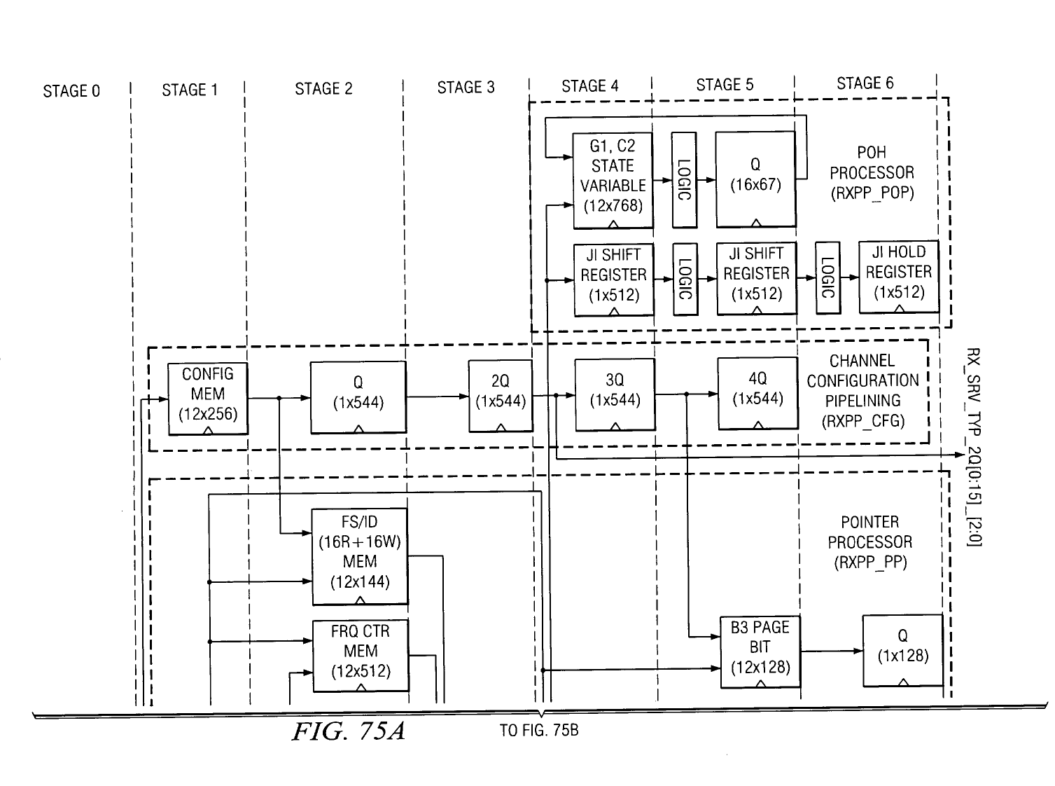

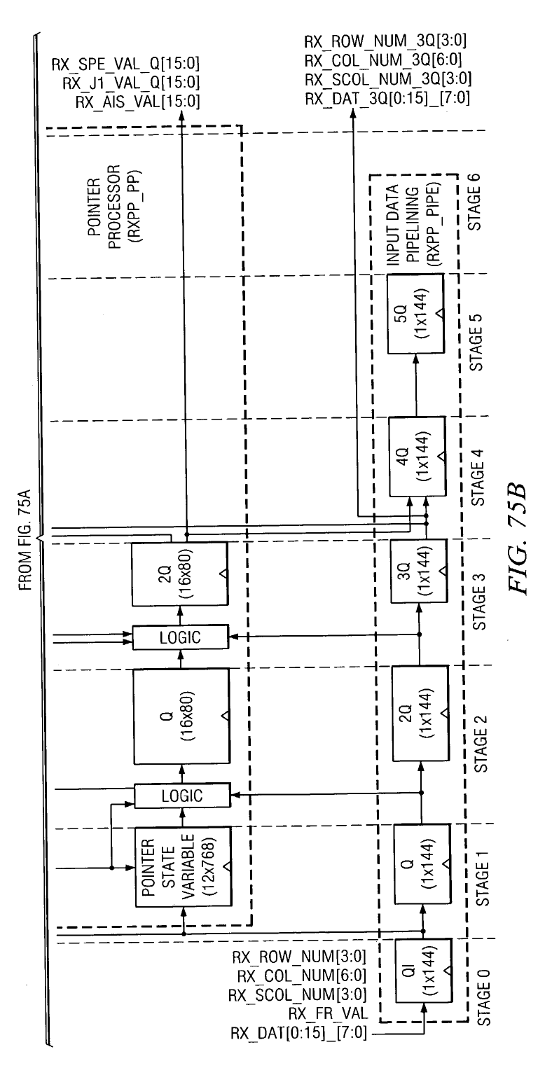

FIG. 75 describes the pipeline stages for the RXPP design excluding the B3 pipeline, showing dual port memories, 32 port register files and flip-flop registers as pipeline stages. Each group of pipeline stages is encased in a dotted line with a label above.

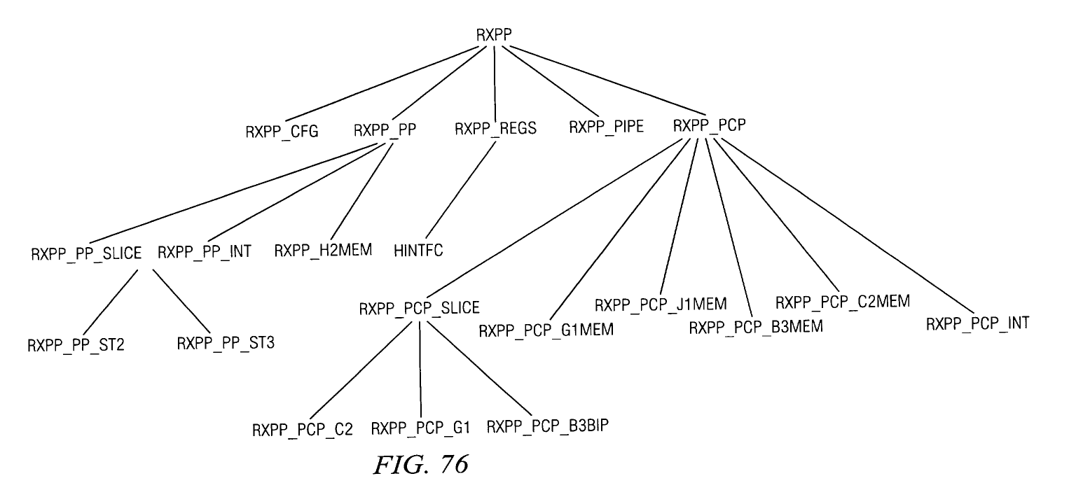

FIG. 76 is a tree diagram that shows the modular structure of RXPP design.

RXPP Configuration Memory (RXPP_CFG)

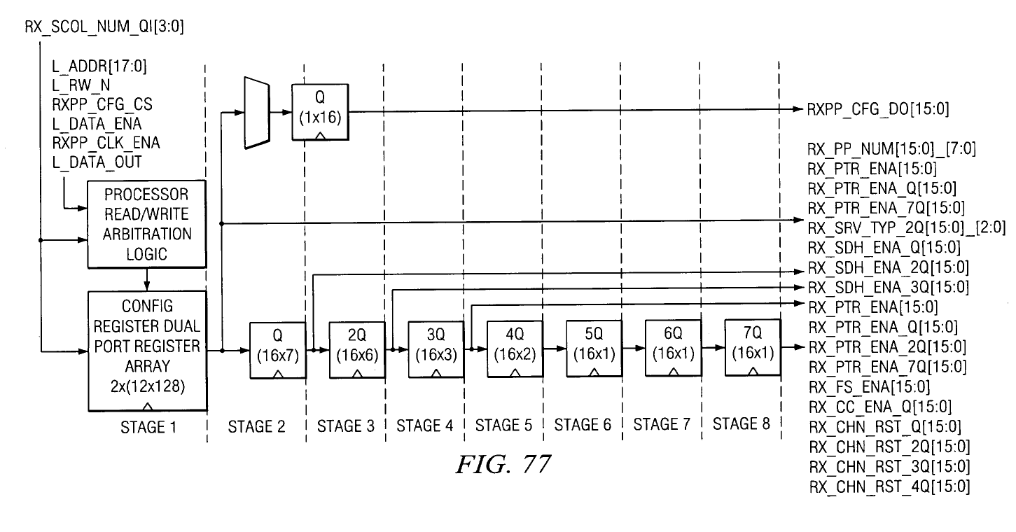

The Receive Pointer Processor Configuration memory block (FIG. 77) is instantiated one time and contains the configuration memory and Datapath to configure the pointer processor for it's various operating modes, as described in the following list:

Two synchronous dual port 12×128 memories, logically organized as a twelve deep by 16 word memory, each word holding sixteen bites (12×256).

1. SONET/SDH Enable, 1 bit.

2. Concatenated channel fixed stuff enable, 1 bit.

3. Concatenation channel enable, 1 bit.

4. Pointer Enable, 1 bit.

5. Synchronous channel reset, 1 bit.

6. Service type, 3 bit.

7. Pointer processor channel number, 8 bit.

Reset state machine to generate address and data to configuration memories.

Arbitration logic to arbitrate between accesses from processor, internal hardware and reset state machine.

Processor read multiplex to multiplex and register single 16 bit word.

During normal operation the receive sub-column number (RX_SCOL_NUM_QI) generated in the framer block reads out the contents of sixteen timeslots (256 bits) of configuration data, and pipelines the data to other blocks in the design. The pointer processor channel number (RX_PP_NUM) is a value from 0 to 191, and marks each concatenated or non-concatenated channel with a unique number. The pointer processor channel number has the following assignment rules:

Titan cannot support more than 64 concatenated channels of any type and they must be assigned channel numbers in the range of 0 to 63. Concatenated channels can be assigned to any timeslot.

For STS1's channel numbers assigned in the range of 0 to 63 can have any timeslot in the range of 0 to 63. Channel numbers in the range of 64 to 191 must be assigned to the same timeslot as their channel number. For example, an STS1 with channel number 90 needs to be assigned to timeslot 90, etc.

The service type (RX_SRV_TYP_{—}2Q) is three bits, but only supports two values, no service and TDM service. TDM service is the default value and enables the TDM interface, while no service disables the TDM interface.

The SDH enable bit (RS_SDH_ENA) enables a channel to be either SONET or SDH. A single port can be programmed to have both SONET and SDH channels, but generally a port will be either all SONET or SDH.

The pointer enable (RX_PP_PTR_ENA) enables the pointer in concatenated and non-concatenated channels. For non-concatenated channels (STS-1'S) the pointer enable is always set, and for concatenated channels the parent pointers must always precede the child pointer, and only one parent pointer can exist.

The fixed stuff enable (RX_FS_ENA) allows programmability of more or less fixed stuff bytes than the standard (N/3-1) SONET formula for concatenated channels. When the bit is set, the timeslot is declared as fixed stuff only in the POH column.

The concatenation enable (RX_CC_ENA) is used to distinguish concatenated from non-concatenated channels.

The channel reset bit (RX_CHN_RST), when set, holds the particular channel in reset and resets all state variables, counters, interrupts, etc. associated with that channel. When the reset bit is cleared, the channel is synchronously removed from the reset state. This bit is used when adding/deleting new service and provides a means of not harming any existing service.

When the processor wants to read or write the configuration memory, a bit is set indicating a processor access is pending. While the processor access is pending, the processor address is compared to the receive sub-column number, and when there is a match, the processor access is granted and the read data is multiplexed and registered. This type of arbitration scheme is used because it allows the use of a dual port memory, which is physically smaller than a two-part memory.

When an asynchronous reset, synchronous soft reset or synchronous soft state machine reset occurs, the reset state machine takes priority of the memory access, and writes the default channel configuration to the memories. The default channel configuration is SONET mode, OC-192c, 63 bytes of fixed stuff, TDM service type and pointer processor channel number 0.

The pointer processor supports the STS-1, STS-3c, STS-6c, STS-9c, STS-12c, STS-15c, STS-18c, STS-21 c, STS-24c, STS-48c, STS-192c payloads for SONET and SDH. The STS-192 payload can be multiplexed from a lower rate payload to form the higher rate payload. Concatenation is based on any one of the following combinations.

| | | |
|---|---|---|
| Single STS-192c | Four STS-48c | Eight STS-24c |
| 16 STS-12c | 64 STS-3c | 192 STS-1 |

Concatenation can also utilize a mix of the following:

| | | |
|---|---|---|
| STS-3c | STS-6c | STS-9c |
| STS-12c | STS-15c | STS-18c |
| STS-21c | STS-24c | STS-48c |

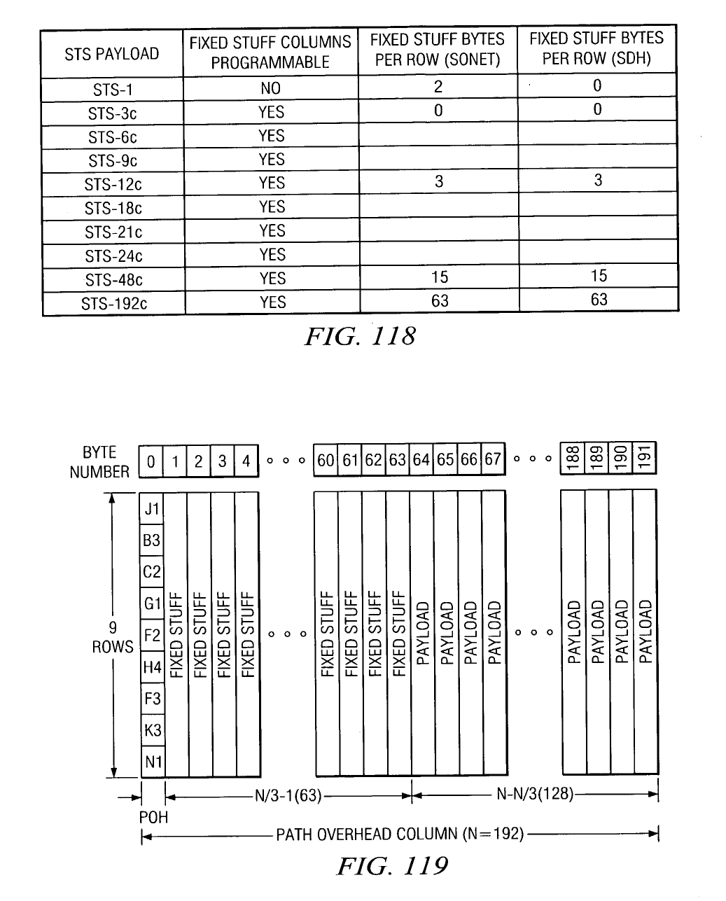

The STS payload pointer indicates the start of the SPE/VC-3. The STS-1 SPE consists of 87 columns and 9 rows of bytes, for a total of 783 bytes. In SONET, the STS-1 SPE has the fixed stuff bytes in 2 columns (column 30 and column 59), which are not used for payload. In SDH, VC-3 has no fixed stuff bytes. The STS-Nc SPE consists of N*87 columns and 9 rows of bytes, for a total of N*783 bytes. The STS-Nc SPE POH column has (N/3−1)×9 bytes for fixed stuff, which is programmable to either carry the payload or not to carry payload. The concatenated payload capacity for SONET and SDH are similar. The number of fixed stuff bytes per row for the STS-1 and STS-Nc payloads are shown in FIG. 118.

The locations of “fixed stuff” columns in an STS-N are programmable, except STS-1, where columns 30 and 59 (as per GR-253) are automatically set as “fixed stuff” columns and are not programmable.

FIG. 119 gives an example of an STS-192c Path Overhead Column.

FIG. 120 diagrammatically illustrates exemplary embodiments of a memory apparatus which can be provided in the pointer processor of FIG. 1 in order to produce flexibly concatenated STS channels according to the invention. The memory apparatus of FIG. 20 is a 32-port memory, including 16 write ports and 16 read ports. This memory apparatus can be used to broadcast the concatenation information from the master channel. For example, STS-192c has one master channel, STS-48c has four master channels and, if provisioned as 9×21c, 1×2c within STS-192 on one port, then there are 22 master channels.

For the write operation, only the master channel is allowed to write whereas, during the read operation, every path can read from any channel. The read/write address is the channel number. The channel numbers are used to associate the master channel with the corresponding slave channels. Once the channel number matches, the slave channel can get the information from the master channel. This permits any desired level of concatenation bandwidth within STS-192, in contrast to the prior art devices which support only STS-3c, STS-12c, STS-48c and STS-192c. For example, concatenation bandwidths such as STS-2c, STS-21 c, STS-24c, STS-51 c, etc. can be produced using the memory apparatus of FIG. 120.

In the operation of the memory apparatus of FIG. 120, the channel number does not suggest the concatenation level (OC3/OC12/OC15/OC21 and so on), so any concatenation can be supported as long as the master channel and the slave channel(s) share the same channel number.

In the 32-port memory apparatus of FIG. 120, the write address is selected based on write enable. The write enable is based on the master channel enable from the configuration memory of the pointer processor. The write address is from the channel number. The read is open to everyone. The read multiplexer on each port is controlled by the channel number (read address) for the read port.

The decoding logic of FIG. 120 generates 192 write enable signals E and multiplexes the data (D) and enable signals according to the write address (Wr_data0, etc.). Each of the 16 output read data multiplexers is a 192-to-1 data multiplexer which makes its selection based on the read address (Rd_data0, etc.).

RXPP Input Pipeline Registers (RXPP_PIPE)

The Receive Pointer Processor Pipeline registers block is instantiated one time and contains pipeline registers for the receive input data—the receive data, row, column and sub-column counters and frame valid. In addition, the blocks contains basic decode logic for the H1, H2, H3, TOH valid and Fixed Stuff valid timeslots. The following list describes it's functions and pipeline stages.

Pipeline stages 0 to 10 for the 7 bit sub-column number.

Pipeline stages 0 to 4 for the 4 bit row and column number.

Pipeline stages 0 to 3 for the 1 bit frame valid input.

Pipeline stages 0 to 6 for the 128 bit input data.

H1,H2,H3 and TOH valid timeslot decode and Datapath.

Non-concatenated channel fixed stuff timeslot decode and Datapath.

Pipeline stages 0 to 1 for the LOF/LOS/LOC/SEF signal.

RXPP Bus Interface and Registers (RXPP_REGS)

The RXPP_REGS is instantiated one time and implements the following functions:

Contains all programmable registers.

Termination of internal bus protocol.

Asynchronous hard reset and soft global and state machine resets.

Address decoding for registers and memory.

Host read data bus multiplexer

Interrupt and mask logic

Host to local bus synchronization

Instantiation of the HINTFC block

Test bus multiplexing of all other sub-modules test bus outputs.

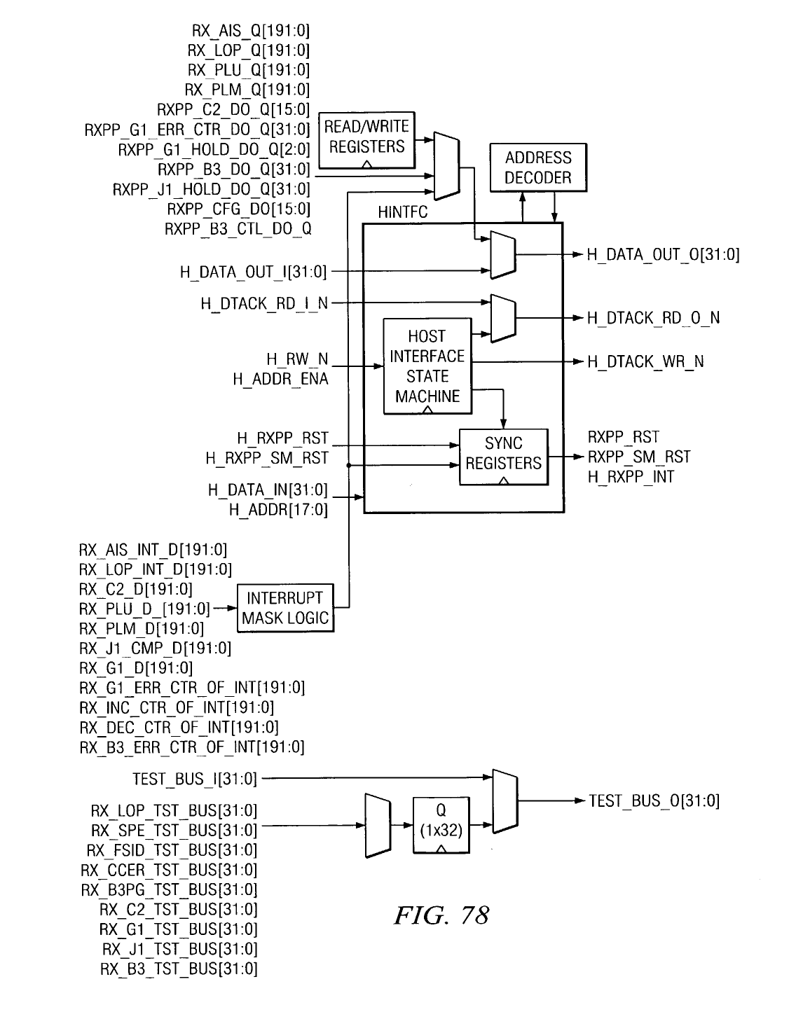

FIG. 78 describes the RXPP_REGS block.

RXPP Pointer Processor (RXPP_PP)

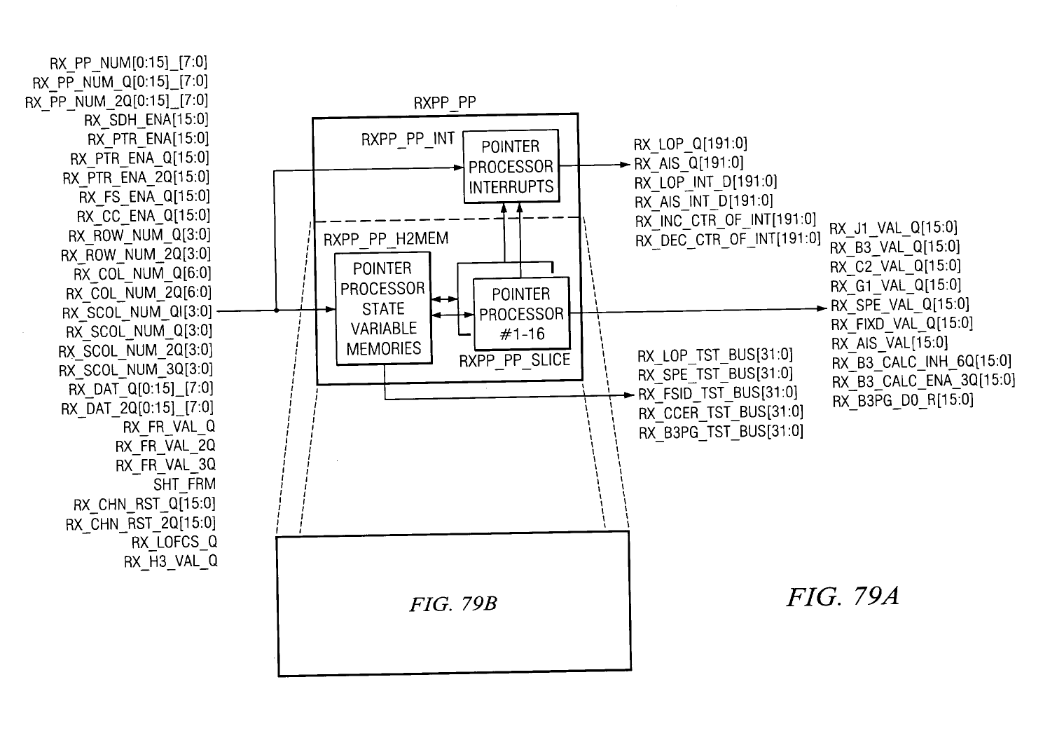

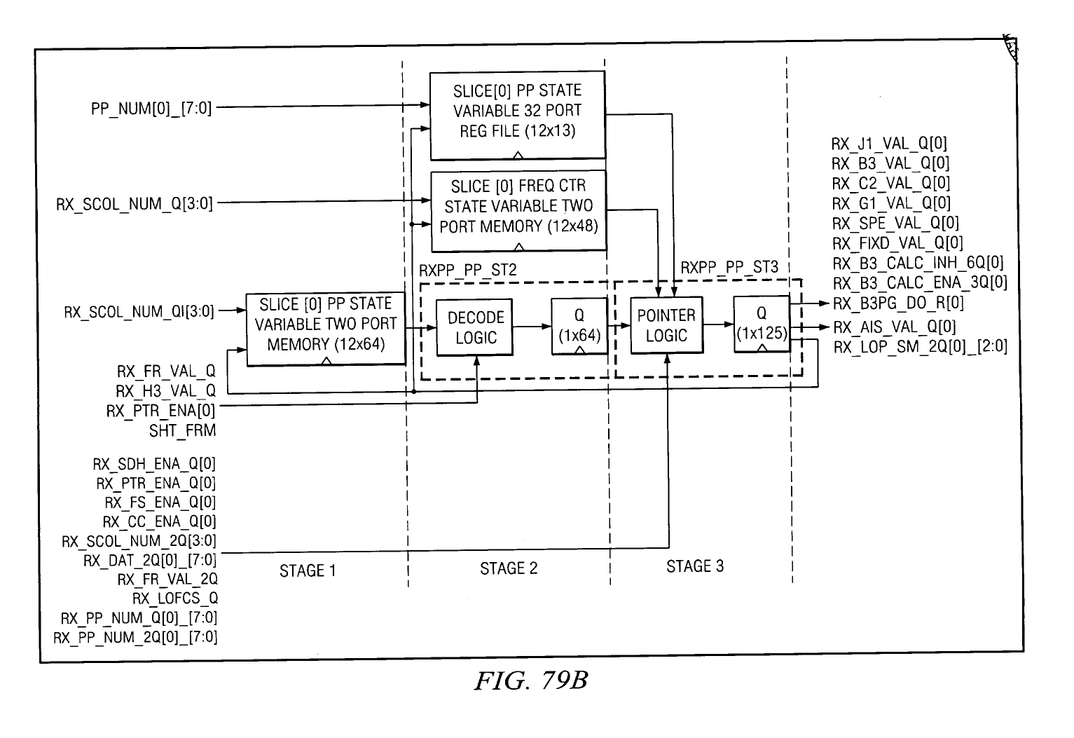

The RXPP_PP block is the portion of the RXPP that contains the pointer processor. There are 16 pointer processor in the design, to accommodate the 128-bit datapath. FIG. 79 describes the RXPP_PP structure.

RXPP_PP Interrupts (RXPP_PP_INT)

The RXPP_PP_INT module is instantiated one time and develops all the pointer processor interrupts, these include:

Loss of Pointer (LOP) Delta Interrupt and Status

Path Alarm Indication Signal (AIS-P) Delta Interrupt and Status

SONET Increment Counter Overflow Interrupt

SONET Decrement Counter Overflow Interrupt

The LOP and AISP interrupts are delta interrupts which means the interrupt is asserted whenever the LOP or AISP status changes state. For each there is an associated status register that indicates the state. When SONET frequency adjustments happen (increments or decrements), there are 24-bit statistic counters that record these events. If the counters overflow due to a large volume of increments or decrements, then an interrupt is set. The delta scheme for these interrupts is not used. These interrupts exist for every SONET path at the STS-1 level.

There are 16 slices of the pointer processor, thus for every clock RXPP_PP_INT receives 16 bits for each functional interrupt. The module writes the interrupts into a register file, which is addressed by the sub-column number. For the delta interrupts, the interrupt input is compared to the previous state of the interrupt to determine if it has changed state, and thus the final interrupt register is set accordingly. Each interrupt can be cleared individually by the software for every STS-1 path.

The block also takes in 16 AIS valid bits and LOP valid bits from the pointer processor slices, and logical OR's them together and pipelines them to develop the 16-bit. AIS valid bus for the TDM block. This bus is used to hold the TDM fifos in reset, which also causes AIS to be output on the system side interface.

RXPP_PP State Variable Memories (RXPP_PP_H2MEM)

The RXPP_PP_H2MEM module is instantiated one time and implements the following functions:

Pointer processor state variable synchronous two port memory, physically organized as 8×(12×128) and logically organized as (192×64).

SONET increment and decrement counter synchronous two port memory, physically organized as 6×(12×128) and logically organized as (192×48).

Pointer processor state variable 32 port register file, physically organized as (12×208) and logically organized as (192×13).

Concatenation error state variable 32 port register file, physically organized as (12×16) and logically organized as (192×1).

B3 page state variable 32 port register file, physically organized as (12×16) and logically organized as (192×1).

Test bus multiplexing for pointer processor state variable memories.

Test bus multiplexing for 32 port register files.

Pipeline stages 2, 3 and 4 for the pointer processor channel number (put here to help FPGA partitioning).

Arbiter and read multiplex logic for processor interface to SONET increment and decrement counter synchronous two port memory.

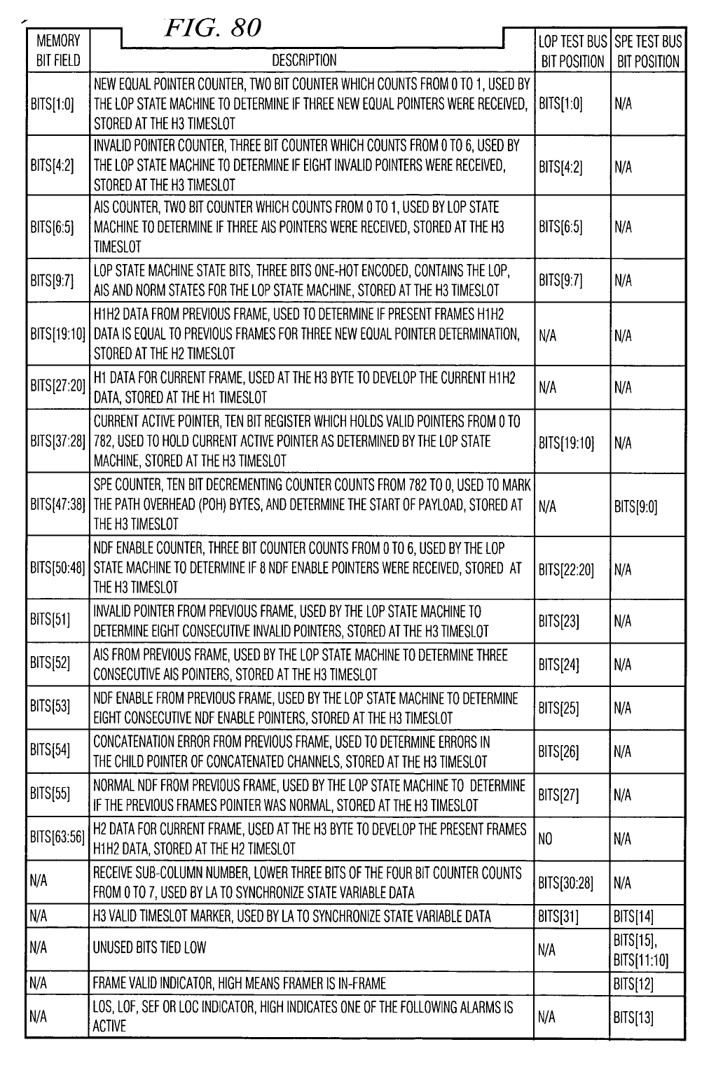

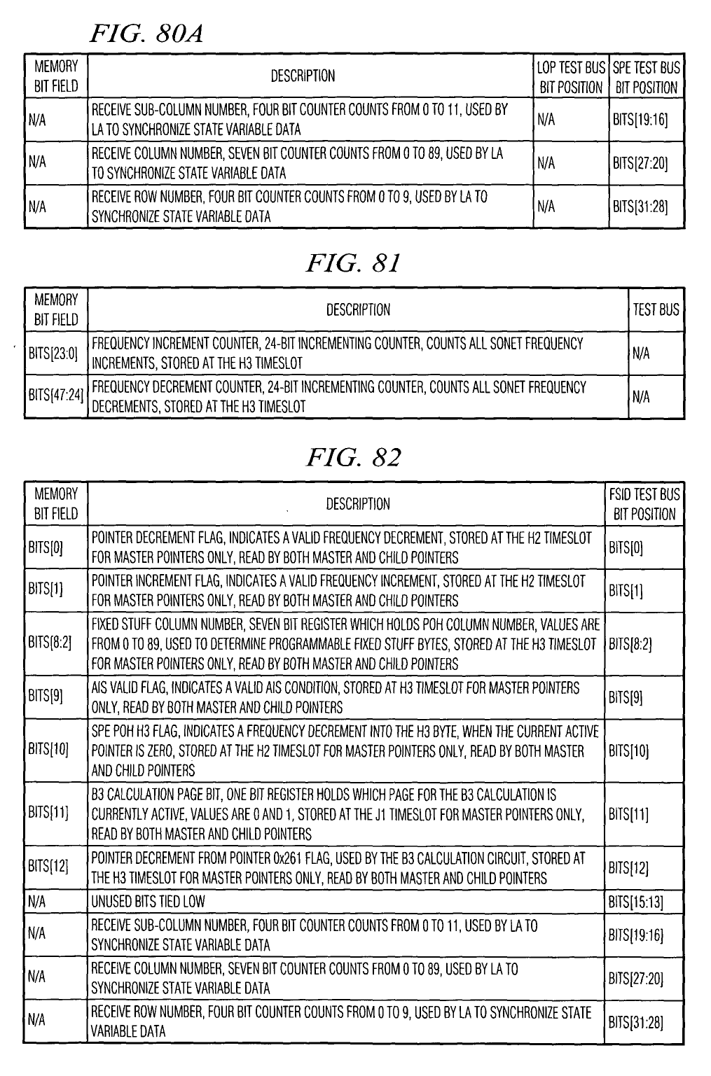

One function of this block is to implement state variable memories and register files that provide storage for the 16 pointer processors. The pointer processor state variable synchronous memory (192×64) holds the state variables that implement the SONET LOP algorithm. These variables are described in FIGS. 80 and 80A as well as if these variables are available on the test bus.

The SONET increment and decrement synchronous memory (192×48) holds the counters to record the increment and decrement statistics. These variables are described below.

The pointer processor state variable 32-port register file (192×13) has 16 read and 16 write ports, each providing a 13-bit interface. The register file has the bit fields shown in FIG. 82.

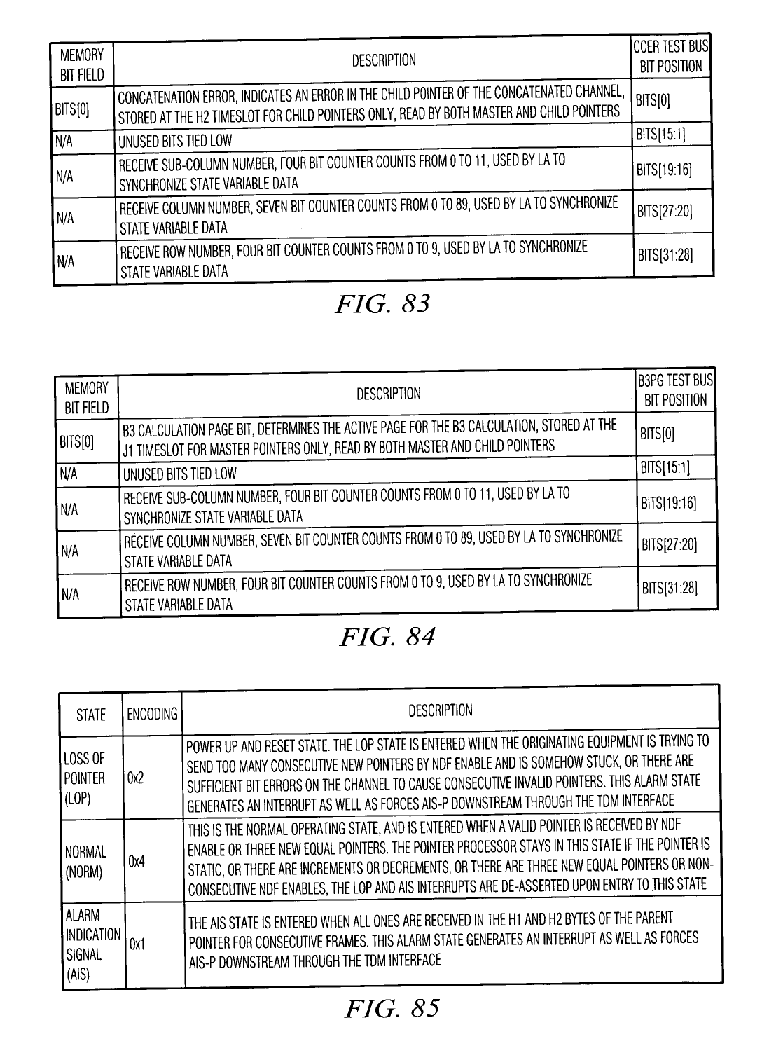

The concatenation error states variable 32-port register file (192×1) holds the state variable for the calculation of concatenation errors in the child pointer fields. This register file has the bit fields shown in FIG. 83.

The B3 page state variable 32-port register file (192×1) holds the state variable that determines the valid B3 page bit. This register file has the bit fields shown in FIG. 84.

RXPP_PP Pointer Processor Slice (RXPP_PP_SLICE)

The pointer processor logic and pipeline stages 2 and 3 are contained in the RXPP_PP_SLICE module, which is instantiated 16 times. There are two sub-modules instantiate in RXPP_PP_SLICE, RXPP_PP_ST2 and RXPP_PP_ST3. The RXPP_PP_ST2 sub-module implements the following functions:

NDF (New Data Flag) filed (upper four bits of the H1 byte) 3 of 4 majority decoding to determine NDF normal or NDF enable.

Increment/decrement 8 of 10 majority decoding on the 10 bit H1/H2 pair.

Programmable SS valid bits detection for SDH (SS bits are bits 2 and 3 of the H1 byte).

New equal pointer comparison.

AIS-P pointer decoding.

Stage 2 pipeline registers.

The RXPP_PP_ST2 block performs decoding function could be performed in the RXPP_PP_ST3 block, however the critical paths would then be too long and would not meet timing. After the decoding functions are performed, the interim values are pipelined for use in the RXPP_PP_ST3 block.

The NDF majority decoding looks for 3 out of 4 majority bits for the decoded value for both NDF normal and NDF enable. The same is true for the increment/decrement decoding, however this is done as 8 of 10.

The SS bits detection is programmable and only for SDH mode. If SS bits detection is enabled, then if the received bits are not 0×1, then the pointer is declared invalid. If the SS bits detection is disabled then the SS bits are ignored as in the case of SONET mode.

Other decoding that is performed is checking the H1/H2 pair for the all ones value, which indicates AIS.

The RXPP_PP_ST3 sub-module implements the following functions:

LOP state machine, 3 bit.

Current active pointer counter, 10 bit.

SPE and J1 valid signal generation.

SPE counter, 10 bit.

Frequency increment/decrement counters, 24 bit.

Concatenation error detection.

Stage 3 pipeline registers.

The LOP state machine determines what is or isn't a valid pointer. The LOP state machine has three states, the NORM state, the LOP state and the AIS state. The LOP states are summarized in FIG. 85.

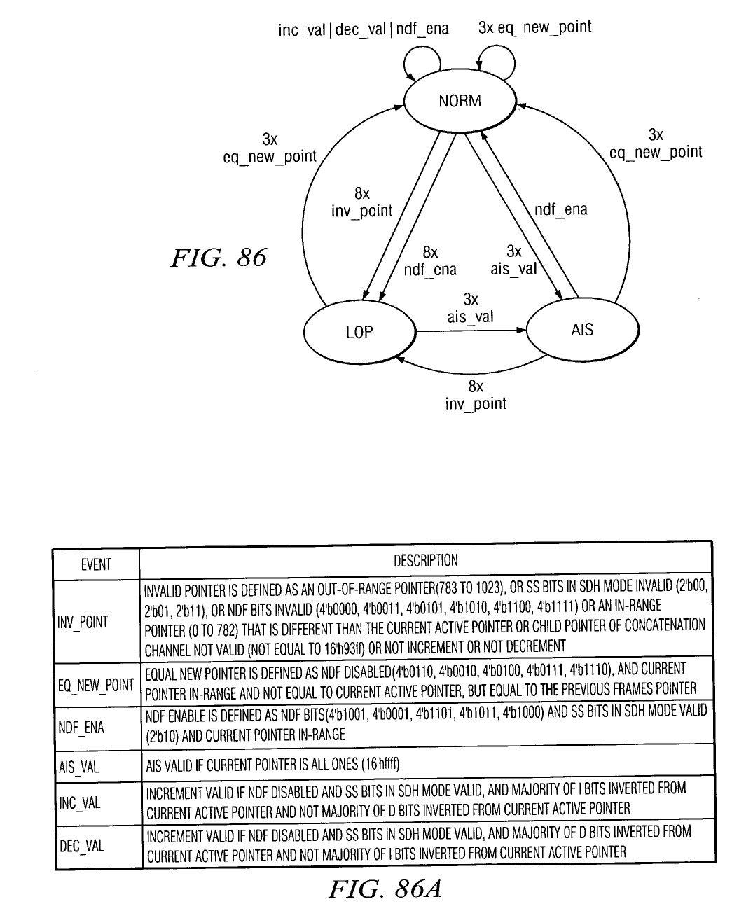

FIG. 86 describes the LOP state machine states and transitions.

The state diagram of FIG. 86 describes the various state transitions that can happened during pointer processing. FIG. 86A describes the meaning of the various events that result in state transitions.

State transitions from LOP to NORM occur when:

Three new equal pointers are received in consecutive frames that are different from the current active pointer.

Three new equal pointers are received in consecutive frames with the first pointer in the sequence having NDF enabled, while the other two frames have NDF disabled.

Note counters are used to record consecutive frames of the various events, and all counters are reset during any state transition described above, except for the counter for NDF Enable.

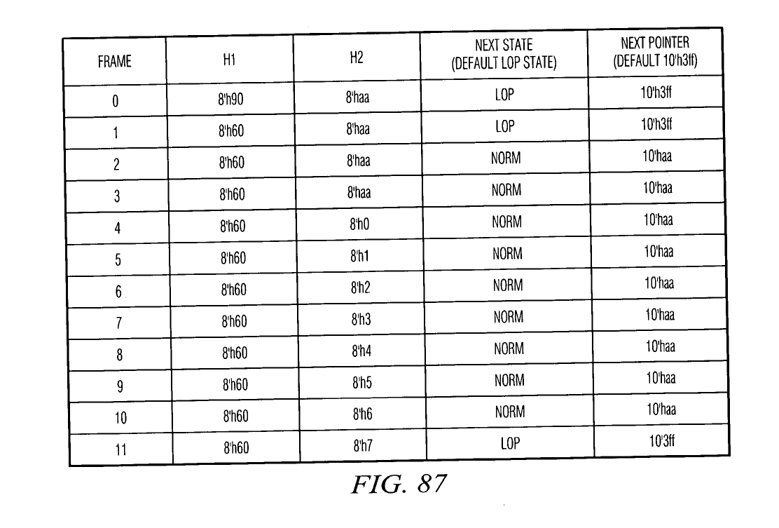

The Titan pointer processor is designed such that it can accurately count consecutive frames of INV_POINT, NDF_ENA and EQ_NEW_POINT. FIG. 87 shows an example of how the Titan pointer processor would interpret a given set of pointers.

The following is a summary of the LOP state machine and related functions of the pointer processor:

LOP state machine supports detection of errors in child pointers of concatenated channels that result in INW_POINT for that pointer.

If a pointer is received with NDF enabled and determined as INV_POINT, then the pointer processor will hold the current active pointer.

If INV_POINT is received then the three frame sequence for EQ_NEW_POINT is broken.

The tag method is being implemented to accurately determine all combinations of three and eight frame sequences of pointer values.

AIS-P is only generated downstream after the valid transitions to the LOP and AIS states. The pointer processor does not act as an all-ones relay.

Majority voting is applied to the I and D bits in the pointer field to determine increment or decrement justifications, looking for 8 out of 10 valid bits.

The SS bits in SDH mode, if not 2'b10 result in INV_POINT. This function can be programmably disabled.

The design supports frequency justifications every other frame, that is a frequency justifications separated by one normal pointer frame. The LOP state is not entered if frequency justifications happen every frame.

RXPP Path Overhead Processor (RXPP_POP)

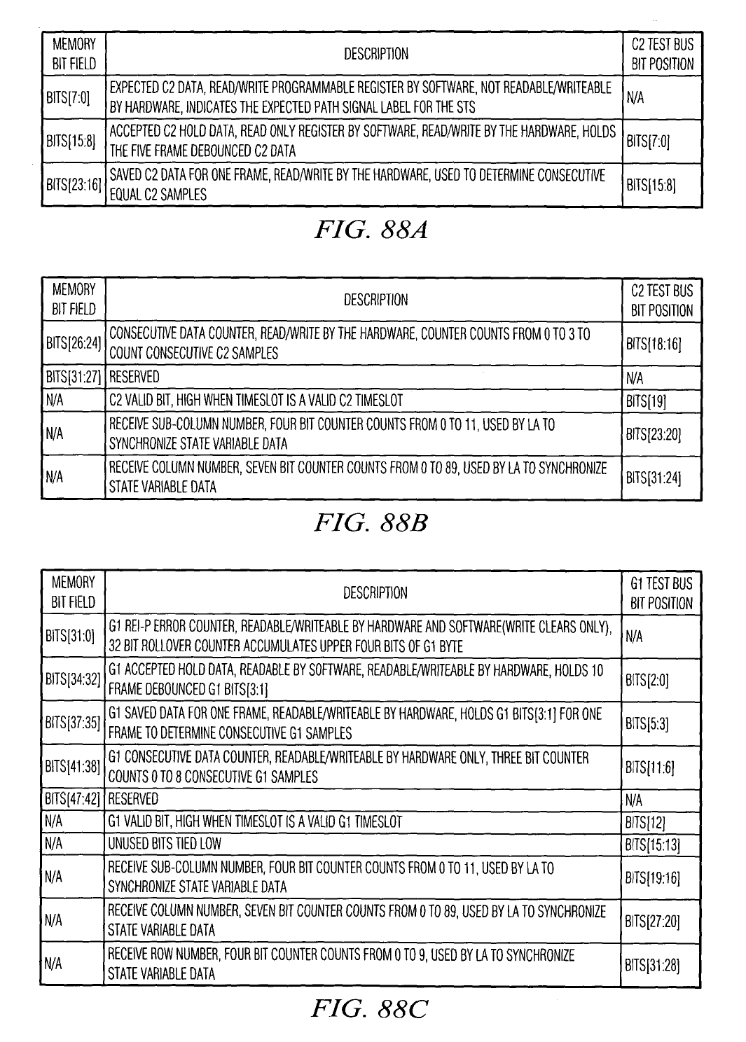

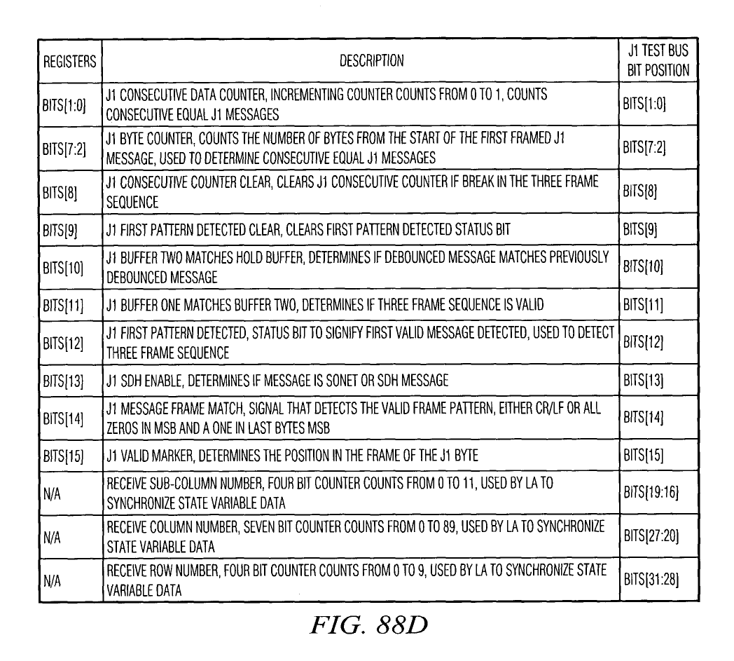

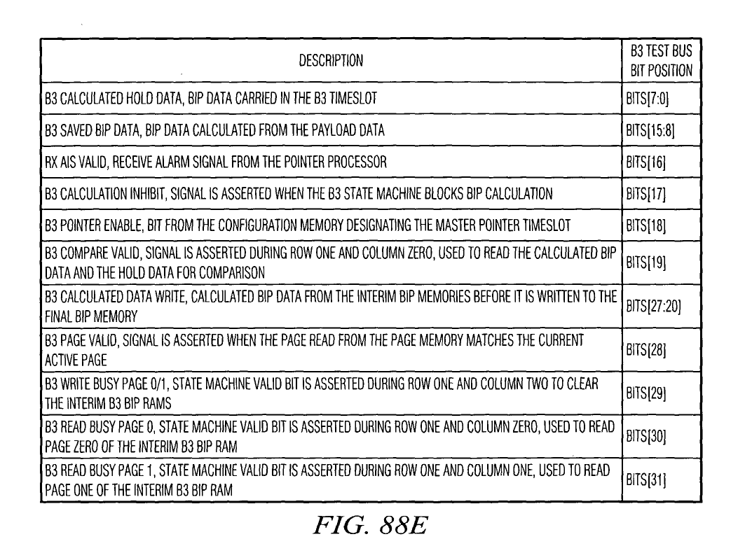

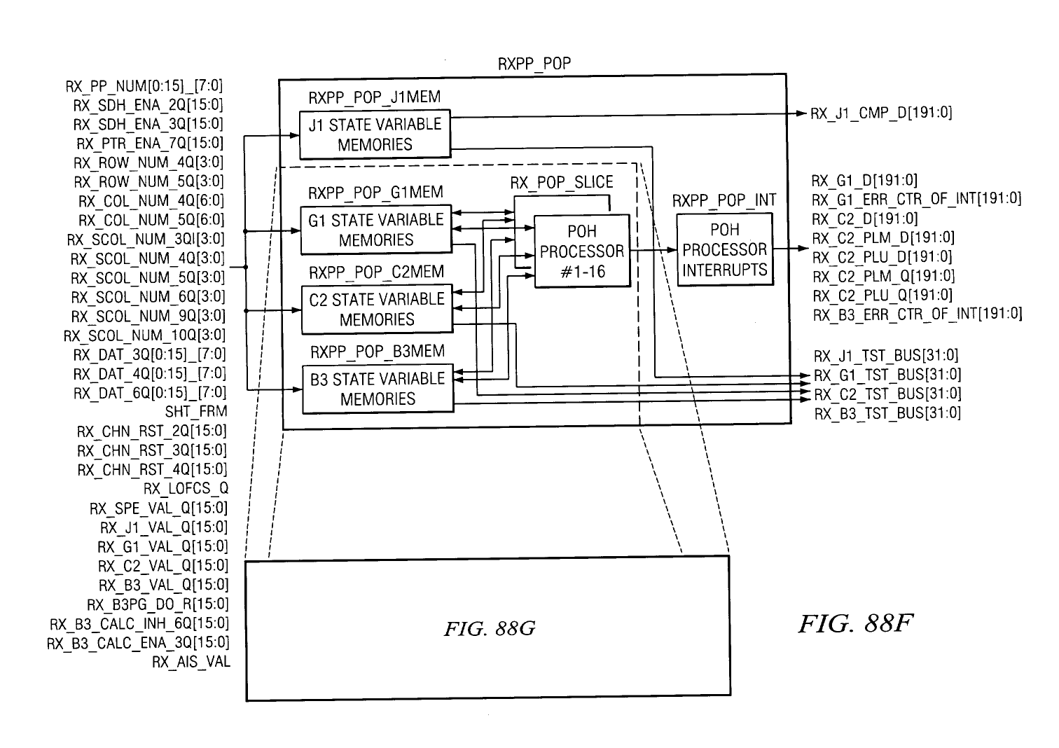

The RXPP_POP block is the portion of RXPP that contains the POH processor. There are 16 POH processors in the design, to accommodate the 128-bit datapath. FIG. 88 describes the RXPP_POP structure.

RXPP_POP Interrupts (RXPP_POP_INT)

The RXPP_POP_INT module is instantiated one time and develops all the POH processor interrupts except the J1 interrupt, these include:

G1 Hold Delta Interrupt and Status.

C2 Hold Delta Interrupt and Status.

C2 Path Label Mismatch (PLM) Interrupt and Status.

C2 Path Label Unequipped (PLU) Interrupt and Status.

G1 Remote Error Indicator (REI) Counter Overflow Interrupt.

B3 Error Counter Overflow Interrupt.

The G1 and C2 Hold, as well as the C2 PLM and PLU interrupts are delta interrupts which means the interrupt is asserted whenever status changes state. For each there is an associated status register that indicates the state. The Titan has the ability to count the B3 errors generated at the near end, which are transmitted in the G1 byte. The REI counters are 32 bits and generate an interrupt when they overflow. Similarly, at the far end Titan can detect and count B3 errors using 32 bit counters and generate an interrupt when they overflow. The delta scheme for these interrupts is not used. These interrupts exist for every SONET path at the STS-1 level.

There are 16 slices of the POH processor, thus for every clock RXPP_POP_INT receives 16 bits for each functional interrupt. The module writes the interrupts into a register file, which is addressed by the sub-column number. For the delta interrupts, the interrupt input is compared to the previous state of interrupt to determine if it has changed state, and thus the final interrupt register is set accordingly. Each interrupt can be cleared individually by the software for every STS-1 path.

RXPP_POP C2 State Variable Memories (RXPP_POP_C2MEM)

The RXPP_POP_C2MEM module is instantiated one time and implements the following functions:

C2 POH state variable synchronous two port memory, physically organized as 4×(12×128) and logically organized as (192×32).

Arbiter and read multiplex logic for processor interface to POH C2 state variable synchronous two port memory.

Test bus multiplexing for C2 state variables.

The C2 POH state variable synchronous memory (192×32) holds the state variables that implement the C2 processing functionality. These variables are described in FIGS. 88A and 88B.

RXPP_POP G1 State Variable Memories (RXPP_POP_G1MEM)

The RXPP_POP_G1MEM module is instantiated one time and implements the following functions:

G1 POH state variable synchronous two port memory, physically organized as 6×(12×128) and logically organized as (192×48).

Arbiter and read multiplex logic for processor interface to POH G1 state variable synchronous two port memory.

Test bus multiplexing for G1 state variables.

The G1 POH state variable synchronous memory (192×48) holds the state variables that implement the G2 processing functionality. These variables are described in FIG. 88C.

RXPP_POP J1 State Variable Memories (RXPP_POP_J1MEM)

The RXPP_POP_J1MEM module is instantiated one time and supports the following functions:

Processing of a single 64 or 16 byte J1 message only.

J1 compare valid interrupt.

J1 state variables to debounce J1 message for three frames.

Pipeline stages 4, 5 and 6.

FIG. 88D describes the RXPP_POP_J1MEM state variable registers.

RXPP_POP B3 State Variable Memories (RXPP_POP_B3MEM)

B3 BIP synchronous two port memory, physically organized as (12×128) and logically organized as (192×8), used to hold final B3 BIP value for each STS-1.

B3 Hold synchronous two port memory, physically organized as (12×128) 15 and logically organized as (192×8), used to hold B3 data that is carried in the B3 byte, used to compare against value in the B3 BIP memory.

B3 Error Counter synchronous two port memory, physically organized as 4×(12×128) and logically organized as (192×32), holds the B3 errors detected by comparing the contents of the B3 Hold memory with the B3 memory.

B3 control two port register file, physically organized as (12×16), logically organized as (192×1), readable/writeable by softwawre, controls bit or block counting mode for the B3 Error Counters.

Test bus multiplexing for B3 state machines.

Pipeline stages 2 to 7 for the pointer processor channel number.

State machines to read the sixteen (12×128) interim B3 BIP calculation memories in the RXPP_POP_B3BIP modules, XOR each STS-1's data together then write to the B3 final BIP memory.

Pipeline stages 4 to 11 for the B3 BIP calculation and error generation.

Arbiter and read multilplex for the B3 control two port register file and the B3 Error Counter synchronous two port memory.

FIG. 88E describes the test bus bit positions for the RXPP_POP_B3MEM module.

RXPP_POP POH Processor Slice (RXPP_POP_SLICE)

The RXPP_POP_SLICE module is instantiated 16 times, and instantiates within it three modules: RXPP_POP_C2, RXPP_POP_G1, and RXPP_POP_B3BIP. The following list describes the functions of the RXPP_POP_C2 module:

Pipeline registers for stage 4.

Five frame C2 consecutive equal byte debounce logic.

C2 change interrupt logic.

PLM and PLU interrupt logic based on C2 expected data register.

The following list describes the functions of the RXPP_POP_G1 module:

Pipeline registers for stage 4.

Ten frame G1 consecutive equal byte debounce logic based on RDI or ERDI processing

REI-P 32 bit counter logic.

G1 change interrupt logic.

REI-P error counter overflow interrupt logic.

The following list describes the functions of the RX_POP_B3BIP module:

B3 BIP synchronous two port memory, physically organized as (12×128) and logically organized as (192×8), used to hold interim B3 BIP value for each STS-1.

B3 BIP logic to read/modify/write B3 interim BIP memory for SONET or SDH applications.

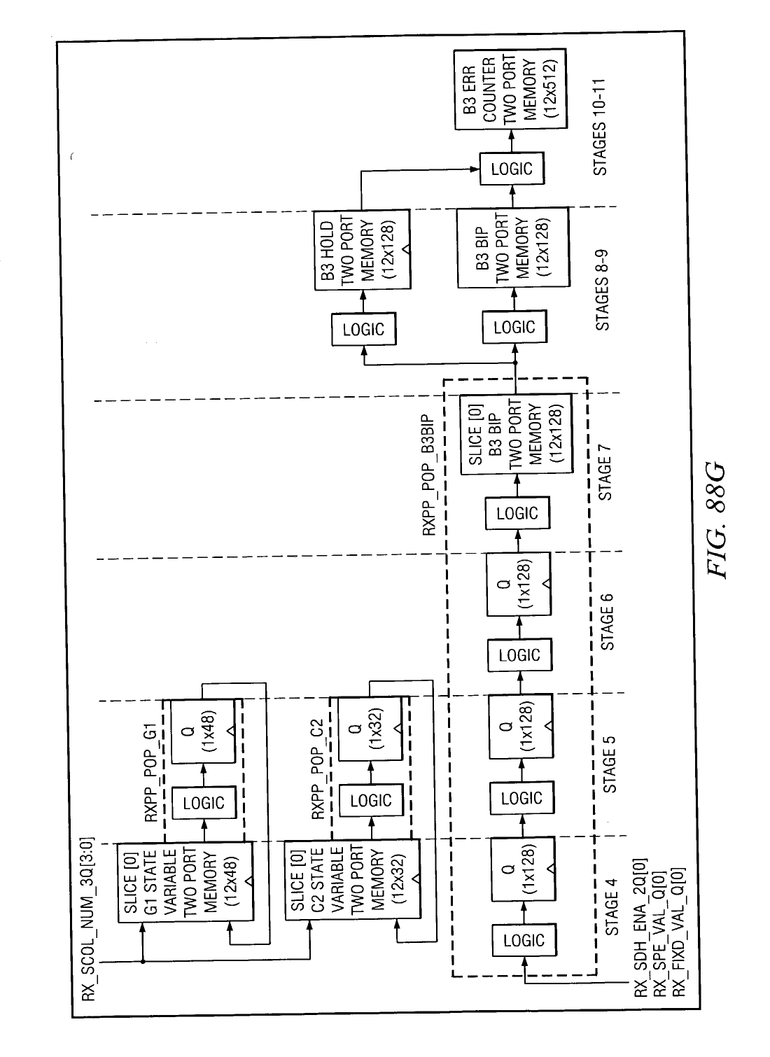

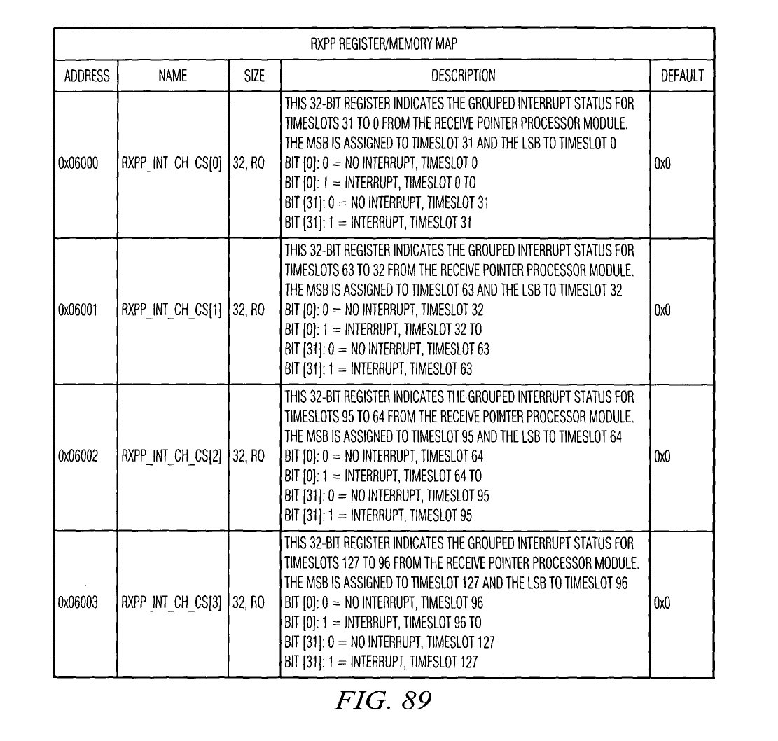

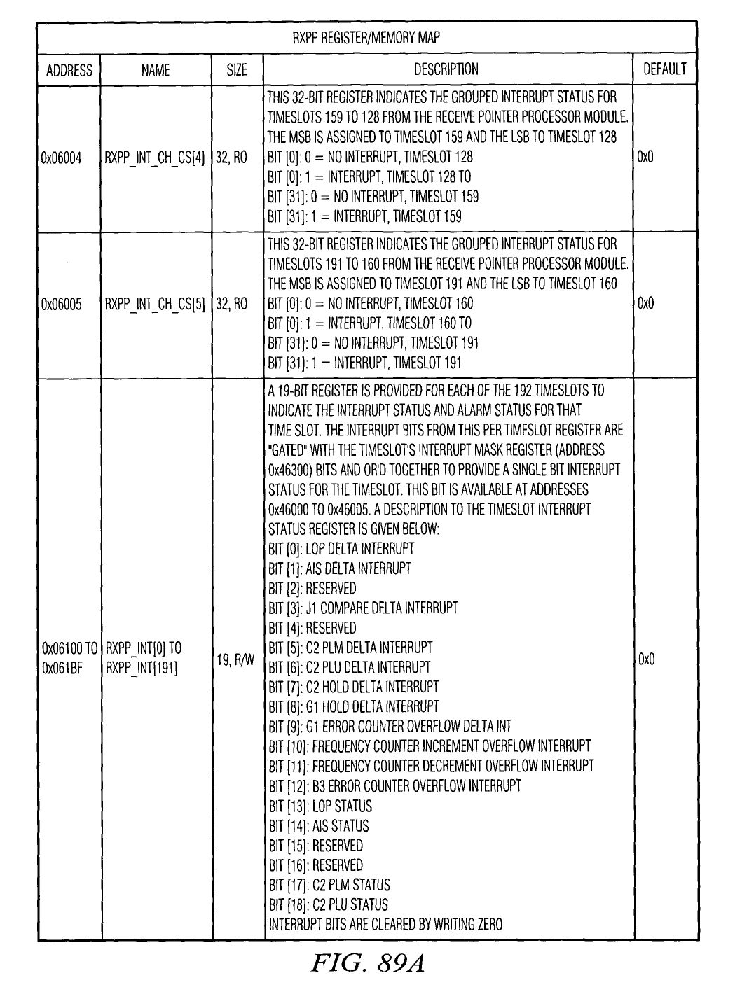

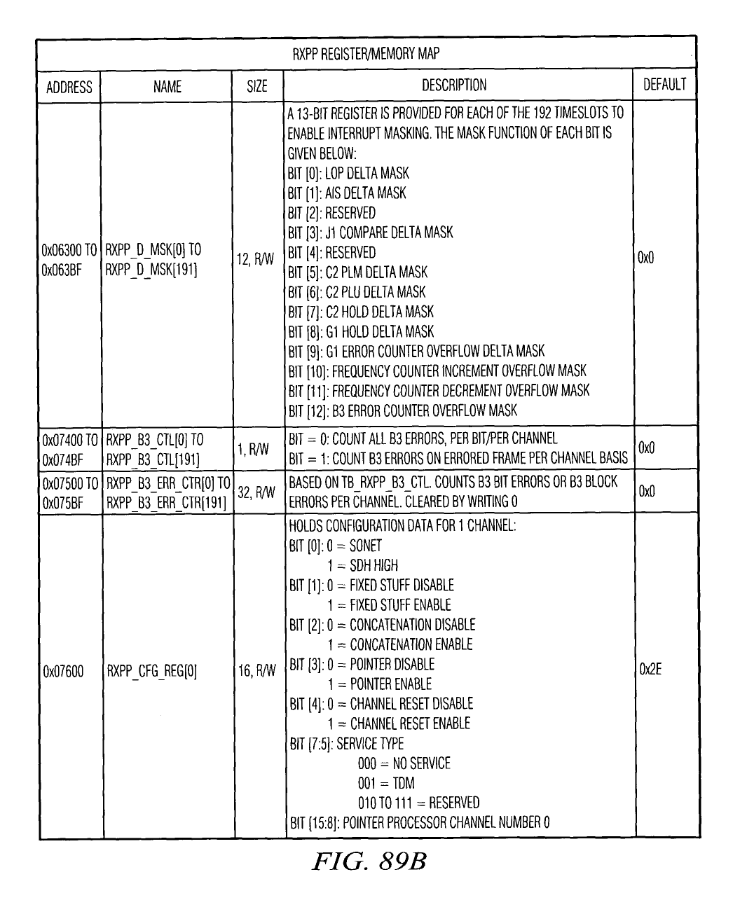

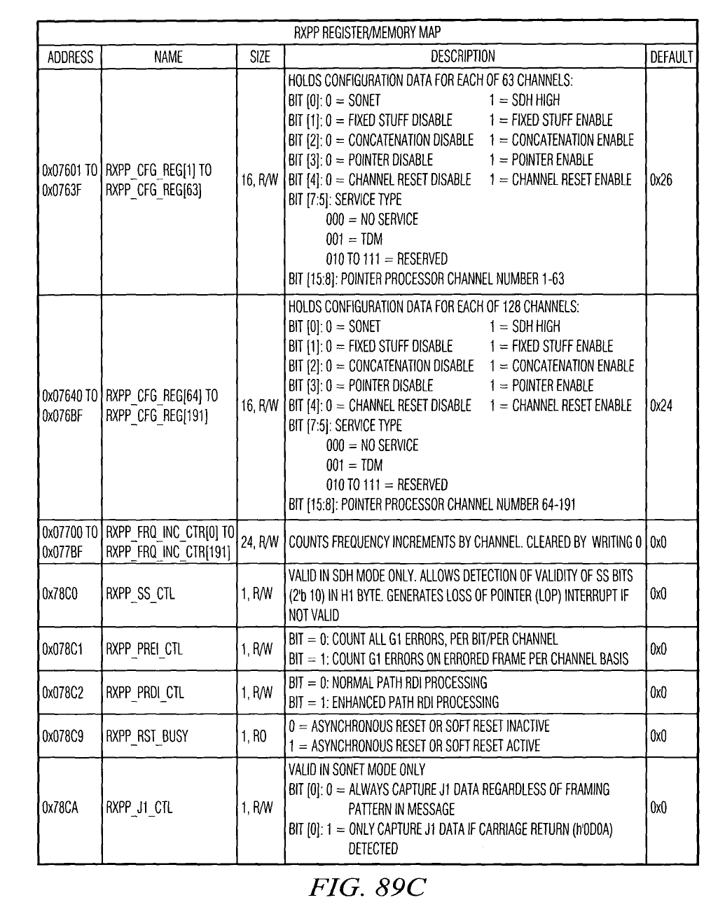

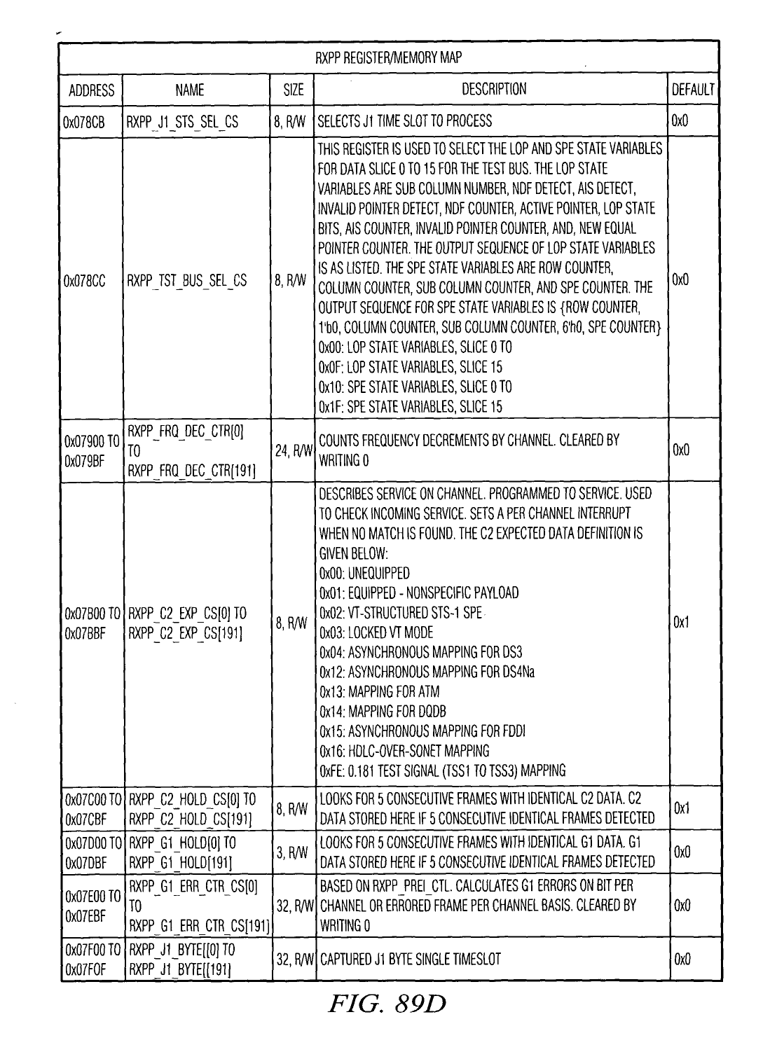

FIGS. 89-89D contain a memory map for all the registers and memories in the RXPP design. The address range reflects the generic address range based on an 18-bit address.

Transmit Pointer Processor PROCESSOR (TXPP)

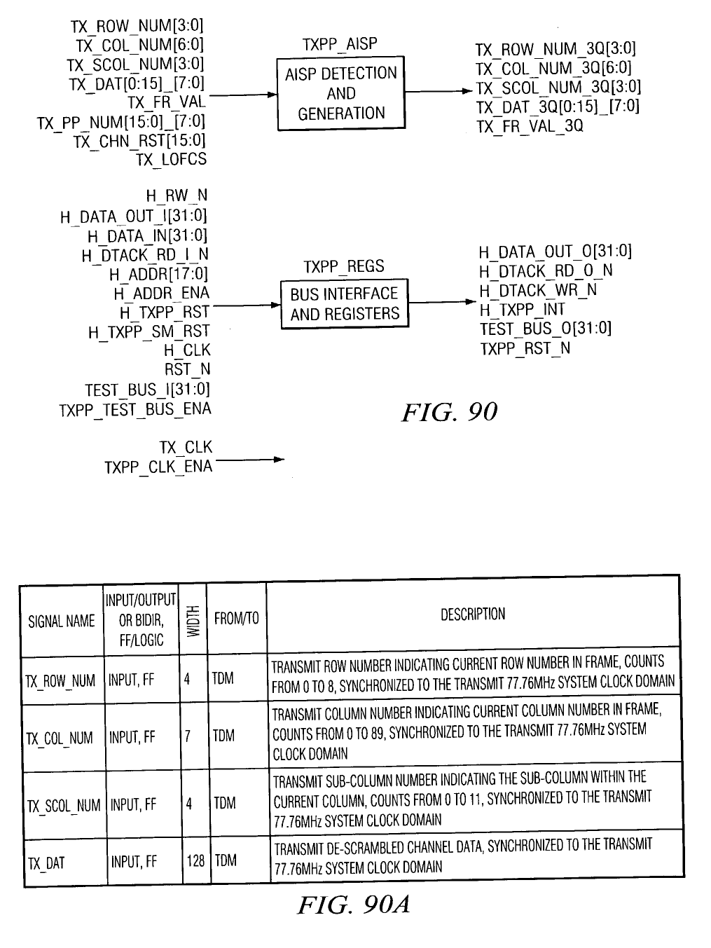

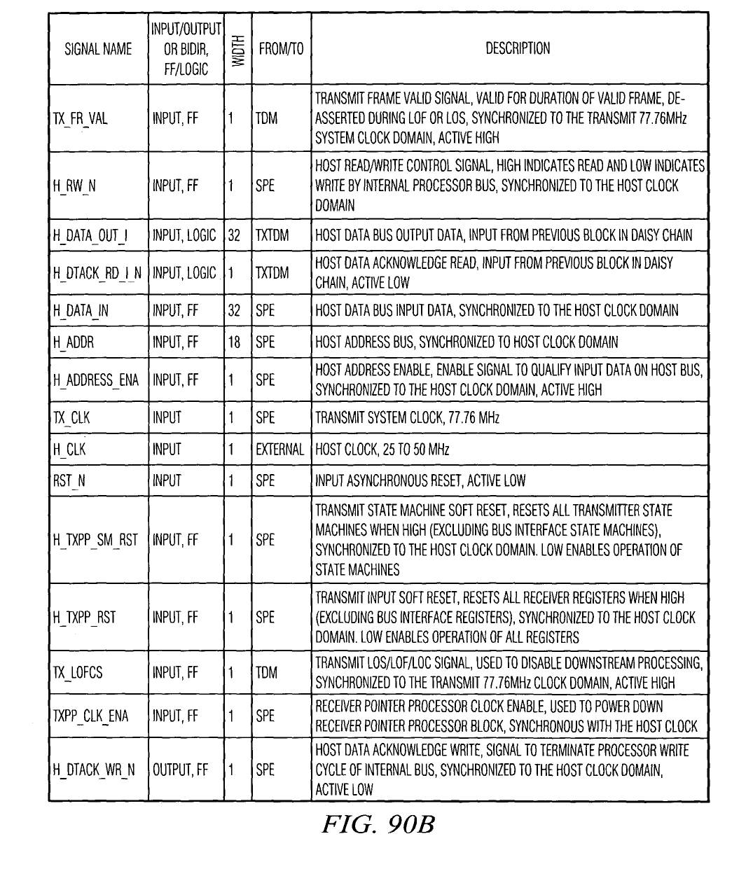

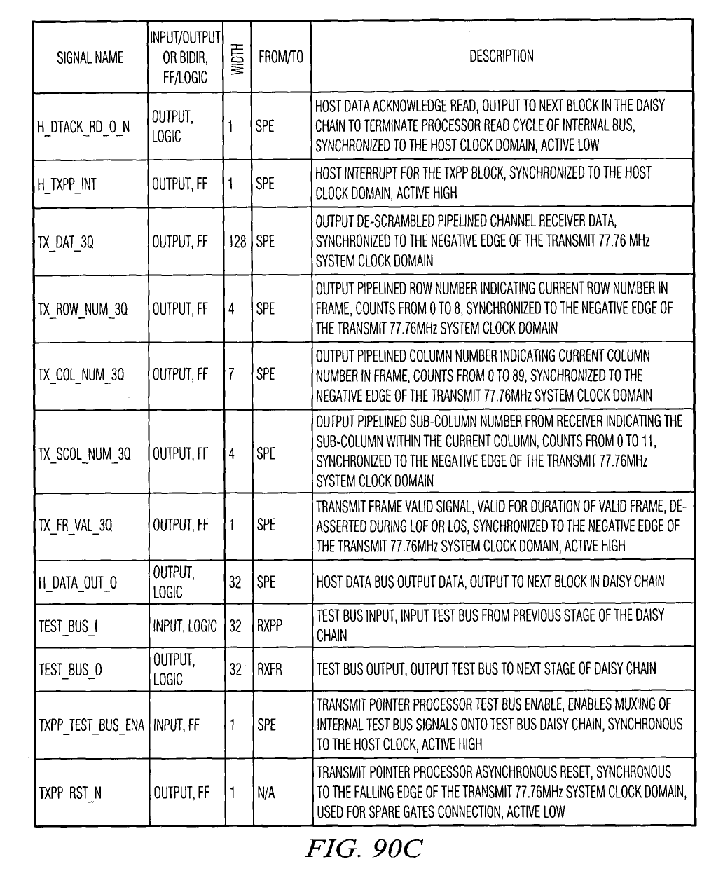

FIG. 90 is a top-level diagram of the modules contained within the TXPP. The interface signals are shown in FIGS. 90A-90C.

The following list describes exemplary features of the TXPP block:

AIS-P generation and detection

1. AIS-P detection in H1, H2 and H3 timeslots for a single frame of all ones pattern per channel.

2. Programmable AIS-P generation on all channels simultaneously.

3. Programmable AIS-P generation on a single channel.

4. AIS-P generation on all channel during system side LOS, LOF, LOC, SEF.

5. AIS-P generation on all channels when system frame not in frame.

Datapath of row, column, sub-column number, and frame valid and system side transmits data, with last pipeline stage registered by the negative edge of the system side clock.

Internal host bus interface termination.

1. Contains all programmable registers.

2. Termination of internal bus protocol.

3. Asynchronous hard reset and soft global and state machine resets.

4. Host read data bus multiplex.

5. Interrupt and mask logic.

6. Host to local bus synchronization.

Test bus support for multiplexing internal signals onto an external bus.

1. AIS-P state variables.

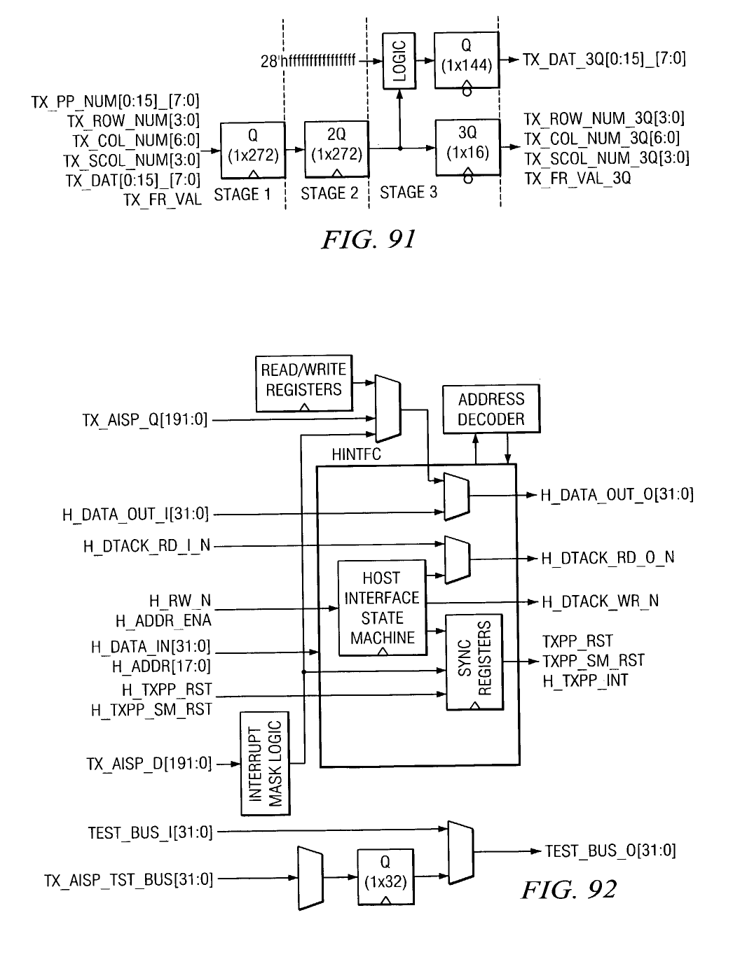

FIG. 91 describes the TXPP datapath.

TXPP Path Alarm Indication Signal (TXPP_AISP)

The TXPP_AISP block is instantiated one time and implements the following functions:

Pipe states 1, 2 and 3 for receive data from TXTDM module.

AIS-P detection in H1, H2 and H3 timeslots for a single frame of all ones pattern per channel.

AIS-P delta interrupt and status after decision of AISP condition.

Programmable AIS-P generation on all channels simultaneously.

Programmable AIS-P generation on a single channel.

AIS-P generation on all channels during system side LOS, LOF, LOC, SEF.

AIS-P generation on all channels when system frame not in frame.

Negative edge flip-flops at pipeline stage 3 for synchronizing data from the system clock domain to the line clock domain.

TXPP Bus Interface and Registers (TXPP_REGS)

The TXPP_REGS in instantiated one time and implements the following functions:

Contains all programmable registers.

Termination of internal bus protocol.

Asynchronous hard reset and soft global and state machine resets.

Address decoding for registers and memory.

Host read data bus multiplexer.

Interrupt and mask logic.

Host to local bus synchronization.

Instantiation of the HINTFC block.

Test bus multiplexing of all other sub-modules test bus outputs.

FIG. 92 describes the TXPP_REGS block.

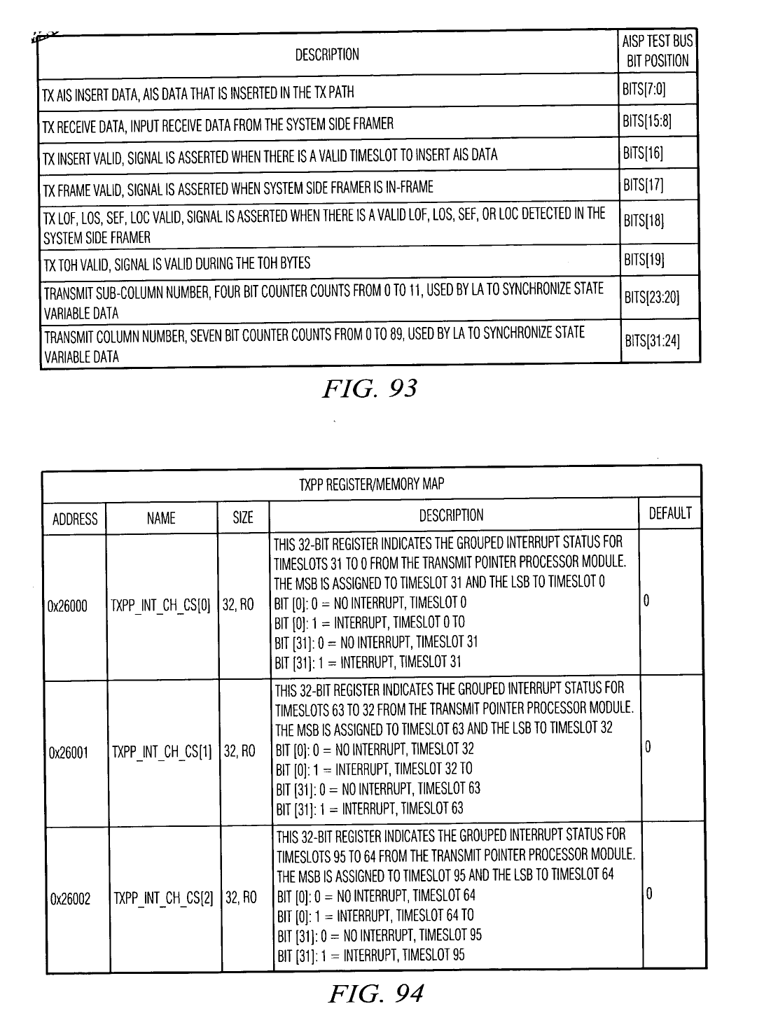

FIG. 93 describes the internal signals that can be multiplexed onto the 32-bit daisy chained test bus from the TXPP module.

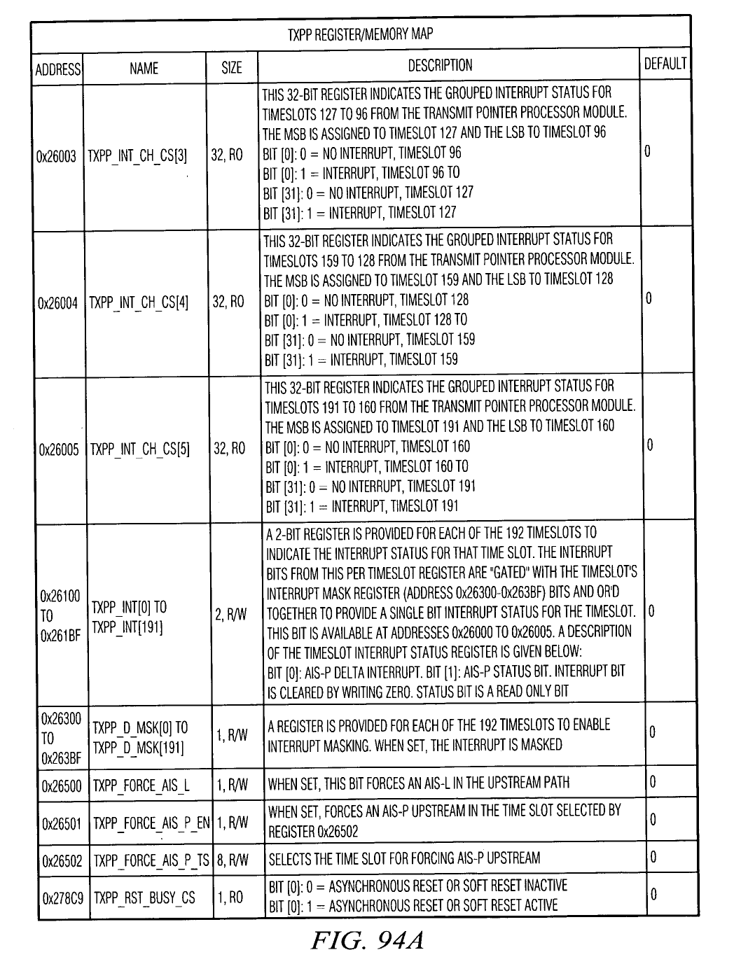

FIGS. 94 and 94A contain a memory map for all the registers and memories in the TXPP design. The address range reflects the generic address range based on an 18-bit address.

Time Division Multiplexer (TDM)

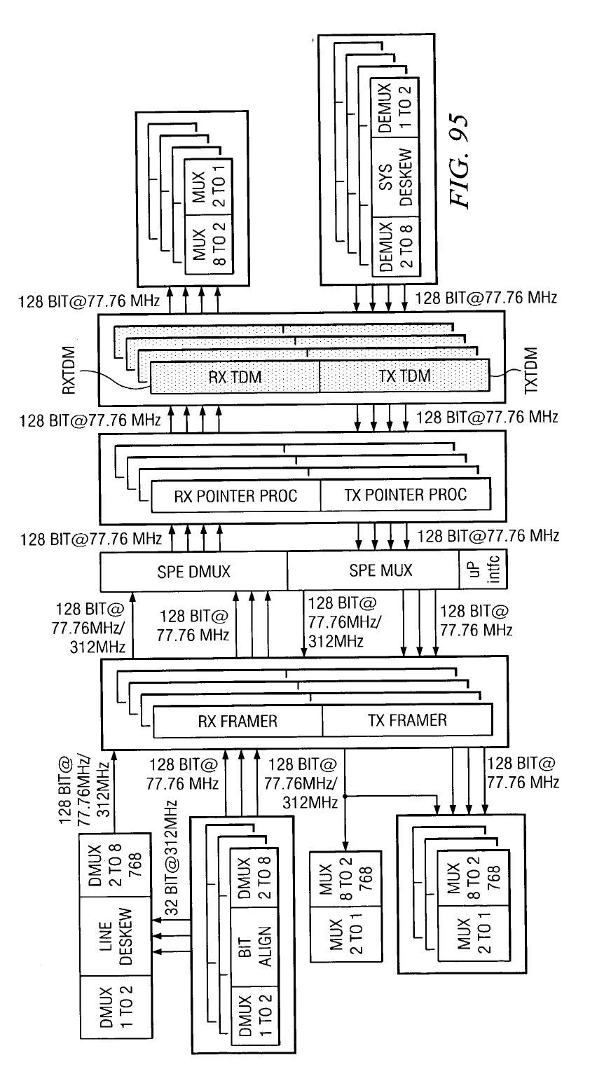

The TDM module (highlighted in FIG. 95) includes four sub-modules: RXTDM, TXTDM, RXSFR, and TXSFR. The RXSFR and TXSFR are the system-side framer. The TXTDM provides the configuration information for the upstream data. The RXTDM has FIFOs to accommodate the different clocks between line side and the system side.

Receive TDM (RXTDM)

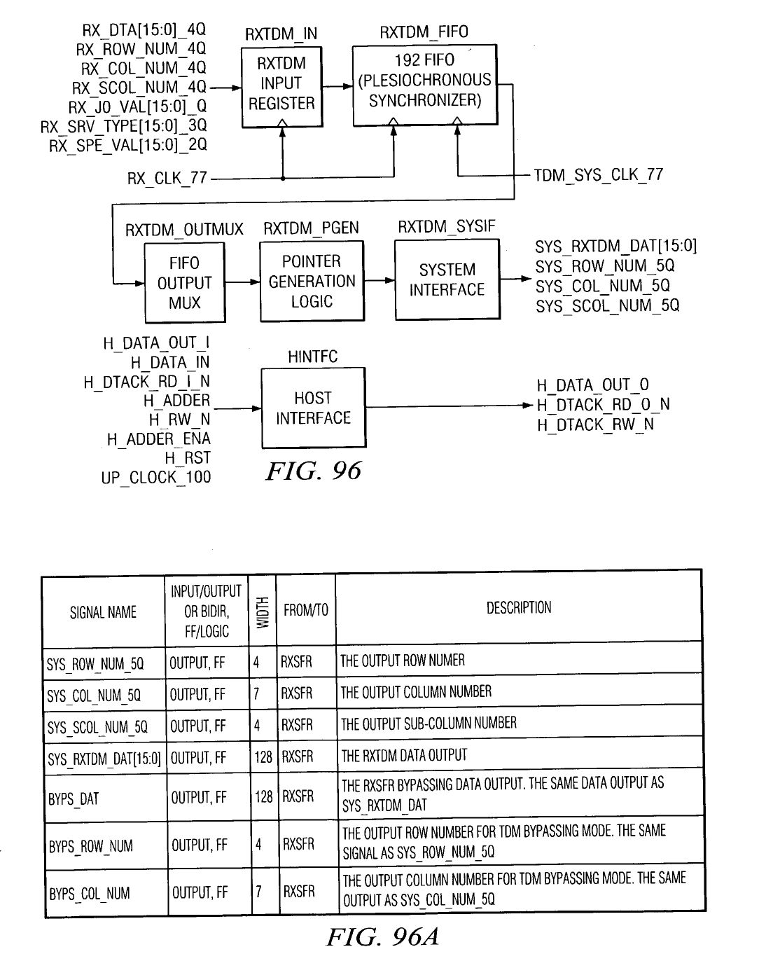

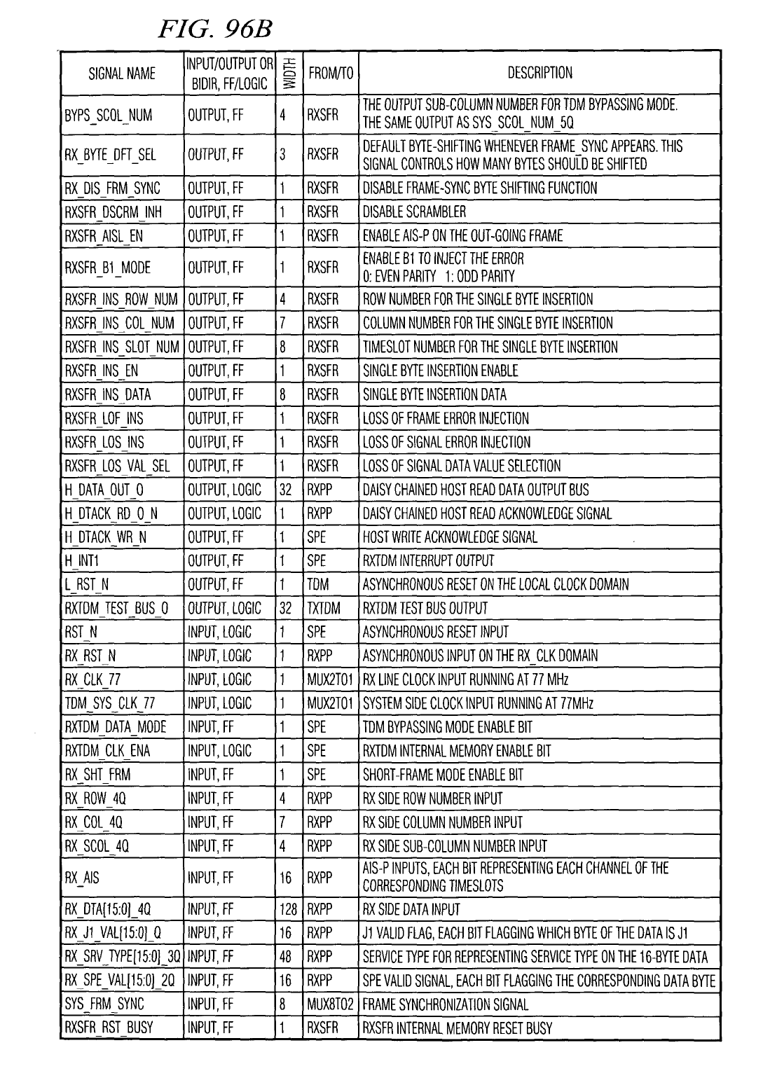

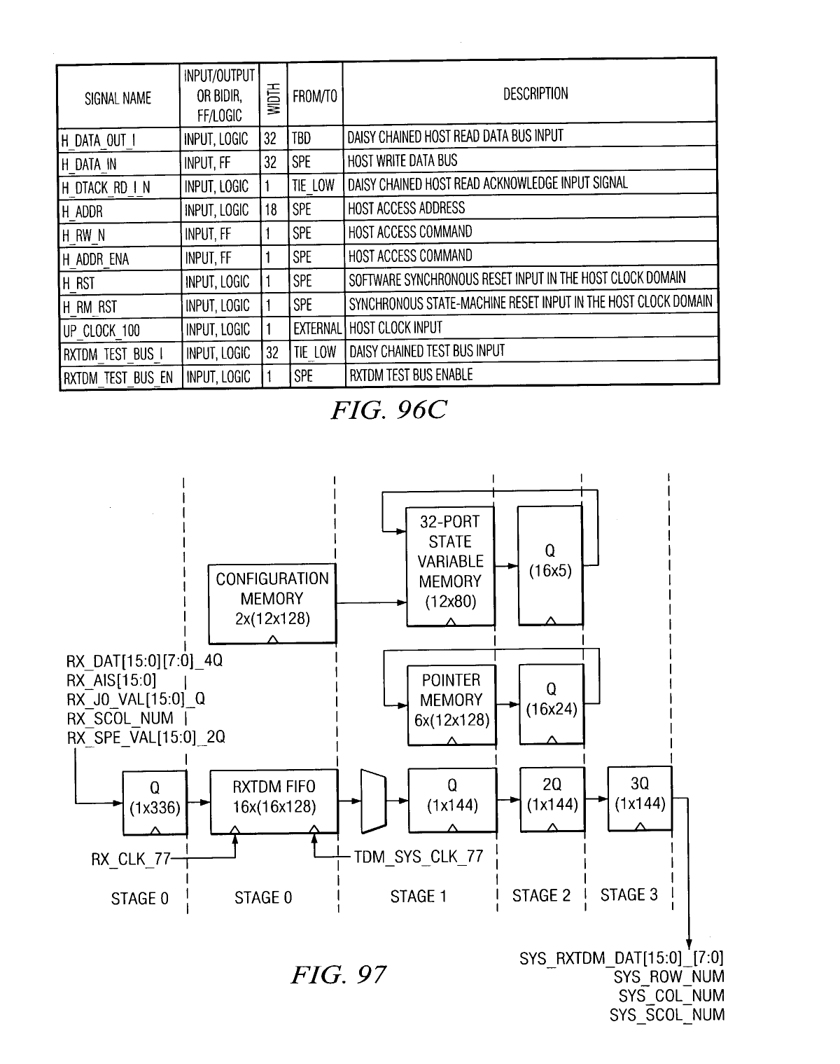

FIG. 96 is a top-level diagram of the modules contained within RXTDM. The interface signals are shown in FIGS. 96A-96C

The following list describes exemplary features supported in the RXTDM block.

Learning the data from RXPP.

1 . The data is latched based on SPE valid and Service type signals.

2. The J1 flag is also latched to flag the POH.

3. AIS-P signals are decoded based on the input sub-column number to generate 192 AIS-P signals.

4. The FIFO write enable signals are generated based on the sub-column number.

192 FIFO for absorbing the frequency difference between line side and system side clocks.

1. Each FIFO is 9-bit wide and 16 level deep.

2. J1 flag is stored in the FIFO.

3. Twelve FIFOs are packed into one memory.

4. The write pointer and read pointers are operating in different clock domains.

5. High and low watermarks are provided to check the FIFO status. Should the difference between the read/write pointers cross the watermark, the pointer increment/decrement is generated.

6. The FIFO underflow/overflow conditions are detected in order to generate AIS-P condition.

7. The AIS-P signals from RXPP are synchronized to the system clock domain.

8. The status for valid data from RXPP is sent across the clock domain to remove the AIS-P.

Multiplexing the FIFO output based on system side sub-column number.

Supporting any concatenation.

1. A configuration memory is available to store all the configuration information.

Regenerate the pointer based on system side row, column and sub-column number.

1. The J1 flag coming out of FIFO determined the pointer value.

2. If the low watermark is crossed, the pointer increment is generated.

3. If the high watermark is crossed, the pointer decrement is generated.

Automatic recovery from AIS-P condition.

1. After receiving valid data from RXPP, RXTDM allows two-frame window to search J1.

2. If no J1 is found within two-frame window, then AIS-P state continues.

Generating AIS-P if FIFO overflow/underflow happens.

Providing channel reset function to force AIS-P condition.

Generating NDF flag whenever the pointer moves other than increment/decrement.

Using FRAME_SYNC signal to preset the row, column and sub-column counter to pre-programmed values.

FIG. 97 shows the pipeline stages inside RXTDM.

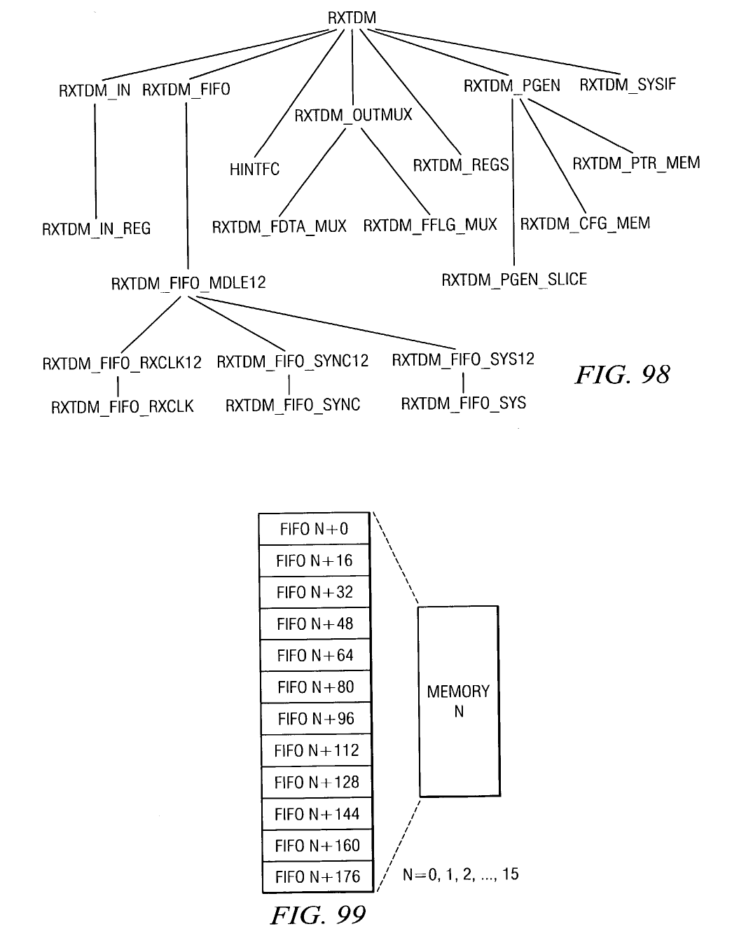

FIG. 98 shows the modular structure of the RXTDM design.

RXTDM Input Register (RXTDM_IN)

The RXTDM input register latches the input data along with row, column, and sub-column from RXPP. The input data are qualified with SPE valid and service type from RXPP for latching. If SPE valid is high and the service type is 001, then the data is latched by the RXTDM_in along with the J1 valid flag. Once the data is latched, the FIFO written enable signals are generated for writing the latched data into the FIFO. Since only 16 bytes of incoming data are latched in any clock and there are 192 FIFOs for accepting the data, the FIFO enable signals are decoded to qualify with the sub-column number.

The RXPP block also generates 16-bit AIS-P signals. These signals represent the AIS-P condition on the line side. These signals have to be decoded into 192 signals, one for each STS-1, by qualifying the sub-column number. The 192 AIS-P signals are sent to the RXTDM_FIFO module for crossing the clock domain.

RXTDM FIFO (RXTDM_FIFO)

There are 192 16×9 FIFOs inside this module, each for one STS-1. Multiple FIFOs can be grouped together to support any concatenation. Each FIFO has its own set of read and write pointers as well as status such as underflow/overflow, AIS-P, and watermark crossing. The writing of the FIFOs are controlled by the SPE valid signals and the service-type signals from RXPP. The reading of the FIFOs are controlled by the pointer generation logic in the system clock domain.

The purpose of these FIFOs is to help the data cross the clock domain. The write happens at the line-side clock while the read happens at the system-side clock. For the write, the FIFO simply accepts all the data whenever the SPE valid signal is active and the service type is right. However, the read can be adjusted according to the watermark crossing that will be explained later.

In order to minimize the area impact from the FIFOs, 12 FIFOs are implemented with a single two-port memory. Since only 16 bytes are written or read at a time, we can use different sub-column number to determine which FIFO to write or read. The FIFOs are arranged as shown in FIG. 99.

Sixteen two-port memories are used to pack 12 FIFOs individually. The memory is 16×128. The depth is 16 since each FIFO is 16-level deep. The width is 128-bit only 108 bits are used since each FIFO takes 9-bit input data (8-bit data plus a J1 flag bit). During the write operation, the write address is actually the multiplexed write pointer. The multiplex is based the line-side sub-column number. For example, when the sub-column number is zero, the first FIFO of each memory is written. The write data is shared by all the FIFOs of each memory. For read, the read address is multiplexed by the system-side sub-column number and the read address is the read pointer.

The FIFO underflow and overflow conditions are determined in the read clock domain (the system clock domain). In order to compare the read and write pointers constantly, Grey code is utilized to avoid the synchronization error. The write pointer is first encoded to a Grey-coded number. The number is then synchronized to the read clock domain along with the write command. At the read clock domain, the encoded number is then decoded back to binary format and used to compare against the read pointer.

A set of watermark registers are used to compare against the difference between the read and the write to provide the information for the pointer generation logic to perform pointer increment or decrement. Since the pointer increment/decrement can only happen once per frame, the write pointer needs to be latched once per frame. During the H1 minus one timeslot, a signal is sent from the pointer generation logic and then synchronized to the write clock domain to latch the write pointer. Then the latched pointer is compared with the read pointer to generate, the difference at the HI timeslot. Since there are 12 clocks in one timeslot, the latched write pointer is stable when the comparison happens. By doing this, we can save many flops for synchronization. The difference between the read/write pointers is then compared with the watermarks. If the difference is larger than the high watermark, the decrement is required at, the pointer generation logic. If the difference is less than the low watermark, the increment is required.

All 192 FIFOs perform the comparison on the read/write pointers to provide the status for overflow/underflow and increment/decrement. However, only the information from those FIFOs designated as the master channels are used later in the pointer generation logic. The read/write pointers of the same channel are advancing at the same pace; therefore, the information from all the FIFOs is identical. The configuration memory in the pointer generation logic determines which FIFO is the master channel.

During AIS-P, all the FIFOs corresponding to the same channel are held in the reset state. The AIS-P is determined on the pointer generation logic that is operating in the system clock domain. The pointer generation logic sends 192 reset signals to the FIFOs, each reset signal is connected to one FIFO. By doing so, the pointer generation logic can specifically hold those FIFO of the same channel into the reset state. The reason behind this is that all the FIFOs of the same channel should behave exactly the same, so that the data read from these FIFO are in sync. The reset signals coming from the read clock domains are directly synchronized to the write clock domain to hold the write pointers at the default position.

The AIS-P condition will hold the FIFO in the reset state. Since the FIFO is operating in two different clock domains, the reset state has to be removed in each clock domain separately. For the read clock domain (the system clock domain), the reset is removed during H3 timeslot since after reset no′ read happens during the H3 timeslot, which allows the read pointers of those FIFOs belonging to the same channel to have the same pointer value. In the write clock domain (the line clock domain), there is a state machine to determine when the reset can be removed. Since the FIFO reset signals are coming from the read clock domain, there is a signal from the read clock domain that is synchronized to the write clock domain to trigger the state machine. The signal is active once per frame and it is active during die H3 timeslot. After receiving the synchronized signal, the state machine waits until the sub-column number wraps around, then starts to remove the reset at the write clock domain. By doing so, the write pointer for the FIFO of the same channel can come out the reset state without being out of sync.

In order to come back from AIS-P automatically, the pointer generation logic needs to know when the RXPP starts to input valid data into the FIFO. The FIFO generates the data valid signal only when the FIFO is held under reset state. Whenever there is valid data from RXPP, the data valid signal is generated and synchronized to the read clock domain. After the pointer generation logic determines to remove the reset on the FIFO, then data valid signal is inactive at the same time when the reset at the write clock domain is removed.

RXTDM FIFO Output MUX (RXTDM-OMUX)

The purpose of this module is to perform 192-to-16 multiplex on data and FIFO status. The multiplexing is based on the sub-column numbers since the sub-column numbers contain the information about which FIFOs output should be fed into the next module. The FIFO status includes overflow/underflow (watermark crossing), AIS-P and first-byte valid status. These statuses are multiplexed with different pipeline stages of the sub-column numbers. This is because each status is needed in different time at the pointer generation logic.

RXTDM Pointer Generation Logic (RXTDM-PGEN)

The pointer generation logic performs the following tasks:

Pointer generation based on the J1 position and the system-side row, column and sub-column numbers.

Pointer increment/decrement based on the FIFO watermark crossing status.

Two frame wide window for automatic recovery from AIS-P.

Forcing AIS-P based on the FIFO underflow/overflow conditions.

Before discussing these tasks in greater detail, we should first look at those memories that help perform these tasks. There are three memories used in this module as listed below:

Configuration memory.

Pointer storage memory.

State variable memory (32-port memory).

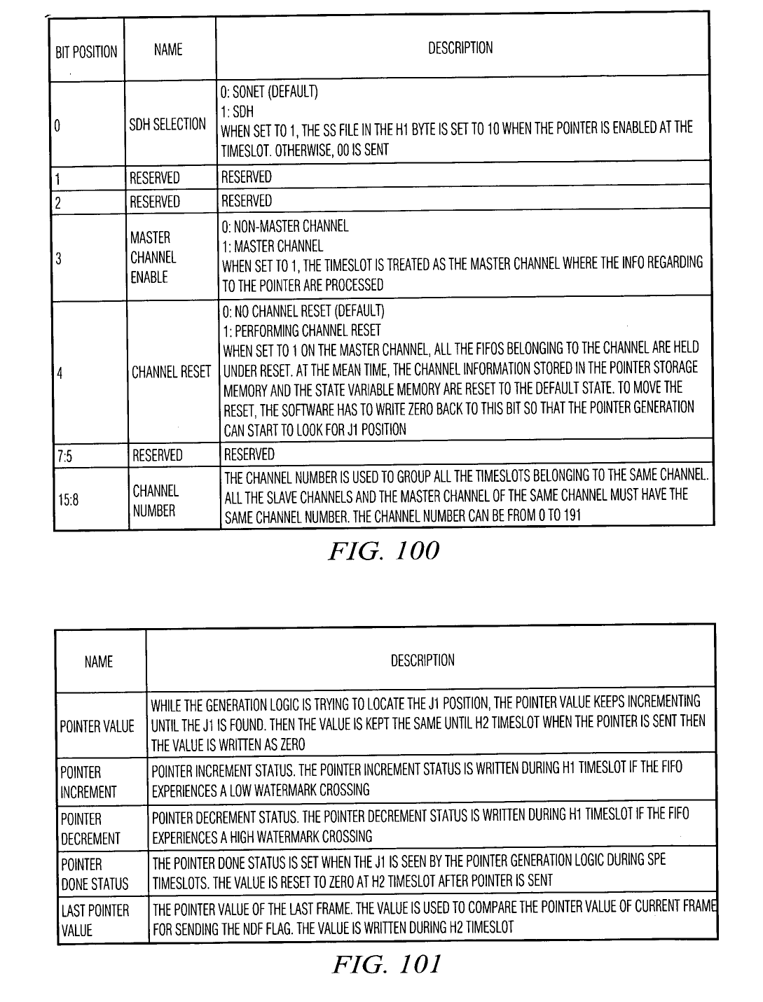

The configuration memory is used to store all the channel information based on timeslot locations. There are 192 locations and each location must have its own configuration information stored in this memory. The information includes that shown in FIG. 100.

Only software through the host interface can write data into the configuration memory. The pointer generation logic only reads the data without modifying. The memory is implemented by using a two-port (one read port plus one write port) memory. In order to allow two agents (host interface and the pointer generation logic) to read at the same time, we need arbitration logic. Internally, the pointer generation logic uses the sub-column number to read the memory. When a read from the host interface is issued, the read address (bits[7:4]) is compared against the sub-column number. If there is a match, the read data is multiplexed according to read address (bits[3:0]) and is latched. The latency of the read cycle can be longer due to the sub-column number match, but we can save lots of area due the deployment of two-port memory instead of dual-port memory.

The pointer storage memory is used to keep the information that is used for the master channel only. The information includes that shown in FIG. 101.

The information stored in the pointer storage memory is written with the default value when channel reset bit of the master channel is one. All of them have the default value of zero except the Pointer Done Status. This is because this bit inhibits the update of the pointer value, and during channel reset, the pointer value should be kept at zero.

The third memory inside the pointer generation logic is the state variable memory. This is a 32-port memory that has 16 write ports and 16 read ports. The variables are written by the master channels but shared by all the timeslots belonging to the same channel. In each cycle, the pointer generation logic processes 16 bytes at a time and the 16 slices of logic need to read/write at the same time. Therefore, 16 read ports and 16 write ports are required. The channel number from the configuration memory is used as the address for accessing the memory. However, only the timeslot with pointer enable bit set to one is able to write back data into the state variable memory.

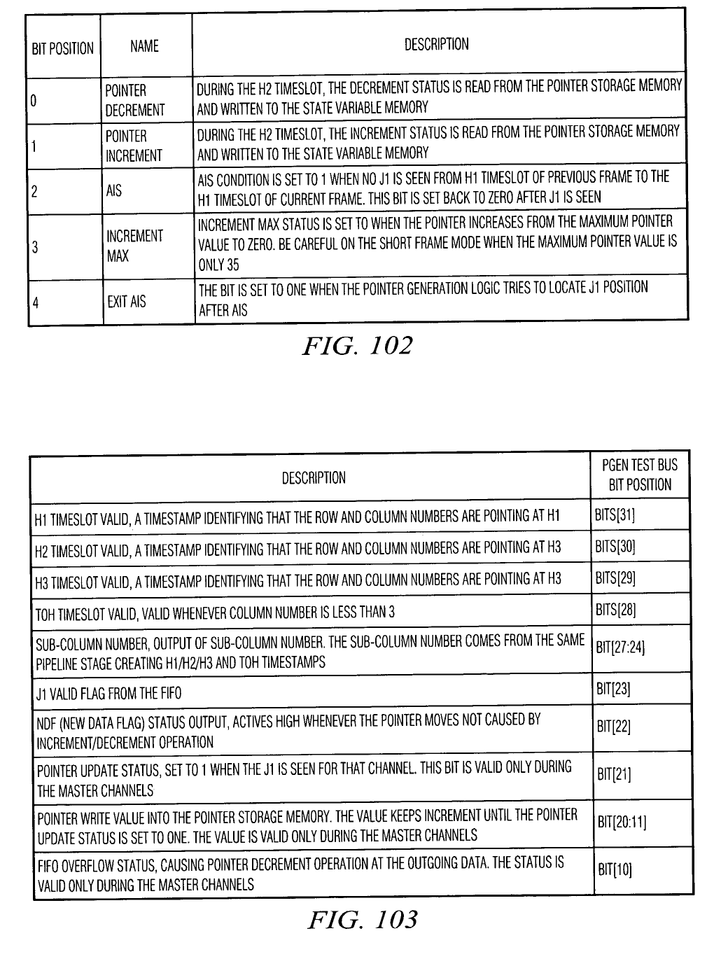

FIG. 102 details the bit description of the state variable memory.

There are four pipelines groups inside RXTDM_PGEN.

Configuration data pipeline.

Pointer status pipeline.

State variable pipeline.

Data pipeline.

These pipelines will be described in detail in the following paragraphs. Since 16 bytes are processed every clock, these pipelines have 16 copies to process 16 bytes.

The configuration memory is written through the host interface only. Inside the pointer generation logic, the data is read from the memory and pipelined to match the same timing as the other pipelines. The memory is accessed by the sub-column number for 16 timeslots of information. Then the information is pipelined accordingly to match the other two pipelines.

The pointer status pipeline is for processing the information that belongs to the master channel only. This information includes the intermittent pointer value, pointer increment/decrement status, pointer update status, current frame pointer value, and the first frame exiting AIS. When the master channel is enabled, this information is written back and read from the pointer status memory. If the byte being processed is designated as slave channel, the pointer status values are simply written back as A zero.

The intermittent pointer value is reset to zero at H2 timeslot and incremented during the SPE until J1 is detected. After J1 is detected, the pointer update status is set to one, which will further prevent the intermittent pointer value from increasing. At the H3 plus 2 timeslot, if the pointer update status is not set to one then the intermittent pointer value is set to one forcefully so that the intermittent pointer can increment at following timeslots. During the TOH, the intermittent pointer value is not supposed to increment. When channel reset is active, the intermittent pointer value is set to all ones to prevent any further increment.

The pointer update status is reset to zero during the H2 timeslot and set to one when the J1 is seen to stop the increment of the intermittent pointer value. During channel reset, the bit is set to one to prevent any increment forcefully. There are two places where J1 is detected but should not update the pointer status. The first one is during the TOH columns. The second one is the H3 plus one timeslot when there is a pointer increment. During the pointer increment, the H3 plus one timeslot is treated as non-SPE timeslot; therefore, if J1 is seen here, it is not qualified as the right pointer position.

The pointer increment/decrement is determined by the FIFO watermark crossing status. When the high watermark is crossed, then a decrement is required and when the low watermark is crossed, an increment is needed. The watermark crossing status comes from the FIFO and then it is written to the pointer status memory at the H1 timeslot. During the channel reset, these bits are written with zero. If the timeslot is designated as the slave channel, zero is written to these bits.

In order to set the NDF (New Data Flag) correctly, the pointer value is stored as the current framer pointer value and compared with the pointer value of the next frame. Since the pointer value is available at the master channel, during the slave timeslots, these bits are simply written with zero. At the H2 timeslot, the read pointer intermittent value is written to the current frame pointer value bits. However, there is a special case—if the pointer is incremented from the maximum pointer value, zero should be written to the current frame pointer value. This is because when the increment is from the maximum, the pointer value is out of range. The pointer value cannot be stored as the current frame pointer value. During channel reset, the current frame pointer value is set to zero.

In order to automatically recover from AIS-P, a two-frame window is allocated for J1 search. If J1 is seen, the right pointer is generated with NDF flag set. If not seen, the logic will go back to AMS condition, and wait for the data valid signal from the FIFO. The first frame exiting AIS flag is set to one at the HI timeslot and when the exiting AIS state variable is one. The flag is set to zero at the last pointer position of the next frame. The purpose of this bit is obviously to flag the first frame out of AIS-P.

The state variable pipeline interfaces with the 32-port memory since the nature of the state variable is single-write-and-multiple-read. The state variable is written only at the master channel but is read throughout all the slave channels of the same path. The broadcasting feature of the 32-port memory is well appreciated.

The increment/decrement status is read from the pointer storage memory and written to the state variable memory at H2 timeslot. The action taken for increment/decrement happens at the H3 or the H3 plus one timeslot. There is plenty of time for the 32-port memory to broadcast the information before the H3 timeslot. Then the increment and decrement status help all the timeslots to control the read on the corresponding FIFOs. For increments, the H3 plus one timeslot has no read operation for the FIFO. For decrement, the H3 timeslot must have read operation for the FIFO.

The AIS status is needed for all the slave channels in order to hold the corresponding FIFO in reset; however, it is only at the master channel where the decision is made. There are three conditions to generation AIS-P. The first one is the channel reset. The second one is when no J1 is seen from the H1 timeslot of the previous frame to the H1 timeslot of the current frame. The third condition is when RXPP generates the AIS-P condition. The AIS-P generated by RXPP is synchronized through the FIFO and sets the state variable. The AIS-P state variable is reset to zero when the J1 is seen after automatically recovering from AIS-P. If the increment from the maximum happens, the logic cannot enter AIS-P condition even though the J1 is not seen during SPE timeslots due to its shift into the TOH columns.

In order to generate the pointer correctly, the logic needs to know when the increment from the maximum pointer position happens. When the pointer position is at the maximum and the increment happens, the state variable is set to one. After J1 is seen in the SPE timeslots, then it is set to zero.

The exiting from AIS is another state variable used to remove the reset on the corresponding FIFO in order to locate J1 position. The bit is set when the channel is in AIS-P and the first valid byte status is available through FIFO. It is set back to zero if within the two-frame widow, a J1 is seen or no J1 is seen within the window. When this bit is set, the logic still holds the output data in the AIS-P state while searching for J1.

The data pipeline deals with the generation of pointers, SPE bytes, FIFO increment and FIFO reset.

The current pointer value is compared against the previous pointer value. If the pointer moves suddenly other than an increment/decrement, then the NDF flag is set. The increment/decrement information comes from the state variable pipeline.

The SS field of HI byte is set to 01 if the SDH mode is selected otherwise, 00 is set.

Normally, the pointer value comes from the pointer storage memory; however, the increment and decrement should be taken into account when the H1 and H2 bytes are generated. If increment is needed, the I bits should be inverted while the D bits are inverted when decrement is required. There are two exceptions. When the state variable increment from the maximum is set, the pointer value is forced to be zero. If AIS-P or channel reset is active, the pointer is set to be all ones.

The data pipeline is responsible for the FIFO read pointer increment. The pointer increment/decrement is meant for the adjustment on the read pointer to accommodate the frequency difference: During increment, the H3 plus one time slot (one of SPE timeslots) does not require the FIFO read pointer. On the other hand, during decrement, H3 timeslot (one of TOH timeslots), the FIFO read pointer should increment. Other than the two exceptions mentioned above, the FIFO read pointer increments only during SPE timeslots.

The read FIFO increment signal is generated clock by clock. Since only 16 of them are generated out of 192, the decoding logic is in place to output 192 FIFO read increment signals. The decoding logic simply qualified with the sub-column numbers.

The FIFO reset is set to one when the state variable AIS is one and exiting from AIS is zero which means the logic just enters the AIS and has not recovered from it yet. If existing from AIS is set to one, then the reset is removed to allow FIFO accepting data from RXPP and outputting data for J1 search. Since we generate 16 of these signals, again, the decoding logic is required; however, the decoding logic locates inside RXTDM_FIFO block.

The RXTDM system interface generates the system-side row, column and sub-column numbers based on the frame sync signal. The frame sync signal is an input to Titan and is synchronized from 622 MHz to 77 MHz. Once the signal is seen, it is treated as a software preset signal to set the system-side row, column and sub-column number to the programmed default value. As discussed in the register definition section, the row, column and sub-column number have different default values to select. For the row number, either row 0 or row 8 can be chosen. For column number, one can choose from 89 (the last column in a frame), 0, 1 and 2. As far as the sub-column is concerned, the full range can be chosen.

The RXTDM_SYSIF has the last stage of data pipeline for the data since this module is the last module in RXTDM.

RXTDM Register (RXTDM_REGS)

The RXTDM_REGS has the interrupt related registers, as well as some registers for RXSFR. There are two kinds of interrupts provided in this module underflow/overflow interrupts and AIS-P interrupts. These interrupts are provided in a STS-1 basis that means each FIFO generates three corresponding interrupts. The underflow/overflow interrupts are generated when a FIFO underflow/overflow happens. The AIS-P interrupt is generated when no J1 flag is seen from H1 timeslot to the H1 timeslot of the next frame. These interrupts can be masked by programming the corresponding interrupt mask register inside this module into one.

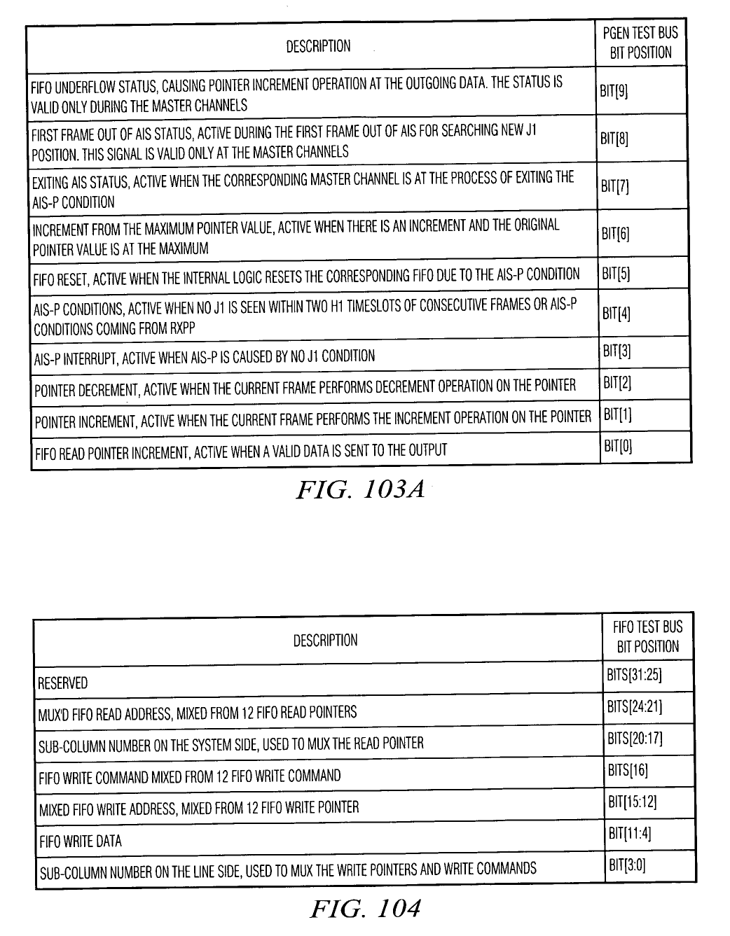

FIGS. 103 and 103A describe the pointer generator test bus bit positions.

FIG. 104 describes the FIFO test bus bit positions.

Receive System Framer (RXSFR)

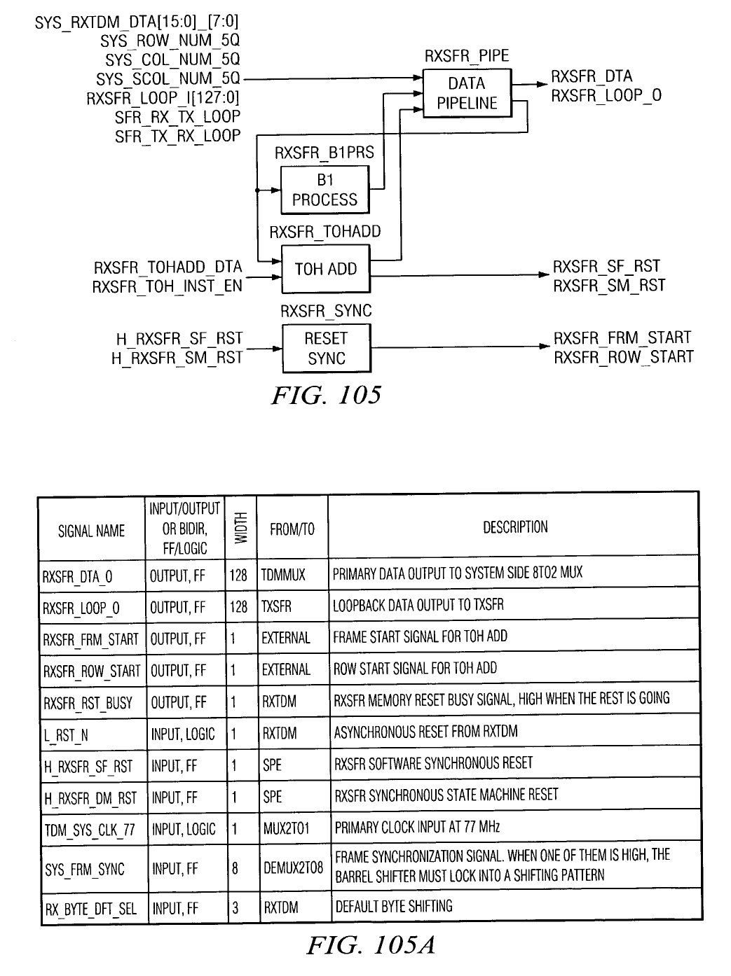

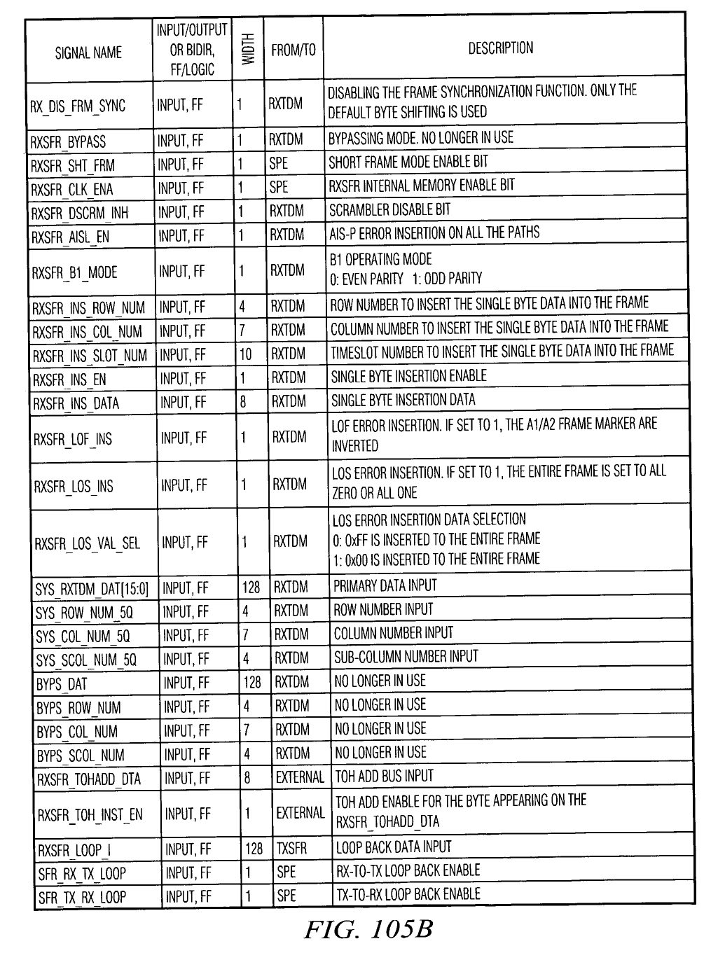

FIG. 105 is a top-level diagram of the modules contained within RXSFR. The interface signals are shown in FIGS. 105A and 105B.

RXSFR Features

Exemplary features of RXSFR include:

Inserting A1/A2 framing pattern.

Generating B 1.

1. A programming bit is provided to invert the B1 calculation result.

Inserting TOH data from external interface.

Inserting single byte data into the frame.

Inserting AIS-P conditions for all the paths.

Inserting LOF error by inverting A1 /A2 frame pattern.

Inserting LOS error by inserting all zero or all ones into entire frame.

Scrambling the data in OC-192 mode.

Providing barrel shifter to shift the data based on FRAME_SYNC signal and the default programmed byte shifting.

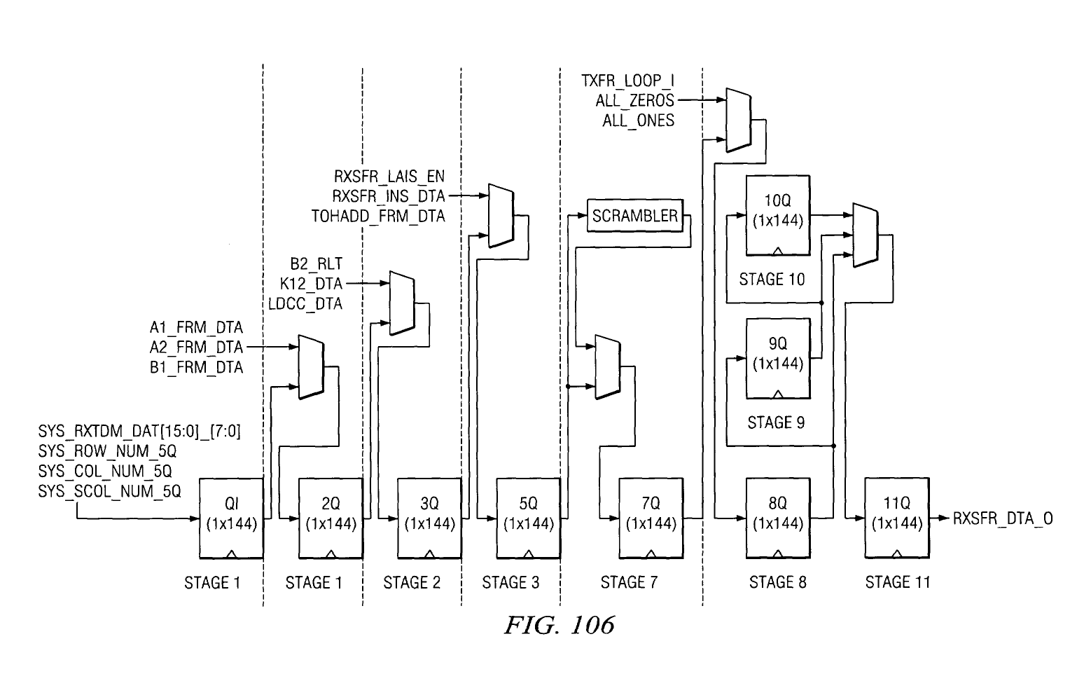

FIG. 106 shows the pipeline stages inside RXSFR design.

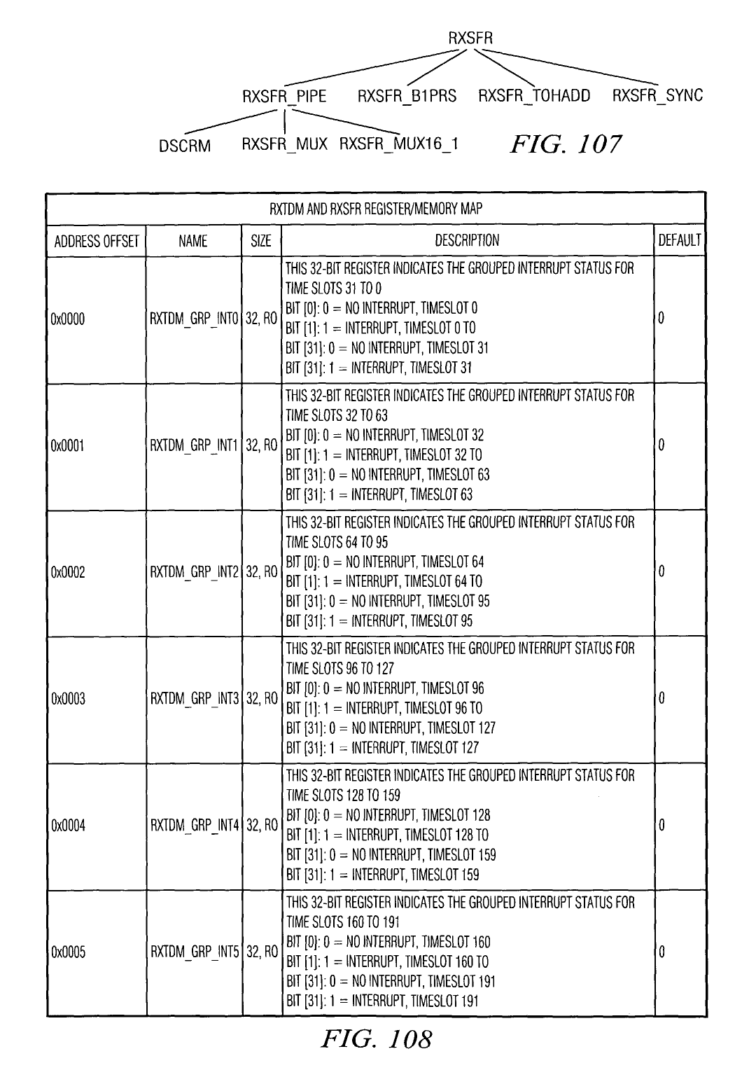

FIG. 107 is a tree diagram that shows the modular structure of the RXSFR design.

B1 Calculation (RXSFR_B1PRS)

The B1 calculation is the same as the module in the TX line-side framer. The calculation is for the entire frame after scrambling and inserted the B1 result in the data before scrambling.

For diagnosis purposes, B1 errors can be inserted by inverting the B1 result by programming RXSFR_B1_MODE register inside RXTDM module.

TOH Add Interface (RXSFR_TOHADD)

The TOH add interface is the same as the TX line-side TOH add interface; however, there are two differences. The first one is the clock. This interface is operating on the system side clock. The second is that this interface only operates in OC-192 mode. Please refer to the TX line-side framer for more details.

Synchronization Module (RXSFR_SYNC)

The function of this module is simple: synchronizing the reset signals to the local clock domain. The reset signals include the software reset and the state-machine reset coming from the SPE module.

Pipeline Stage (RXSFR_PIPE)

There are three main stages of the pipeline. The first one is for inserting AIS-P, B 1, TOH add bytes and the single frame byte from a programmable register. The second state is for scrambling. The last stage functions as a barrel shifter based on the FRAME_SYNC signal synchronization result.

The first stage pipeline multiplexes the frame marker, the B1 result, AIS-P, TOH add bytes and the signal frame byte. The frame marker is fixed because the framer is operating in OC-192 mode only. However, for diagnostic purposes, we can invert the frame marker to insert LOF. The B1 result comes from the RXSFR_B1PRS module and the TOH add bytes come from RXSFR_TOHADD module. The AIS-P insertion forces all ones on H1, H2, H3 slots and the entire SPE. This is qualified as AIS-P for all paths. In this pipeline stage, we can insert one byte in any position of the frame. The control registers are inside RXTDM. These registers include RXSFR_INS_ROW, RXSFR_INS_COL, RXSFR_INS_SLOT_NUM, RXSFR_INS_EN and RXSFR_INS_DATA. The summation determines how many byte shifts are required.

The second stage of pipeline is the scrambler. The scrambler is only operating in OC-192 mode. Please refer to the RX line-side framer for more details.

The last stage of pipeline acts like a barrel shifter. The synchronization for the FRAME_SYNC signal is from 622 MHz to 77 MHz. Therefore, potentially there is a 8-clock window in the 77 MHz domain in which the result from 622 MHz can fall. In order to compensate for this inaccuracy caused by the 8-clock window, a barrel shifter is designed to shift the bytes according to the synchronization result. The synchronization result is an 8-bit bus. The 8-bit result is then summed with the default byte shifting from RXTDM (RXTDM_BYTE_DFT_SEL). The summation then determines how many bytes are shifted. During the system side RX-to-TX loop back, this feature is disabled. It can be also disabled by the programmable register RXTDM_DIS_FRM_SYNC inside RXTDM module.

At the last stage of the pipeline, LOS can be introduced by multiplexing all zeros or all ones into the data stream. The enable bit is RXSFR LOS_INS and the value selection bit is RXSFR_LOS_VAL_SEL.

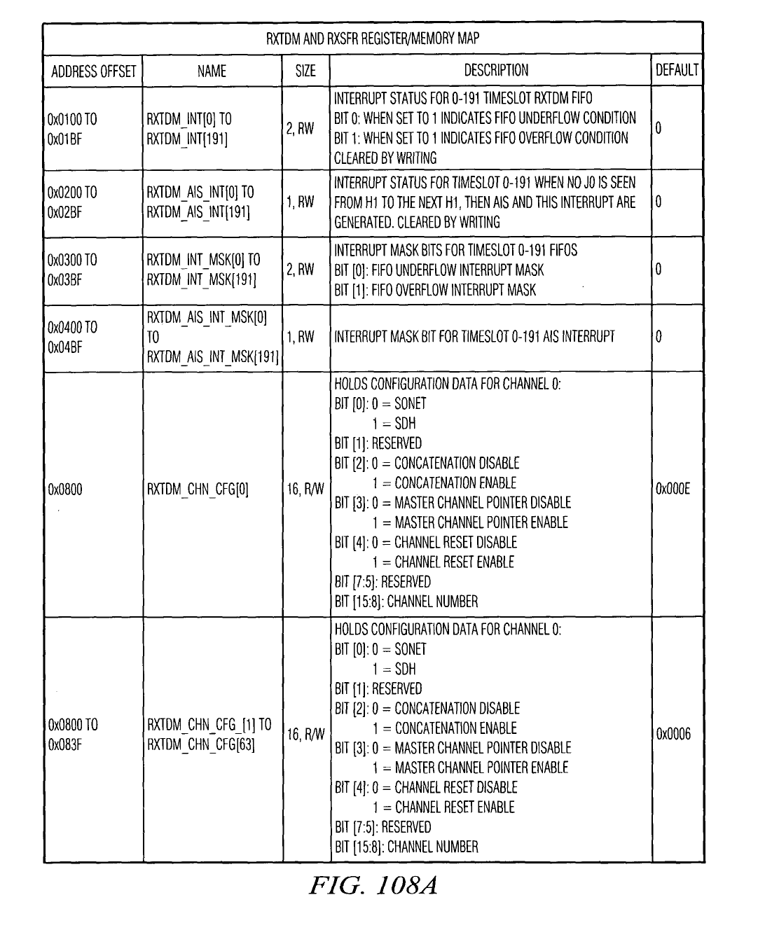

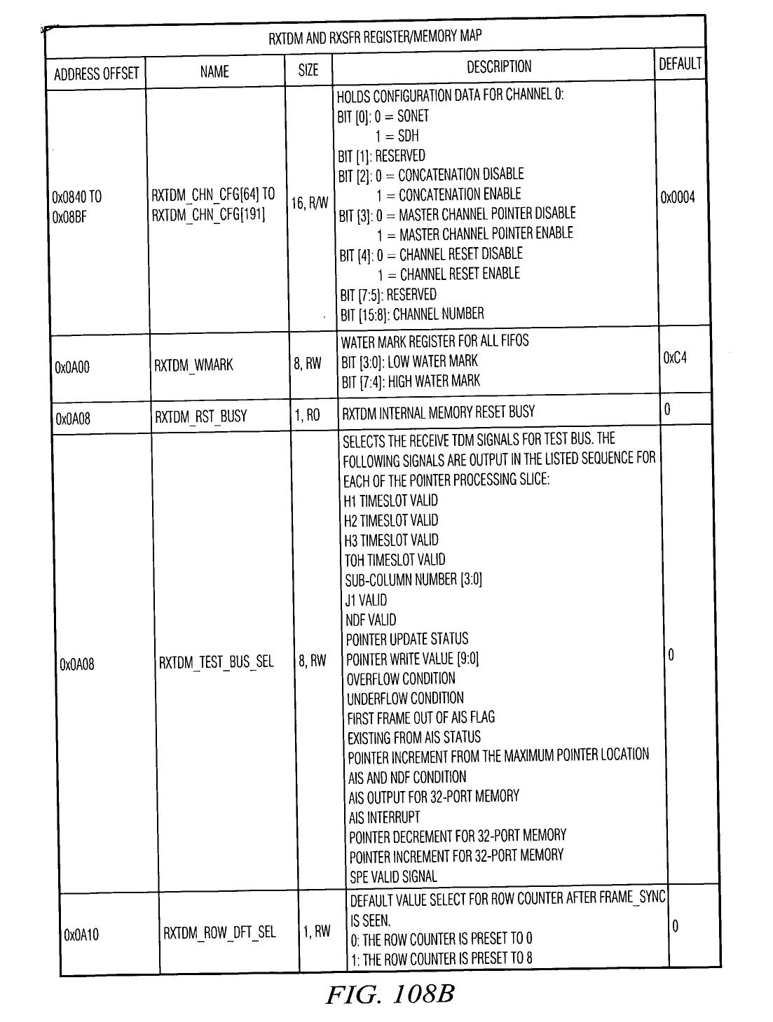

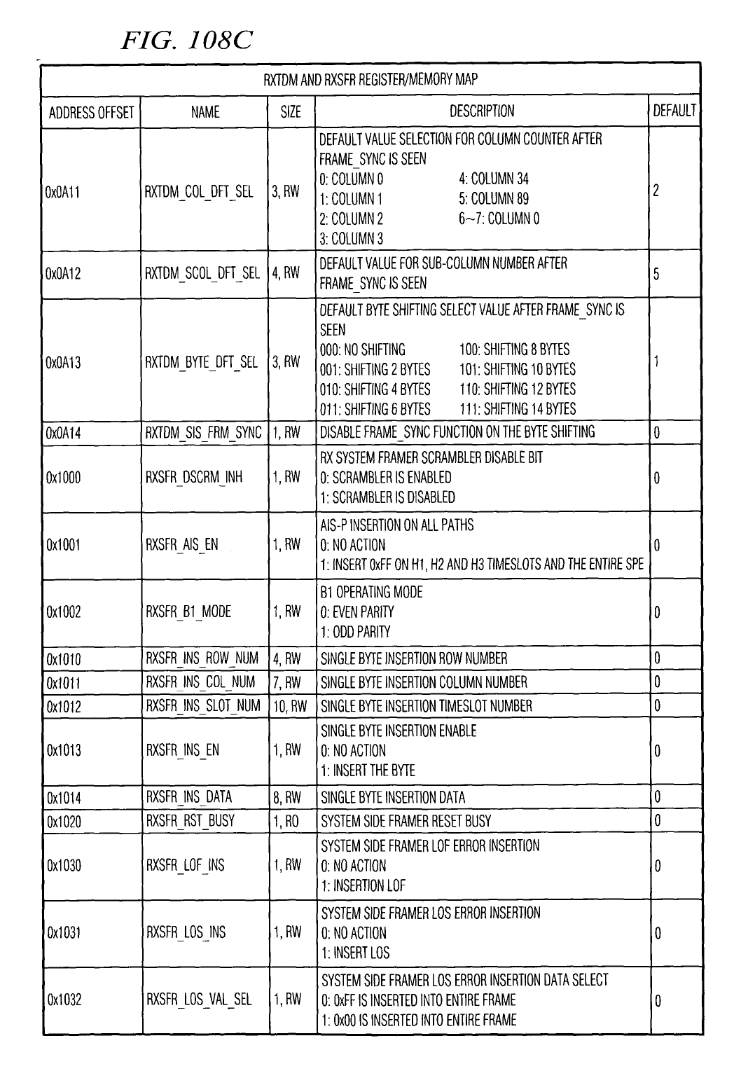

FIGS. 108-108C contain a memory map for all the registers and memories in the RXTDM and RXSFR designs. The address range reflects the generic address range based on an 18-bit address.

Transmit TDM (TXTDM)

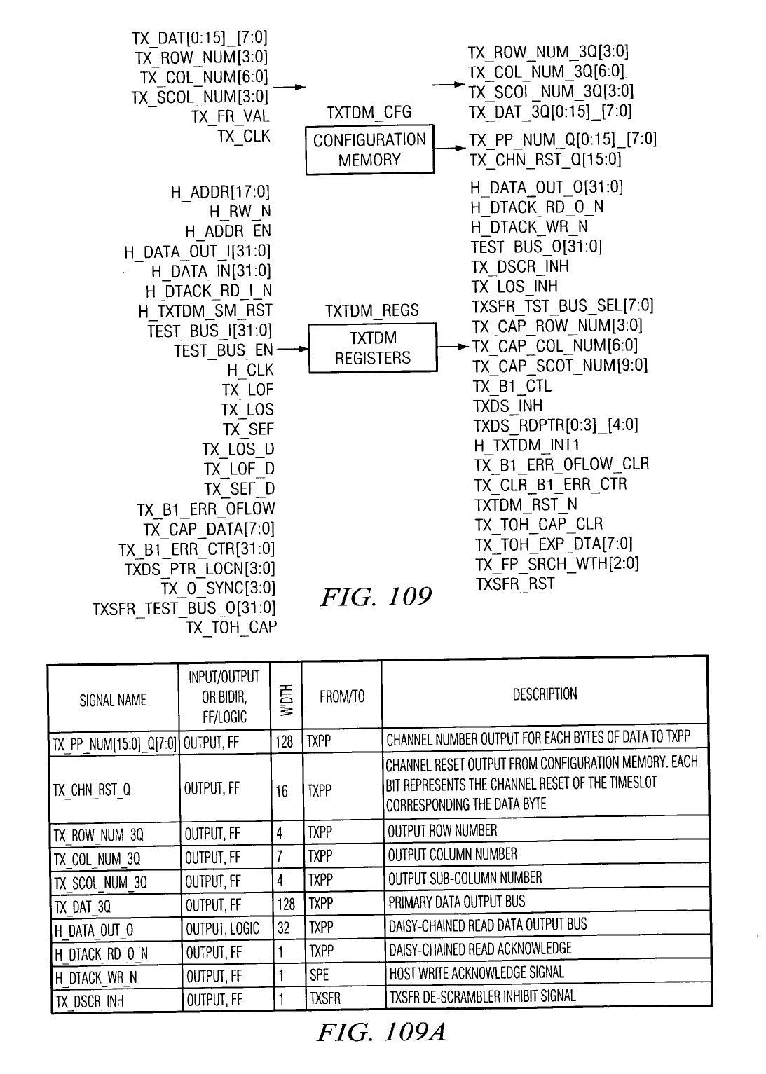

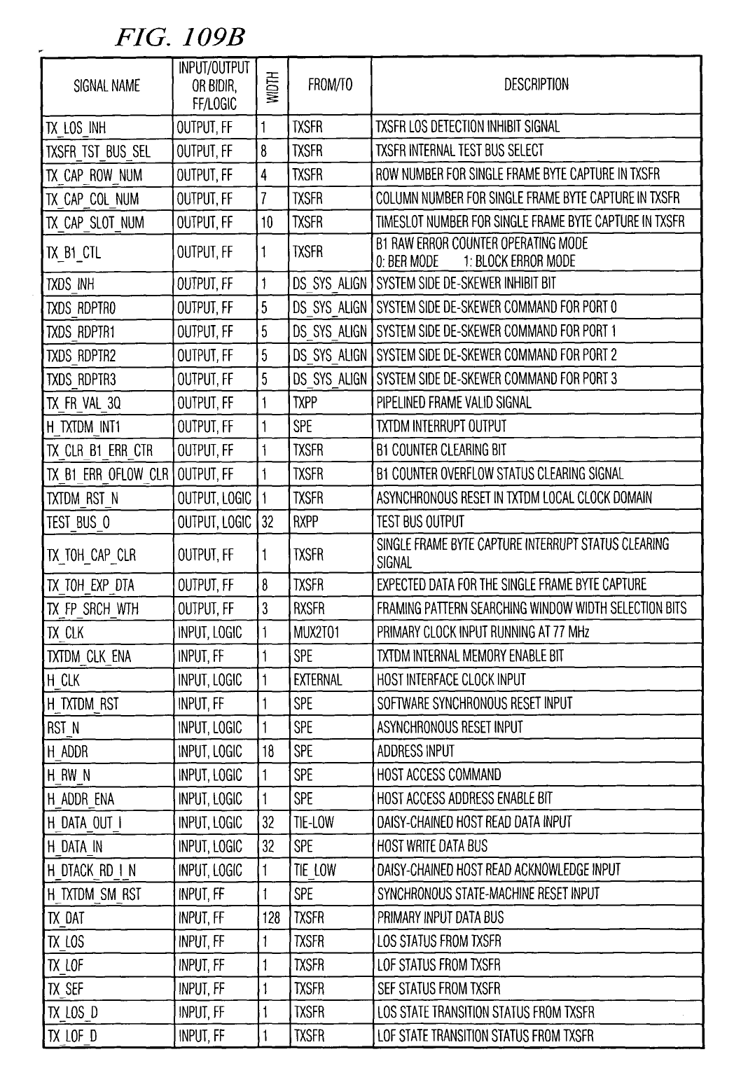

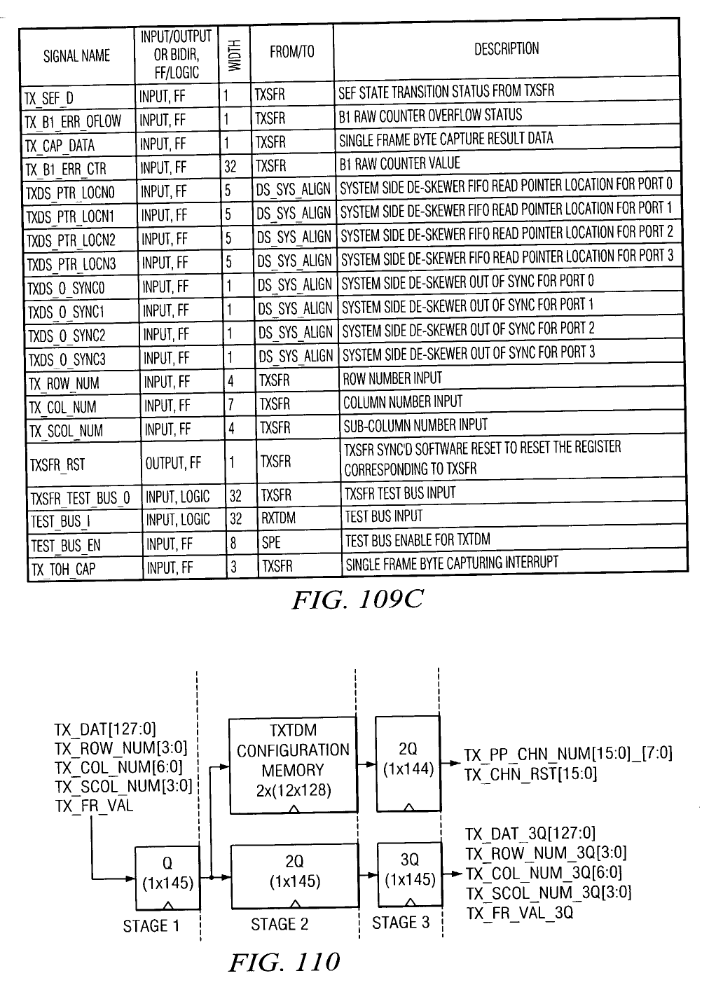

FIG. 109 is a top-level diagram of the modules contained within TXTDM. The interface signals are shown in FIGS. 109A-109C.

The TXTDM block is instantiated one time and provides the following exemplary features:

Configuration memory, synchronous two port memory, physically organized as 2×(12×128), logically organized as 192×16.

Pipeline stages 1, 2 and 3 for TXPP channel number and channel reset.

Pipeline stages 1, 2 and 3 for input row, column and sub-column numbers and input data.

Provides programmable read/write registers and interrupts for TXSFR and DS_SYS_ALIGN.

Test bus multiplexing for TXSFR state machines.

FIG. 1 10 describes the datapath of the TXTDM block.

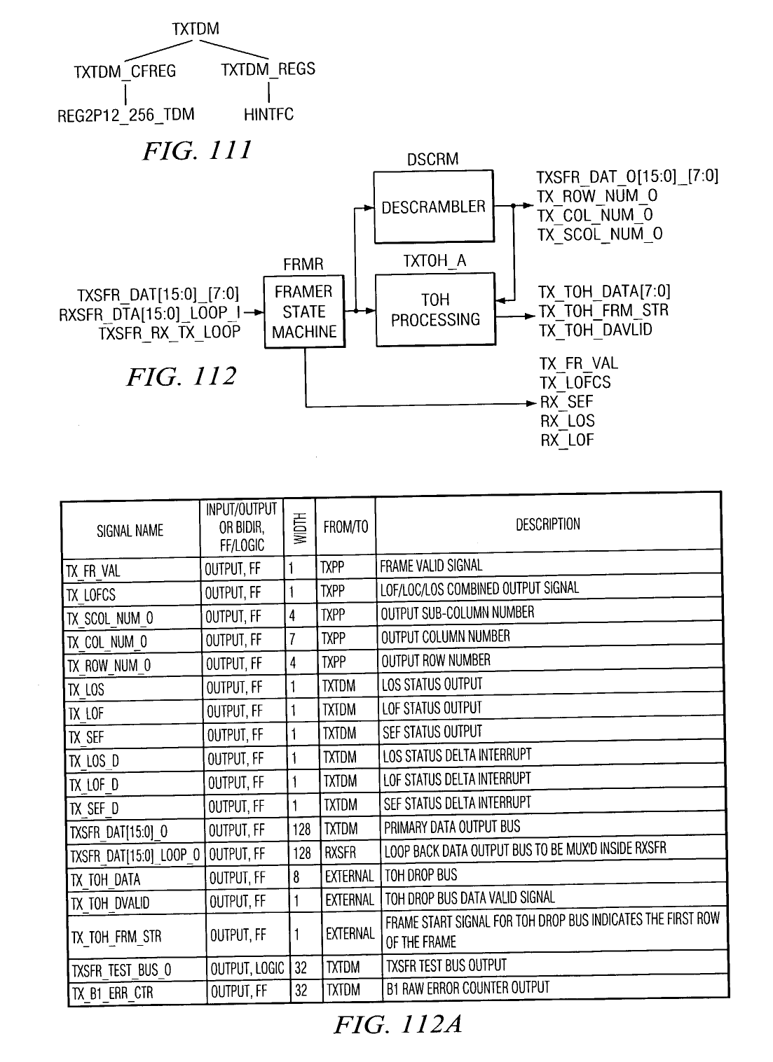

FIG. 111 describes the modular structure of the TXTDM block.

TXTDM Configuration Memory (TXTDM_CFG)

The configuration module stores all the configuration information accessed by the sub-column number. The information then is pipelined accordingly to the TXPP module. Please refer to the register definition for more details on the configuration registers.

The configuration memory is designed by two-port memory (one read port plus one write port). The write is only comes from the host interface. The read can be from the host interface and the internal logic. To arbitrate between two agents for read, the sub-column number is used to make the decision. The read address (bits[7:4]) from the host interface is compared against with the sub-column number. If they match, the data read from the memory is multiplexed according to bits[3 :0] to provide the read data for the host interface. The read from the internal logic always has the higher priority than the read from the host interface.

TXTDM Bus Interface and Registers (TXTDM_REGS)

The register module has all the registers of TXTDM and TXSFR except the configuration registers. It provides the decoding for accessing these registers as well as a state machine to interact with the host interface. It also has the data multiplexing for reading the registers. This module also includes the host interface module.

The TXTDM block does not output any signals onto the test bus but outputs the TXSFR state machine signals onto the test bus.

Transmit System Framer (TXSFR)

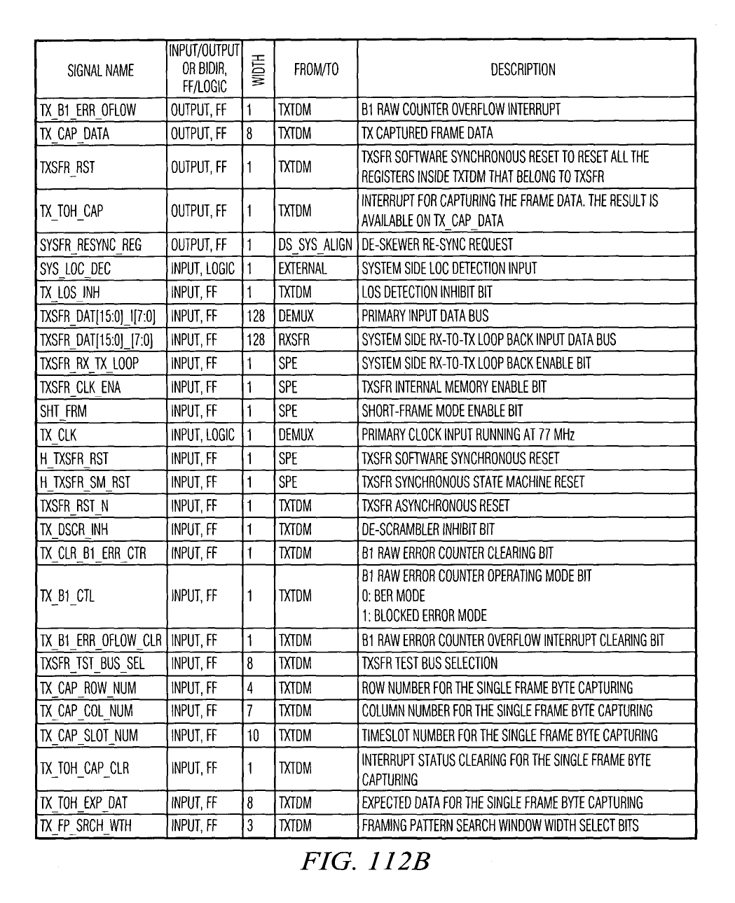

FIG. 112 is a top-level diagram of the modules contained within TXSFR. The interface signals are shown in FIGS. 112A and 112B.

Exemplary features of TXSFR include:

Framing Pattern match.

1. Programming window for A1/A2 pattern match while trying to go in frame.

2. Four byte window for A1/A2 pattern match while try to go back to in-frame while experiencing SEF.

3. Generating row, column and sub-column number based on the framing pattern matching while trying to go in frame.

Framing State Machine determines if the framer is in-frame, SEF or out of frame.

LOF (Loss of Frame) declaration and termination.

1. A counter to count consecutive bad frames for 3 ms in order to declare LOF.

2. A separate counter to count consecutive good frames for 3 ms in order to terminate LOF.

3. A good frame is defined as the framing pattern matches and appears at the right timeslot.

4. The framing pattern matching window is programmable from 4 bytes up to 12 bytes.

LOS (Loss of Signal) declaration and termination.

1. A counter to count consecutive all zero or all ones in the data for 50 us to declare LOS.

2. A separate counter to count for 125 us window, within this window if any non-zero or non-one pattern is seen then LOS is terminated.

LOC (Loss of Clock) reporting.

De-scramble the incoming data in OC-192 mode.

B1 calculation and comparison.

1. A 32-bit raw error counter is provided to count the error in either block mode or BER mode.

2. An interrupt is generated when the raw error counter overflow.

TOH dropping

1. Each TOH row is stored in the memory and dropped during SPE timeslots.

2. A data valid signal is generated.

3. A frame start signal is provided to flag the first TOH row.

Single frame byte capturing based on programmed row, column, and timeslot numbers and the expected data.

1. When the captured data is the same as the expected data, an interrupt is generated.

The following diagram shows the pipeline stages inside TXSFR design.

The following diagram describes the RTL hierarchy of the TXSFR module.

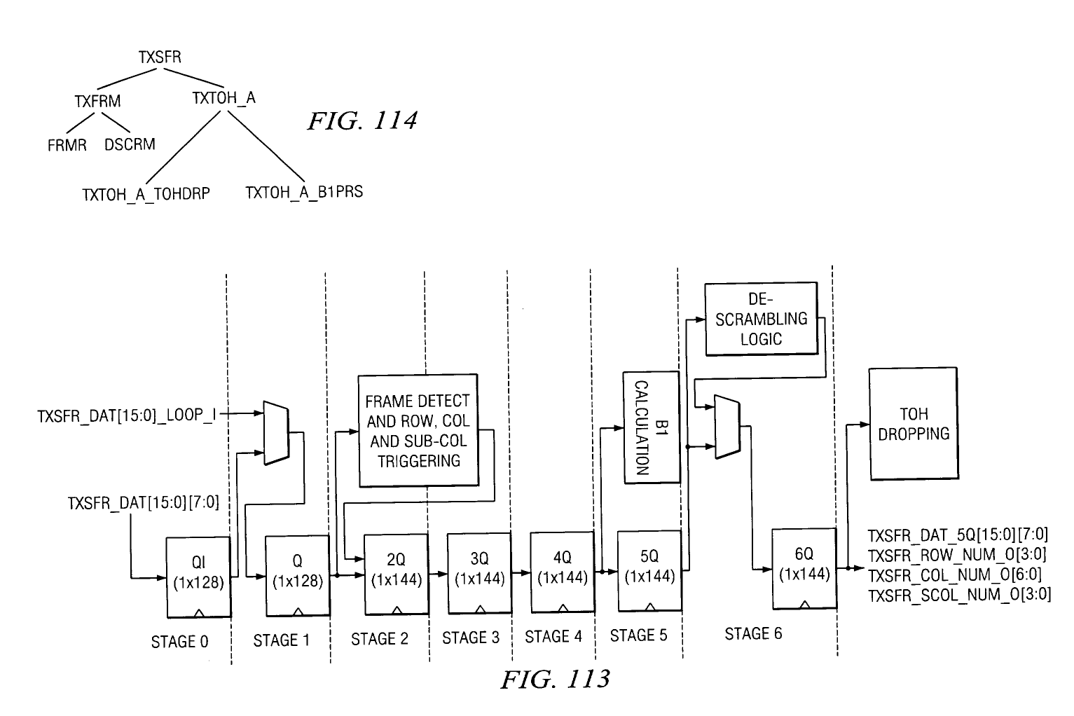

FIG. 113 shows the pipeline stages in TXSFR, and FIG. 114 shows the modular structure of TXSFR.

Framer State Machine (FRMR)

The module is the same as the RX line-side framer's FRMR module. The only difference is this module is operating in OC-192 mode only. Please refer to the RX line side framer for more details.

All the interrupts generated by this module are reported in the TXTDM module.

Scrambler (DSCRM)

The scrambler uses the same module as that inside the RX line-side framer. Again, the difference is this module only operates in OC-192 mode only. Please refer to the RX line-side framer for more details.

TOH Drop (TXTOH_A_TOHDR0P)

The TOH drop interface is the same interface as that inside RX line-side framer. The differences are the clock and the mode. In this module, the clock is derived from the TX system-side clock and this module only supports OC-192 mode.

BI Calculation (TXTOH_A_B1PRS)

The B1 calculation module here does not provide SF/SD alarms. Only the error counter is provided to accumulate the errors. The counter can operate in two modes: BER and blocked error mode. The control bit is TXSFR_B1_MODE in TXTDM module. If the counter rolls over, an interrupt (TXSFR_B1_OFLOW_STAT) is set. This interrupt is also inside TXTDM module.

TXSFR Test Bus

The TXSFR block outputs the same signals onto the test bus as those described in the RXFR test bus section, since it instantiates the same FRMR design. These signals, are connected to the test bus via the TXTDM block, since that is where all the programmable registers exist.

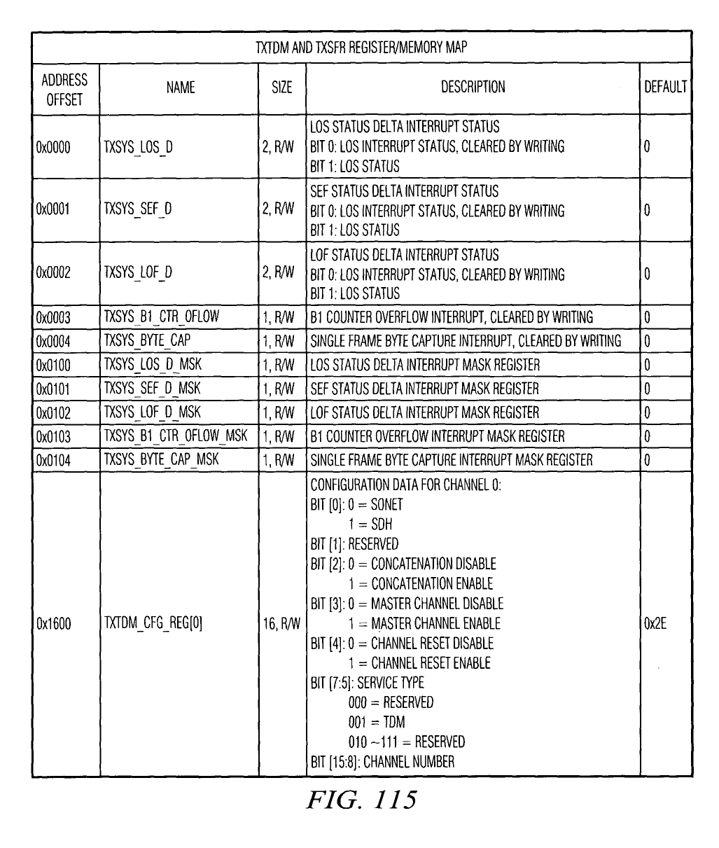

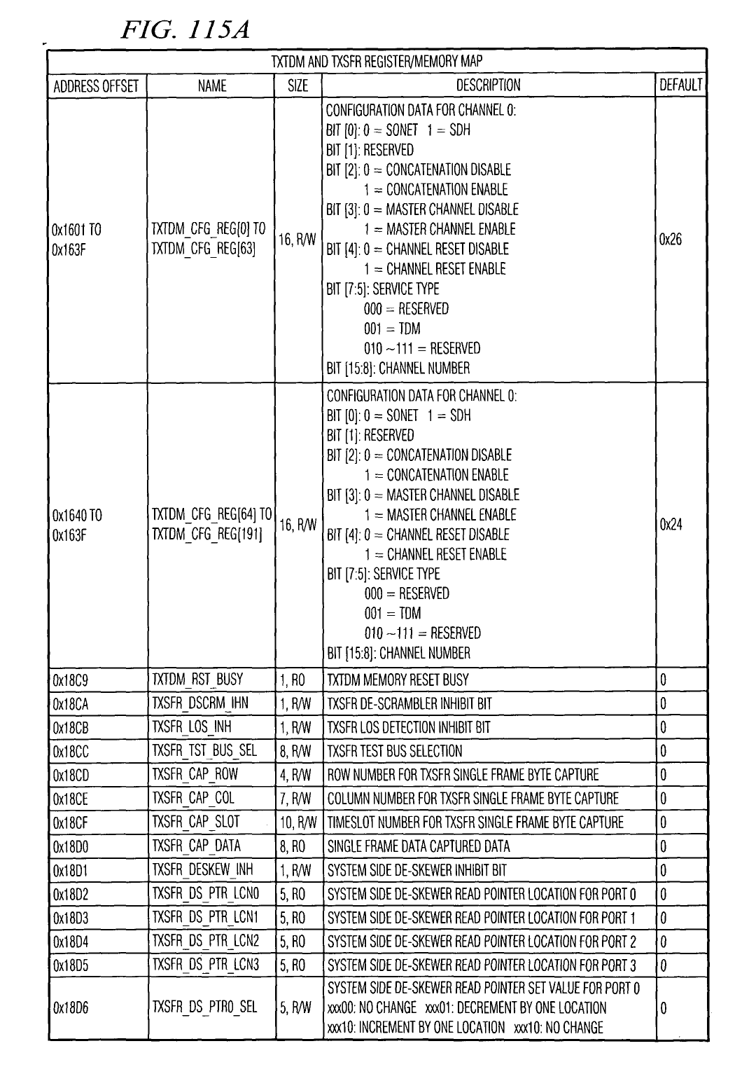

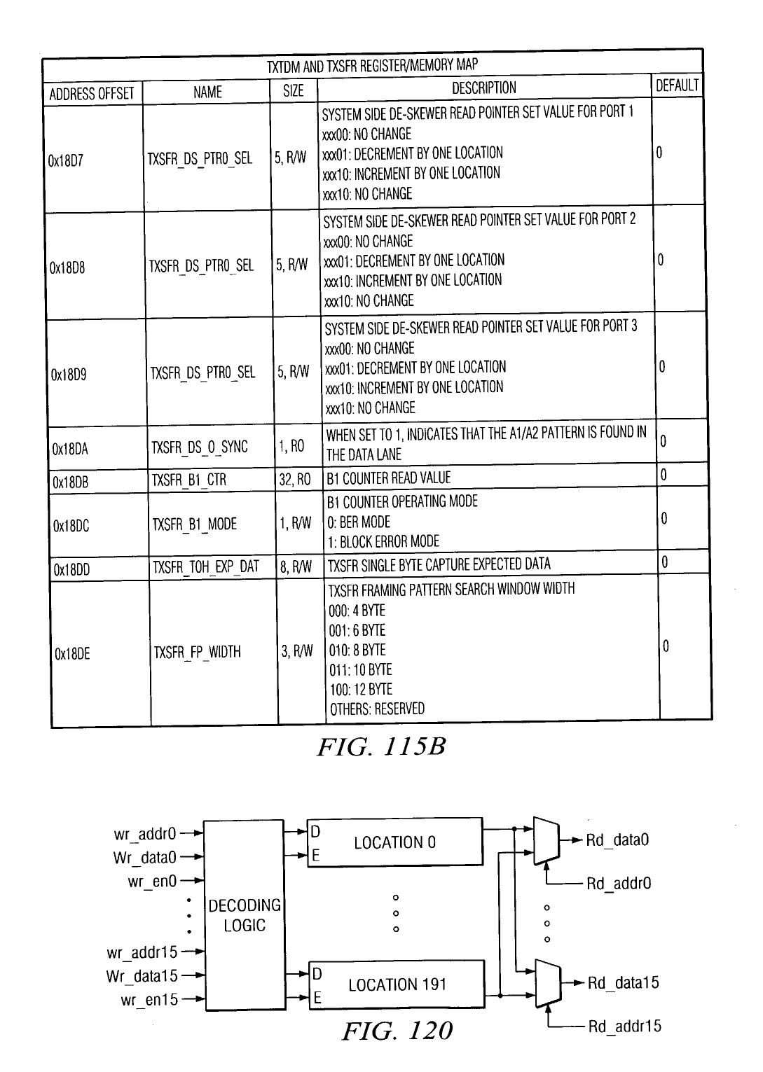

FIGS. 115-115B contain a memory map for all the registers and memories in the TXTDM and TXSFR designs. The address range reflects the generic address range based on an 18-bit address.

Although exemplary embodiments of the invention are described above in detail, this does not limit the scope of the invention, which can be practiced in a variety of embodiments.

What is claimed is:

1. A data processing apparatus, comprising:
an input for receiving input data that has been transmitted over an optical network;
a first switching apparatus coupled to said input and responsive to said input data for producing a first data stream having a first data rate;
a second switching apparatus coupled to said input and responsive to said input data for producing a second data stream having a second data rate; and
a data processor coupled to said first switching apparatus and said second switching apparatus for performing data processing operations on either of said first and second data streams.

2. The apparatus of claim 1, wherein said optical network is a SONET network, and wherein said first and second data streams respectively correspond to OC-192 and OC-768 data streams.

3. The apparatus of claim 1, provided on a single chip integrated circuit device.

4. A data processing apparatus, comprising:
an input for receiving a data stream that has been transmitted over an optical network;
a framer coupled to said input for identifying within said data stream a plurality of data frames, each said data frame including a payload portion and an overhead portion;
a data processor coupled to said framer for performing data processing operations on said data frames; and
a data port coupled to said framer for providing access, externally of said data processing apparatus, to said overhead portions of said data frames.

5. The apparatus of claim 4, wherein the optical network is a SONET network, said frames are SONET frames, and said overhead portions are transport overhead (TOH) portions of said SONET frames.

6. The apparatus of claim 5, provided on a single chip integrated circuit device.
